(19) United States
(12) Patent Application Publication
(10) Pub. No.: US 2018/0095653 A1
(43) Pub. Date: Apr. 5, 2018

(54) DEVICE, METHOD AND GRAPHICAL USER INTERFACE FOR HANDWRITTEN INTERACTION

(71) Applicant: Martin HASEK, San Francisco, CA (US)

(72) Inventor: Martin HASEK, San Francisco, CA (US)

(21) Appl. No.: 15/236,446

(22) Filed: Aug. 14, 2016

Related U.S. Application Data
(60) Provisional application No. 62/204,989, filed on Aug. 14, 2015.

(51) Int. Cl. G06F 3/0488; G06F 3/0354; G06F 3/041; G06F 3/0481; G06F 1/16

(52) U.S. Cl. CPC G06F 3/04883; G06F 3/03545; G06F 1/1626; G06F 3/04817; G06F 1/1609; G06F 3/0412

(57) ABSTRACT

A device, method and graphical user interface to facilitate handwritten interaction. The device includes a core hardware module including a stylus digitizer and electronic paper display and a stylus as handwritten input for the stylus digitizer. The device also includes a handwriting interface to enable drawing, writing and handwritten interactions thereby providing a user with a completely new handwriting experience and digital interaction. The handwriting interface is one of a monochrome interface and color interface. Further, the device includes a slate configured with the monochrome interface and includes a toolbar with a plurality of tools and brushes. Furthermore, the device includes a plurality of interface elements to enable handwritten interaction to achieve a unique look of the graphical user interface and an input area configured in the monochrome interface to allow a user to edit and redraw a design of an interface element or current graphical design of the interface. Moreover, the device includes an imprint area with a brush tool to enable the user to define a pattern by drawing and a plurality of functional brushes to enable specific functions in the drawing.

### TECHNICAL FIELD

Embodiments of the disclosure relate generally to handwriting devices. Embodiments relate more particularly to provide a unique digital interface/platform for electronic handwriting interaction.

### BACKGROUND

Handwriting is a style or manner of writing by hand that characterizes a particular person. Today, pencil and paper has evolved into natural digital paper interfaces. Several handwriting applications exists that allow users to handwrite on their device (such as iPads) using a finger. Further, tablet devices with stylus inputs have now become increasingly popular. A few existing handwriting devices with stylus input are usually using LCD or OLED panels as the main display which leads to higher power consumption. Another pitfall is that these handwriting devices fails to provide a regular pencil and paper interaction and has very limited readability on sunlight. However, none of the applications provide a handwritten interaction.

In the light of the above discussion, there appears to be a need to provide a device for handwritten interaction.

### OBJECTIVE OF INVENTION

The principal objective of the embodiments herein is to provide a complex handwritten networking platform and digital environment with robust handwritten interaction, networking and sharing.

Another objective of the embodiments herein is to communicate with other users via handwriting chat and other ways of networked writing.

Yet another objective of the embodiments herein is to allow users to use drawings and writings at the same time. The user can share the handwritten content with other users in network, in post time mode or in real time mode (such as handwritten chat of multiple users).

### SUMMARY

The above-mentioned needs are met by a device, method and graphical user interface to facilitate handwritten interaction.

An example of a device and graphical user interface to facilitate handwritten interaction. The device includes a core hardware module including a stylus digitizer and electronic paper display and a stylus as handwritten input for the stylus digitizer. The device also includes a handwriting interface to enable drawing, writing and handwritten interactions thereby providing a user with a completely new handwriting experience and digital interaction. The handwriting interface is one of a monochrome interface and color interface. Further, the device includes a slate configured with one of the monochrome interface and color interface and includes a toolbar with a plurality of tools and brushes. Furthermore, the device includes a plurality of interface elements to enable handwritten interaction to achieve a unique look of the graphical user interface and an input area configured in one of the monochrome interface and color interface to allow a user to edit and redraw an image. Moreover, the device includes an imprint area with a brush tool to enable the user to define a pattern by drawing and a plurality of functional brushes to enable specific functions in the drawing.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE VIEWS OF DRAWINGS

In the accompanying figures, similar reference numerals may refer to identical or functionally similar elements. These reference numerals are used in the detailed description to illustrate various embodiments and to explain various aspects and advantages of the present disclosure.

FIG. 01 is a basic generic view of Noteslate device 100, Noteslate stylus 101 with drawing tip 105 and eraser 107 for handwritten input 102, which is displayed on monochrome electronic paper display 104, additionally controlled by three programmable buttons 103, each of the buttons 111 112 113 has specific function in Noteslate interface, Noteslate branding 106, according to the embodiments as disclosed herein;

FIG. 02 is showing various sizes of Noteslate device, large Noteslate device 200 with 13.3-inch display size 204, medium Noteslate device 210 with 9.7-inch display size 214, small Noteslate device 220 with 6.0-inch display size 224, according to the embodiments as disclosed herein;

FIG. 03 is a basic view of Noteslate device 300 with monochrome 6.8-inch screen 304 and Noteslate stylus 301 for drawing input of handwritten content 302, which is displayed on monochrome electronic paper screen 304, additionally controlled by programmable buttons 303, according to the embodiments as disclosed herein;

FIG. 04 is showing overview of Noteslate device 100 parts assembly, which consists of device body housing 401, battery 402, PCB electronic circuits 403, soft buffer layer 407, stylus touch digitizer 404, electronic paper display unit 104, top frame panel housing 405 with optional finger touch (resistive or capacitive) layer 406, programmable three buttons 103, and stylus 101, according to the embodiments as disclosed herein;

FIG. 05 is a basic generic view of Noteslate device 100, Noteslate stylus 101 with drawing tip 105 for handwritten input 102, which is displayed on monochrome electronic paper display 104, additionally controlled by programmable three buttons 103, each button 111 112 113 has specific function across Noteslate interface, device body housing 401 and top frame housing 405, according to the embodiments as disclosed herein;

FIG. 06 is showing three options of front view of Noteslate device 100 and options for branding 106 and position of programmable buttons 103, according to the embodiments as disclosed herein;

FIG. 07 is showing three options of front view of Noteslate device 100 and options for programmable buttons 103 position, according to the embodiments as disclosed herein;

FIG. 08 is describing 13.1-inch Noteslate device 200, with three programmable buttons 103, 13.3-inch electronic paper display unit 204 for handwritten input with stylus 102, stylus contains drawing tip 105 and eraser 107, 13.3-inch Noteslate device has various connectors and switches, including share switch button 801 described in details on FIG. 20 and FIG. 21, including audio 3.5 mm jack output 802, Power ON/OFF button 803, USB micro connector 804, and micro SD card reader 805, according to the embodiments as disclosed herein;

FIG. 09 is describing optional finger touch input 902 by hand 901 which is available for Noteslate device 100, the basic handwritten input 102 is provided by stylus 101, stylus touch 110 and stylus digitizer 404 placed below the electronic paper display unit 104, the optional finger touch input 902 is provided by finger touch layer 406 above the electronic paper display unit 104, various combinations and functions of parallel inputs can be adjusted by the user by pressing or holding combinations of three programmable buttons 103, according to the embodiments as disclosed herein;

FIG. 10A illustrates three programmable buttons 103. The basic design consists of an overall circular shape 113 and embossed surface 115 with tiny tip 114 in the center which brings haptic feedback to the user. FIG. 10B-FIG. 10G show side profiles of various button shapes. FIG. 10H shows a different rectangular button shape with rectangular haptic tip 117 in the center. FIG. 10F (shown in side profile) shows a capacitive touch button 116 completely nested under the top surface of the Noteslate device, according to the embodiments as disclosed herein;

FIG. 11 is describing various actions programmed with three programmable buttons 103, these buttons 111 112 113 can be programmed to various functions, these functions can be adjusted to specific action in current drawing application, by various combinations of any buttons 111 112 113 user can define infinite amount of functions across the Noteslate interface, according to the embodiments as disclosed herein;

FIG. 12 is describing optional finger touch slider input 1201 by hand 901 which can be available on Noteslate device 100, the basic handwritten input 102 is provided by stylus 101 and stylus digitizer 404 placed below the electronic paper display unit 104, the optional finger touch input 902 is provided by finger touch layer 406 above the electronic paper display unit 104, various combinations and functions of parallel inputs can be adjusted by the user by pressing or holding combinations of three programmable buttons 103, the finger touch slider bar 1201 is placed on the edge of the device 100 and consists of 5 touch sensitive capacitive buttons 1301 1302 1303 1304 1305, by touch combinations of these buttons user can achieve various functions described in FIG. 13, according to the embodiments as disclosed herein;

FIG. 13 is describing finger touch slider input principles and touch combinations with 5 capacitive touch buttons 1301 1302 1303 1304 1305, by various combinations of finger touch, finger slide and various directions of finger movement user can call specific action in current Noteslate interface, e.g. page scroll, close page, etc., touch slider bar works with parallel touch inputs so user can define even more enhanced functions with two fingers, e.g. zoom in, zoom out, etc., according to the embodiments as disclosed herein;

FIG. 14 is showing different solution for programmable buttons 103 using capacitive touch technology below the front device surface 405, this feature is helping to achieve smooth continuous frontal device surface, the capacitive touch sensor 141 is placed under the surface creating continuous surface area, the electronic paper display unit 104 is nested on the same level to achieve completely smooth top device surface, no visible height difference at the edge 142 between display surface 104 and front panel surface 405, according to the embodiments as disclosed herein;

FIG. 15 is describing various actions programmed with three programmable capacitive buttons 103, these buttons 111 112 113 can be programmed to various functions, these functions can be adjusted to specific action in current drawing application, by various combinations of any buttons 111 112 113 user can define infinite amount of functions across the Noteslate interface, compared to regular programmable buttons capacitive solution can provide more enhanced ways of interaction (e.g. page scrolling, page navigation, page jumping direction, etc.), the exact touch sequence of touch button input is essential for the accurate functionality, according to the embodiments as disclosed herein;

FIG. 16 is showing magnetic holder functionality of Noteslate device 100, the stylus 101 can be freely lay down to the display area 104 and stays there thanks to magnetic mechanism inside the stylus 1600 and the opposite magnetic functionality 1601 behind the display area, the magnetic power provided by the holder 1602 keeps the pencil stable on the device surface 1603 against gravity or movements, according to the embodiments as disclosed herein;

FIG. 17A-FIG. 17F show different designs for the side profile of the Noteslate device body 100. FIG. 17A shows a minimal side edge profile 1700 with respect 1701 to back flat surface. FIG. 17B shows a smooth curvature. FIG. 17C shows a minimal curvature 1703 to achieve the thinnest visible device profile 1700. FIG. 17D shows a curvature profile defined by two symmetrical parts—front panel 1705 and back slate body 1706 symmetrical about horizontal axis 1704 to achieve smooth shape. FIG. 17E shows a block design 1707 of the device body. FIG. 17F shows a block design 1707 with enhanced embossed paper block texture 1708, according to the embodiments as disclosed herein;

FIG. 18A-FIG. 18B show the placement of connectors on Noteslate device 100. FIG. 18A shows a minimal side edge profile 1700 with respect 1701 to back flat surface. The continuous connectors outline 1801 has the same angle and is similar to side profile 1701. Connectors 801 802 803 804 805 are placed on a flat vertical surface. FIG. 18B shows profile curvature 1702 with a smooth outline. The continuous connectors outline 1802 has the same angle and is similar to side profile 1702. The connectors 801 802 803 804 805 are placed on a flat vertical surface, according to the embodiments as disclosed herein;

FIG. 19 is a placement of connectors on the Noteslate device 100, according to the embodiments as disclosed herein;

FIG. 20A shows share switch button 801 moving in a sequence (AA-AB-AC) from left to right to make the online sharing 1500 available and get connected to the network 1510. The share switch button turns on/off Wi-Fi module or 3G/4G module to connect and activate the sharing features in Noteslate. The button can be operated by using the stylus 101 and the precise stylus tip 105 which fits into sharing switch button 2001. The user can switch the button 2002 from left 2003 to the right 2004 to turn on the sharing feature on Noteslate device 100. Network status is indicated on the device with two icons, 2003 showing offline status, 2004 showing online status. FIG. 20B shows the reverse sequence (BA-BB-BC) for using share switch button 801 to turn OFF the online sharing, according to the embodiments as disclosed herein;

FIG. 21 is describing the alternative share switch button 801 design, the functionality is the same as on stylus controlled share switch button design, to make the online sharing 1500 available and get connected to the network 1510, using the finger tip 901 which fits into sharing switch button 2101, user can switch the button 2102 from left 2003 to the right 2004 to turn on the sharing feature on Noteslate device 100, the status is indicated on the device with two icons, 2003 showing offline status, 2004 showing online status, according to the embodiments as disclosed herein;

FIG. 22 is a drawing of Noteslate stylus 101 with hexagonal design 2201, the stylus contains rubberized drawing tip 2202 and eraser 2203, it contains also two optional functional buttons 2205 2207 placed on the stylus body 2206 2208, according to the embodiments as disclosed herein, e.g. these functional buttons can be used for eraser/function 01 2205 or gesture input/function 02 2207;

FIG. 22A and FIG. 22B are describing various thickness of eraser line 2220 2221 based on the direction user holds the stylus eraser 2202 towards the display surface 104, eraser tip 2202 has two different widths 2210 2211 to achieve two various eraser line thickness 2220 2221, custom branding 2222 can be added on the stylus, according to the embodiments as disclosed herein;

FIG. 23 is a drawing of Noteslate stylus 101 with triangular design 2301, the stylus contains rubberized drawing tip 2302 and eraser 2303, it contains also two optional functional buttons 2304 2305 placed on the stylus body 2306, according to the embodiments as disclosed herein e.g. these functional buttons can be used for eraser/function 01 2304 or gesture input/function 02 2305;

FIG. 24 is a drawing of Noteslate stylus 101 with chalk design 2401, the stylus contains rubberized drawing tip 2402 and eraser 2403, it contains also two optional functional buttons 2404 2405 placed on the stylus body 2406, according to the embodiments as disclosed herein e.g. these functional buttons can be used for eraser/function 01 2404 or gesture input/function 02 2405;

FIG. 24A and FIG. 24B are describing various thickness of drawing line based on the direction user holds the stylus 2401 towards the display surface 104, stylus has two different ends with two different widths 2402 2403 to achieve two various eraser line thickness 2408 2409, the orientation of the stylus is optionally sensed by the gyroscope 2420 inside the stylus, according to the embodiments as disclosed herein;

FIG. 25 is a drawing of Noteslate stylus 101 with smooth circular design 2501, the stylus contains rubberized drawing tip 2502 and eraser 2503, it contains also two optional functional buttons 2504 2505 placed on the stylus body 2506 2507, according to the embodiments as disclosed herein, e.g. these functional buttons can be used for eraser/function 01 2504 or gesture input/function 02 2505;

FIG. 26A is a drawing of edge holder magnetic stylus 2601 for Noteslate device 100 which can be attached to Noteslate body 401. The stylus design contains magnetic channel 2600 to easily snap onto device edge 1700, plus stylus drawing tip 2602 and eraser 2603. The magnetic snap feature is provided by stylus internal magnetic elements 2605. FIG. 26B is a cross-sectional view of stylus 2601, according to the embodiments as disclosed herein;

FIG. 27 is describing advanced stylus 2701 handwritten interaction and handwriting input 102 on Noteslate device 100, based on angle position of stylus 2705 and data from internal stylus 9-axis gyroscope unit 2420 the user can change own handwriting style or any current handwritten input, image shows changes of drawing input A 2711 B 2721 based on changed position of stylus A 2702 B 2722, these changes can be drawing direction, line deviation, parameters of handwritten input (e.g. line thickness, brush spread distance, line drawing velocity, etc.) changed from initial start of the drawing line 2700 (stylus touch point 110) on the drawing screen 104, according to the embodiments as disclosed herein;

FIG. 28 is an image of Noteslate 9.7-inch model 2800, containing programmable buttons 103, connectors 801 802 803 804 805, 9.7-inch electronic paper display 2804, hexagonal stylus 2201 for handwritten input 102, according to the embodiments as disclosed herein;

FIG. 29 is an image of Noteslate 6.8-inch model 2900, containing programmable buttons 103, branding 106, connectors 801 803 804 805, microphone 806, 6-8-inch electronic paper display 2904, triangular stylus 2301 for handwritten input 102, the side of the device is decorated with embossed paper block structure 1708, according to the embodiments as disclosed herein;

FIG. 30 is describing magnetic stylus 3333 attachment for Noteslate device 100, the stylus 3333 contains magnetic module 3001 with at least two magnetic elements 3002, so it can be easily attached to side of the device, the side of the device body 401 also contains magnetic module 3011 with magnets 3003 assembled inside device, according to the embodiments as disclosed herein;

FIG. 31 is describing magnetic stylus 3333 attachment for Noteslate device 100, the stylus 3333 contains magnetic module 3001 with at least two magnetic elements 3002, so it can be easily attached to side of the device, the side of the device body 401 also contains magnetic module 3011 with magnets 3003, these magnets 3003 are placed on the side of other connectors 801 803 804 805 806, according to the embodiments as disclosed herein;

FIG. 32 is describing magnetic stylus 3333 attachment for Noteslate device 100 created by the front panel 401, the stylus 3333 contains magnetic module 3001 with at least two magnetic elements 3002, so it can be easily attached to the front panel 401 of the device which also contains magnets 3003 or is magnetic itself (e.g. steel plated), according to the embodiments as disclosed herein;

FIG. 33 is showing application of paper block texture 1708 on the Noteslate device body design 100, embossed paper block texture 1708 is wrapped around the body and around the edges 3010, according to the embodiments as disclosed herein;

FIG. 33A is showing regular texture design 3301, FIG. 33B is showing more randomized texture design 3302, according to the embodiments as disclosed herein;

FIG. 34A-FIG. 34C illustrate solar cover accessories 3400 for Noteslate device 100 from different perspectives. FIG. 34A and FIG. 34B show that cover 3400 has pocket 3403 for nesting the stylus 101, and FIG. 34C illustrates an elastic strap 3402 for attaching the cover to Noteslate device 100. Cover 3400 works as a solar powered charger. The electric power is gained by photovoltaic panel 3401 exposed 3411 to sun light source 3410 and connected via USB 3404 to the device 804, according to the embodiments as disclosed herein;

FIG. 35A-FIG. 35C is another illustration of solar cover accessories 3400 for Noteslate device 100 from different perspectives, this time using a magnetic snapping mechanism to attach the solar cover 3400. FIG. 35A shows a top three-quarter view of cover 3400 that includes pocket 3403 for nesting the stylus 101 and magnetic snapping mechanism 3501 for attaching to Noteslate device 100 by magnetic snapping features 3502. FIG. 35B shows a side view of the solar cover and Noteslate device. FIG. 35C shows the solar cover rotated open according to the embodiments as disclosed herein;

FIG. 36 is an illustration of solar cover accessories 3400 for any tablet device 3600, the cover 3400 has elastic strap 3402 for attaching to tablet device 3600, the cover 3400 works as a solar powered charger, the electric power is gained by photovoltaic panel 3401 exposed 3411 to sun light source 3410 and connected 3602 via USB 3603 or wireless charging module 3620 to the device 3600, according to the embodiments as disclosed herein;

FIG. 36A is a side view of solar powered cover accessories 3400, according to the embodiments as disclosed herein;

FIG. 36B is showing solution with additional back cover plate 3610 which helps to attach the cover 3400 to the device 3600, according to the embodiments as disclosed herein;

FIG. 37A-FIG. 37C illustrate “PORTRAIT” solar cover accessories 3400 for tablet device 3600. Cover 3400 has magnetic snapping mechanism 3501 for attaching to tablet device 3600 such that the cover opens in an arc longitudinally (in a “PORTRAIT” orientation). FIG. 37A shows a top three-quarter view of a Netslate device with solar cover. FIG. 37B shows a side view. FIG. 37C also shows a side view, with the additional detail of a wireless charging module on the bottom. Photovoltaic panel 3401 generates electric power from sunlight, and connects via USB 3601 3602 or wireless charging module 3620 to the device 3600, according to the embodiments as disclosed herein;

FIG. 38A-FIG. 38C illustrate “LANDSCAPE” solar cover accessories 3400 for any tablet device 3600. Cover 3400 has magnetic snapping mechanism 3501 for attaching to tablet device 3600 such that the cover opens across the width in a short arc (in a “LANDSCAPE” orientation). FIG. 38A shows a top three-quarter view of a Netslate device with solar cover. FIG. 38B shows a side view. FIG. 38C also shows a side view, with the additional detail of a wireless charging module on the bottom. Photovoltaic panel 3401 generates electricity from sunlight and connects via USB 3601 3602 or wireless charging module 3620 to the device 3600, according to the embodiments as disclosed herein;

FIG. 39 is description of charging the tablet device 3600 or Noteslate device 100 with photovoltaic solar cover accessories 3400, according to the embodiments as disclosed herein;

FIG. 40 is an illustration of alternative Noteslate device design concept “SLATE” 4000 which represents the slate archetype approach, it features random curved outlines 4001 and specific embossed texture 4002, also features typical curved 4005 4006 4007 three buttons 103 and characteristic branding 4003, the appropriate design language 4008 is applied also to stylus 101, according to the embodiments as disclosed herein;

FIG. 41 is an illustration of alternative Noteslate device design concept “BLOCK” 4100 which represents the iconic block design approach, it features integrated tubular stylus holder 4103 and specific embossed side texture 3302, also features typical squared 4105 4106 4107 three buttons 103, the simple stylus design features snap ring 4102 to fit into the holder 4104, according to the embodiments as disclosed herein;

FIG. 42 is an assembly illustration of alternative portable Noteslate device design concept “MULTI OFFICE” 4200 focused on use in office space, it represents a multifunctional device approach, the “MULTI OFFICE” setup represents complex paper document management product and contains 5 basic compatible and connected units: Noteslate device 4200, portable printer 4201, solar powered charger with expandable photovoltaic module 4202, additional battery pack 4203 and portable paper documents scanner 4204; all the functional units 4200 4201 4202 4203 4204 are docked in flexible docking module 4205 for charging 4209 and connectivity 4208, according to the embodiments as disclosed herein;

FIG. 43 all the functional units 4200 4201 4202 4203 4204 are attached to main dock 4205 with elastic features 4210 and holes 4202, each functional unit 4200 4201 4202 4203 4204 contains own USB connection 4212 to get connected to other units, user can share documents between devices through USB, Bluetooth or WiFi, according to the embodiments as disclosed herein;

FIG. 44 schematic is showing approximate size of “MULTITOUCH” design concept (4200 FIG. 42) and dock size 4205 in relationship to regular office files 4400 dimensions 4401 4402, according to the embodiments as disclosed herein;

FIG. 45 is an illustration of alternative Noteslate device design concept “SMOOTH” 4500 which represents the simplicity approach, it features smooth curved body profile with symmetrical 1704 front panel 1705 and back panel 1706, it features specific middle button 4502, stylus integrates magnetic holder 2600 to be attached to device edge 1700, one of three buttons is highlighted 4502, FIG. 45a is a side profile of “SMOOTH” design concept 4500, according to the embodiments as disclosed herein;

FIG. 46A and FIG. 46B is an illustration of additional versions of “SMOOTH” 4500 design concept with various button positions, functional button 4500 contains functional joystick to adapt additional functions 4503a 4503b 4503c 4503d, FIG. 46b shows no buttons device design placement, according to the embodiments as disclosed herein;

FIG. 47 is an illustration of alternative Noteslate device design concept “ZOOSLATE” 4700 focused on children's usability, according to the embodiments as disclosed herein;

FIG. 48 is a description of transparent tablet accessories “HAPTIC SCREEN COVER” 4901 for enhanced handwriting experience, this cover 4901 is made from semi-flexible plastic material contains embossed textured surface 4800 and adhesive back surface to be attached onto tablet device screen, this accessories enhances the drawing experience and stylus 4801 use by better friction and haptic feel when drawing, according to the embodiments as disclosed herein;

FIG. 49 is a schematic detail drawing of tablet accessories “HAPTIC SCREEN COVER” with embossed textured top surface 4800 and adhesive back side 4902, the surface 4800 brings suitable friction and haptic feedback for handwriting movement 4904 with stylus 4801, the haptic cover 4901 is attached directly to display surface 4804 and all the stylus 110 and finger touch 901 remain functional thanks to touch digitizer unit behind 4903, according to the embodiments as disclosed herein;

FIG. 50A and FIG. 50B are variations of “HAPTIC SCREEN COVER” covering the whole tablet device 3600 area 5001, cover plastic film 4901 can extend just to the edges 142 of screen area 4804 or extend to the whole device area 5001, this is creating continuous top surface for better smooth handwriting experience 4805, FIG. 50C is showing other alternative textures of embossed haptic texture 5010 5011 5012 5013, the cover 4901 can contain holes 5003 for exposing tablet features or buttons 5004, according to the embodiments as disclosed herein;

FIG. 51A and FIG. 51B are variations of “HAPTIC SCREEN COVER” covering the whole tablet device 3600 even behind display area 5002, FIG. 51.B is showing hole feature 5101 for optional tablet device button 5102 (e.g. finger reader which needs to be available through haptic cover 4800), according to the embodiments as disclosed herein;

FIG. 52 is an illustration of Noteslate 1-bit color mode interface which is the core of handwritten interaction, according to the embodiments as disclosed herein;

FIG. 52a is describing other alternative color modes of Noteslate interface, FIG. 52b are examples of 1-bit interface is other color combinations, according to the embodiments as disclosed herein;

FIG. 53 is describing basic 4-corner navigation principles, 4-corner page navigation works across Noteslate interface and is universal for any app interaction, the 4-corner functionality is on top of any other interface interaction (e.g. user jumps between Noteslate pages), according to the embodiments as disclosed herein;

FIG. 54 is describing “DOUBLE SWIPE” 4-corner navigation, double swipe offers deeper navigation. user gets into sub menus and navigates twice more in between pages (e.g. between game page sessions or between application pages); user can navigate to “PAGE TAG” menu and “HOMEBAR”, by “DOUBLE SWIPE” user can launch the general device “SETTINGS” menu, according to the embodiments as disclosed herein;

FIG. 55 this schematic depicts pagination principle used across Noteslate device and interaction using 4-corner navigation (e.g. user navigates between applications and other pages by order in Noteslate content), according to the embodiments as disclosed herein;

FIG. 56 this schematic depicts reversed pagination principle used across Noteslate device and interaction using 4-corner navigation (e.g. user navigates between applications and other pages by reversed order in Noteslate content), according to the embodiments as disclosed herein;

FIG. 57 4-corner menu interaction applied to “SLATE” interface, user can also use 4-corner navigation to go to other application pages, according to the embodiments as disclosed herein;

FIG. 58 4-corner menu interaction applied to “CHAT” interface, user can also use 4-corner navigation to go to other application pages, according to the embodiments as disclosed herein;

FIG. 59 4-corner menu interaction applied to “READER” interface, user can also use 4-corner navigation to go to other application pages, according to the embodiments as disclosed herein;

FIG. 60 4-corner interaction example applied to “CONTENT” interface, user can also use 4-corner navigation to go to different pages of content thumbnails, according to the embodiments as disclosed herein;

FIG. 61 4-corner menu interaction for “CONTENT” showing basic menu functionality, 614 searching thumbnails by timeline (year/month/day) and 613 search thumbnails by specific tags, according to the embodiments as disclosed herein;

FIG. 62A shows a search page with the timeline displayed on the left, and search results shown as thumbnail pages, FIG. 62B is a closeup of a timeline showing particular features thereof, according to the embodiments as disclosed herein;

FIG. 63A-63D show various aspects of timeline usability. In FIG. 63A, the user searches for pages (displayed as thumbnails) by year. In FIG. 63C, the user searches for pages (displayed as thumbnails) by month. In FIG. 63D, the user selects pages (displayed as thumbnails) by day. Appropriate page thumbnails are displayed in the content—a simple and convenient way to find the right handwritten content in the Noteslate interface. FIG. 63B shows the Noteslate search feature with a user's finger touch point 902 shown on the timeline.

FIG. 64 is describing basic page formats available in Noteslate interface, according to the embodiments as disclosed herein;

FIG. 64a “FULLSIZE PAGE” is the most common Noteslate interface format, the whole content or its part can be shared, width and height is defined by interface resolution and size (e.g. used in basic drawing interface), according to the embodiments as disclosed herein;

FIG. 64b “SLICE PAGE” is unique Noteslate page format with constant width and variable height, its height is based on current interaction, user cuts custom size based on content he did (e.g. used in blogging Noteslate application), according to the embodiments as disclosed herein;

FIG. 64c “SHORTNOTE PAGE” format is using variable width and constant height (e.g. used in Shortnote application—user can optionally cut the sides of the content and share it to Shortnote social stream), according to the embodiments as disclosed herein;

FIG. 65A “PAGE ROLL” is a special infinite page format with infinite height, further down user scrolls, more drawing surface is created, (e.g. this page type is used in chat application). The user is able to share parts of the page, and, as the user draws on the page, the page extends its length based on the amount of user's handwritten input. The user can scroll in both directions to get to past and to present, according to the embodiments as disclosed herein;

FIG. 65B “NOTERON” is a multiple page format, which consists of nine full-size pages attached into one drawing board. The pages can be used as one continuous drawing board or as separate networked full-size pages connected over handwritten network, according to the embodiments as disclosed herein;

FIG. 66 examples of various page formats used in specific application interface, according to the embodiments as disclosed herein;

FIG. 66A “FULLSIZE PAGE” example used in “SLATE” application; user is able to draw on the full screen size format, according to the embodiments as disclosed herein;

FIG. 66B “SLICE PAGE” example used in “SLOG” blogging application; this interface is using slice-page format; user is able to cut the page whenever he needs its end; user is able to share smaller than full-page formats to Noteslate handwritten network, according to the embodiments as disclosed herein;

FIG. 66C “SHORTNOTE PAGE” example used in “SHORTNOTE” application; this interface is using the basic principle of this application is to allow user to create hand drawn or written content in limited input area with constant page height and variable width; user shares this stream of own content to Noteslate handwritten network and further; other users are viewing the content and are able to search by specific hashtags, according to the embodiments as disclosed herein;

FIG. 67A “PAGE ROLL” page example used in “CHAT” application using “PAGE ROLL” page format; in this application interface two or multiple users are able to draw and write on one continuous page; users see all the interaction in one interface, all in one page; real time communication is optional feature, according to the embodiments as disclosed herein;

FIG. 67B “NOTERON” page type used in Noteron application example, according to the embodiments as disclosed herein;

FIG. 68 diagram depicts sharing principles on one page among more users, available in real time mode 1511 or batch mode 1512 (e.g. used in chat application between two users drawing on the same page roll, each user is using own customized interface but with the same content), according to the embodiments as disclosed herein;

FIG. 69 basic overview of “CONTENT” page which is special type of page in Noteslate interface, content shows the overview of pages, drawings, application pages, data which are contained or related to current Noteslate device, interface and username, “CONTENT” is an overview of available content in current Noteslate interface, grid arrangement can be customized, “CONTENT” visual can be redrawn by the user, “CONTENT” grid consists from interactive functional areas (e.g. shortcuts, pages, links, folders, etc.), according to the embodiments as disclosed herein;

FIG. 69A is showing basic layout with 16 functional areas—page thumbnails—“IMPRINT”s—icons—tags—folders—blocks—shortcuts—networked content, according to the embodiments as disclosed herein;

FIG. 69B is showing basic layout with 64 functional areas, according to the embodiments as disclosed herein;

FIG. 69C is showing random layout with 32 functional areas, according to the embodiments as disclosed herein;

FIG. 70 is showing “cutout” principle to create page thumbnail, if the drawing on page is created the thumbnail of the page appears in content, “cutout” is creating same size thumbnail cutout from the drawing page, according to the embodiments as disclosed herein;

FIG. 71 is showing “miniature” principle to create page thumbnail, if the drawing on page is created the thumbnail of the page appears in content, “miniature” is creating thumbnail from the whole drawing page area, according to the embodiments as disclosed herein;

FIG. 72 is showing thumbnail creation based on networked content, this content can be interactive application, drawing channel in Noteslate network or any other updated page drawing, the thumbnail is also updated at the same time as the page itself, according to the embodiments as disclosed herein;

FIG. 73 examples of “CUTOUT” (FIG. 73A) and “MINIATURE” (FIG. 73B) page thumbnail generated in the Noteslate content from various apps, tags and drawings, according to the embodiments as disclosed herein;

FIG. 74A depicts basic principles of right handed interface. The Noteslate interface font is tilted left based on natural rotation of the device from portrait to landscape mode (the interface itself is not rotating). The user draws with right hand and holds the device with left hand, according to the embodiments as disclosed herein;

FIG. 74B depicts basic principles of left handed interface. The Noteslate interface font is tilted right based on natural rotation of the device from portrait to landscape mode (the interface itself is not rotating). The user draws with left hand and holds the device with right hand, according to the embodiments as disclosed herein;

FIG. 75A FIG. 75B FIG. 75C is showing complex principles of right handed interface for various localized language and cultural preferences, the Noteslate interface font is tilted left based on natural rotation of the device from portrait to landscape mode (the interface itself is not rotating), user draws with right hand and holds the device with left hand, according to the embodiments as disclosed herein;

FIG. 75D FIG. 75E FIG. 75F is showing complex principles of right handed interface for various localized language and cultural preferences, the Noteslate interface font is tilted right based on natural rotation of the device from portrait to landscape mode (the interface itself is not rotating), user draws with left hand and holds the device with right hand, according to the embodiments as disclosed herein;

FIG. 76A FIG. 76B FIG. 76C is showing complex principles of right handed interface for various localized language and cultural preferences, the Noteslate interface font is tilted left based on natural rotation of the device from portrait to landscape mode (the interface itself is not rotating), user draws with right hand and holds the device with left hand, according to the embodiments as disclosed herein;

FIG. 76D FIG. 76E FIG. 76F is showing complex principles of right handed interface for various localized language and cultural preferences, the Noteslate interface font is tilted right based on natural rotation of the device from portrait to landscape mode (the interface itself is not rotating), user draws with left hand and holds the device with right hand, according to the embodiments as disclosed herein;

FIG. 77 diagram shows principles and definition of “IMPRINT” interface element, according to the embodiments as disclosed herein. “IMPRINT” is one of the core Noteslate interface elements; the core feature of “IMPRINT” is the ability to redraw its visual by hand drawing, user can activate redrawing mode anytime across Noteslate interface to change the design of any “IMPRINT” available in current interface layout; “IMPRINT” can be used as visual overlay for any functional interactive element defined by the area of interaction (e.g. button, page thumbnail, tool, icon, label description, brush pattern, brush tag, etc.); “IMPRINT” element is essential for any interface customization and redrawing, users can create, save, share, export and implement other “IMPRINT”s or whole sets of “IMPRINT”s (e.g. interface templates, content templates, brushes, icons, etc.)

FIG. 78A-FIG. 78G illustrate various “IMPRINT” types and shapes within which the user can draw customized images on user-interface elements, such as buttons, icons, tools, and thumbnail pictures. FIG. 78A shows a basic rectangular “IMPRINT” area; FIG. 78B shows a custom-shaped rectilinear “IMPRINT” area; FIG. 78C shows a circular “IMPRINT” area; FIG. 78D shows how a page thumbnail can be an “IMPRINT” area; FIG. 78E shows how a brush tool icon can be an “IMPRINT” area; FIG. 78F shows how an irregular custom shape can be an “IMPRINT” area; FIG. 78G shows that an “IMPRINT” area can be of almost any size; and FIG. 78H shows how the “IMPRINT” feature can customize a button. The “IMPRINT” area defines the functional interactive area and the area for redrawing which is suitable for specific interface element, according to the embodiments as disclosed herein;

FIG. 79A-FIG. 79D are examples of how the corner gap detail indicates the orientation of “IMPRINT” based on interface settings and localization, “IMPRINT” features are rotated based on interface settings for right- and left-handed writers, and according to language and cultural preferences. FIG. 79A shows the corner gap detail positioned in the upper left; FIG. 79B shows the corner gap detail positioned in the upper right; FIG. 79c shows the corner gap detail positioned in the lower left; FIG. 79D shows the corner gap detail positioned in the lower right;

FIG. 80 is a basic schematic process of single “IMPRINT” redrawing, it's describing three steps of redesigning any interface element by drawing, according to the embodiments as disclosed herein;

FIG. 81 is redrawing of “IMPRINT” area with two customizable fields available in one area (e.g. page thumbnail, homepage background, etc.), user has to select by hand which area he wants to redraw, according to the embodiments as disclosed herein;

FIG. 82 is a basic use of “IMPRINT” element in Noteslate interface, user can change and redraw the home page (e.g. content page) by using various “IMPRINT”s as page thumbnails; after redrawing mode is activated (by holding the middle button for 3s or touching the screen for 3s), user can redraw the whole screen area by one continuous drawing and save it as a new design template with preserving the same functionality and interaction, this unique interface customization and individual redrawing is specific for Noteslate interface, according to the embodiments as disclosed herein;

FIG. 83 is showing the use of homepage redrawing on regular tablet device, “IMPRINT” element (e.g. homepage application icons) can be redrawn by the user, user can change and redraw the home screen by using various “IMPRINT”s as page thumbnails; after redrawing mode activation (e.g. touching the finger for 3s on the screen) user can redraw the whole screen area with one continuous drawing and save it as a new design template with preserving the same functionality and interaction, this unique interface customization can be applied to other mobile Noteslate platforms, according to the embodiments as disclosed herein;

FIG. 84 in redrawing mode (activated by Noteslate button or touching the screen for 3s), user can rearrange the functional “IMPRINT”s by finger touch and simply reorganize them for further customization and redrawing), according to the embodiments as disclosed herein;

FIG. 85 is the example of redrawing applied to content home page; the interactive functional area is preserved; redrawn design is continuous across the screen and each functional page thumbnail have own specific redrawing design, according to the embodiments as disclosed herein;

FIG. 86 is a redrawing of functional full page area with specific functional fields; user can activate redrawing mode and redraw the page with preservation of the functional interface features, according to the embodiments as disclosed herein;

FIG. 87 is the example of content page redrawing; user starts with functional page “IMPRINT” layout and by redrawing mode he can redraw all the page thumbnails into custom drawing layout; the functional interaction remains the same even without visible page thumbnail borders, according to the embodiments as disclosed herein;

FIG. 88 are the examples of potential redrawing of the same customized functional layout of content page; user can achieve two different visuals with the same functionality depending on own preferences, according to the embodiments as disclosed herein;

FIG. 89 another example of content page redrawing in landscape mode with the same functional layout as FIG. 87, the functionality remains the same even without visible page thumbnail borders, according to the embodiments as disclosed herein;

FIG. 90 is description of multiple linked page areas with own custom “IMPRINT” design; user is defining the functionality of each area and also can activate redrawing mode to attach specific visual to each page; user can attach link, shortcut or hyperlink to any of the functional area; this way user can create interactive, natural and unique drawing storytelling content, according to the embodiments as disclosed herein;

FIG. 91A and FIG. 90B is an alphabet overview of Noteslate system and interface font; FIG. 91A shows “Noteslate REGULAR RIGHT” and FIG. 91B shows “Noteslate REGULAR LEFT”; these fonts are used in default interface description, default functional element layouts, default page thumbnail design, etc. and is the core feature of Noteslate interface customization and localization, according to the embodiments as disclosed herein;

FIG. 92B is showing Noteslate drawing toolbar structure and placement in the interface layout (FIG. 92A), the structure of the toolbar is defined by set of functional tool “IMPRINT”s; each specific application interface has own specific toolbar settings with tools available, according to the embodiments as disclosed herein;

FIG. 93A-FIG. 93E show five clearly labeled examples of customization of Noteslate toolbars; the structure and visual appearance depend on user preferences and settings. All visual changes are available through redrawing mode, according to the embodiments as disclosed herein;

FIG. 94A-FIG. 94D are four examples of an additional tool bar with shortcuts to recent documents appearing above the application's toolbar; each application shows its own recent documents above the toolbar. For example, FIG. 94A shows shortcuts to the latest pages above the “SLATE” toolbar; FIG. 94B shows shortcuts to the latest CHAT sessions above the “CHAT” toolbar; FIG. 94C shows shortcuts to the latest documents opened above the “READER” toolbar; and FIG. 94D shows shortcuts to the latest movies above the “ANISLATE” toolbar;

FIG. 95 is describing principle of toolbar redrawing; each tool has own “IMPRINT” for visual which can be changed and customized through redrawing mode; this allows to create completely individual and non obtrusive set of tools, according to the embodiments as disclosed herein;

FIG. 96 is description of timer bar element indicating time aspect for various interface elements (full length shows 100% of set value); FIG. 96A and FIG. 96B shows examples of timer bar in connection with username (e.g. chat application where it shows activity of the user), according to the embodiments as disclosed herein;

FIG. 97A-FIG. 97C show three visual concepts for “IMPRINT” element selection, according to the embodiments as disclosed herein; FIG. 97A shows the default “IMPRINT” frame; FIG. 97B shows the “invert” option; FIG. 97C shows the “IMPRINT” frame bounded on the side and bottom with a 3-pixel border to give a 3D appearance. FIG. 97D shows examples of different directions in the 3-pixel border and in the direction and slant of the handwriting, based on left- and right-handedness of the writer, orientation of the Noteslate device, and on cultural differences in writing conventions;

FIG. 97D shows various approach for various localization settings, according to the embodiments as disclosed herein;

FIG. 98 is an example of “ANISLATE” application for drawing animatics and storyboards; interface is using timer bar element for frame still time adjustment; user can specify time length of each frame to set the whole movie timeline, according to the embodiments as disclosed herein;

FIG. 99 is a interface layout description of handwritten gesture input keyboard placement which works same way in portrait or landscape mode, according to the embodiments as disclosed herein;

FIG. 100 is a detailed handwritten gesture keyboard layout containing all QWERTY characters and specific areas for gesture input, according to the embodiments as disclosed herein;

FIG. 101 depicts the handwritten gesture keyboard learning process; user repeats the gesture input for specific gesture character to create multiple recognizable gesture master templates; the gesture recognition is provided thanks to this family of repeated gesture inputs, according to the embodiments as disclosed herein;

FIG. 102 is basic visual template of handwritten gesture keyboard for initial gesture input recognition (using Noteslate Regular font), according to the embodiments as disclosed herein;

FIG. 103 is description of process of handwritten gesture keyboard customization and creating own unique handwritten character alphabet which is used for QWERTY character input across Noteslate interface, according to the embodiments as disclosed herein;

FIG. 104 is schematics of handwritten character alphabet inputs and type of gesture characters, according to the embodiments as disclosed herein;

FIG. 105 is example what user can do with own unique handwritten character alphabet; this alphabet contains unique set of gesture characters with proper recognition training and unique customized design; user A can share the alphabet to other user B or share it to public Noteslate handwritten library in Noteslate warehouse, according to the embodiments as disclosed herein;

FIG. 106 is description of private communication principles using customized handwritten gesture characters and share alphabet among user A and user B, according to the embodiments as disclosed herein;

FIG. 107 is process of adding additional custom gestures into handwritten gesture keyboard (handwritten gesture alphabet); this process includes triple gesture training to achieve initial precise gesture recognition and reliability; user can define these additional gestures with function and gesture design, according to the embodiments as disclosed herein;

FIG. 108A shows a handwritten gesture keyboard with three gesture characters (“A”, “B”, “C”) highlighted; the user can define his or her own custom gesture design for each specific QWERTY character; FIG. 108B is a conceptual diagram showing how Noteslate lets the user “train” the interface in his or her custom gesture alphabet design, according to an embodiment;

FIG. 109 is an example of completely customized handwritten gesture keyboard and all characters in handwritten alphabet; the QWERTY layout still allows to edit the gesture design, according to the embodiments as disclosed herein;

FIG. 110 is another example of completely customized handwritten gesture keyboard, according to the embodiments as disclosed herein;

FIG. 111 are examples of customized gestures attached to specific interface function and action, according to the embodiments as disclosed herein;

FIG. 112 is description of handwritten gesture input mode, how user can input anytime gesture; user can activate the gesture input area by clicking gesture button 01 on the stylus 2205 2305 2405 2505 or by touching the gesture input tool in Noteslate drawing toolbar; the gesture input is made in this gesture input area (e.g. “SAVE” gesture) or created freely anywhere on the screen (e.g. “LINK” gesture), according to the embodiments as disclosed herein;

FIG. 113A depicts “TRIANGLE” handwritten gesture character, according to the embodiments as disclosed herein;

FIG. 113B depicts “SQUARE” handwritten gesture character, according to the embodiments as disclosed herein;

FIG. 113C depicts “CHART” handwritten gesture character, according to the embodiments as disclosed herein;

FIG. 113D depicts “LINK” handwritten gesture character, according to the embodiments as disclosed herein;

FIG. 113E depicts “EMOJI” handwritten gesture character, according to the embodiments as disclosed herein;

FIG. 113F depicts “CHAT” handwritten gesture character, according to the embodiments as disclosed herein;

FIG. 114A depicts “HEART” handwritten gesture character, according to the embodiments as disclosed herein;

FIG. 114B depicts “FIGURINE” handwritten gesture character, according to the embodiments as disclosed herein;

FIG. 114C depicts “PLAY” handwritten gesture character, according to the embodiments as disclosed herein;

FIG. 114D depicts “CLOUD” handwritten gesture character, according to the embodiments as disclosed herein;

FIG. 114E depicts “PLANE” handwritten gesture character, according to the embodiments as disclosed herein;

FIG. 114F depicts “BOW” handwritten gesture character, according to the embodiments as disclosed herein;

FIG. 115A depicts “ARROW” handwritten gesture character, according to the embodiments as disclosed herein;

FIG. 115B depicts “BUTTON” handwritten gesture character, according to the embodiments as disclosed herein;

FIG. 115C depicts “SHARE” handwritten gesture character, according to the embodiments as disclosed herein;

FIG. 115D depicts “PLUS” handwritten gesture character, according to the embodiments as disclosed herein;

FIG. 115E depicts “CONNECT” handwritten gesture character, according to the embodiments as disclosed herein;

FIG. 115F depicts “LOCK” handwritten gesture character, according to the embodiments as disclosed herein;

FIG. 116A depicts “DUO” handwritten gesture character, according to the embodiments as disclosed herein;

FIG. 116B depicts “TRIO” handwritten gesture character, according to the embodiments as disclosed herein;

FIG. 116C depicts “QUATRO” handwritten gesture character, according to the embodiments as disclosed herein;

FIG. 116D depicts “DNA” handwritten gesture character, according to the embodiments as disclosed herein;

FIG. 116E depicts “BULB” handwritten gesture character, according to the embodiments as disclosed herein;

FIG. 116F depicts “APPLE” handwritten gesture character, according to the embodiments as disclosed herein;

FIG. 117A depicts “HASHTAG” handwritten gesture character, according to the embodiments as disclosed herein;

FIG. 117B depicts “STAR” handwritten gesture character, according to the embodiments as disclosed herein;

FIG. 117C depicts “HOUSE” handwritten gesture character, according to the embodiments as disclosed herein;

FIG. 117D depicts “KEY” handwritten gesture character, according to the embodiments as disclosed herein;

FIG. 117E depicts “CHECK” handwritten gesture character, according to the embodiments as disclosed herein;

FIG. 117F depicts “CANCEL” handwritten gesture character, according to the embodiments as disclosed herein;

FIG. 118 is a schematic illustrating single handwritten gesture character used for specific interface function; this includes gesture design recognition and verification, according to the embodiments as disclosed herein;

FIG. 119 is describing the principle of sharing the unique handwritten gesture character into public Noteslate warehouse library; this includes the gesture design, robust recognition training and examples of use across the interface; other users can download the gesture and implement it into own Noteslate interface, according to the embodiments as disclosed herein;

FIG. 120 is an illustration of “EMOJI” handwritten gesture used for gesture input shortcut of a more complex emoji drawing, its position is based on gesture input area position, according to the embodiments as disclosed herein;

FIG. 121 is an illustration of “TABLE” handwritten gesture used for gesture input shortcut of a more complex table element drawing, its position is based on gesture input start position, according to the embodiments as disclosed herein;

FIG. 122 is an illustration of “CHART” handwritten gesture used for shortcut to input a more complex interactive application element, its position is based on gesture input area position, according to the embodiments as disclosed herein;

FIG. 123 is an illustration of “HYPERLINK” handwritten gesture used for shortcut to insert hyperlink address into the drawing, the position of drawing is based on gesture input area position, according to the embodiments as disclosed herein;

FIG. 124 is an illustration of “LINK” handwritten gesture used for linking two elements in the current drawing page together, the proper functionality is based on gesture input start position and end position, according to the embodiments as disclosed herein;

FIG. 125A is an example of “LINK” gesture use case; user links one element (drawing) to another (hyperlink) to create interactive page element; FIG. 125B shows additional toolbar properties and tools, according to the embodiments as disclosed herein;

FIG. 126 is a description of adding page tags process with “PAGE TAG” menu 1260; page tags are the core organization element for Noteslate device; user can attach as many tags as necessary; basic search through Noteslate content is based on tag search; some of the tags are automatically attached to drawing, based on type of application used for drawing creation; (basic tag menu is available in upper left corner in default localization settings), according to the embodiments as disclosed herein;

FIG. 127 is depicting basic “SHARE” icon look; the visual is used in Noteslate interface, on share switch button or anywhere else with Noteslate sharing available, according to the embodiments as disclosed herein;

FIG. 128 depicts special interface element “Missile”; this element is interactive drawing element used primarily in gaming applications (e.g. for targeting, shooting, etc.) adding element of precision into game plan); user draws precise missile line up to limiting border, from where the line is extended further (based on last pixel points curvature or tangent of the curvature approximation), according to the embodiments as disclosed herein;

FIG. 129 is an example of interface customization in gaming application “SLATE INVADERS”; user can redraw most of the gaming elements to define own game design; this game design can be shared further as on FIG. 131, according to the embodiments as disclosed herein;

FIG. 130 is an example of interface customization in gaming application “TIC TAC TOE” in multiplayer mode; both users can redraw own core gaming symbols (handwritten gesture characters) and use them in a game plan, according to the embodiments as disclosed herein;

FIG. 131 is a schematic principle of sharing the customized user interface; after redrawing all the application elements user is able to share this set as customized user interface into Noteslate warehouse and publish it for other users, according to the embodiments as disclosed herein;

FIG. 132 is the layout drawing of “NOTESCHOOL” application; this application is using different layout for functional organization and own pages navigation; it contains own structure for content navigation, according to the embodiments as disclosed herein;

FIG. 133 is an overview of Noteslate warehouse, the basic source of software add-ons for Noteslate platform; these are including Noteslate applications, interface assets, handwritten gestures, brushes, additional interface features, etc.; part of the assets are made by Noteslate users (e.g. customized interface template, content template, custom gestures, custom brushes, etc.), according to the embodiments as disclosed herein;

FIG. 134A shows an example of a Noteslate social user's profile page; this is the epicenter of published handwritten content across the Noteslate handwritten network, and includes shared pages, published “IMPRINT”s, icons, templates, and shared handwritten content from other users and from various Noteslate social channels. FIG. 134B shows a Noteslate page with content from channels. The user can see his or her own activity and the activity of other users in the network, including the content they created, published and shared. Netslate's sharing feature also works as cloud data backup for own Noteslate pages shared by the user, according to the embodiments as disclosed herein;

FIG. 135A depicts the special interface element “DEFLECTOR” which is an “obstacle” drawn in real-time by the user into the current interface; this “DEFLECTOR” element is used across the Noteslate interface, especially in gaming interfaces for reflecting other gaming elements (e.g., the ball 1351); the behaviors of the “DEFLECTOR” depend upon the drawing line shape and the brush used. FIG. 135B illustrates the direction of the ball 1351 after it strikes the “DEFLECTOR” at a specified point. The user can define and influence the gaming interaction by various parameters of the deflector drawing, according to the embodiments as disclosed herein;

FIG. 136 depicts gaming interface “SLATE PONG” using the “DEFLECTOR” element; based on the “DEFLECTOR” drawing shape player can affect the movement of the ball (e.g. direction, speed, etc.); the goal of the game is to ping the ball to the other side by drawing proper reflective line, according to the embodiments as disclosed herein;

FIG. 137 depicts special interface element “FUNCTIONAL BRUSH”, which is drawn in real-time by the user into the current interface, which is a linear interface element for specific interaction; each “FUNCTIONAL BRUSH” has own properties and parameters how it affects further interface elements; this element is used mainly in gaming interactions, according to the embodiments as disclosed herein;

FIG. 138 is depicting an example of gaming interface “SLATE FALL”; interface is using “FUNCTIONAL BRUSH” element to define the core interaction elements; the goal of the game is to keep the ball inside the paper area by drawing various “FUNCTIONAL BRUSH” lines around; the ball is still falling in vertical direction (in default speed, direction, movement) affected further by obstacles and drawn elements (“FUNCTIONAL BRUSH” lines and shapes), according to the embodiments as disclosed herein;

FIG. 139 is the process of defining custom “BRUSH IMPRINT” pattern; user can add this type of brush pattern as tool anytime into the toolbar; some of these brushes can be used further across Noteslate interface as graphical brushes (e.g. drawing pattern) or also as functional texture input (e.g. type of goods, texture as parameter, etc.); customized brush patterns made by the user can be shared further and published in Noteslate warehouse, according to the embodiments as disclosed herein;

FIG. 140 is an application example “PIZZA APPLICATION” using “BRUSH IMPRINT” patterns as functional element (e.g. choosing the right ingredient), according to the embodiments as disclosed herein;

FIG. 141 is example of “VISUAL TAG” interface, which is using “BRUSH IMPRINT” patterns as functional element (e.g. adding specific tag to each drawing area on the page); user can quickly add multiple tags to multiple elements and publish them online (e.g. user pushes stylus button 01 2205 2305 2405 2505 to select the are and than adds visual tags to area), according to the embodiments as disclosed herein;

FIG. 142A and FIG. 142B together depict the “SHAKE ERASING” functionality implemented into Noteslate hardware and software. FIG. 142A shows a drawn figure on the page. After the Noteslate is shaken, FIG. 142B shows only a faint “noise” outline of the drawing that transitions into complete erasure. The user shakes physically the device in specific direction and rotation to erase the current page; this interface function is using data from gyroscope unit in Noteslate device, according to the embodiments as disclosed herein;

FIG. 143A-FIG. 143C show three variations of “SHAKE ERASING” functionality defined for various directions and uses. FIG. 143A depicts the one-sided rotation shake. FIG. 143B depicts the planar translation shake, and FIG. 143C depicts the diagonal rotation (Chinese fan) shake;

FIG. 144a is describing “STRAIGHT LINE” interface element; the element is made by drawing onto the display; any line is counted and straight line is defined by approximation of created pixels; the most pixels made in one straight line are defining the success of line direction and 100% of ideal straight line success, according to the embodiments as disclosed herein;

FIG. 144b is showing actual gaming interface using “STRAIGHT LINE” element; the goal of this game is to draw straight line (or optionally multiple lines); user gets points for successfully drawn aligned pixels with even multiple lines possible (e.g. score is based on overall number of pixels drawn in current session, according to the embodiments as disclosed herein;

FIG. 145 is describing “PAGES TRANSITION” interface principle and ways to customize that; FIG. 145a FIG. 145b FIG. 145c are describing default navigation between pages (e.g. first page and second page) and transition page containing specific pattern, drawing or animation, according to the embodiments as disclosed herein;

FIG. 146 is describing “NOTERON CONNECTION” which is primary element for multiple drawing connectivity; used mainly in gaming (e.g. multiplayer for “NOTERON” application) this element can be generally basic tool for getting connected to other device's pages; this function can be used in other applications; position on screen page is transferred to other user so the drawing can smoothly continue, according to the embodiments as disclosed herein;

FIG. 147 is an example of “NOTERON ELEMENT” use in “NOTERON” application; the goal of this game application is to draw as many pixels as possible (with reasonable drawing theme) using only one drawing line, then user sends the line further (to the edge of the screen) or terminates the drawing; user is also able to start a new drawing, or get input request from other users, according to the embodiments as disclosed herein;

FIG. 148 is an overview of basic “SHARE” function on Noteslate device, available through “SHARE TOOL” with “SHARING BUTTON” turned on; user A selects which type of sharing he wants to use for current page or shared content in current interface, then user A can share the content to user B depending on the settings of “SHARE” function, according to the embodiments as disclosed herein;

FIG. 149A-FIG. 149B illustrate the basic “SHARE” interface on Noteslate. FIG. 149A shows the handwritten content that the user wants to share. FIG. 149B shows the “SHARE” manu. From this one simple “SHARE” interface, the user is able to choose the type of sharing, choose the channels, add tags, share outside of Noteslate handwritten network, share to mobile devices, existing social networks, etc.; this “SHARE” function is available only with the “SHARING BUTTON” turned on; user can also “SHARE” to other users outside of Noteslate handwritten network, according to the embodiments as disclosed herein;

FIG. 150 is a schematic overview of “SHARE” function, settings and options; it describes types of sharing on Noteslate device; user is able to “SHARE” to various channels across Noteslate handwritten network, share to Internet network (e.g. mobile devices, email, web, HTML, etc.) or shared completely offline through physical cable or SD card; availability of specific type of “SHARE” function depends on currently used Noteslate application interface (e.g. “CHAT” application allows you to share in real time the current “PAGE ROLL”) and “SHARING BUTTON” position (e.g. user is able to “SHARE” offline with “SHARING BUTTON” switched off, according to the embodiments as disclosed herein;

FIG. 151 depicts “REAL TIME SHARING” on Noteslate device; user A is able to draw something onto screen and share it in real time (pixel by pixel or in small pixel batches) with the other user B; the other user B can interact immediately with the shared content; e.g. this is used in “CHAT” application for real time interaction and communication, according to the embodiments as disclosed herein;

FIG. 152 depicts “REAL TIME SHARING” on Noteslate device for two parallel inputs from user A and user B; user A is able to view and draw something onto screen and share it in real time (pixel by pixel or in small pixel batches) with the other user B; user B is able to view and draw something onto screen and share it in real time (pixel by pixel or in small pixel batches) with the other user A; both users can interact with each other immediately and with the shared content (e.g. this is used in “CHAT” application for real time interaction and communication); e.g. this can be used also as additional real-time sharing type in “SLATE” application for networked collaboration on one page, according to the embodiments as disclosed herein;

FIG. 153 depicts an example of “REAL TIME SHARING” drawing application on Noteslate device with two mutual simultaneous drawing inputs from user A and user B; the content is share in between in real time pixel by pixel or in small pixel batches; both users see mutual content and can add or interact with that, according to the embodiments as disclosed herein;

FIG. 154 depicts an example of “REAL TIME SHARING” between multiple users; users can view and draw anytime and interact with the content made by any of them; content is shared between these three users across Noteslate handwritten platform using “SHARE” functionality and Noteslate platform sharing channels; users can limit the number of viewers and add optionally other users to interact; this is basic principle for collaboration on drawings, according to the embodiments as disclosed herein;

FIG. 155 is a schematic overview of “SHARE” function with sharing settings to other devices, using Internet connectivity; user is able to communicate with other users outside Noteslate handwritten network and get connected through specific Noteslate interface for other platforms (e.g. mobile devices platforms, web platform, etc.); all the settings are available through “SHARE” interface, according to the embodiments as disclosed herein;

FIG. 156 depicts the “THREE LINE UNLOCKING GESTURE” drawing input interface; user can unlock own Noteslate device and account by specific combination of three simple lines; it brings freedom of custom gesture design and security control over handwritten content inside device or account, according to the embodiments as disclosed herein;

FIG. 157 describes the “THREE LINE UNLOCKING GESTURE” input recognition principles; this unique unlocking signature recognition compares various aspects of the “THREE LINE UNLOCKING GESTURE” design (e.g. line lengths, angles, pattern, cross sections, etc.); after successful gesture input recognition user is able to unlock and use the device with own account, according to the embodiments as disclosed herein;

FIG. 158 depicts the “SINGLE LINE UNLOCKING GESTURE” drawing input interface; user can unlock own Noteslate device and account by specific combination of three simple lines; it brings freedom of custom gesture design and security control over handwritten content inside device or account, according to the embodiments as disclosed herein;

FIG. 159 describes the “SINGLE LINE UNLOCKING GESTURE” input recognition principles; this unique unlocking signature recognition compares various aspects of the “SINGLE LINE UNLOCKING GESTURE” design (e.g. line lengths, angles, pattern, cross sections, etc.); after successful gesture input recognition user is able to unlock and use the device with own account, according to the embodiments as disclosed herein;

FIG. 160 describes the “DRAWING QUALITY” aspect of any content created and shared in Noteslate interface, optionally share across Noteslate handwritten network; this “DRAWING QUALITY” aspect depends on various parameters of each drawing (e.g. drawing itself, network and sharing related parameters, backend parameters); all the parameters are measured and counted into “RATING”; this “DRAWING QUALITY” aspect can be used for individual drawing monetization, open-source monetization and other long term evolution of Noteslate handwritten platform, according to the embodiments as disclosed herein.

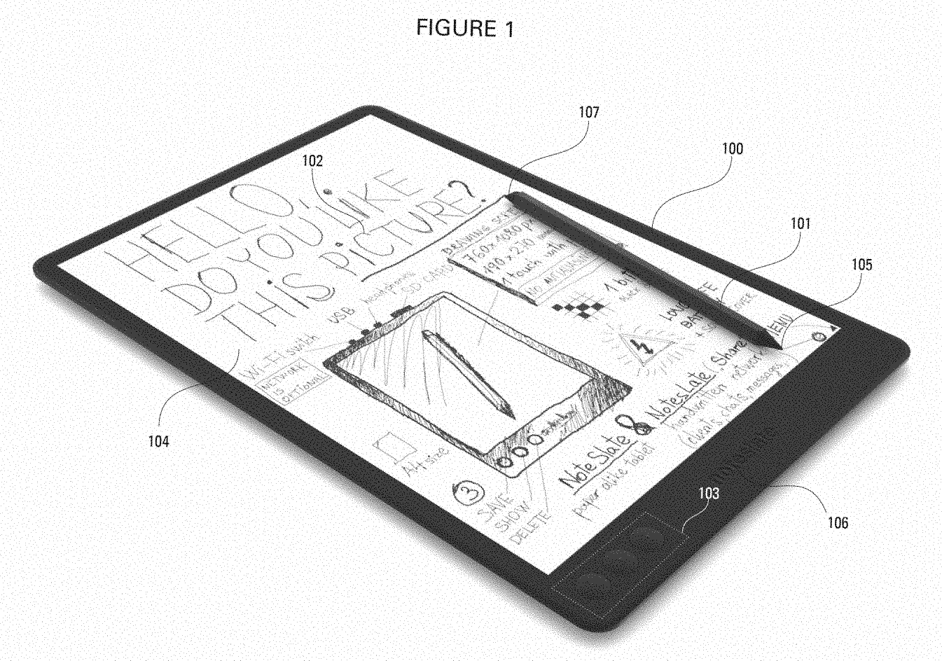

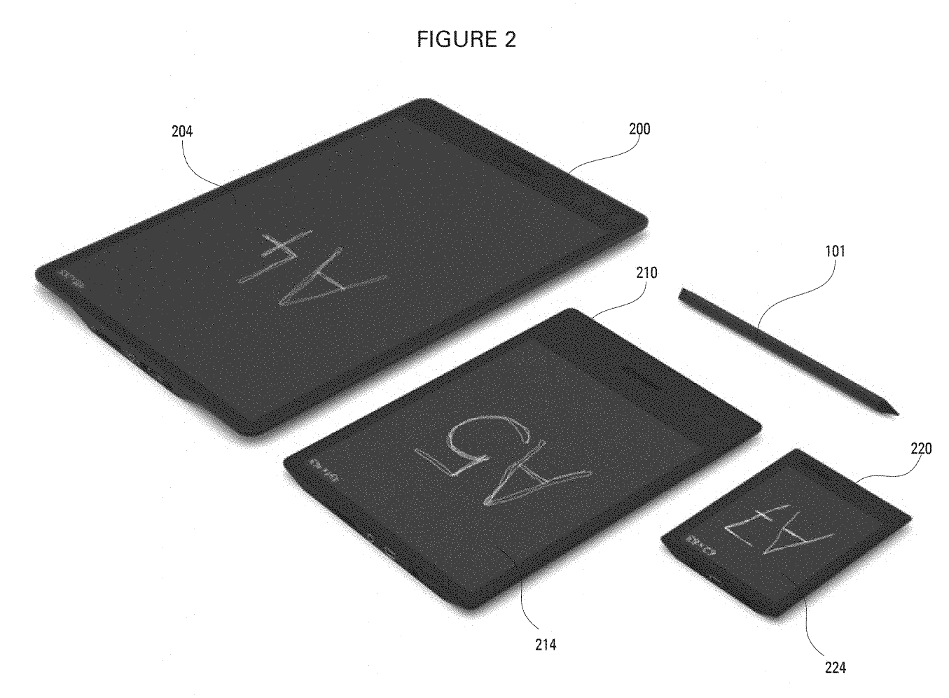

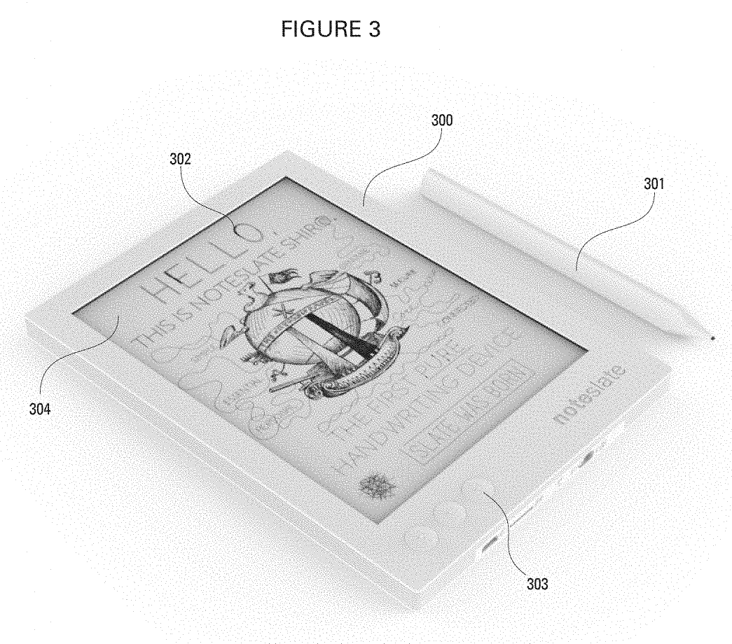

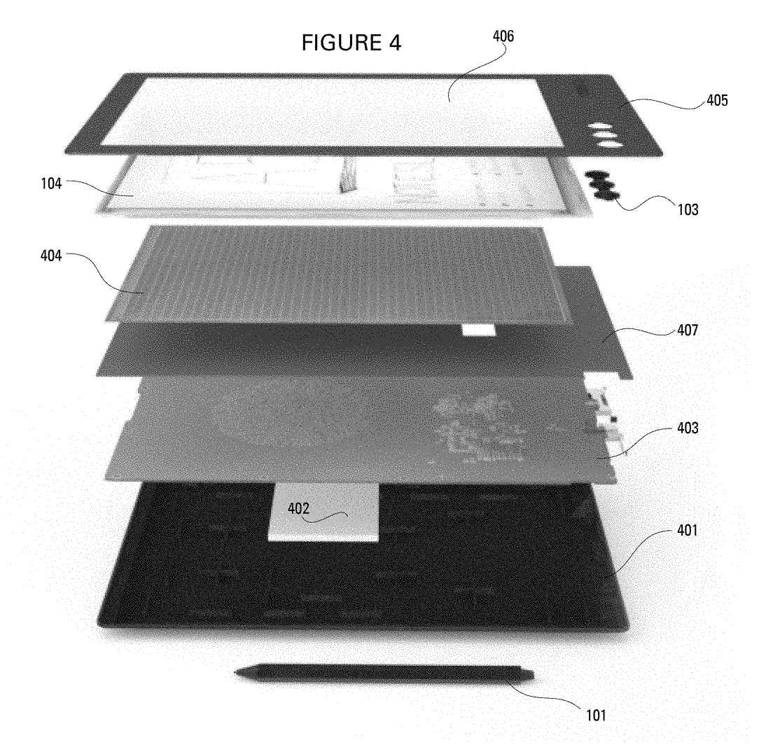

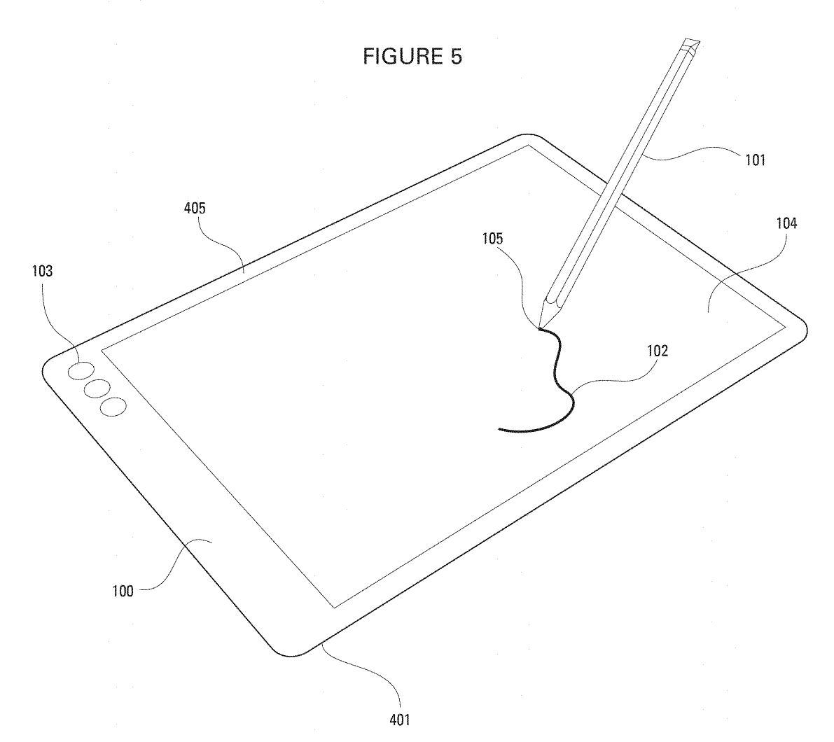

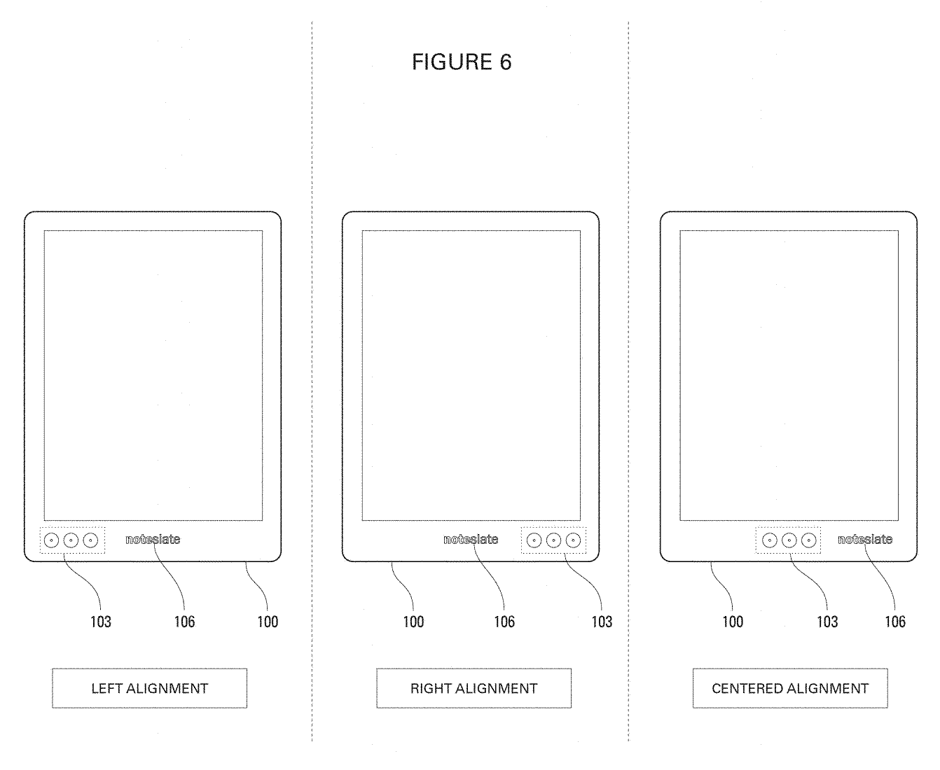

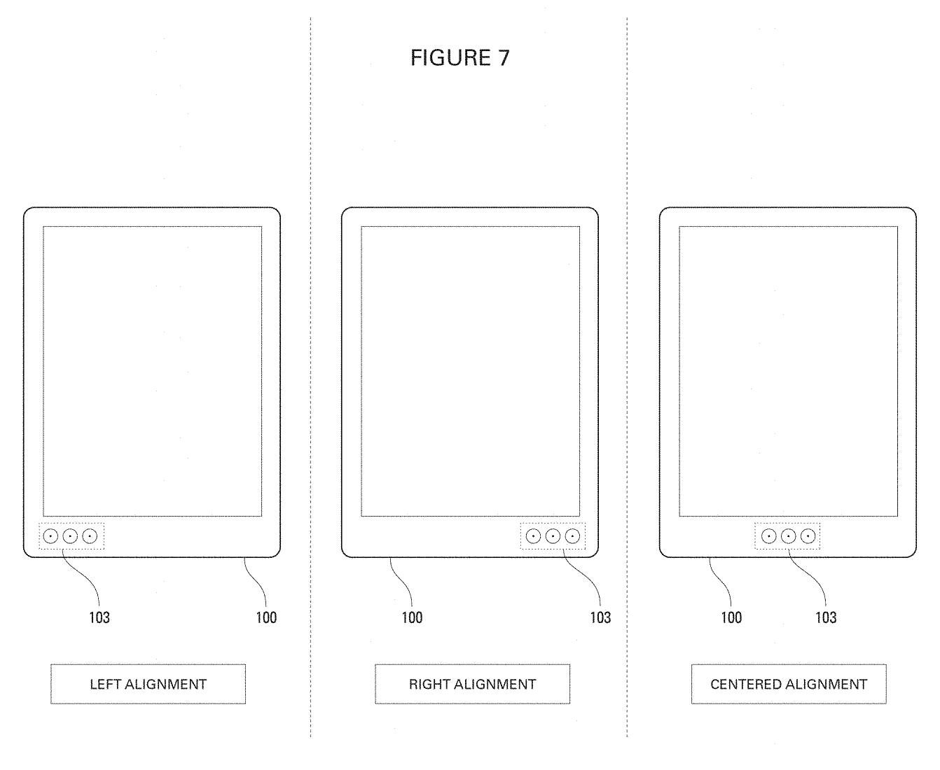

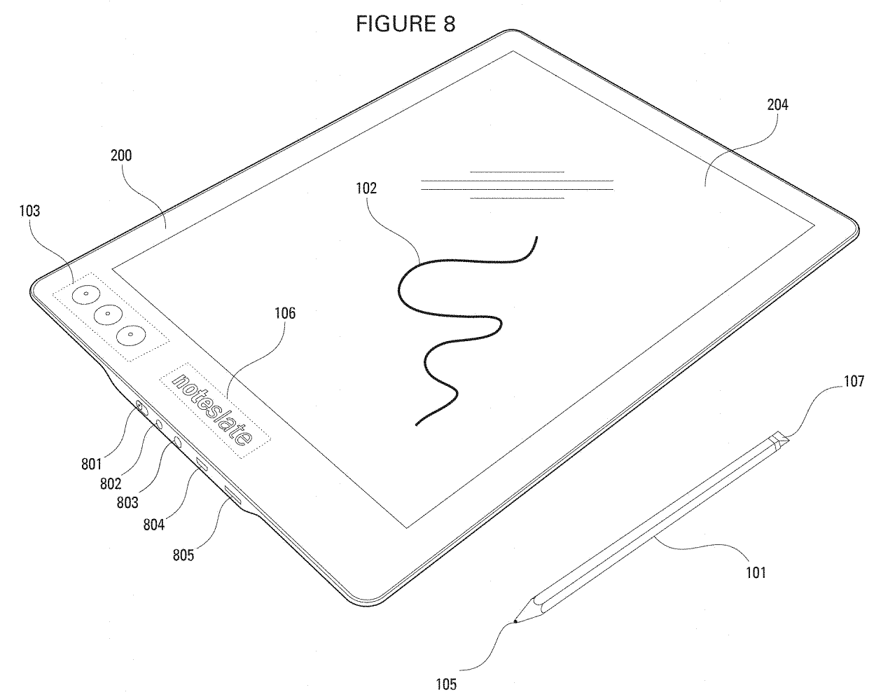

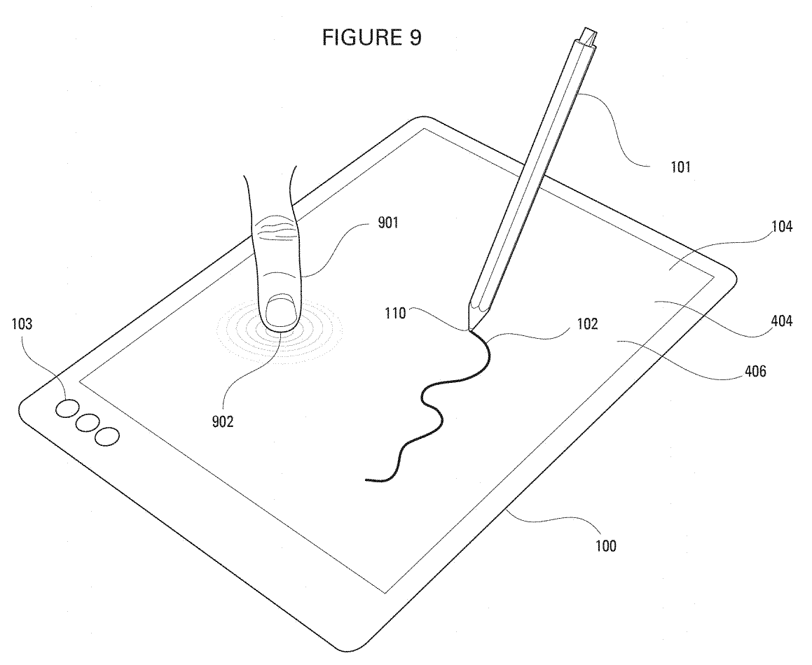

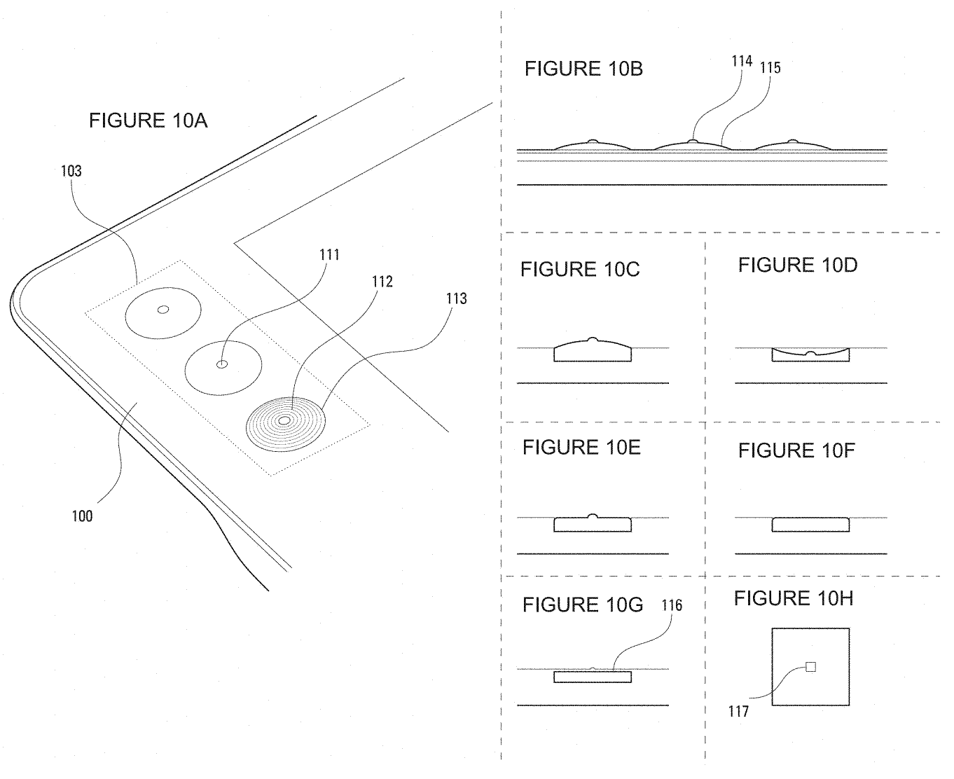

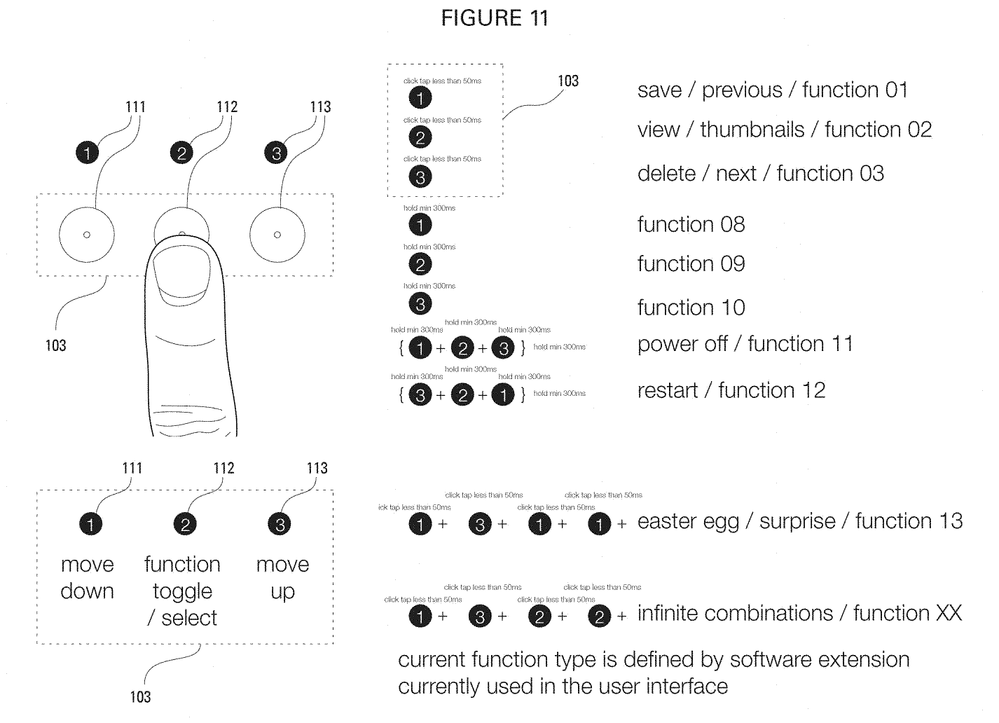

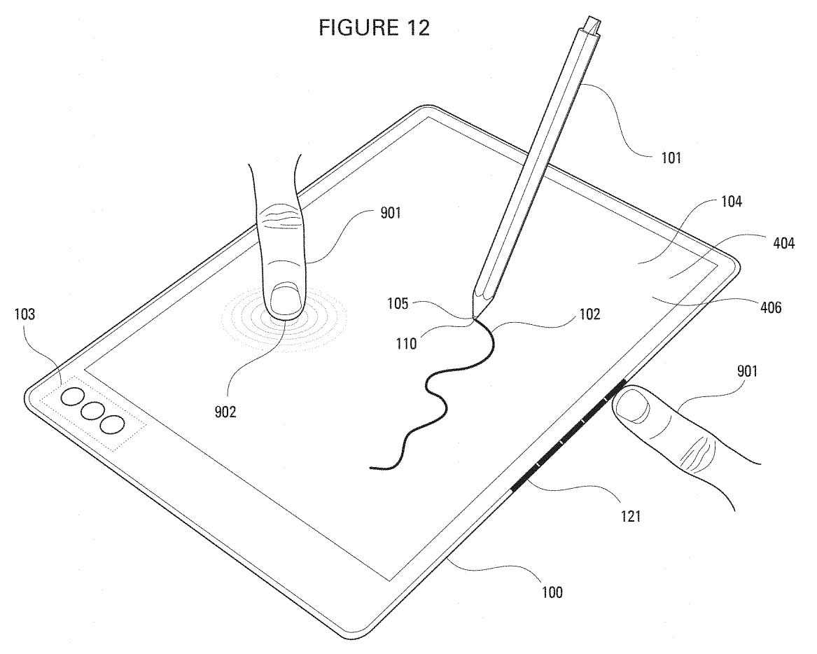

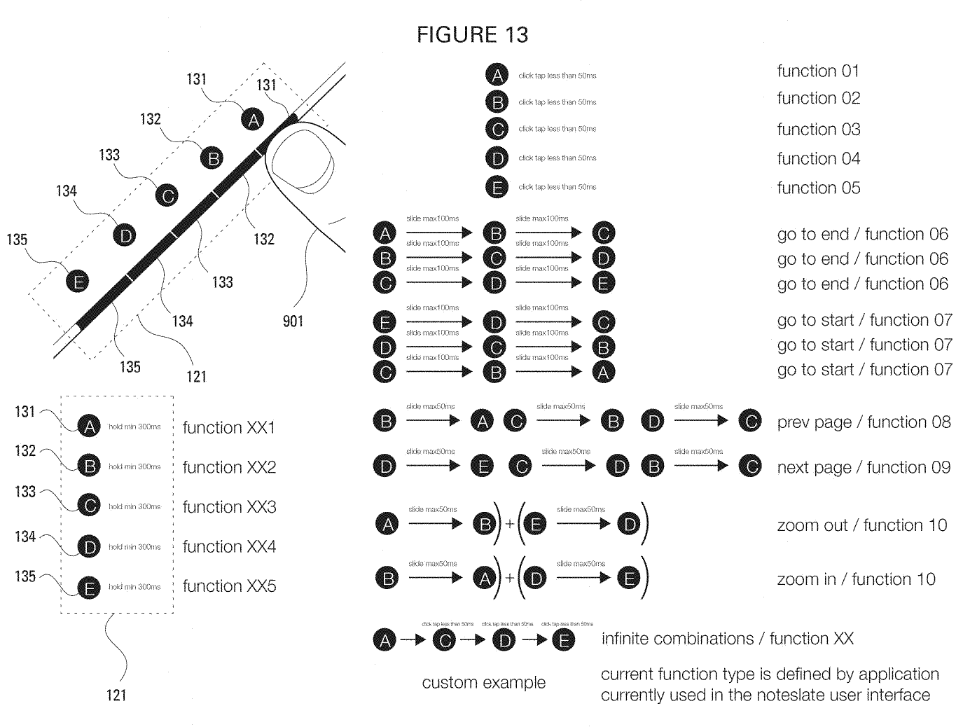

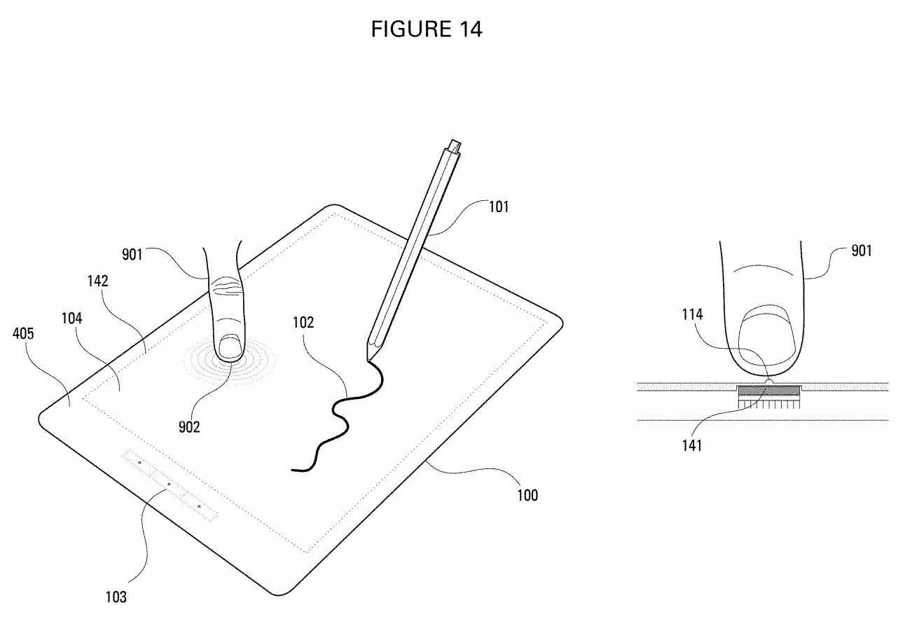

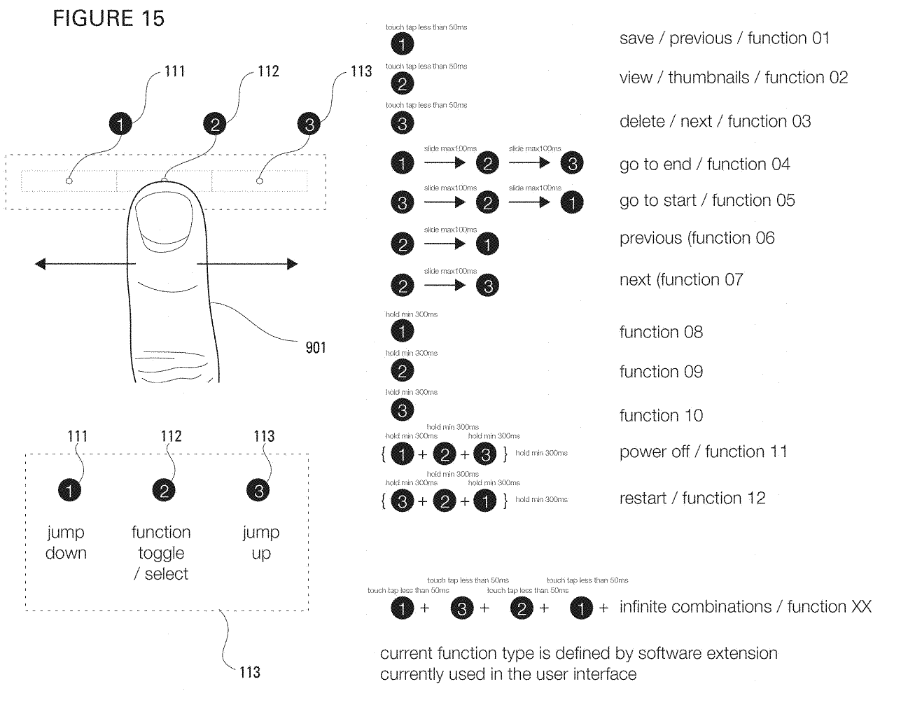

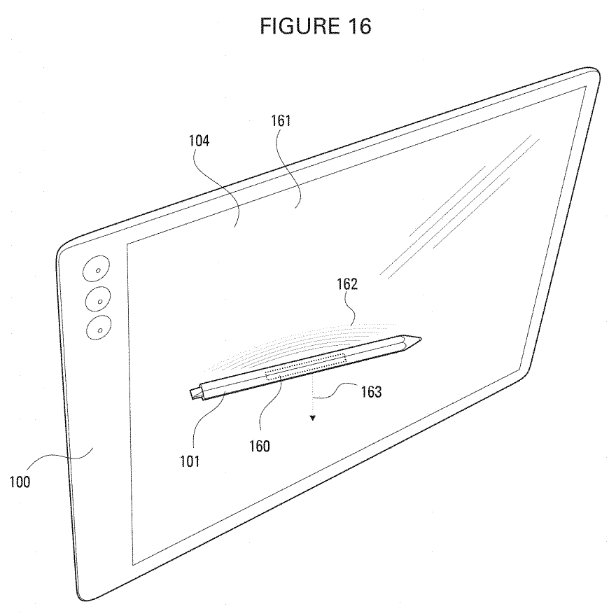

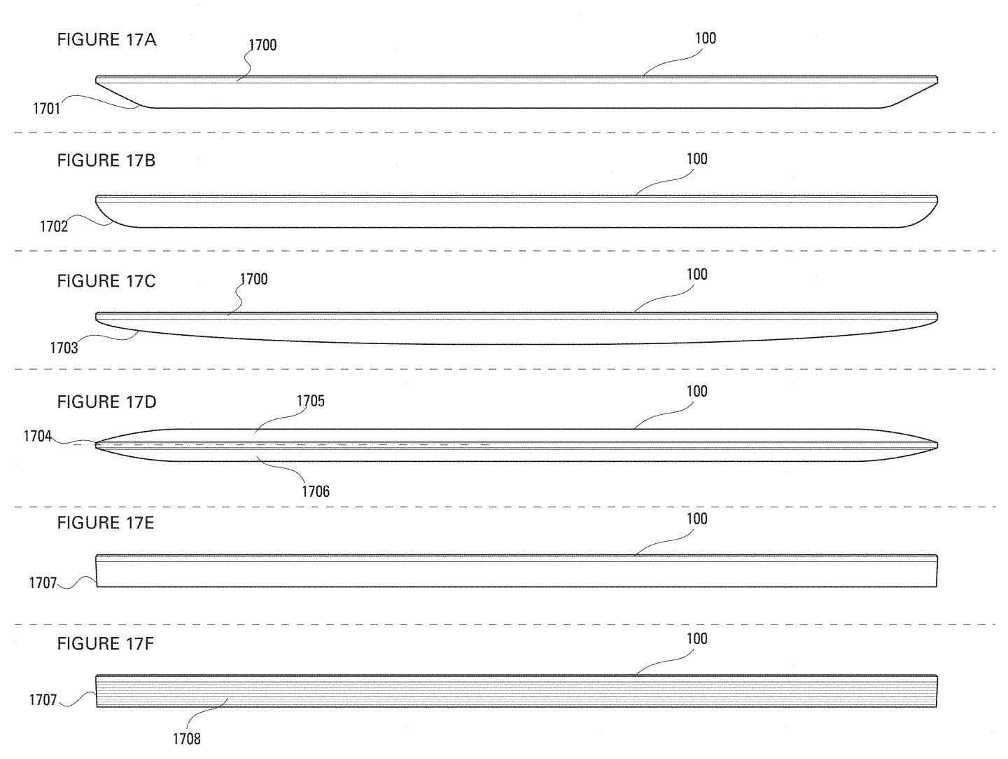

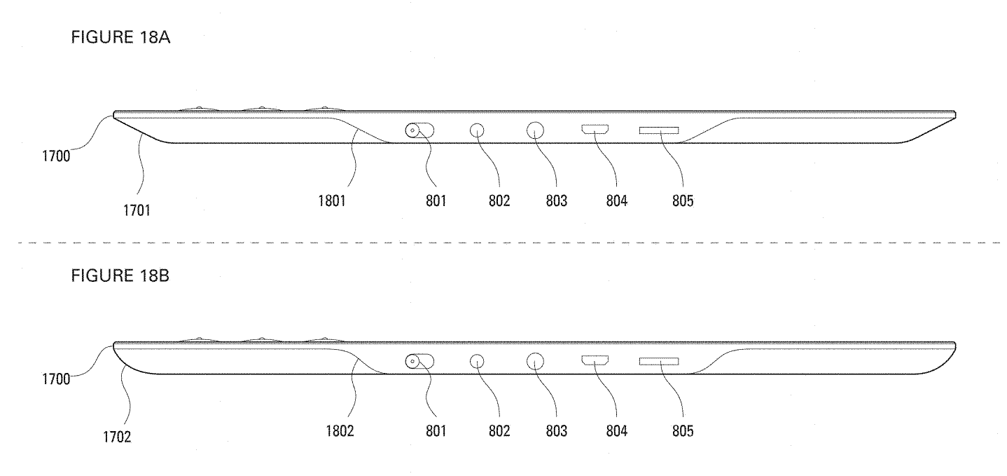

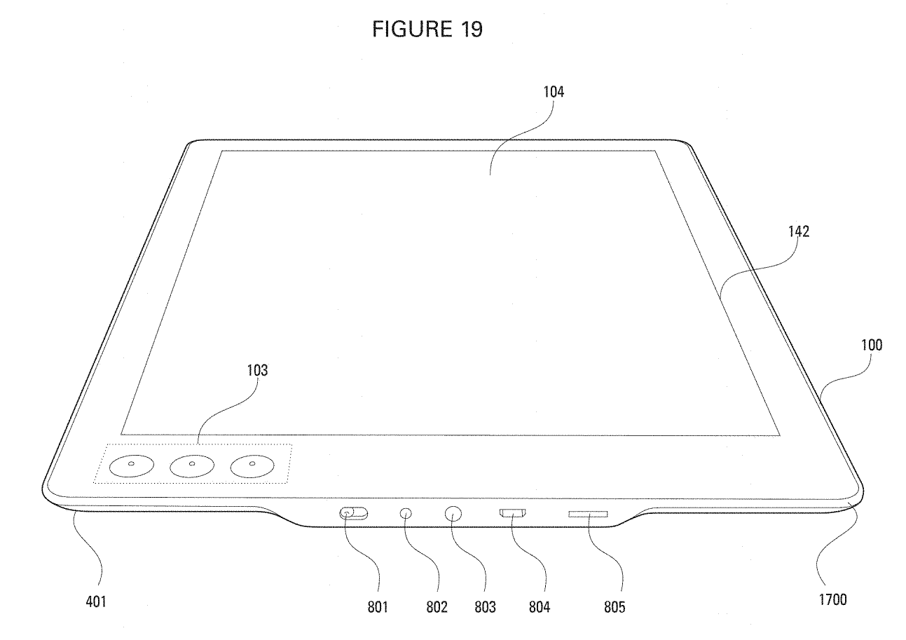

### DETAILED DESCRIPTION OF THE EMBODIMENTS

The above-mentioned needs are met by a device, method and graphical user interface for handwritten interaction. The following detailed description is intended to provide example implementations to one of ordinary skill in the art, and is not intended to limit the invention to the explicit disclosure, as one or ordinary skill in the art will understand that variations can be substituted that are within the scope of the invention as described.

The handwriting device disclosed herein is referred to as “Noteslate handwriting device”.
100 Noteslate handwriting device is an electronic paper based tablet computer device for handwritten interaction with digital stylus 101 input and capacitive finger touch 407; device is used for handwritten interaction and for creating handwritten input 102, device contains basic electronic paper display 104 module and stylus digitizer 405 for handwritten input.
100a Noteslate handwriting device of user A.
100b Noteslate handwriting device of user B.
100c Noteslate handwriting device of user C.
100e Noteslate handwriting device of user E.
101 Noteslate stylus is a digital computer peripheral for interaction on Noteslate device 100, stylus input is processed by digitizer module 405 in Noteslate device to display handwritten input and interaction.
101a Noteslate stylus of user A.
101b Noteslate stylus of user B.
101c Noteslate stylus of user C.
101e Noteslate stylus of user E.
102 Handwritten input made by the user's stylus 101 input 102, digitized by stylus digitizer 405 and displayed on electronic paper display module, made in Noteslate interface 520; this digital monochrome image can be further edited, shared, or published; creating this monochrome handwritten content by drawing or writing is the core experience on Noteslate device. In a preferred embodiment, the user can redraw specific interface elements to achieve a completely unique look of the Noteslate handwritten interface 520.
103 Basic three programmable Noteslate buttons.
104 monochrome electronic paper display module with matte and rugged surface, suitable for handwritten input.
105 Noteslate stylus drawing tip.
106 Noteslate branding.
107 Noteslate stylus eraser.
110 Stylus touching the display, point of drawing.
111 The first of programmable Noteslate buttons.
112 The second of programmable Noteslate buttons.
113 The third of programmable Noteslate buttons.
114 The basic button centered haptic tip.
115 The basic button profile is shaped in various ways.
116 The basic button is hidden under the front panel (capacitive touch solution).
117 Rectangular basic button design with rectangular haptic tip.
121 Slider touch input composed from 5 capacitive touch buttons.
131 Capacitive touch button number 1 (part of the slider).
132 Capacitive touch button number 2 (part of the slider).
133 Capacitive touch button number 3 (part of the slider).
134 Capacitive touch button number 4 (part of the slider).
135 Capacitive touch button number 5 (part of the slider).
141 Capacitive button internal component.
142 Continuous, flushed or visible edge (transition) between the display 102 and device front panel 405.
160 Magnetic module inside the Noteslate stylus.
161 Magnetic (e.g. steel) backplate unit behind the display module.
162 Magnetic force from the stylus holding it on the display.
163 Gravity or movement force.
200 Large A4 size Noteslate device with 13.3-inch display.
210 13.3-inch electronic paper display.
220 Medium A5 size Noteslate device with 9.7-inch display.
204 9.7-inch electronic paper display module.
214 Smallest A6 size Noteslate device with 6-inch display.
224 6-inch electronic paper display module.
300 Small A6 size Noteslate device with 6.8-inch display.
301 Triangular stylus for 6.8-inch Noteslate device.
302 Handwritten input made by user and displayed on display.
303 Three programmable Noteslate buttons.
304 6.8-inch electronic paper display module.
401 Noteslate device back plate body part made from plastic, aluminum, magnesium, wood or other material.
402 Internal battery.
403 Main printed circuit mother board.
404 Stylus digitizer touch input layer.
405 Front panel surface.
406 Front finger touch digitizer layer (capacitive or resistive).
407 Soft foam antistatic internal buffer layer.
520 Noteslate unique handwritten monochrome 1-bit interface, basic software GUI for handwritten interaction on Noteslate device, can be adapted for various color modes and applications.
520a Noteslate interface of user A.
520b Noteslate interface of user B.
520c Noteslate interface of user C.
520d Noteslate interface of user D.
520e Noteslate interface of user E.
521a Noteslate interface working in monochrome 8-bit color scheme.
521b Noteslate interface working in inverted color scheme.
521c Networked Noteslate interface 1510 with various inputs from different simultaneous users, each user's drawing input is represented by one color.
521d Noteslate interface is running in RGB mode (e.g. for tablets) with photo background.
522a Black 525a and White 525b color only scheme of 1-bit interface 520.
522b White 525a and Black 525b color only scheme of 1-bit interface 520.
522c Blue 525a and White 525b color only scheme of 1-bit interface 520.
522d Blue 525a and Black 525b color only scheme of 1-bit interface 520.
522f Red 525a and White 525b color only scheme of 1-bit interface 520.
522g Red 525a and Black 525b color only scheme of 1-bit interface 520.
522h Green 525a and White 525b color only scheme of 1-bit interface 520.
522i Green 525a and Black 525b color only scheme of 1-bit interface 520.
523 Customized unique color scheme of 1-bit interface 520 combining two random colors for foreground 525a and background 525b.

(e.g. Yellow 525a and Black 525b color only scheme of 1-bit interface 520).
523a User selects any color 525a.
523b User selects any color 525b.
525a Foreground color in Noteslate interface 520, mostly made by handwritten stylus input 102 or displaying elements.
525b Background color in Noteslate interface 520.
528a Vertical number of pixels of current display in ns GUI 520.
528b Horizontal number of pixels of current display in ns GUI 520.
531 User's finger touches in upper left corner to open a menu.
532 User's finger touches in upper right corner to open a menu.
533 User's finger touches in lower right corner to open a menu.
534 User's finger touches in lower left corner to open a menu.
535 Finger swipe touch for additional touch interaction functionality.
536a Finger touch adds features to current page, specific functionality depends on current application interface 520.

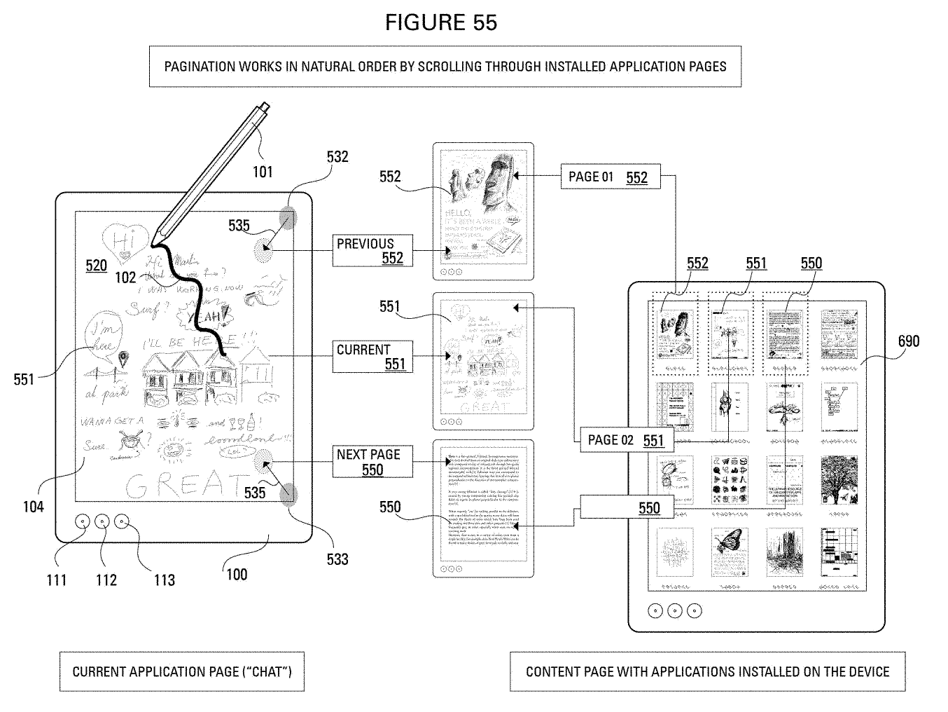

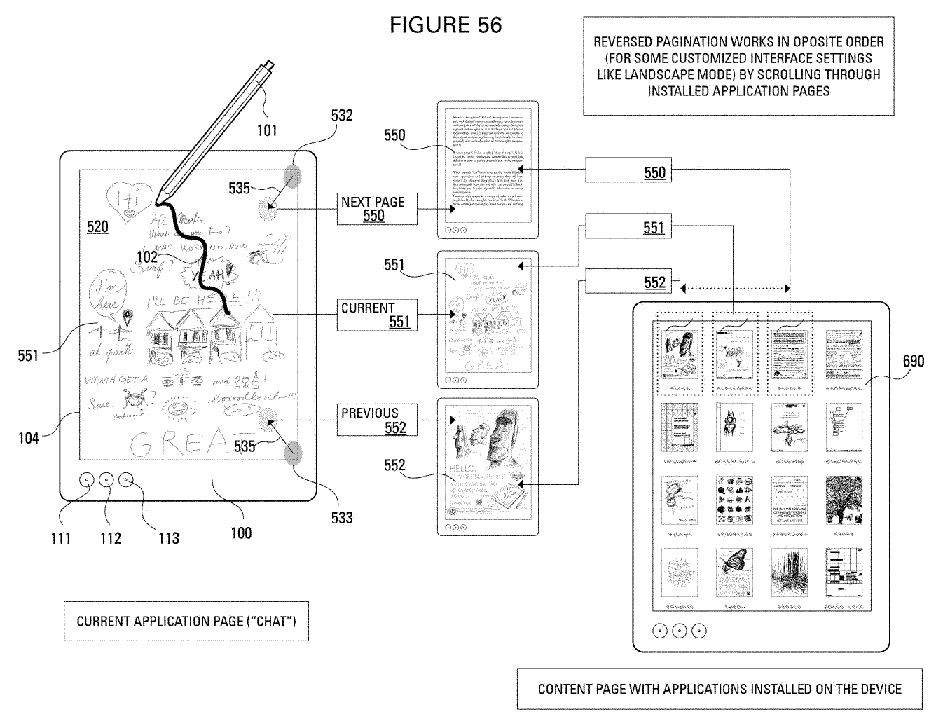

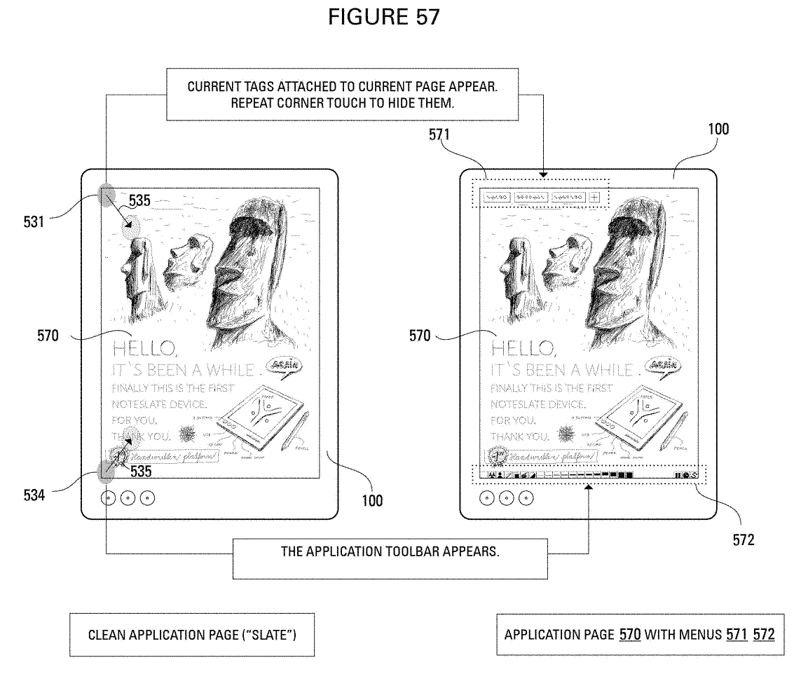

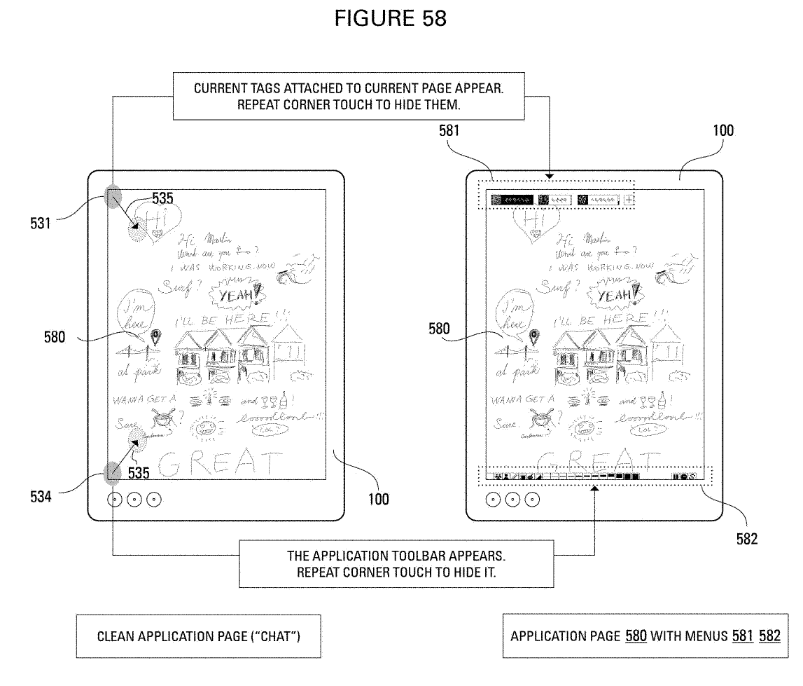

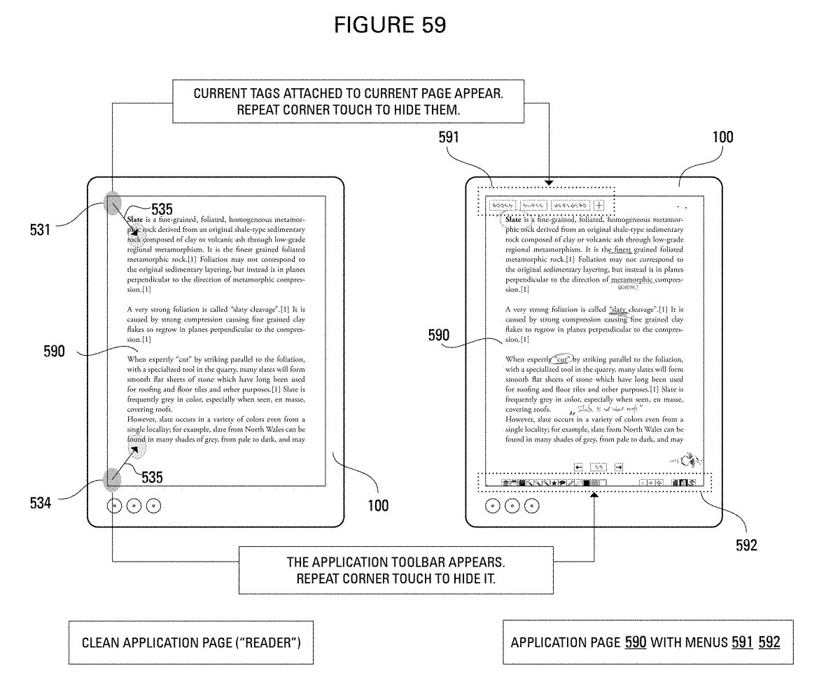

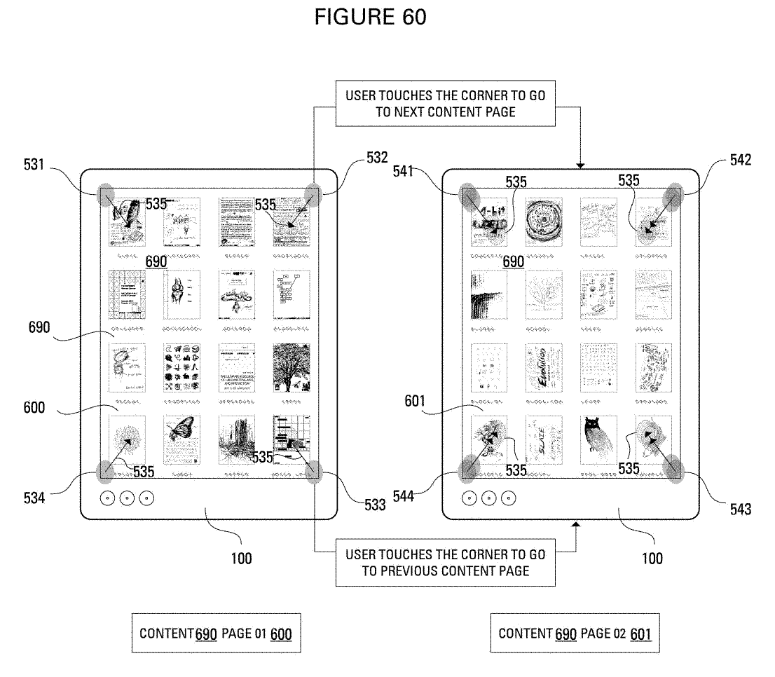

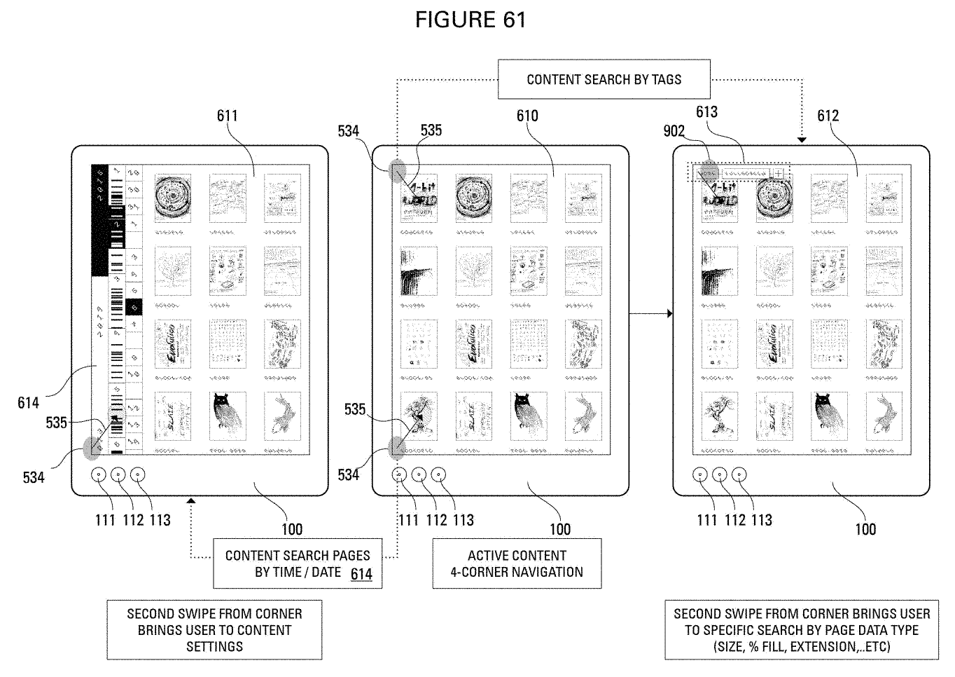

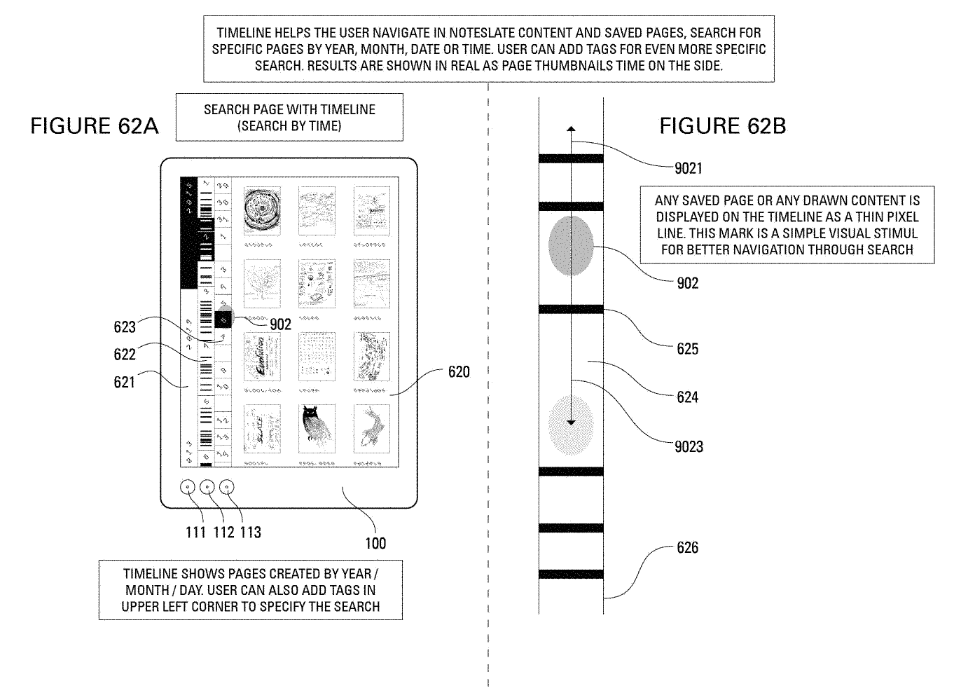

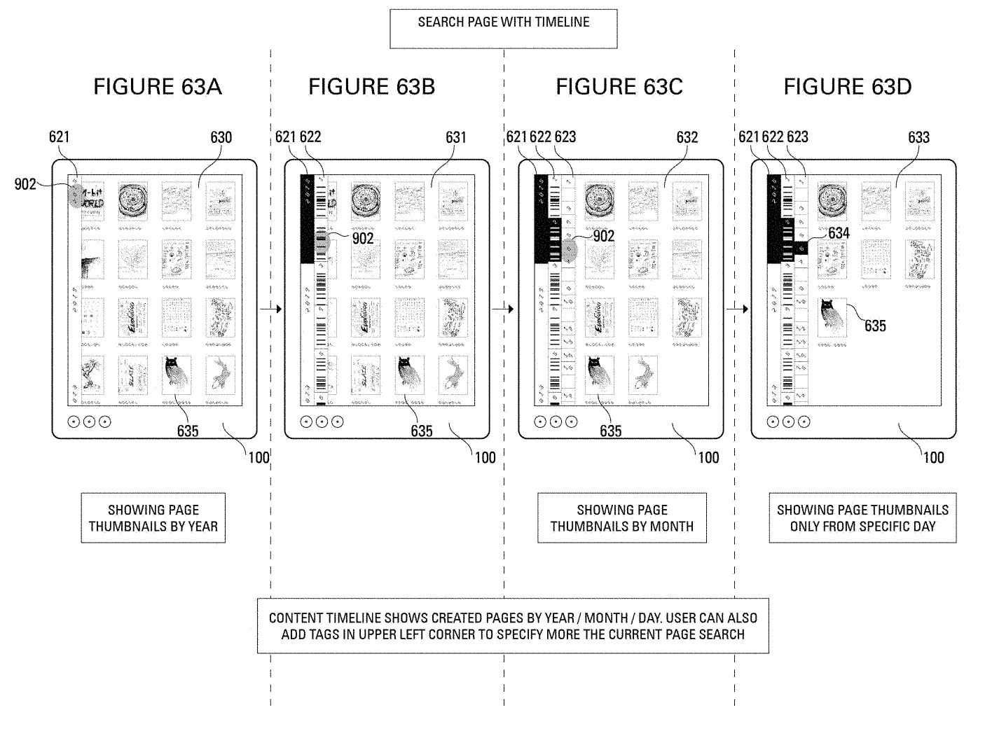

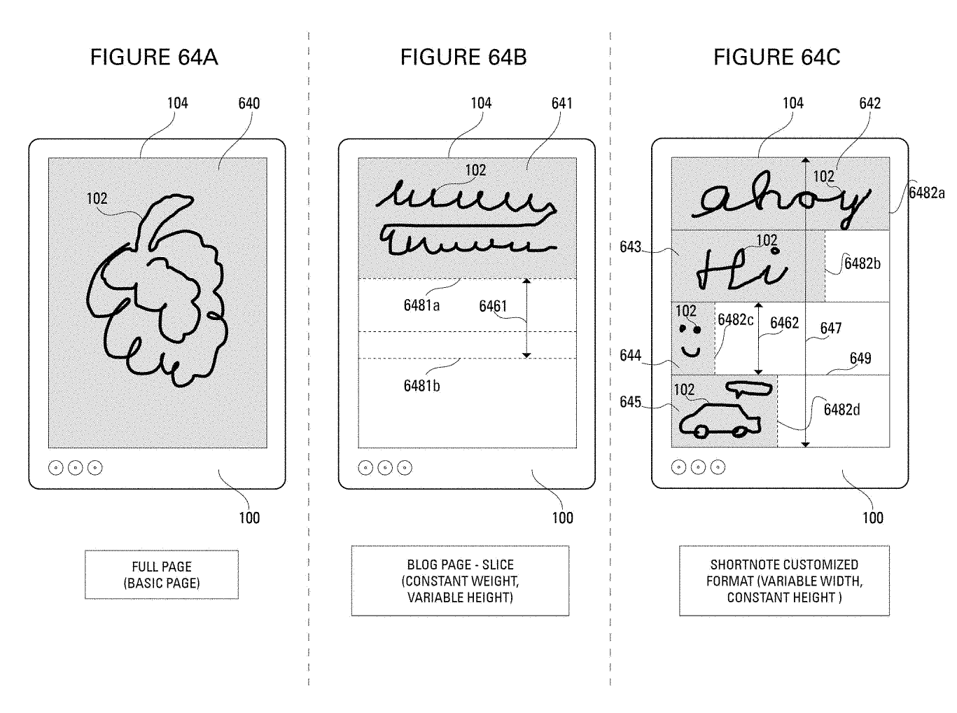

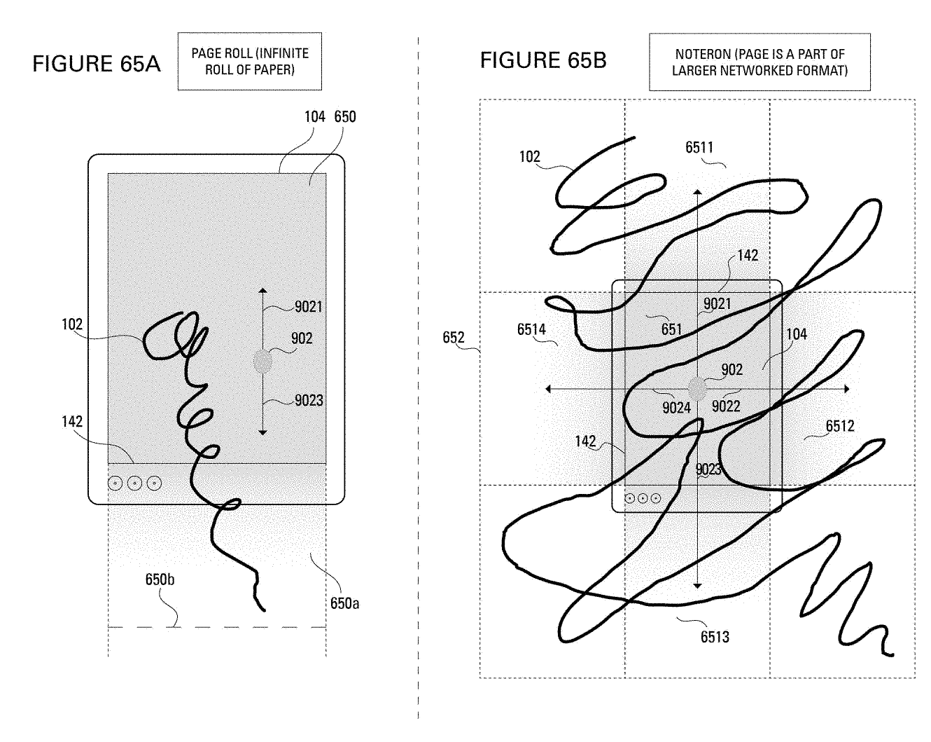

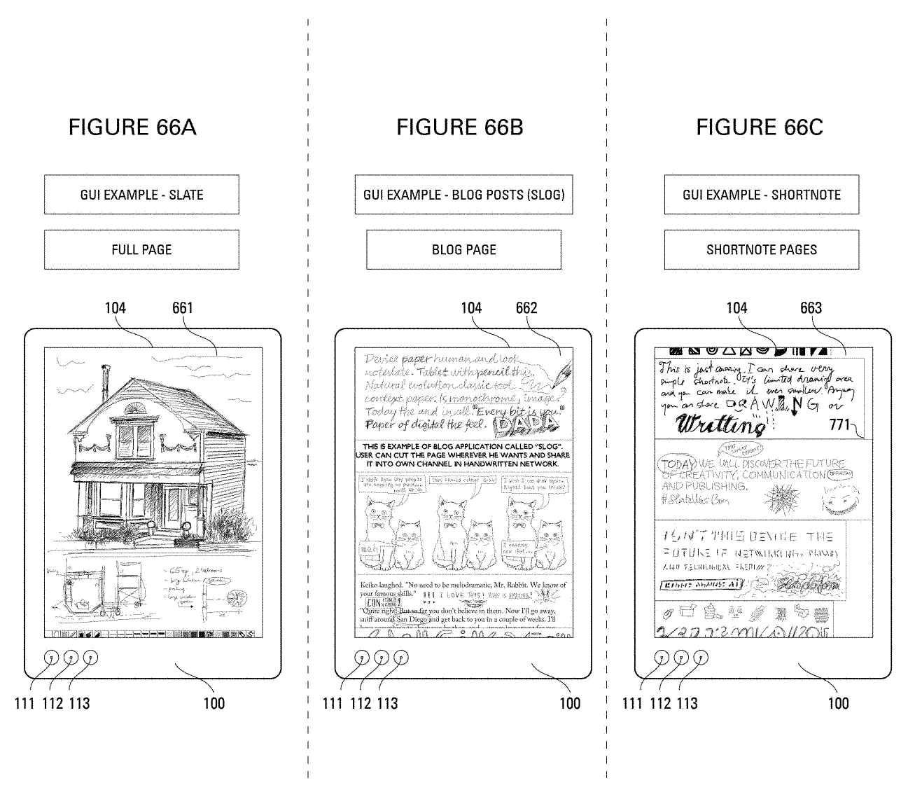

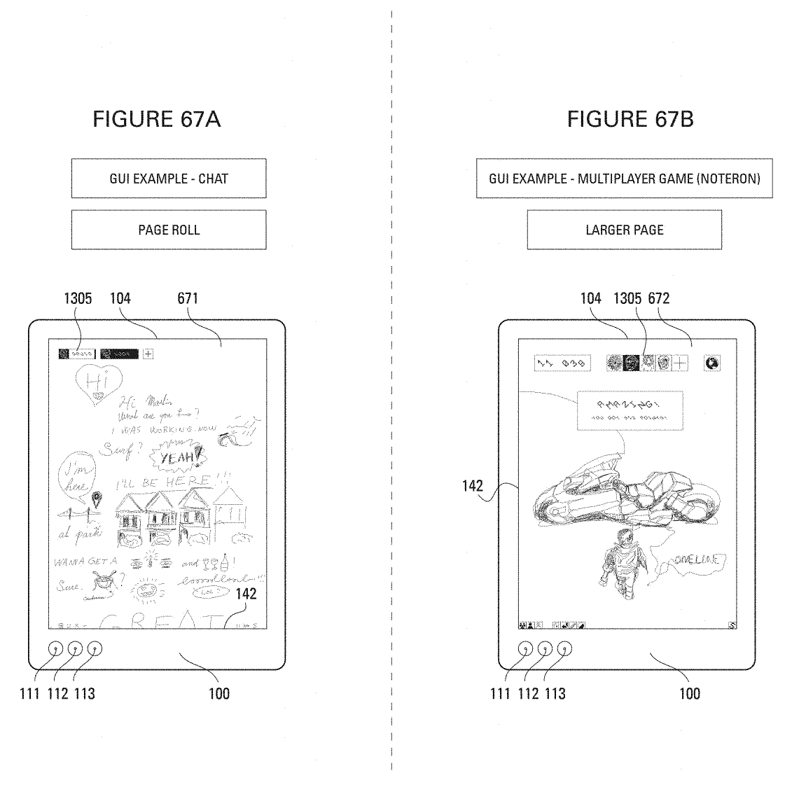

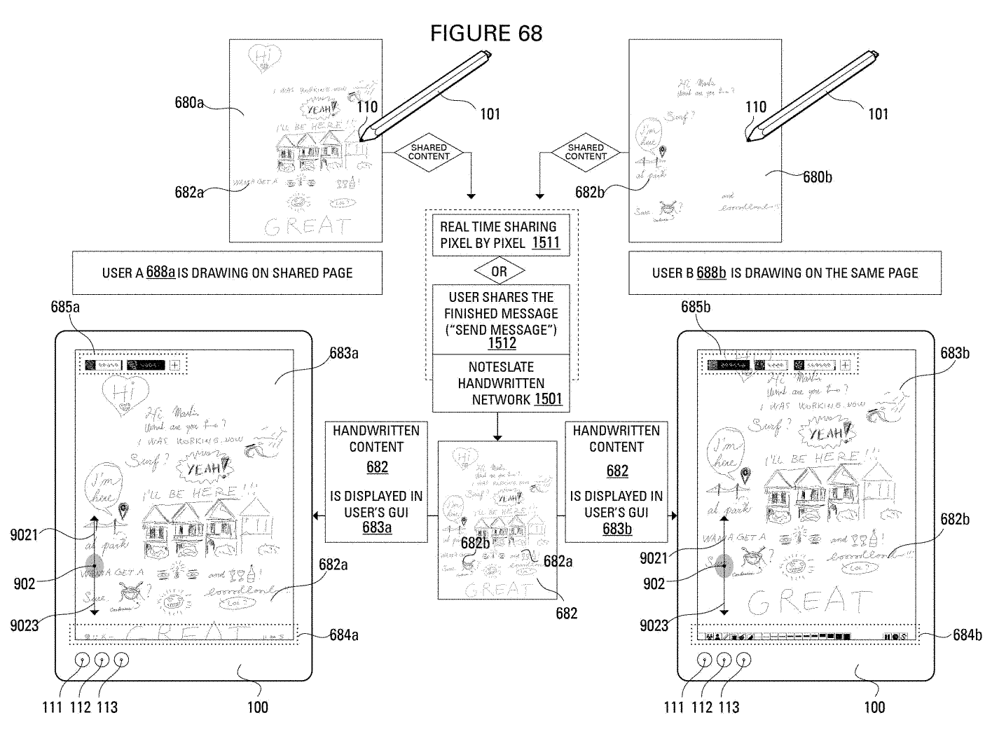

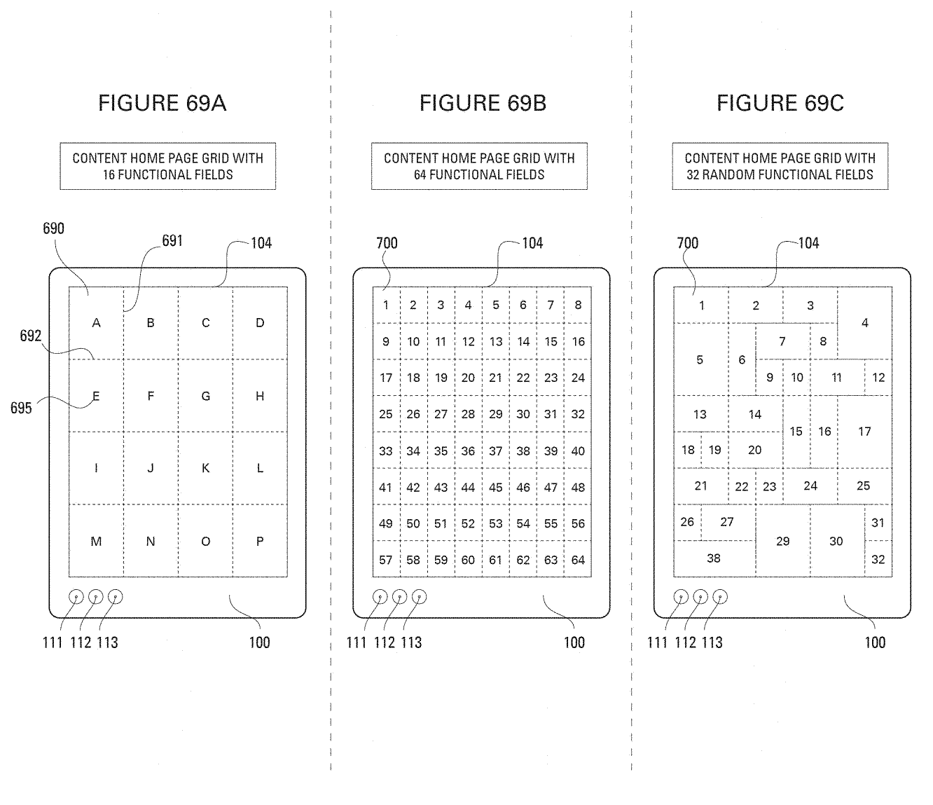

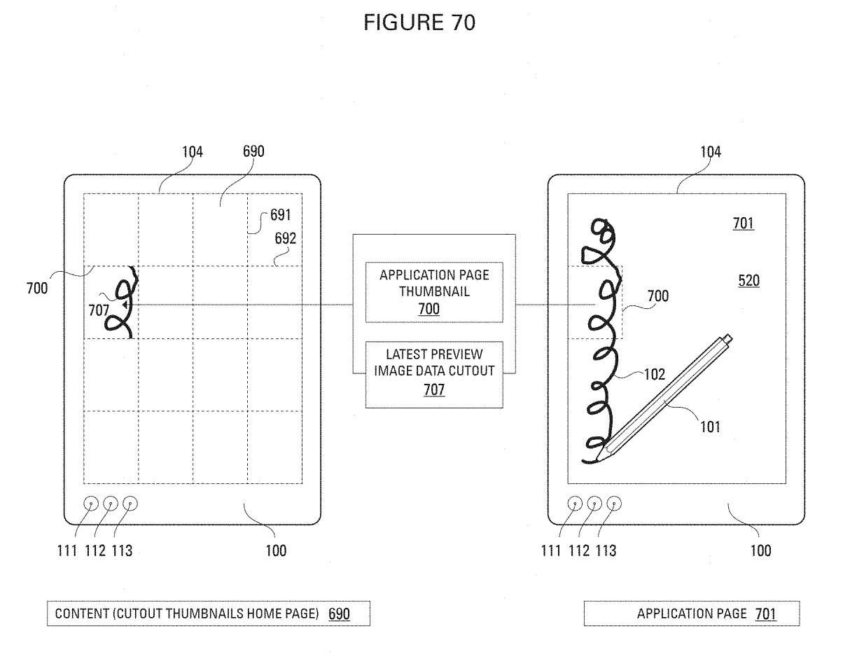

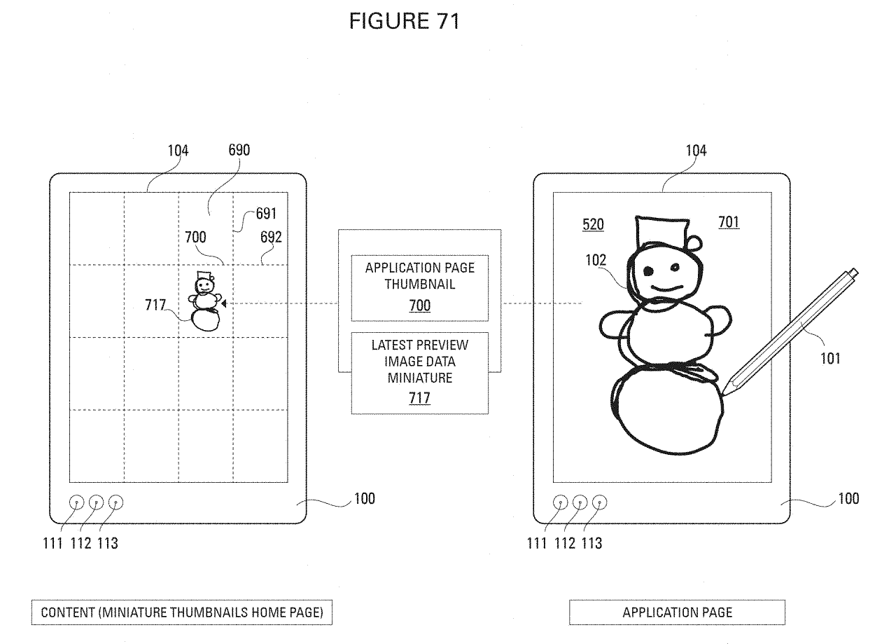

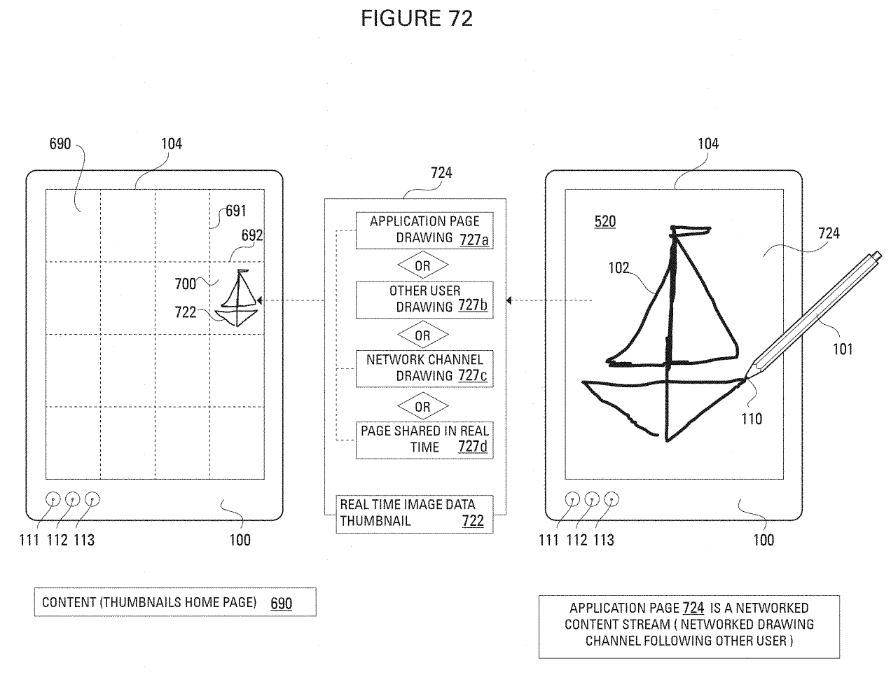

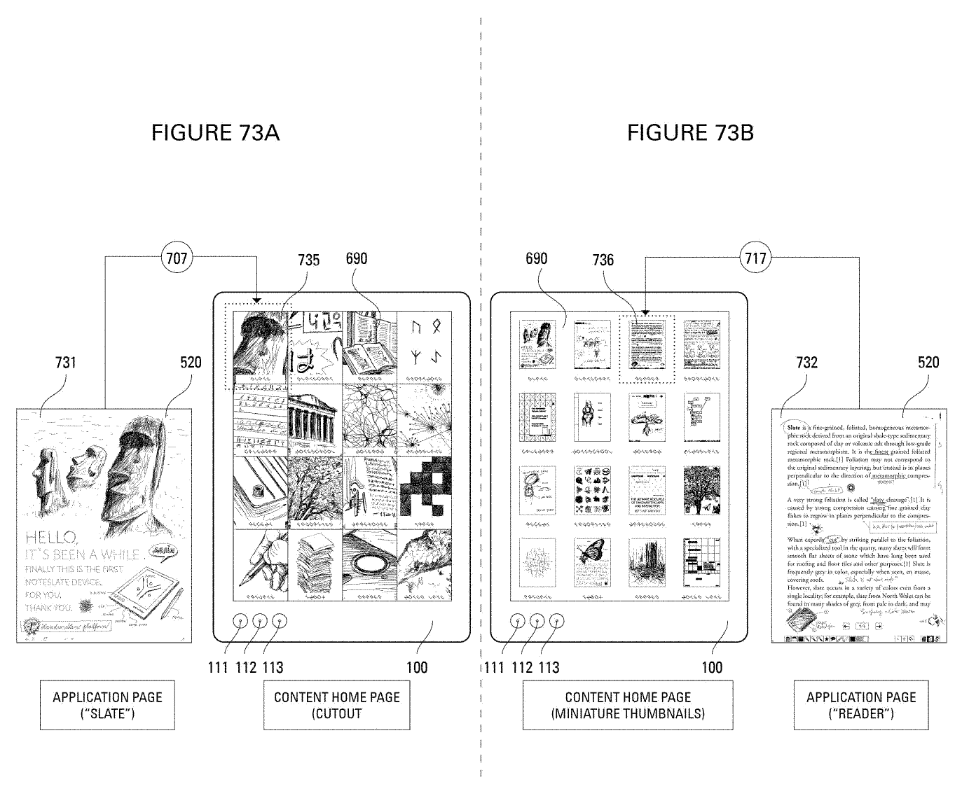

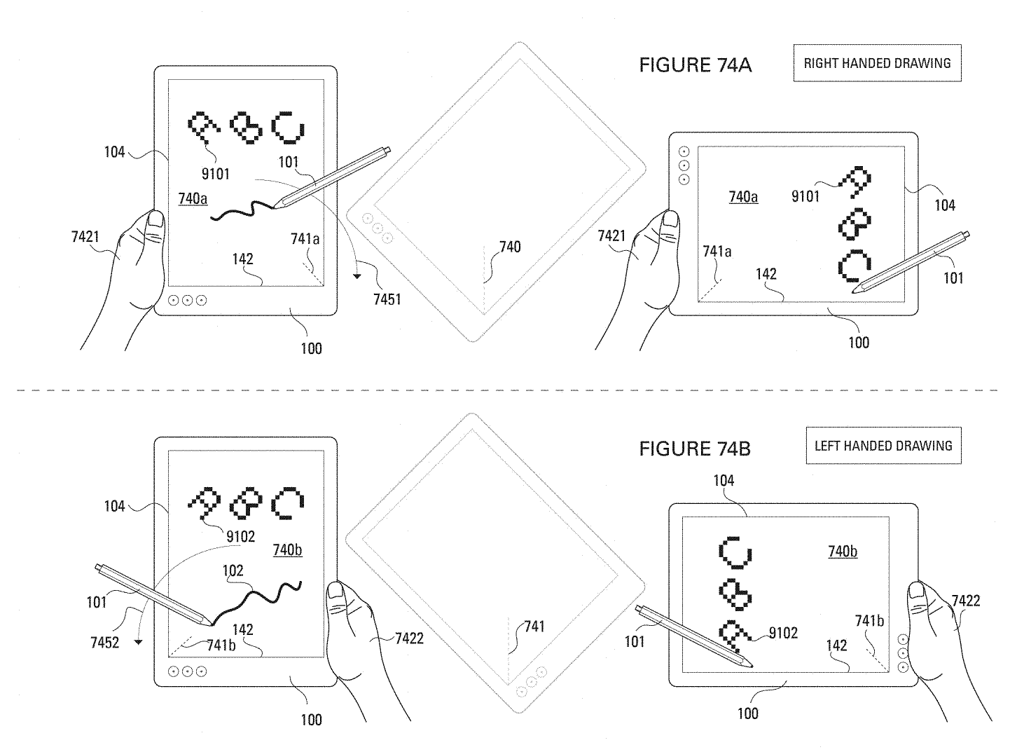

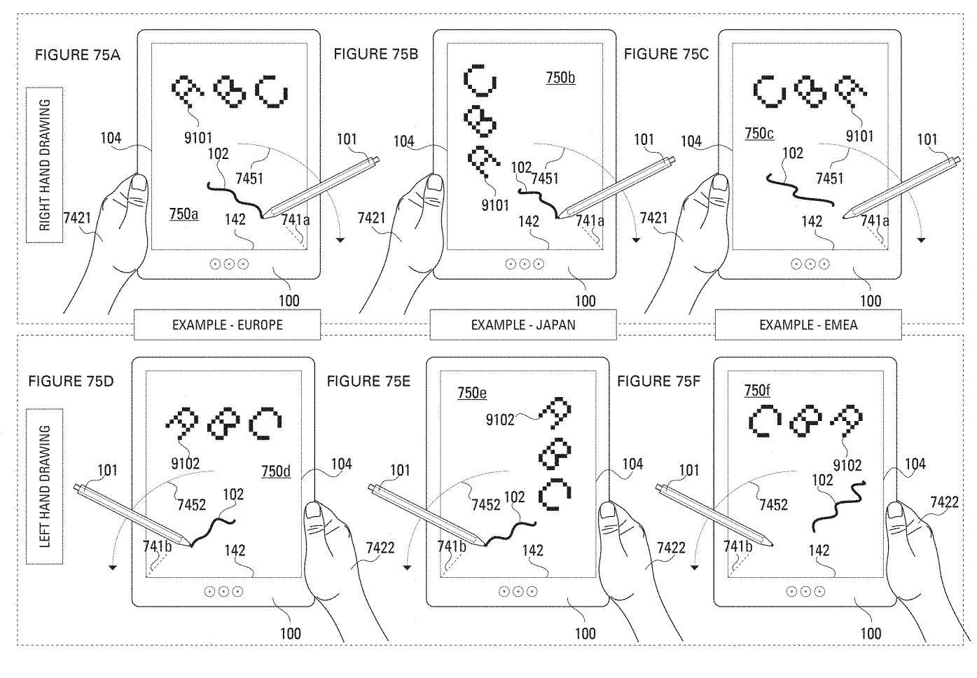

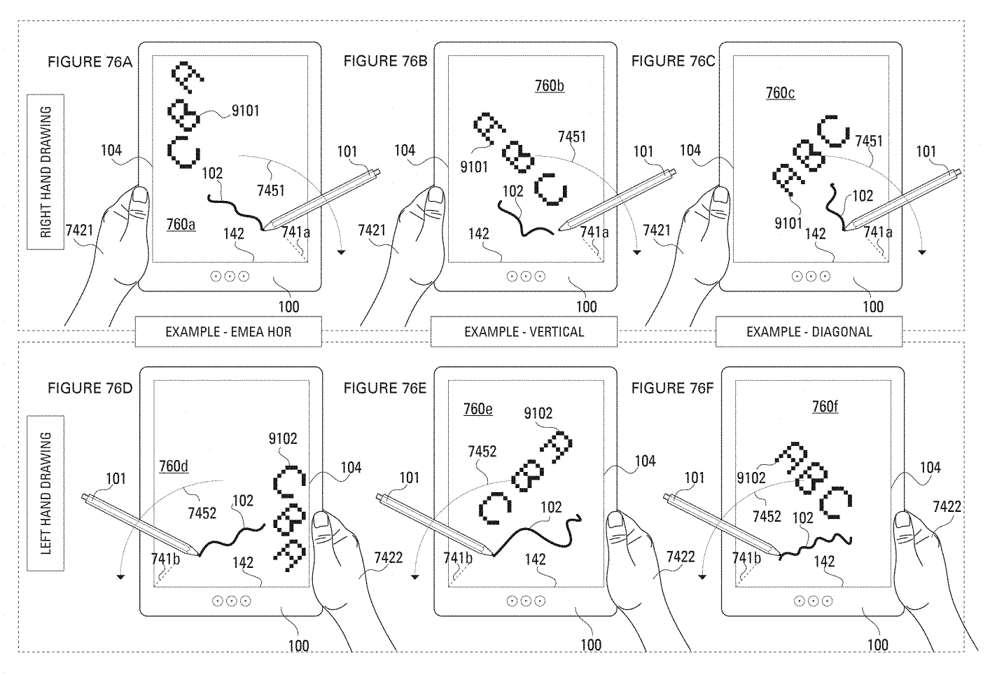

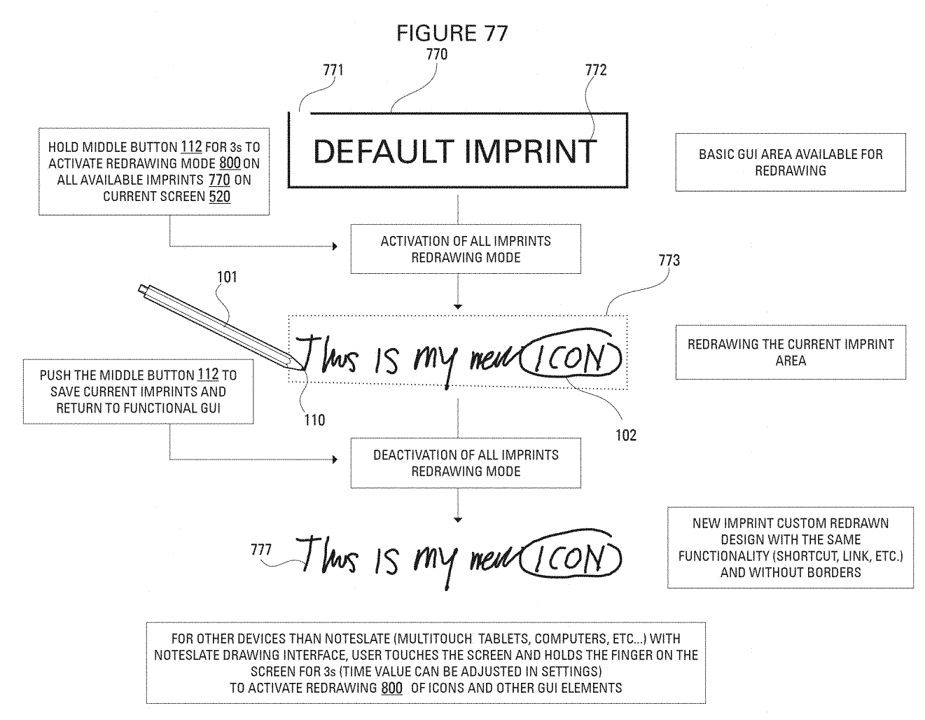

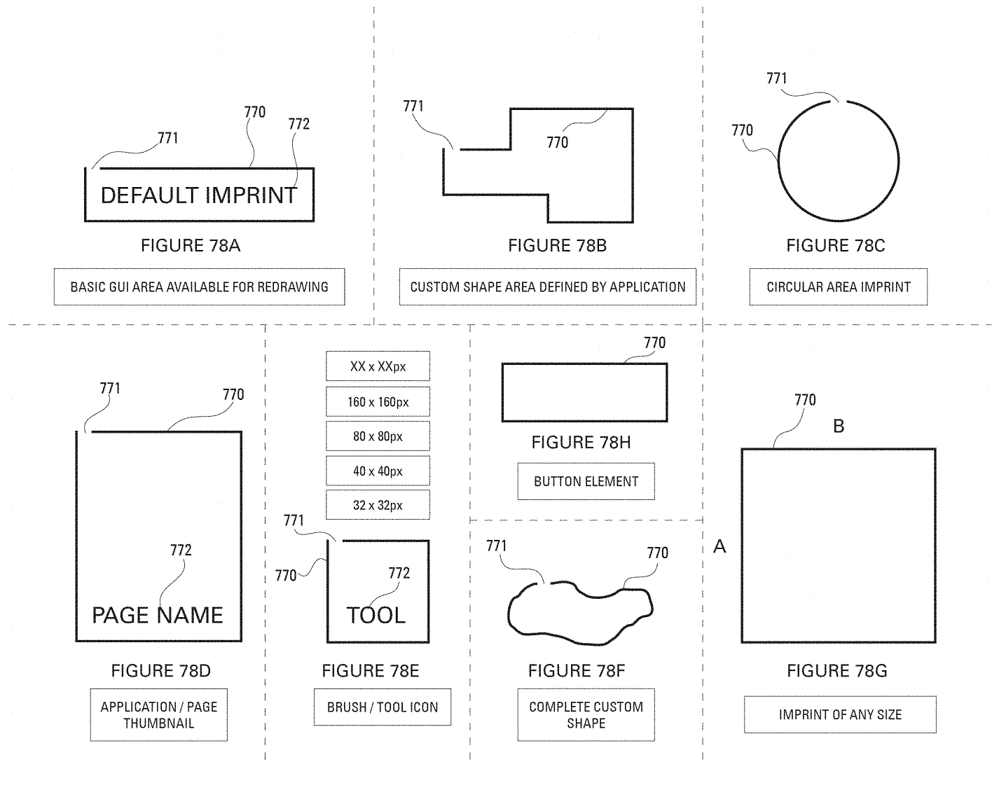

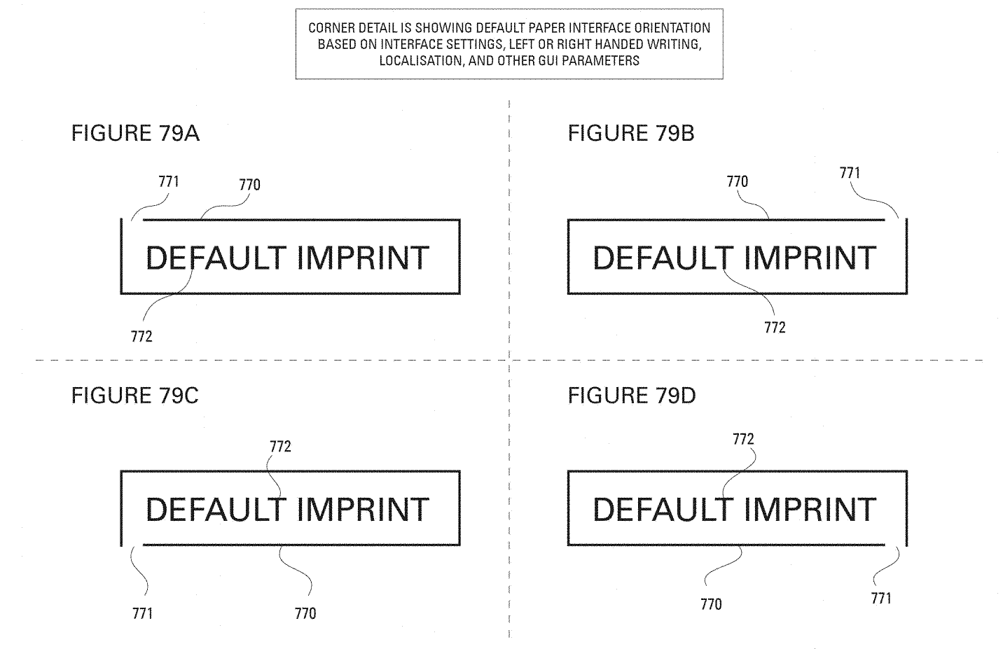

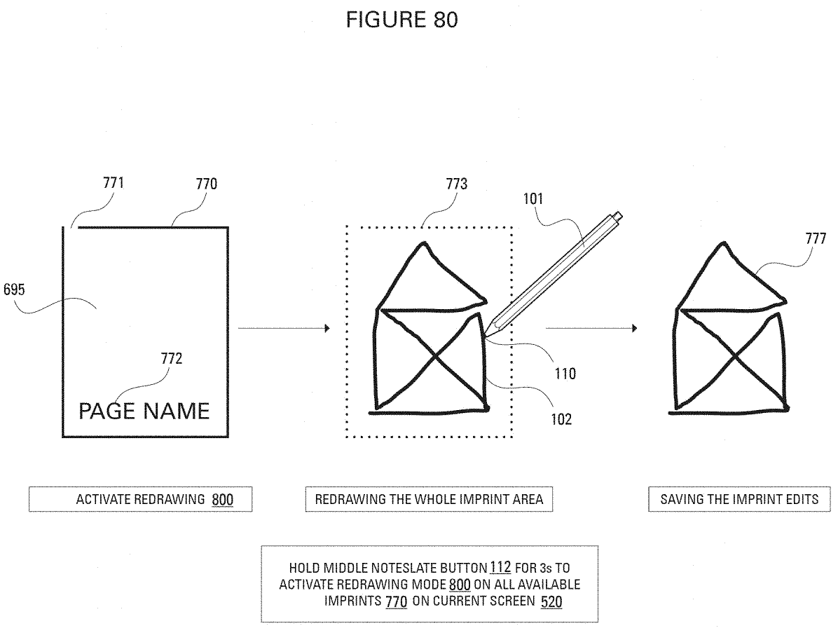

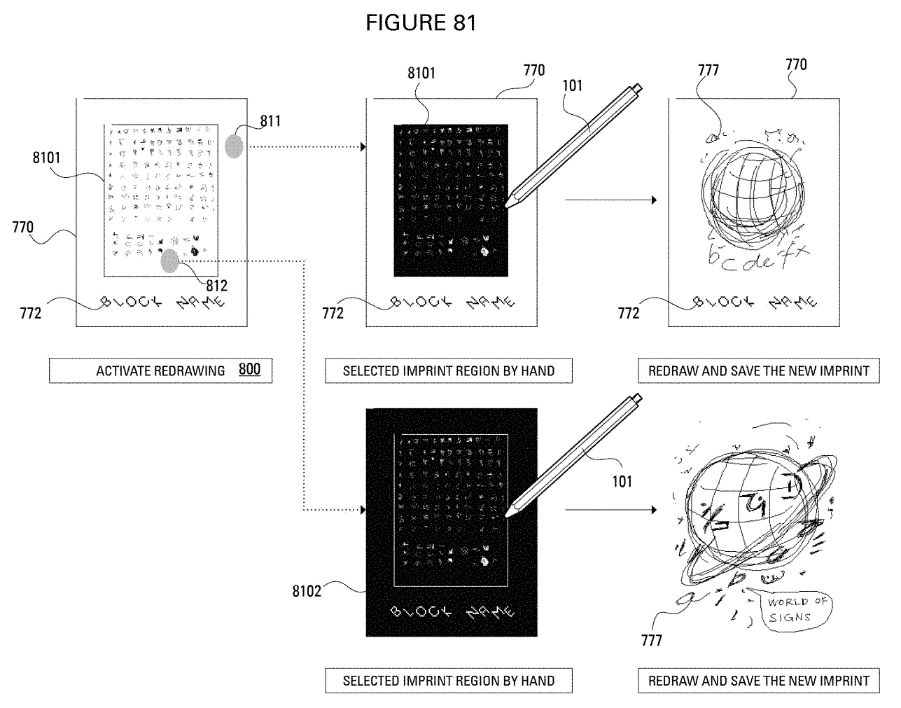

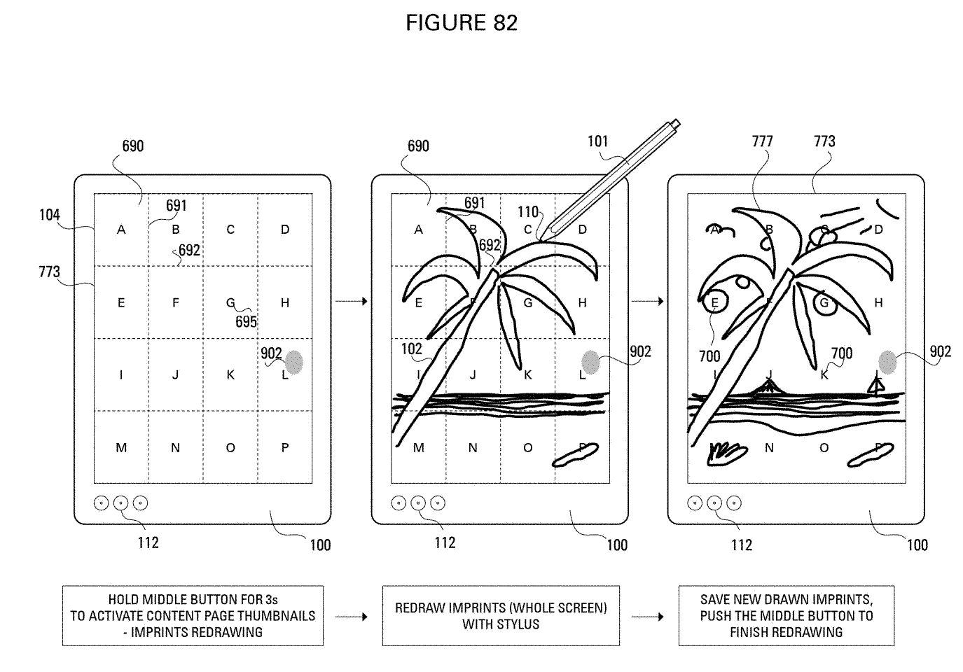

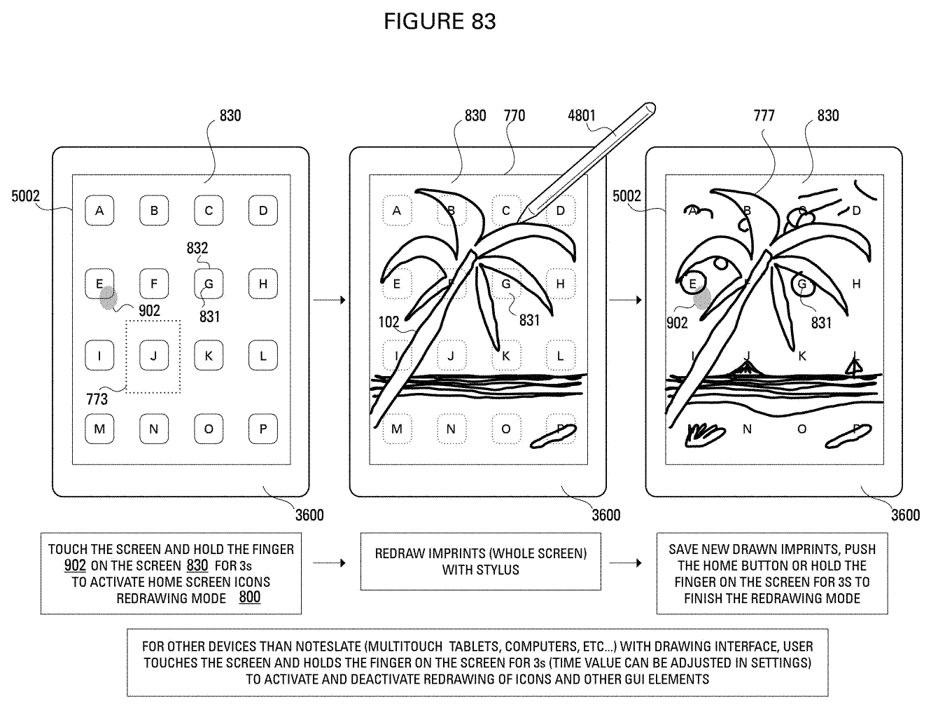

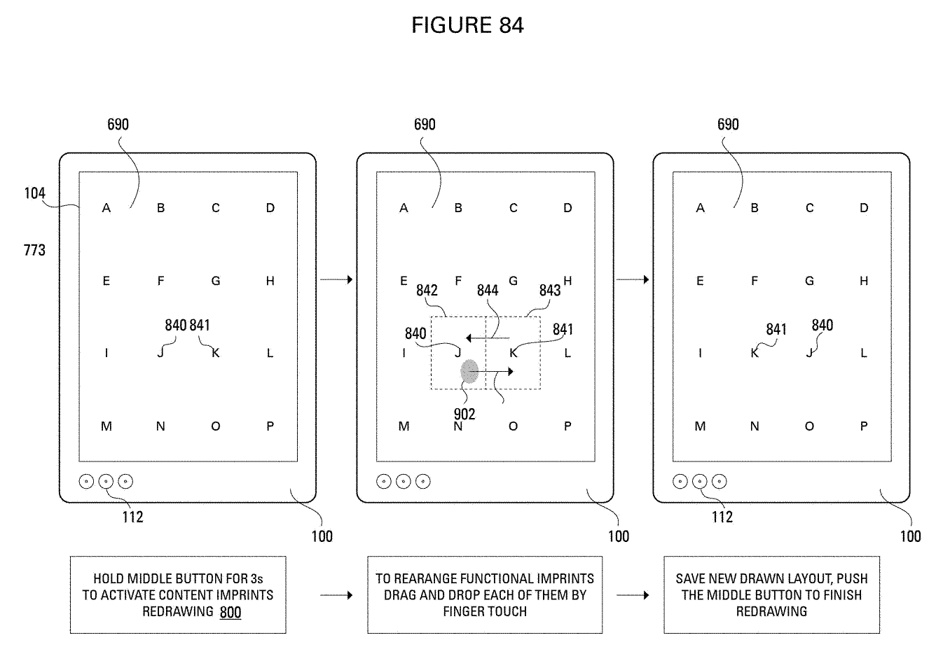

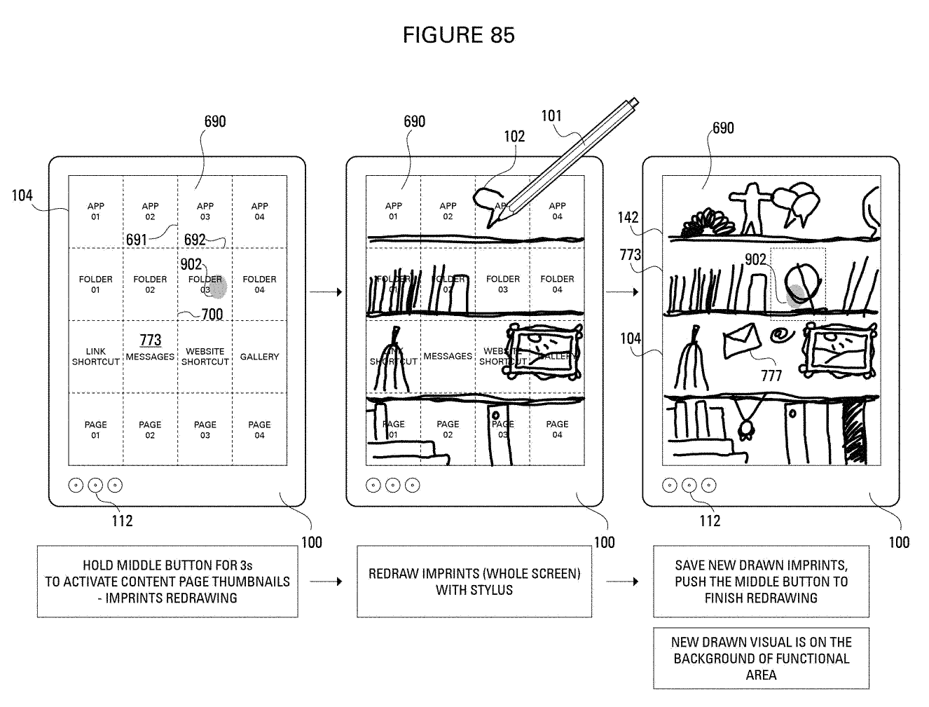

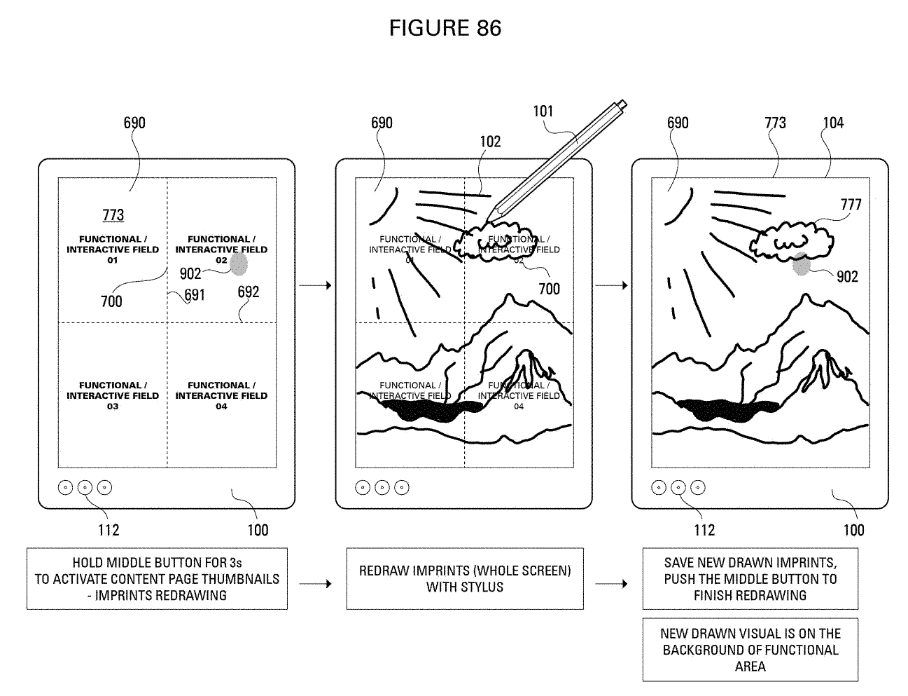

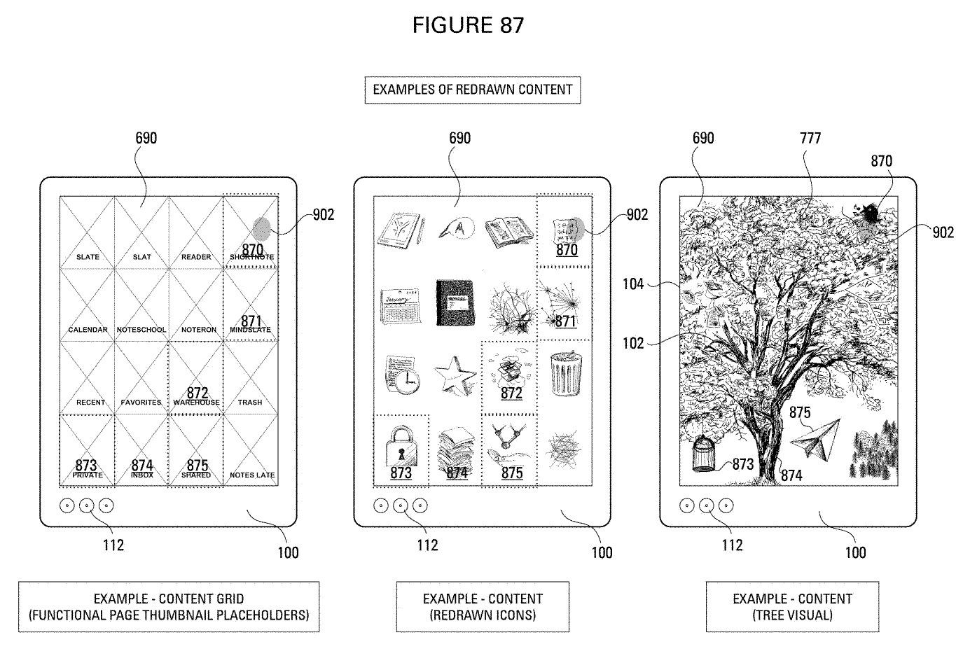

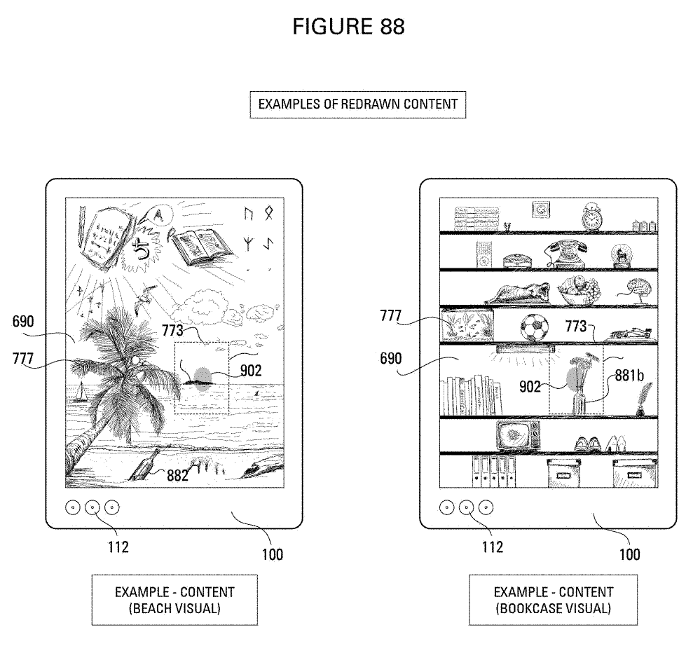

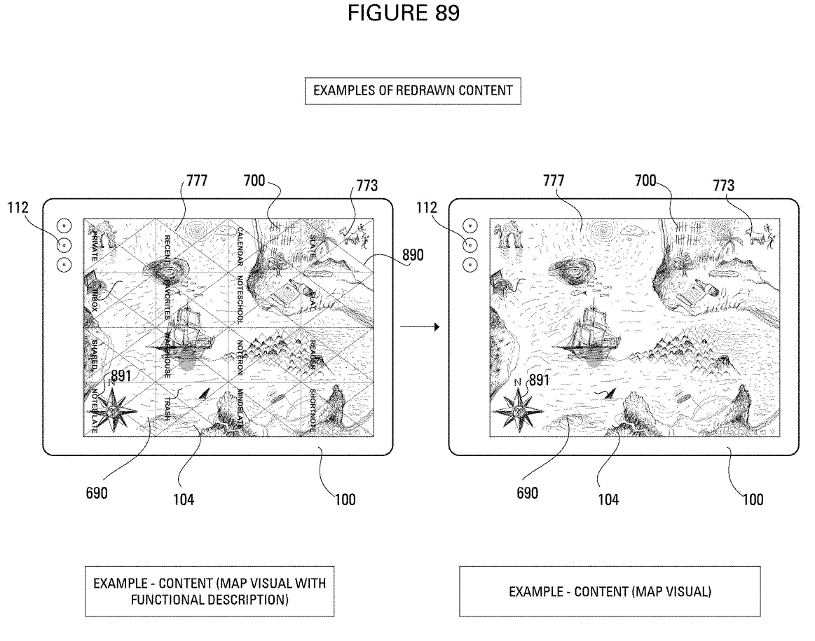

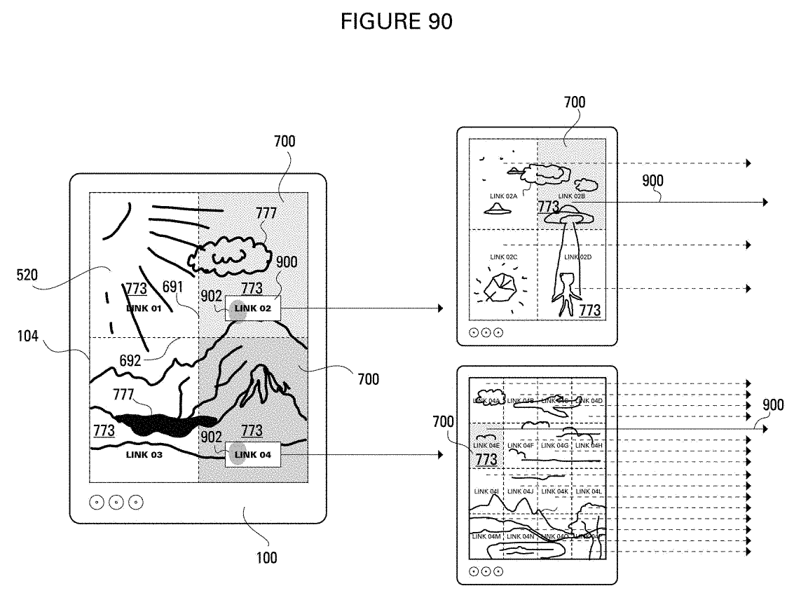

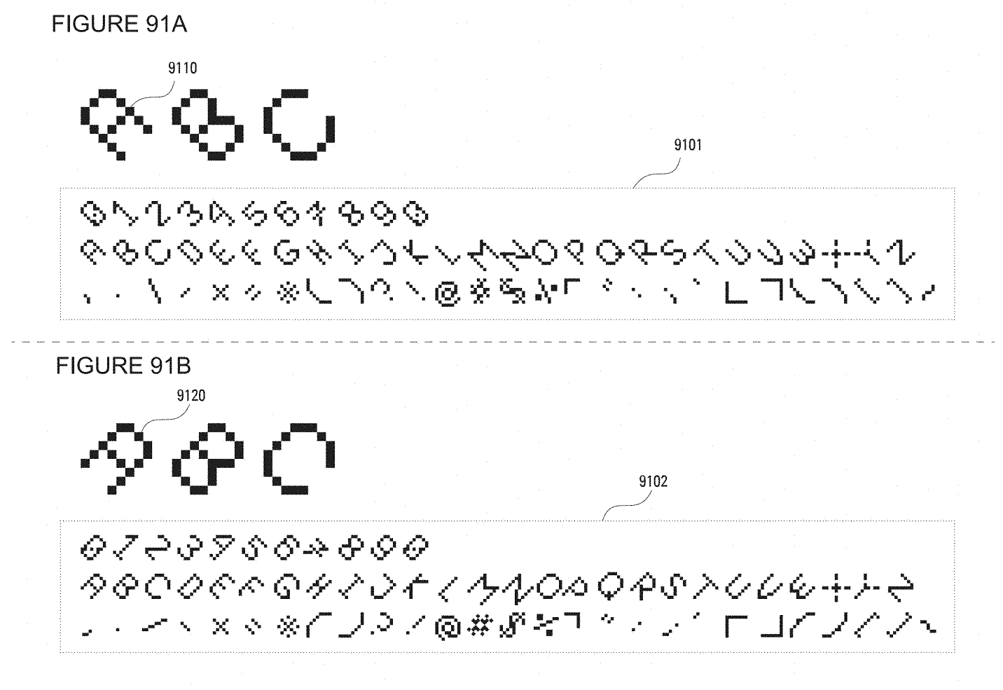

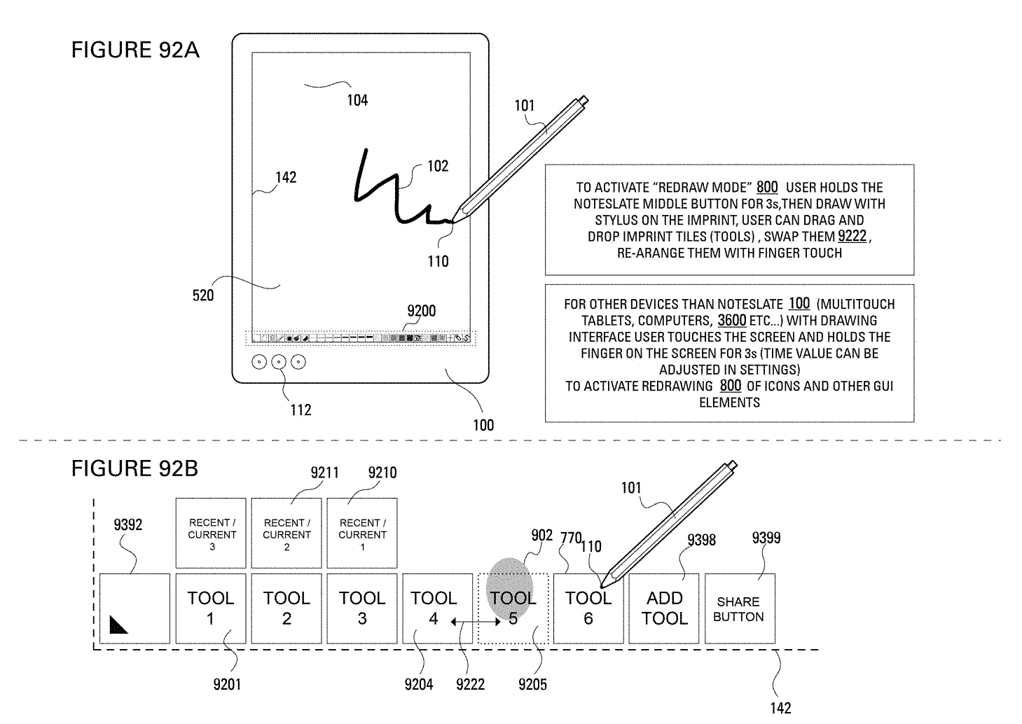

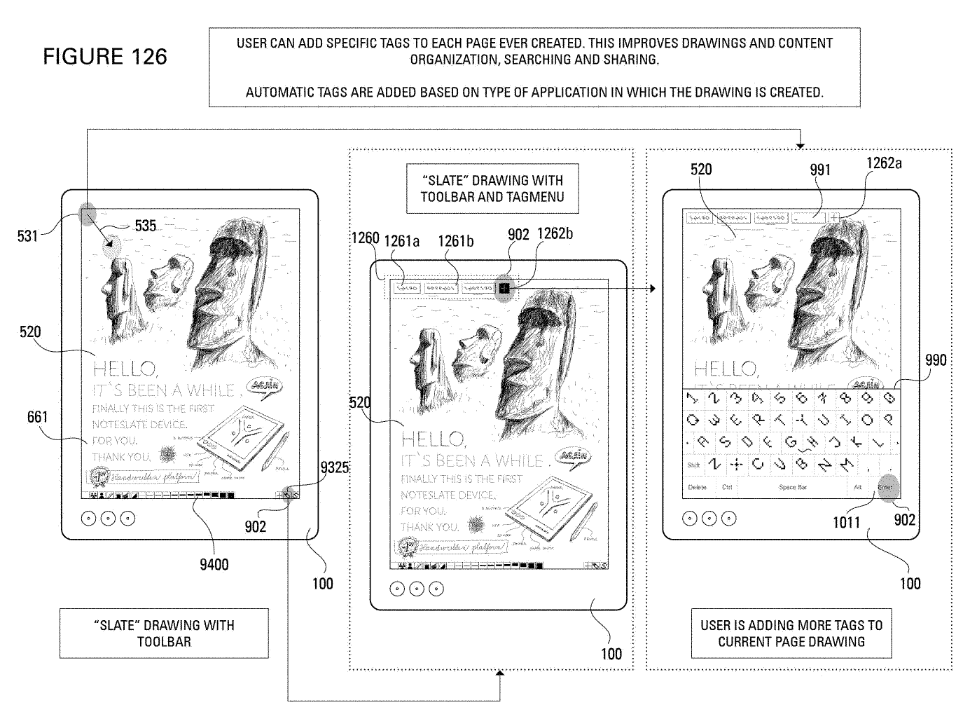

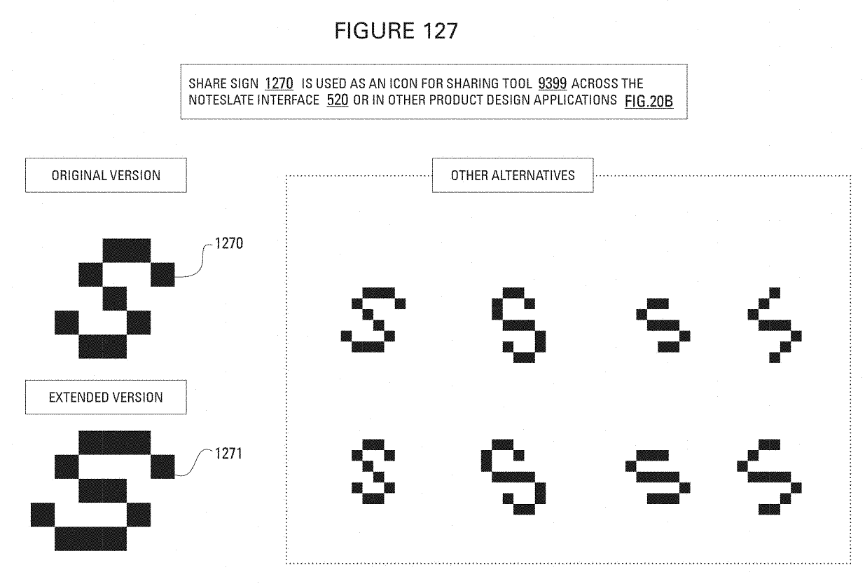

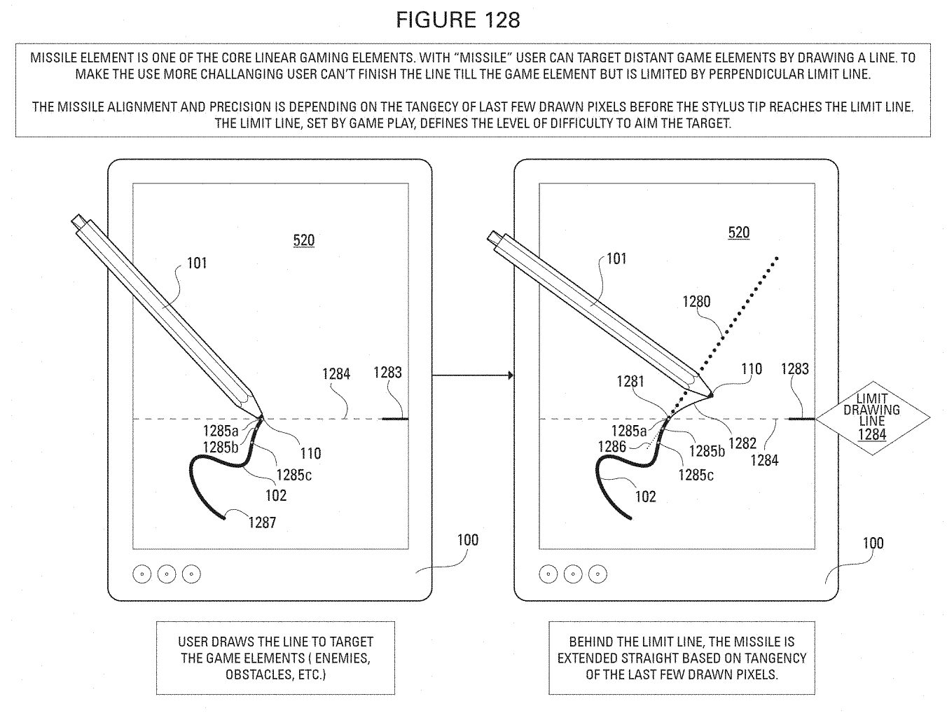

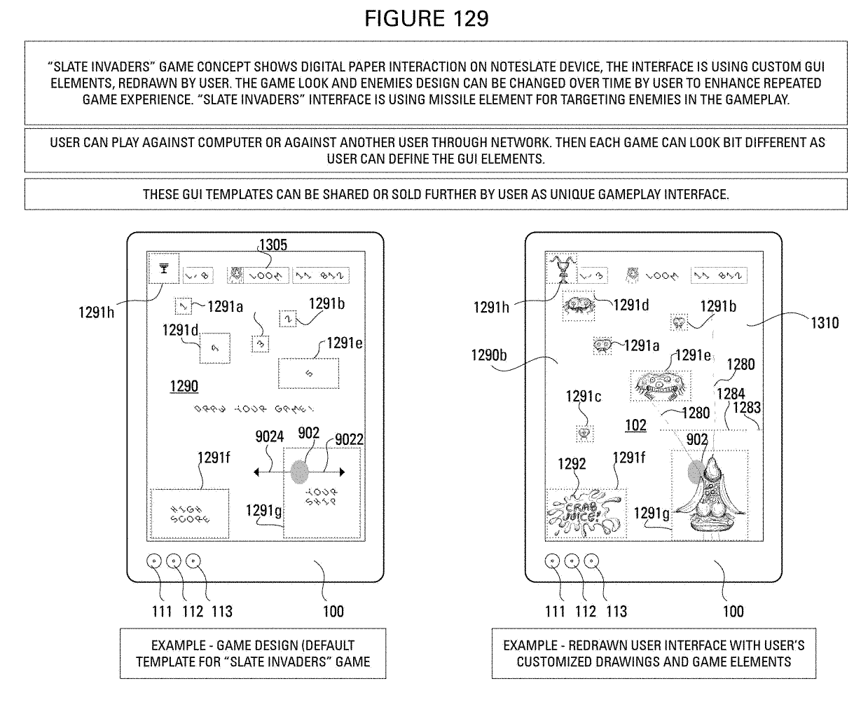

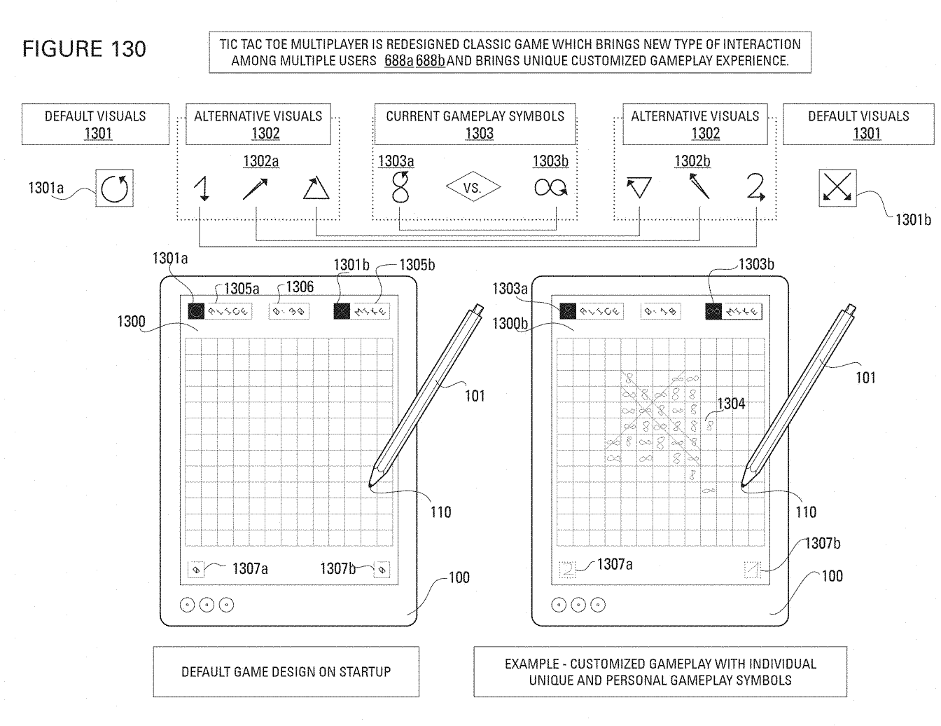

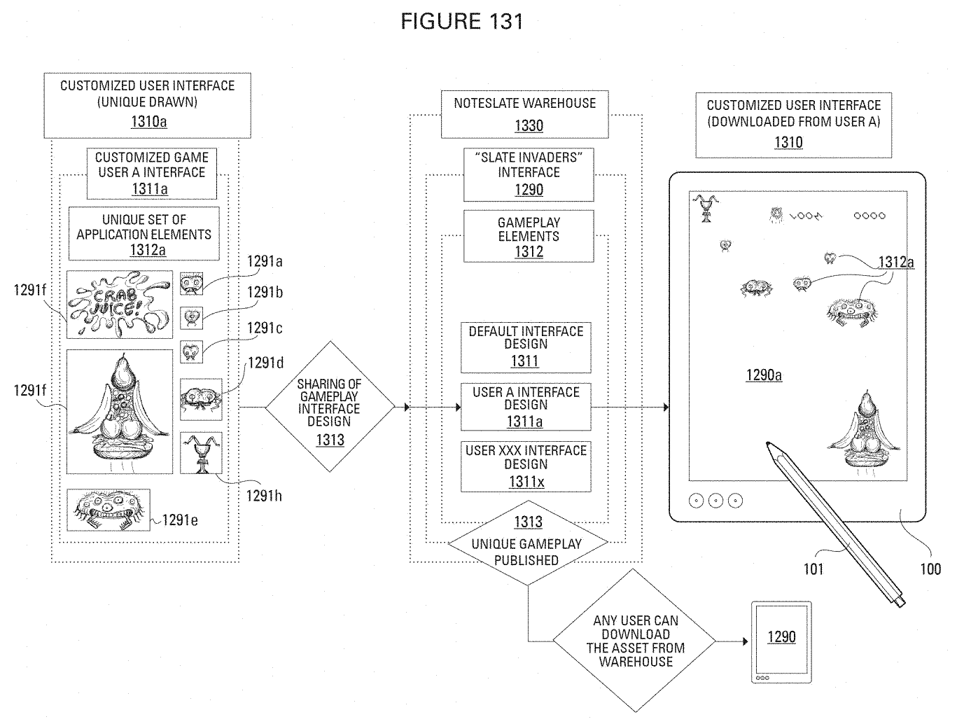

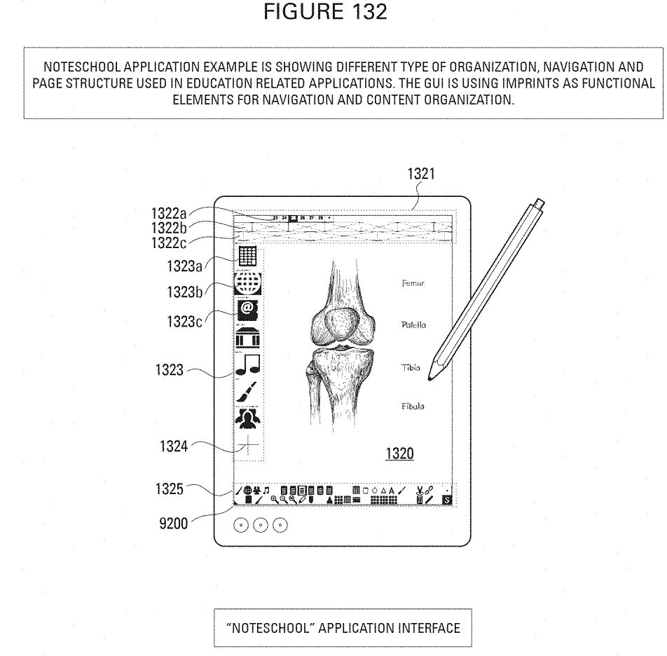

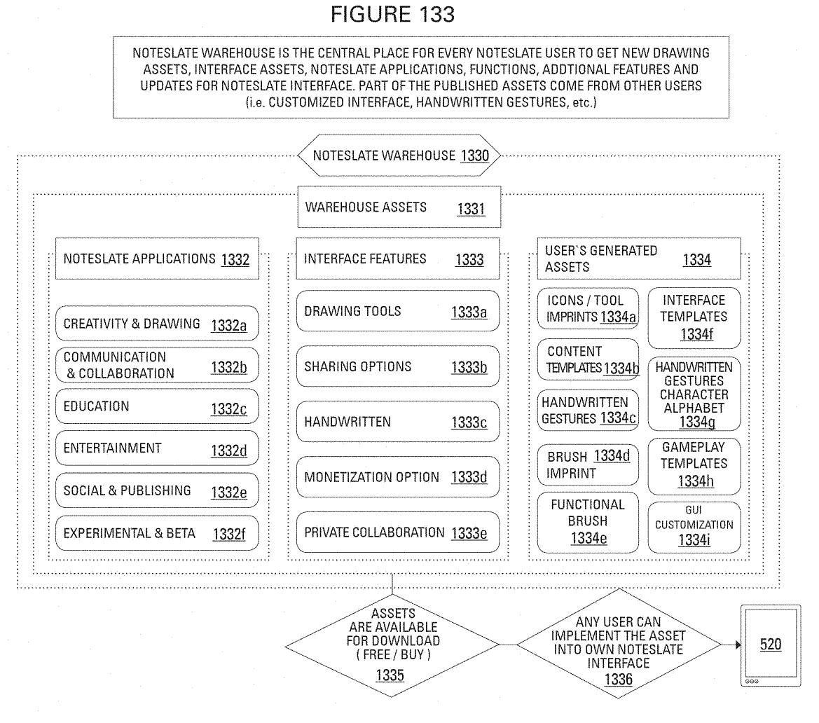

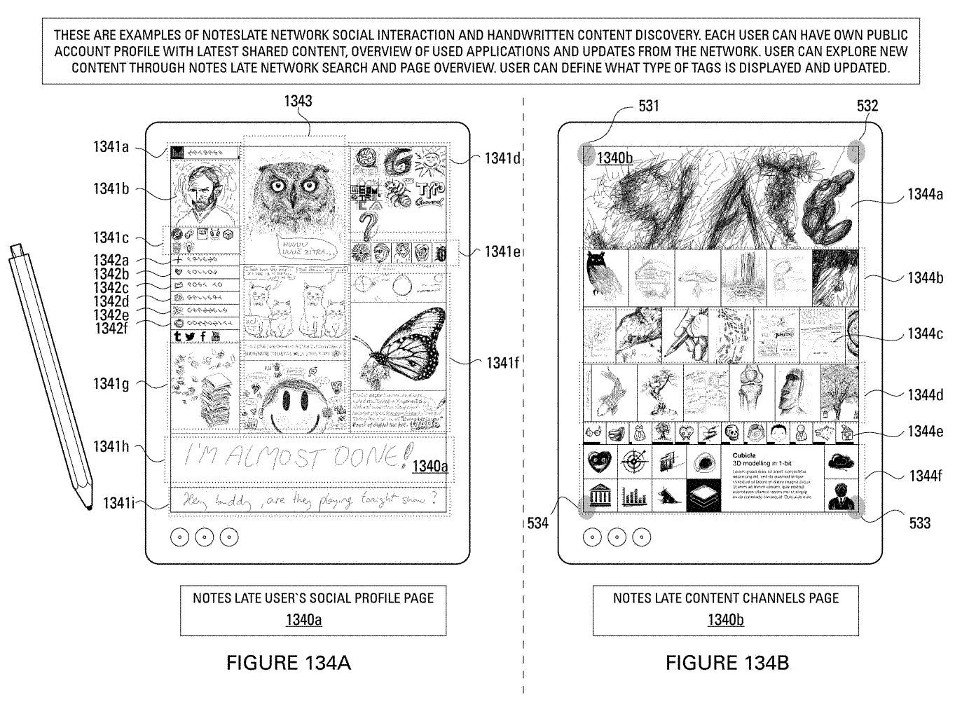

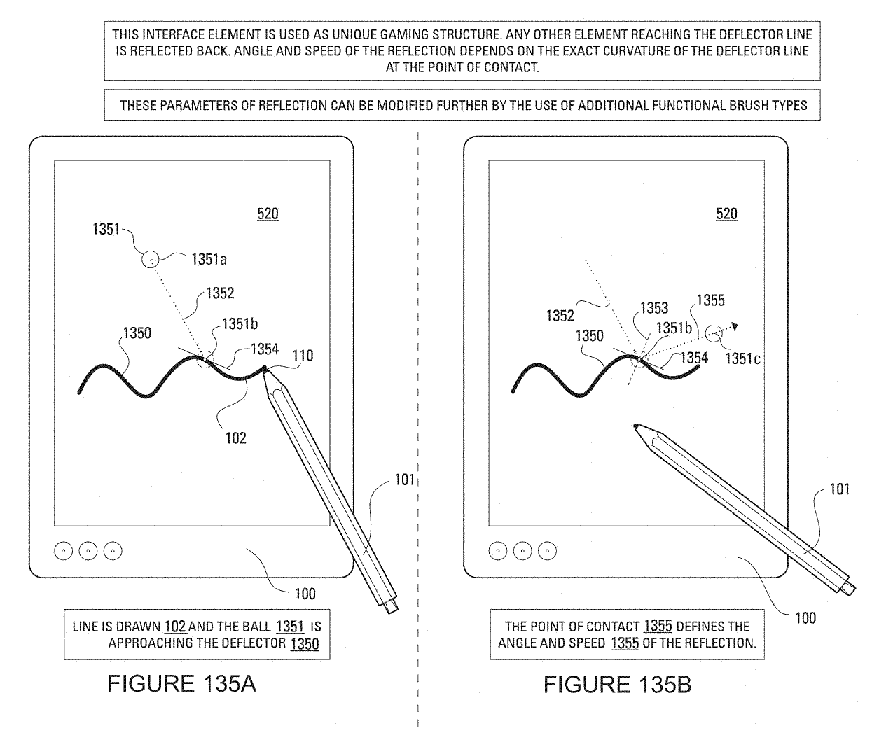

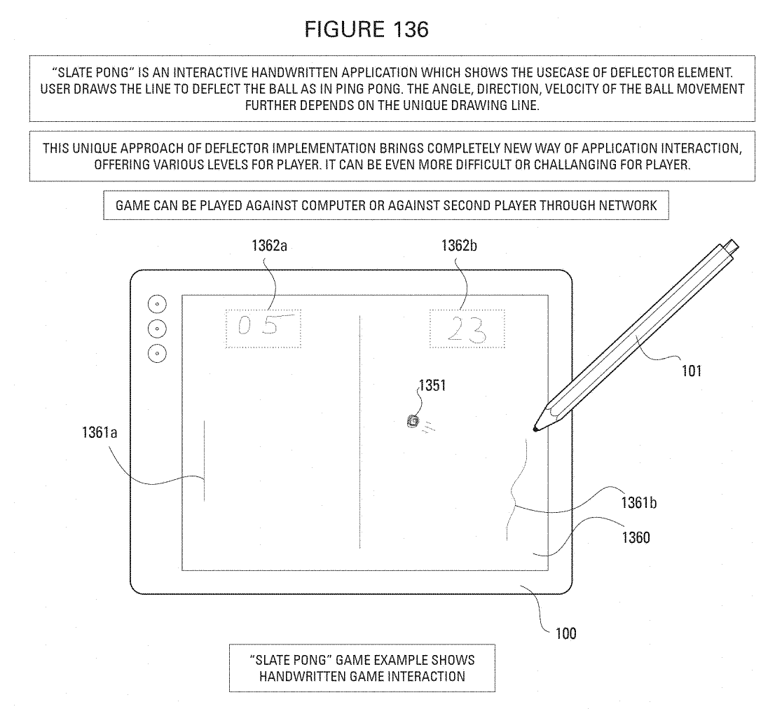

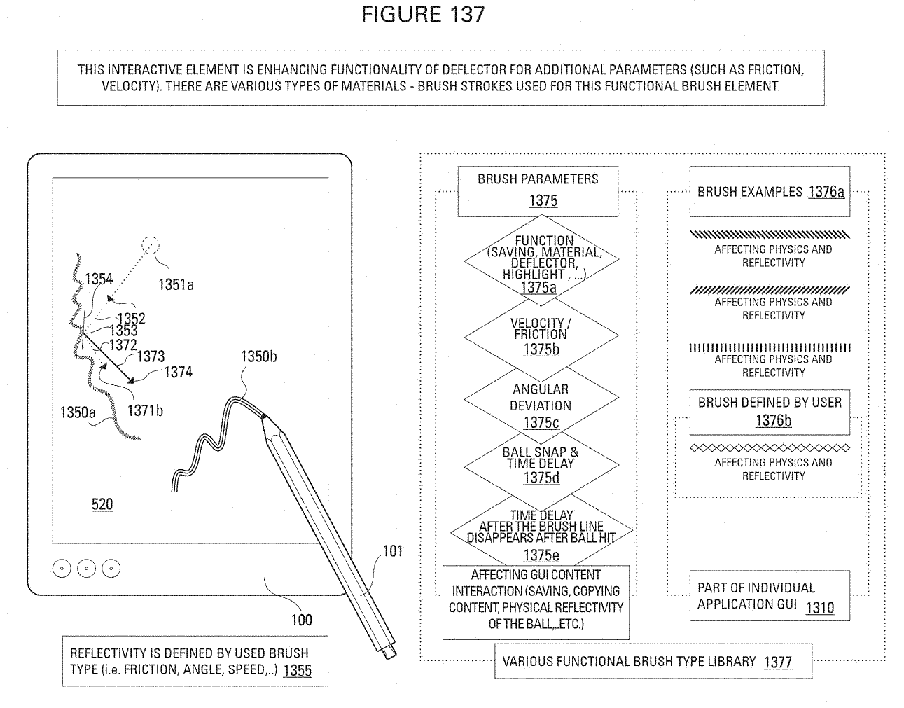

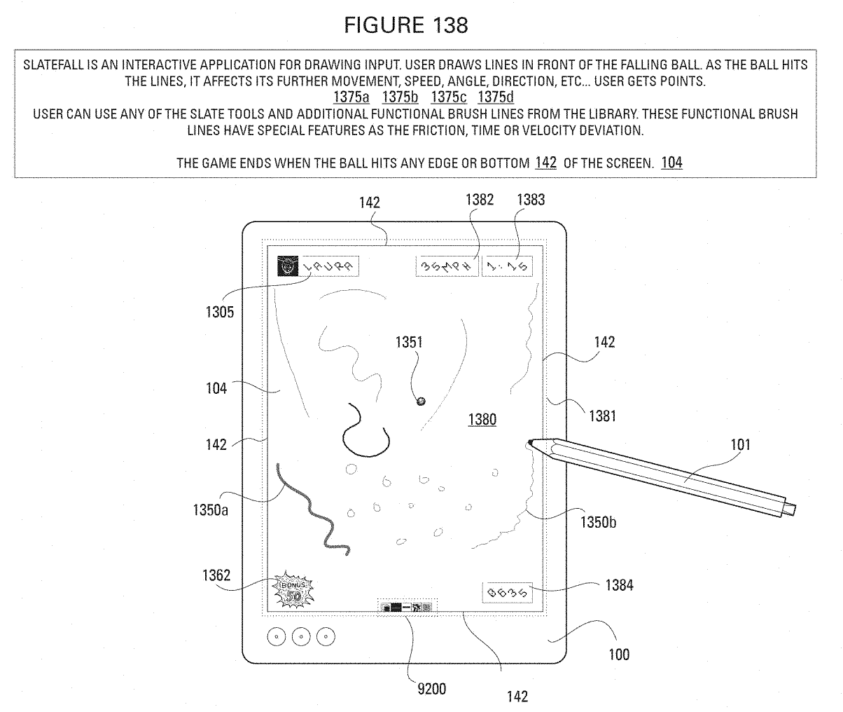

(e.g. adding tags to the page as seen on FIG. 126).
536b Finger touch navigates to next page across Noteslate content (user jumps between Noteslate pages, e.g. user can go to another application as seen on FIG. 55, FIG. 56).
536c Finger touch navigates to previous page across Noteslate content (e.g. user goes to previous page in Noteslate interface as example on FIG. 55, FIG. 56, e.g. user jumps to another chat session in chat application).
536d Finger touch uncovers/hides a drawing toolbar 9200.
541 Quick secondary finger touch “DOUBLE SWIPE” on the same place, which brings user to upper menu level (e.g. navigates to “PAGE TAG” search menu, “HOMEBAR”, etc.).
542 Quick secondary finger touch “DOUBLE SWIPE” on the same place, which brings user to upper menu level (e.g. jumps to next application, besides jumping to next page only).
543 Quick secondary finger touch “DOUBLE SWIPE” on the same place, which brings user to upper menu level (e.g. jumps to previous application, besides jumping to previous page only).
544 Quick secondary finger touch “DOUBLE SWIPE” on the same place, which brings user to upper menu level (e.g. opens up the “APPLICATION SETTINGS”, e.g. in “CONTENT” brings up general “DEVICE SETTINGS” menu).
545 Secondary finger swipe is also recognized for enhanced touch functionality.
546 “HOMEBAR” menu with overview of active applications; user can easily launch more apps 546c or terminate the currently running ones; additional overview of battery life and current Noteslate account using current interface.
546a Application icon (“IMPRINT”) of active application running on Noteslate device (recently active page with interactive handwritten content).
546b Redrawn application icon (customized “IMPRINT”).
546c Launch new application button opens up new page with running application.
547 “PAGE TAG SEARCH” menu allows searching anytime Noteslate content by tag input; similar to “PAGE TAG” menu for adding tags for current page.
548 example of “DOUBLE SWIPE” bringing “DEVICE SETTINGS” menu (e.g. depends on currently used interface, user is navigated to “DEVICE SETTINGS” menu from content, “APPLICATION SETTINGS” from current application.
549 Additional “HOMEBAR” information such as battery life, signal, storage used, etc.) brought by “DOUBLE SWIPE” in upper left corner; touch function is customizable in “DEVICE SETTINGS”.
550 Next application page based on Noteslate “CONTENT” pages order.
551 Current application page based on Noteslate “CONTENT” pages order.
552 Previous application page based on Noteslate content order.
570 Noteslate “Slate” application page with basic interface.
571 Adding page tags and current tags overview by touch 536a.
572 Uncover “Slate” drawing toolbar 9200 via touch 534.
580 Noteslate “Chat” application page with basic interface.
581 Adding people to chat session and overview of opened chat sessions via touch 536a.
582 Uncover “Chat” drawing toolbar 9200 by touch 534.
590 Noteslate “Reader” application page with basic interface.
591 Adding tags to document page and overview of used tags via touch 536a.
592 Uncover “Reader” drawing toolbar 9200 by touch 534.
600 The first page of Noteslate “CONTENT” 690.
601 Next page of Noteslate “CONTENT” 690.
610 Default page view of Noteslate “CONTENT” 690 with all page thumbnails.
611 Selected page view of Noteslate “CONTENT” 690 with selected page thumbnails based on timeline 614 selection.
612 Selected page view of Noteslate “CONTENT” 690 with selected page thumbnails based on selected page tags menu 613 selection.
613 Adding “PAGE TAG” menu.
614 Content timeline showing actual time/date range selection
620 Content interface 690 showing selection of pages by date.
621 Select pages based on selected year.
622 Select pages based on month range.
623 Select pages based on selected date.
624 “TIMELINE” single bar (year or month or day or hour).
625 “TIMELINE” markup showing page created at specific time.
626 “TIMELINE” single bar border.
630 “CONTENT” interface 690 showing current pages selection by date.
631 “CONTENT” interface 690 showing selected pages by date (months).
632 “CONTENT” interface 690 showing selected pages by date (days).
633 “CONTENT” interface 690 showing selected pages by date (hours).
640 Single “FULLPAGE” Noteslate page format using whole resolution of 528a per 528b pixels.
641 “SLICE” Noteslate page format, using variable pixel height 6461 based on user's interaction, user defines the cutting line 6481.
642 “SHORTNOTE” page format, the height 6462 is fixed number of pixels (e.g. 300px for Shortnote app), user defines each side slice 6483 and overall image length for sharing, from one “FULLPAGE” Shortnote format 642 user can create custom formats for sharing 643 644 645.
643 Sliced “SHORTNOTE” format.
644 Sliced “SHORTNOTE” format.
645 Sliced “SHORTNOTE” format.
647 Full pixel height of current interface.
649 Horizontal divider for assorted “SHORTNOTE” pages.
650 “PAGE ROLL” Noteslate page format, with variable length 528a extended 650a and with fixed page width 528b, user cuts the end of the page 650b wherever is needed, even out of the basic interface format 104, (e.g. infinite page roll without any cut is used in chat application).
650a Extended page area beyond the basic page format 104.
650b Cut off the page roll to finish the format for sharing and other purpose.
651 “NOTERON” page format is describing extended page area in all directions, pages 6511 6512 6513 6514 are related and connected to basic drawing interface 651, the page smoothly extends to outer area of the display area 104.
652 Basic “NOTERON” is interconnection of 9 “FULLPAGE” pages tile grid.
661 Example of “SLATE” interface using “FULLPAGE” page format.
662 Example of “Slog” interface using “slice” page format.
663 Example of “Shortnote” interface using “SHORTNOTE” page format.
671 Example of “Chat” interface using “page roll” page format.
672 Example of “Noteron” interface using “NOTERON” page format.
680a Interactive chat interface of user A.
680b Interactive chat interface of user B.
682 Handwritten content 682a 682b merged into one content.
682a Handwritten content drawn by user A.
682b Handwritten content drawn by user A.
683a Customized “CHAT” interface of user A.
683b Customized “CHAT” interface of user B.
684a Customized “CHAT” drawing toolbar element of user A.
684b Customized “CHAT” drawing toolbar element of user B.
685a Current opened “CHAT” sessions of user A.
685b Current opened “CHAT” sessions of user B.
688a User A (networked).
688b User B (networked).
688c User C (networked).
690 Noteslate “CONTENT”—this interface shows the whole content, pages, pages thumbnails, application, application pages, and other data on current Noteslate device, it's the core overview of Noteslate content, applications, pages and drawings.
691 Vertical Noteslate “CONTENT” grid divider.
692 Horizontal Noteslate content grid divider.
695 Functional link of specific imprint, page thumbnail or icon.
700 Area of page thumbnail imprint, each page has own thumbnail in Noteslate content defined by settings of content grid size 691 692.
701 Current application page with GUI elements.
707 “CUTOUT”—cutout of application page 701 used for page thumbnail.
717 “MINIATURE”—resized image of application page 701 used for page thumbnail.
722 The application page resized thumbnail (“MINIATURE” 717).
724 Various types of application page thumbnails based on thumbnail design and updating type (miniature, cutout, live, etc.), these live thumbnails can be used for user interaction engagement and drawing potential content sharing monetization, these default designs can be edited and customized with redrawing mode 800.
727a Generic application page thumbnail, updates only when application or page is opened.
727b Interactive page thumbnail can be updated from other user over network 1510 (e.g. chat session).
727c Networked 1510 live page thumbnail is continuously updated over network 1510 1501 1502.
727d Real time updated thumbnail creates live mini page drawing on the home screen—Noteslate content 690 updated in real time over network 1510 1501 1502.
731 Application interface example (“SLATE”).
732 Application interface example (“Chat”).
735 Application content thumbnail example—“CUTOUT” (“SLATE”).
736 Application content thumbnail example—“MINIATURE” (“CHAT”).
740a Default right handed Noteslate interface layout and settings.
740b Default left handed Noteslate interface layout and settings.
741a The right handed interface axis all the interface elements are tilted by.
741b The left handed interface axis all the interface elements are tilted by.
750a Specific right handed interface layout and settings (“Europe”).
750b Specific right handed interface layout and settings (“Japan”).
750c Specific right handed interface layout and settings (“EMEA”).
750d Specific left handed interface layout and settings (“Europe”).
750e Specific left handed interface layout and settings (“Japan”).
750f Specific left handed interface layout and settings (“EMEA”).
760a Specific right handed interface layout and settings (“EMEA horizontal”).
760b Specific right handed interface layout and settings (“Vertical”).
760c Specific right handed interface layout and settings (“Diagonal”).
760d Specific left handed interface layout and settings (“EMEA hor”).
760e Specific left handed interface layout and settings (“Vertical”).
760f Specific left handed interface layout and settings (“Diagonal”).
770 “IMPRINT” border and default outline.
771 The “IMPRINT” outline spacer indicating the interface orientation.
772 Default design of “IMPRINT” label.
773 The active imprint redrawing area and functional link area.
777 The edited customized redrawn “IMPRINT” drawing is without any “IMPRINT” borders.
800 Imprint redrawing mode 800 is a Noteslate handwritten interface 520 core feature which allows the user to edit and redraw anytime any imprint 770 available on current screen, (page thumbnails, brushes, GUI elements, etc.) and still keep the same functionality of the edited interface, to redraw and customize the interface user pushes middle Noteslate button 112 and holds it for 3s, any imprint visible on current screen is available for redrawing, user can redraw anytime any part of the interface, this process and unique feature is the core of Noteslate handwritten interface 520 customization and personalization, customized user interface is an interface 520 which is redrawn by user via redrawing mode 800, the user modifies all current available interface imprints 773 and draws new own design 777, this redrawn interface design is saved, used and displayed across the whole interface. In a preferred embodiment, the user can redraw specific interface elements to achieve a completely unique look of the Noteslate handwritten interface 520.

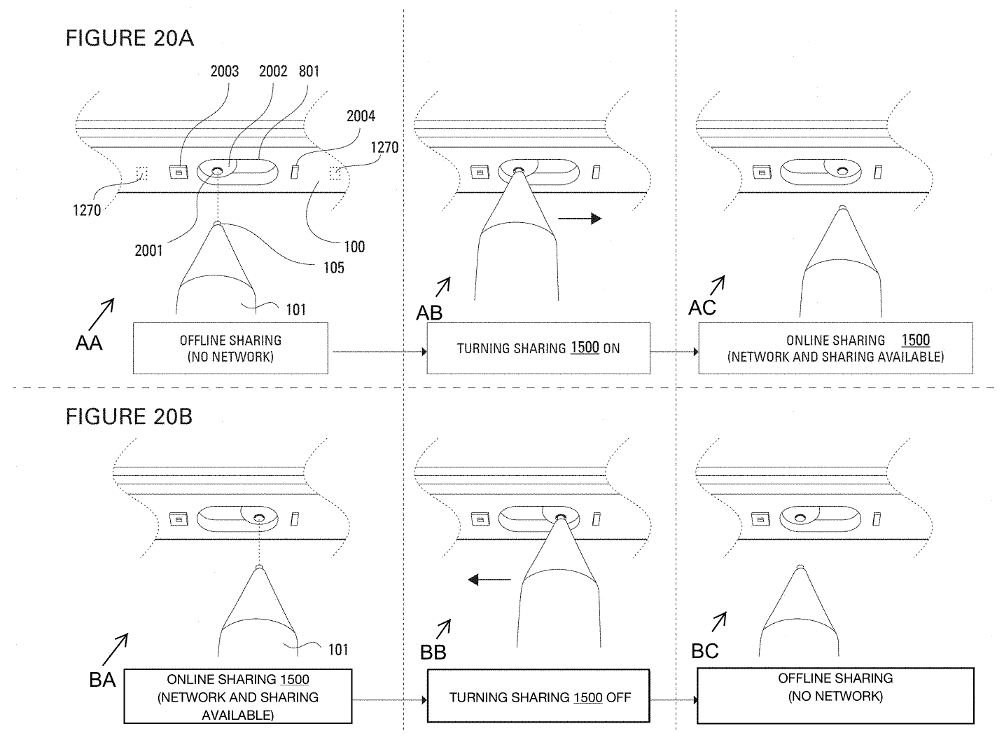

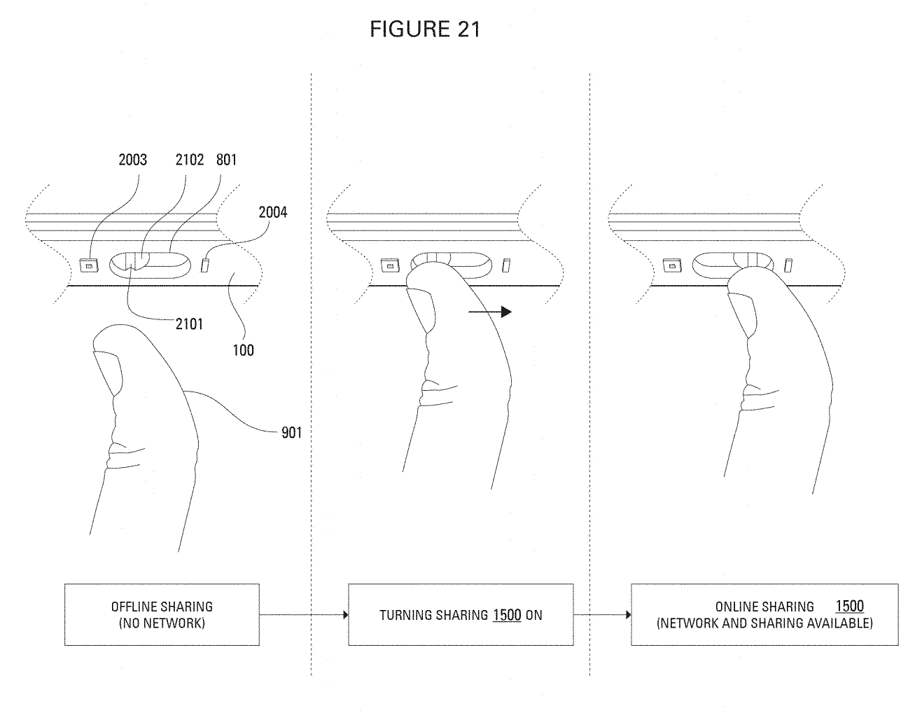

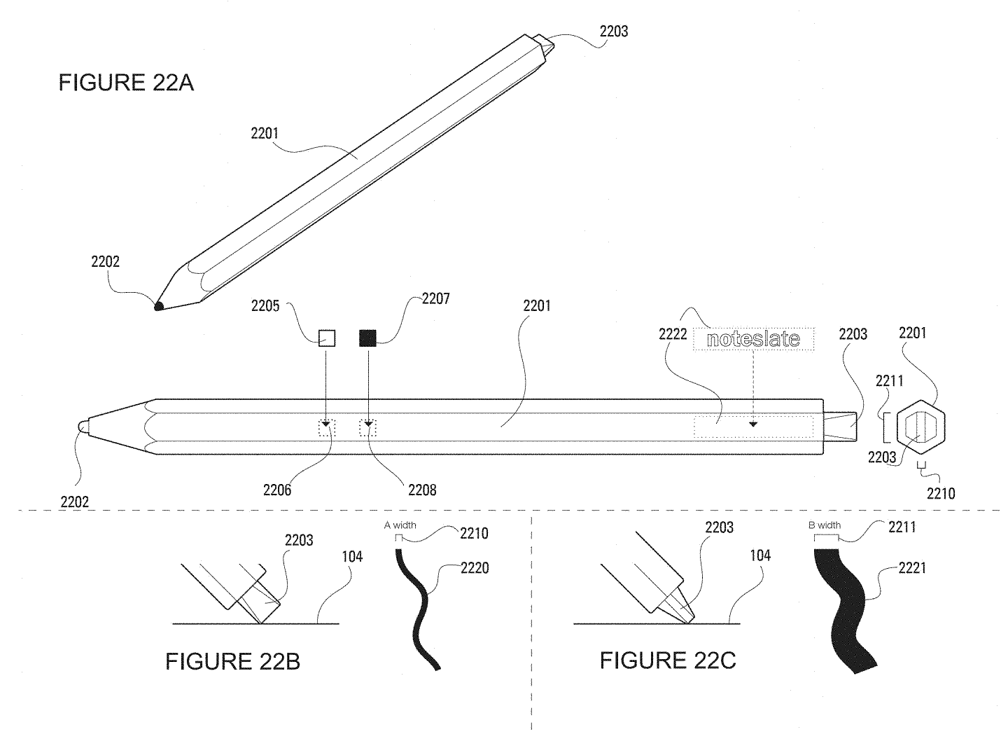

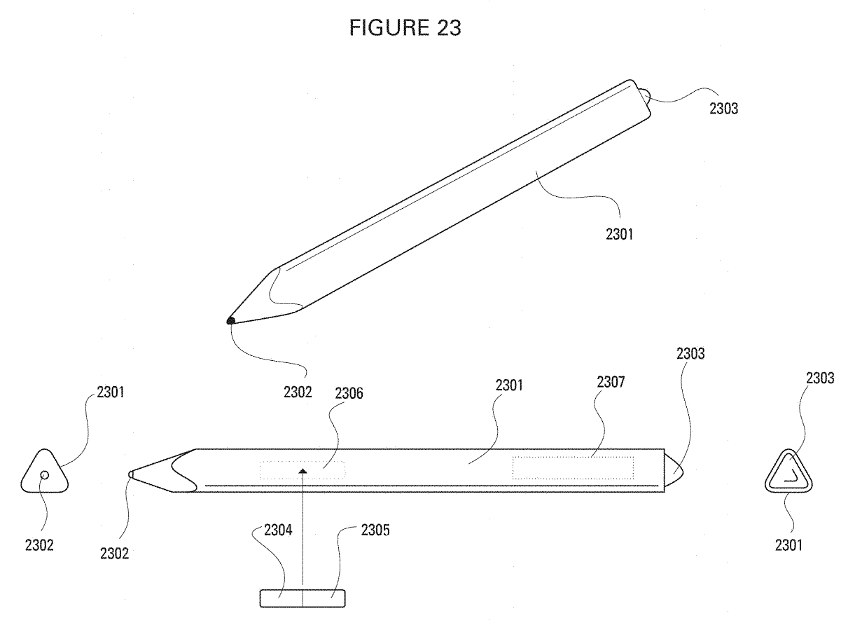

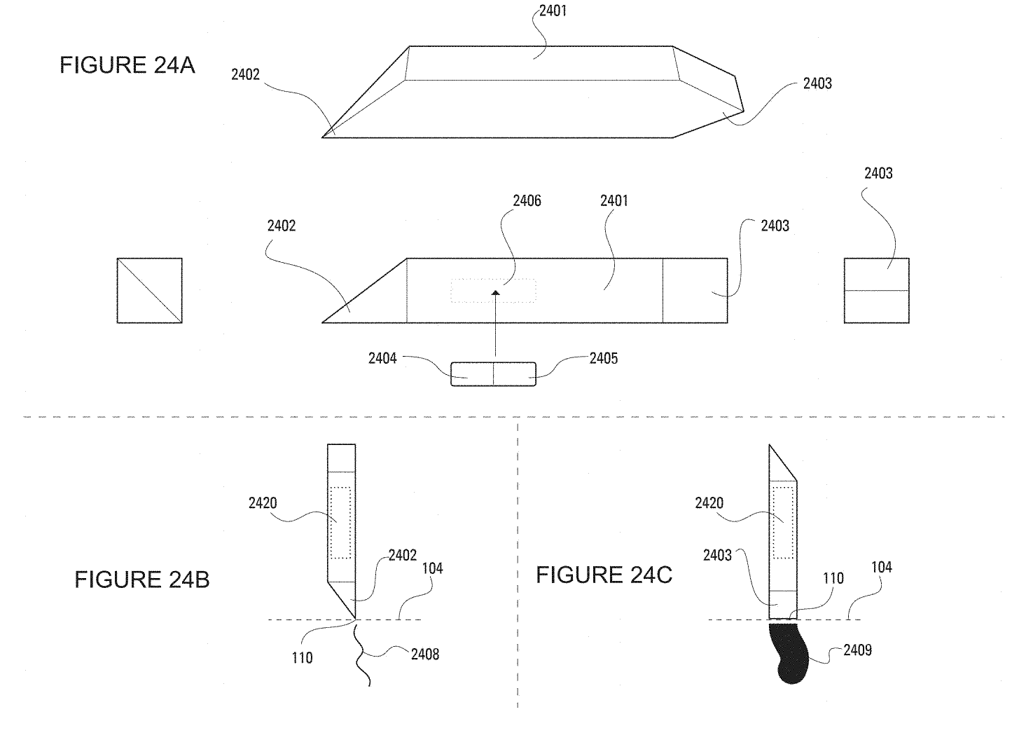

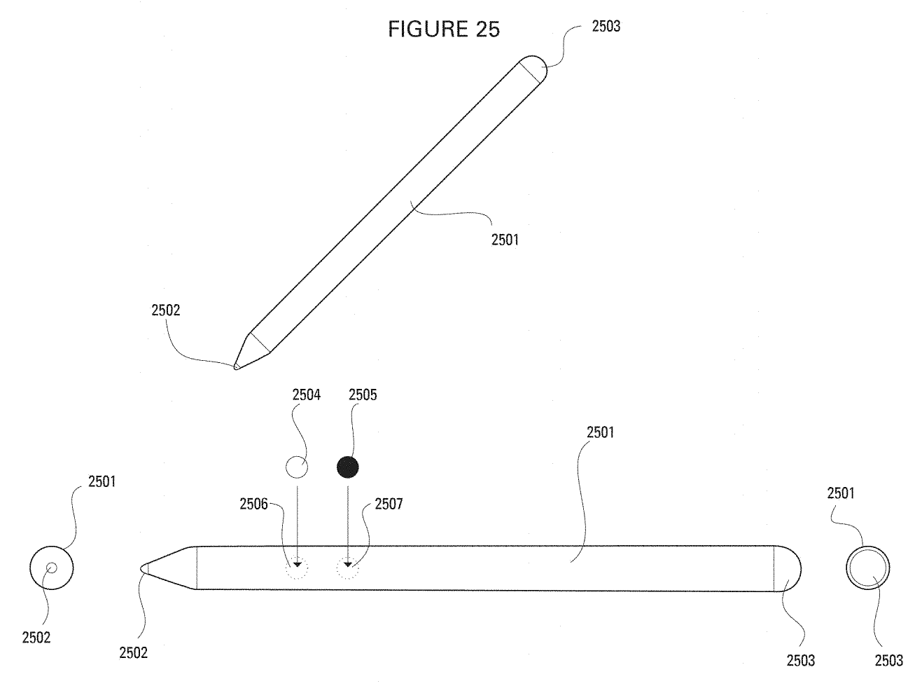

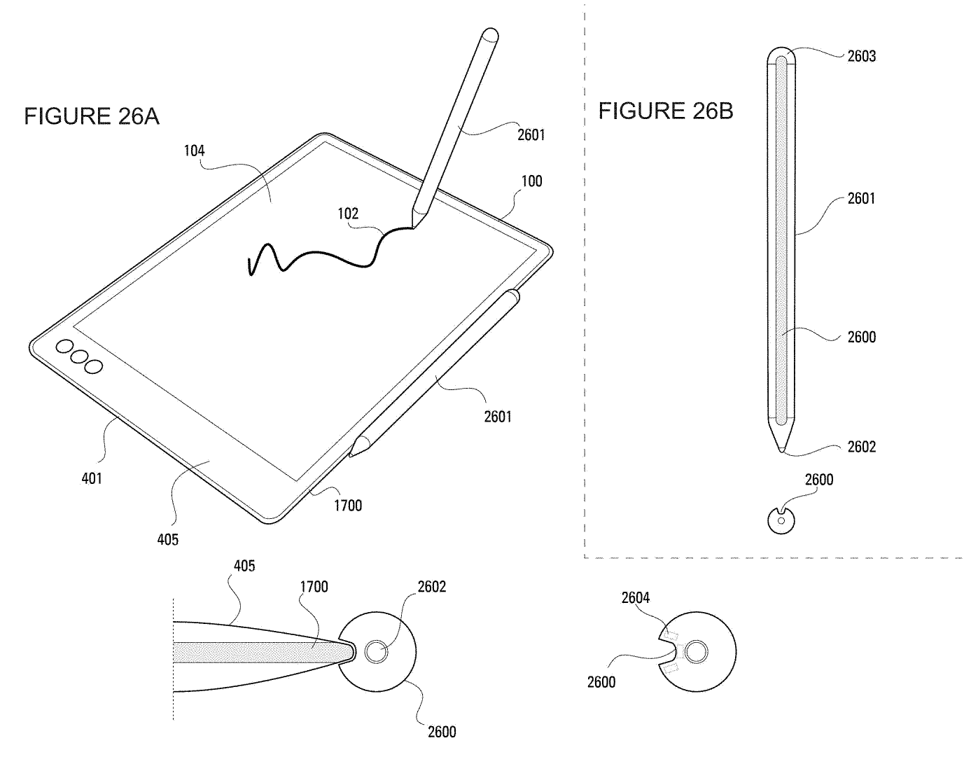

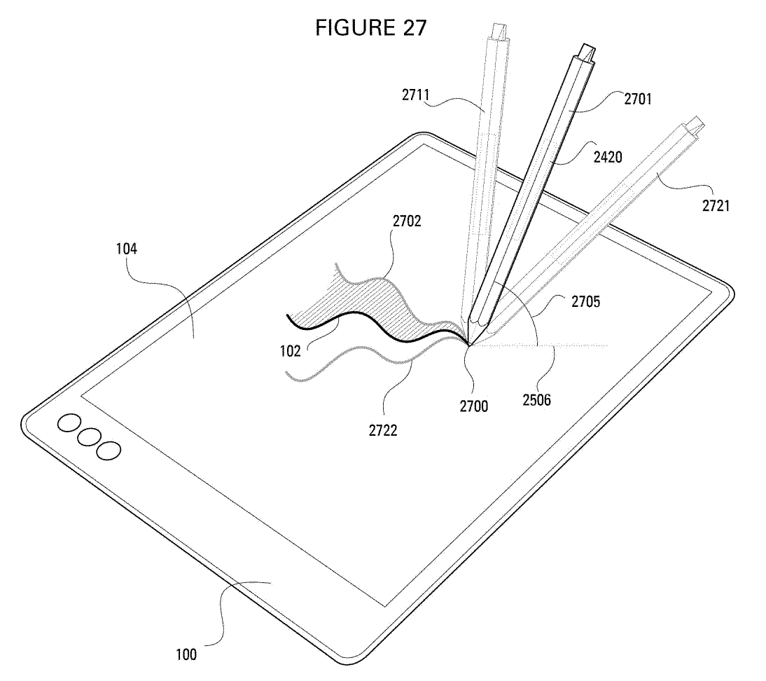

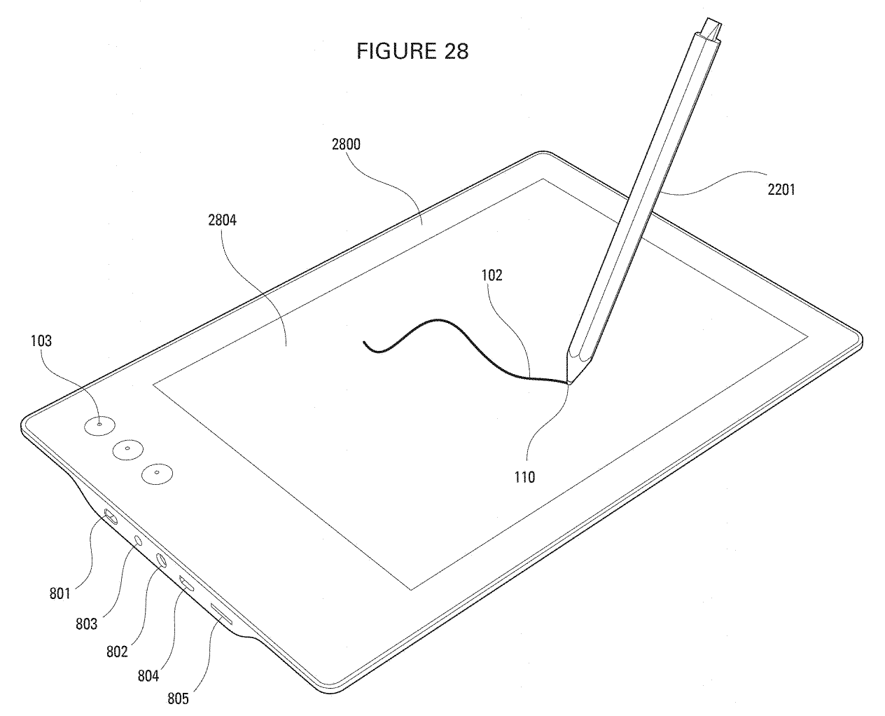

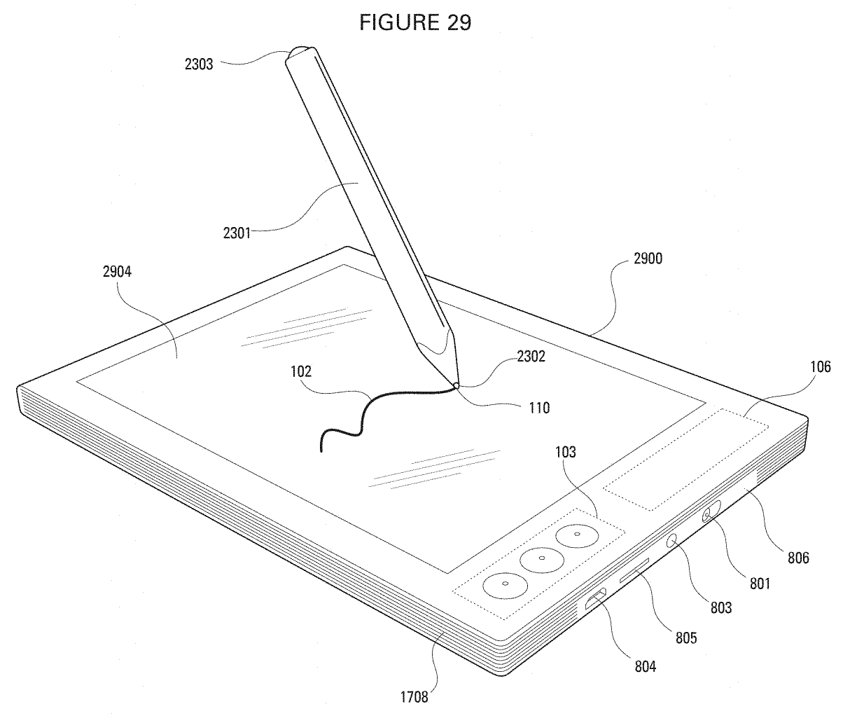

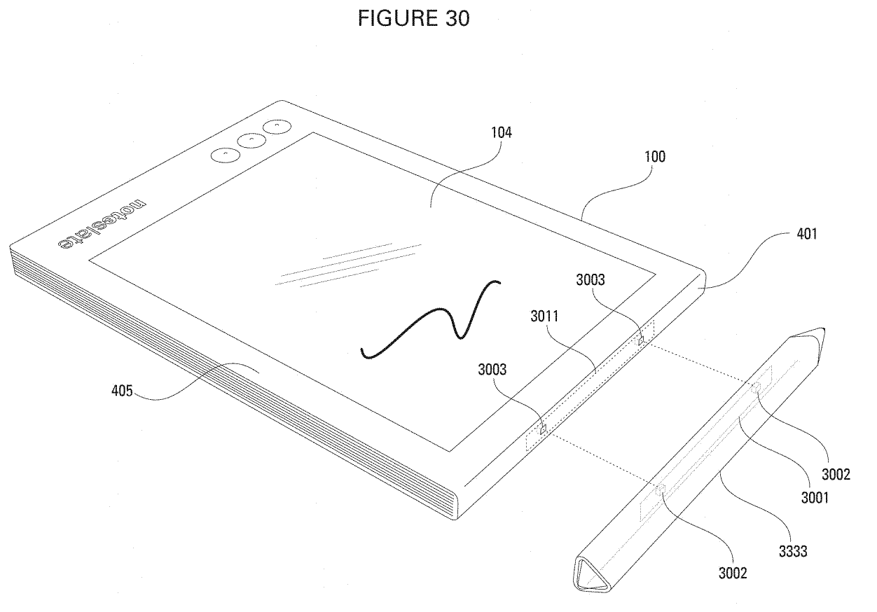

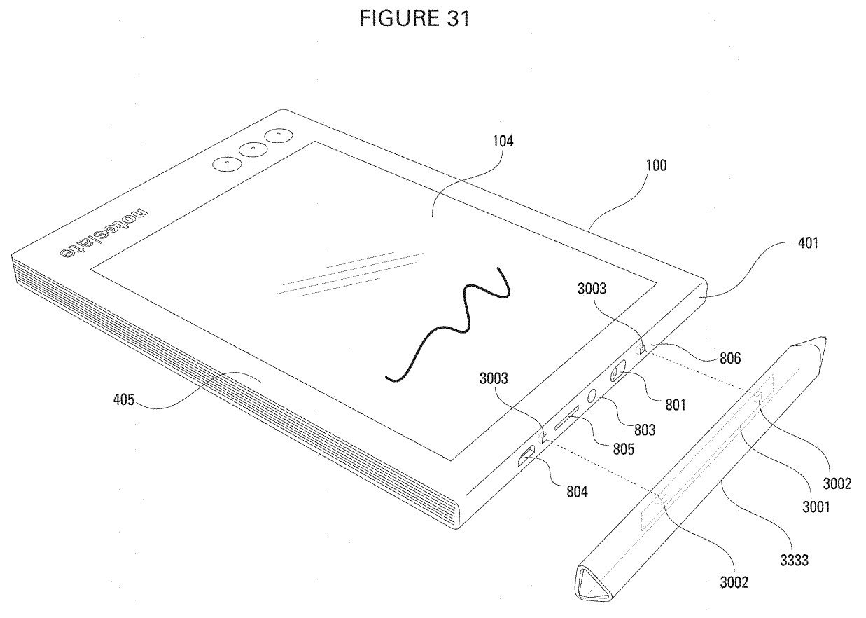

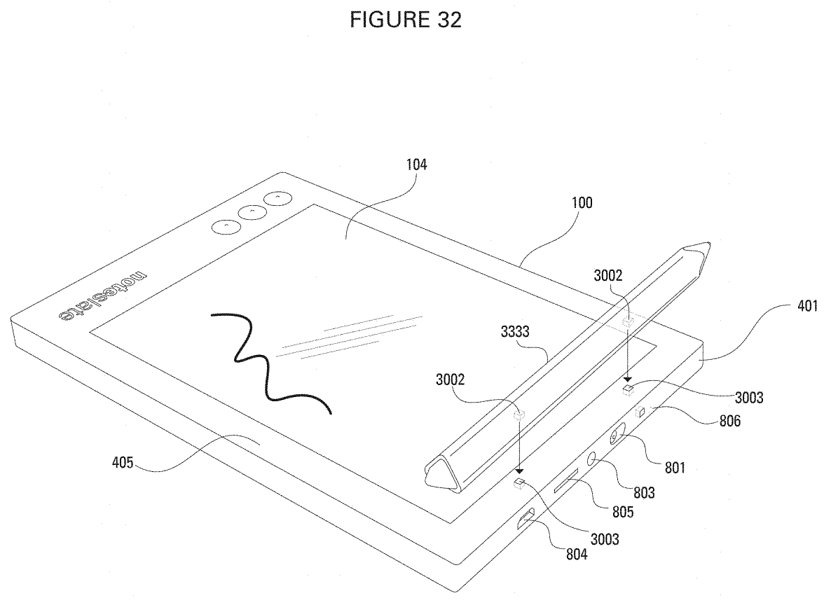

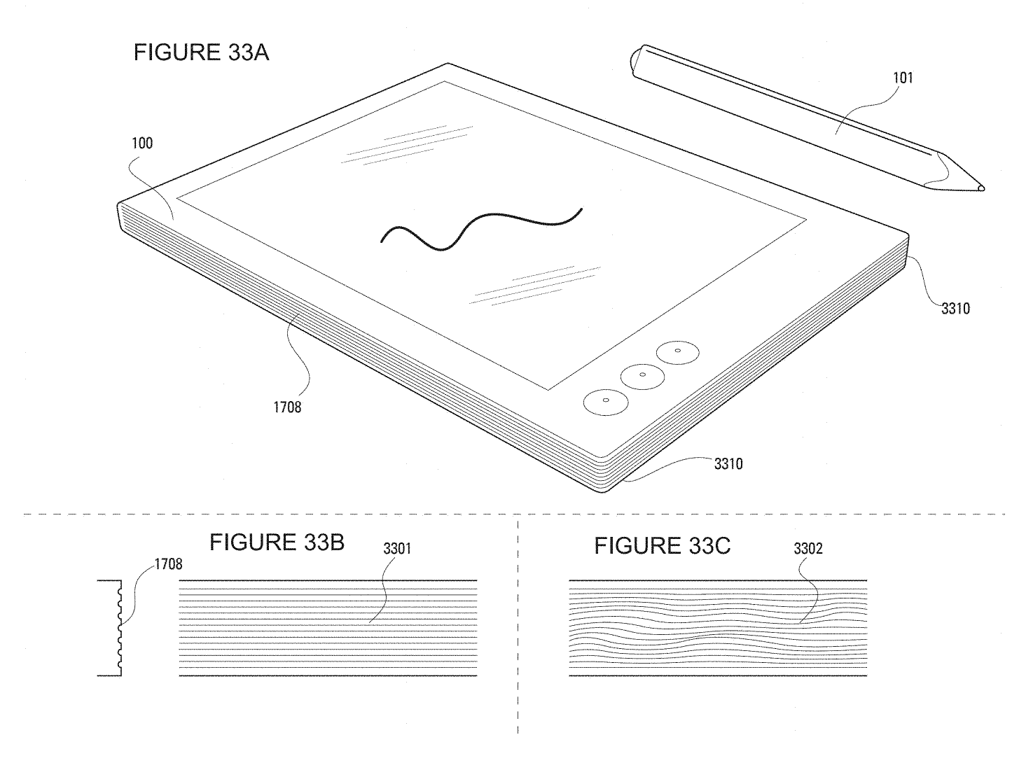

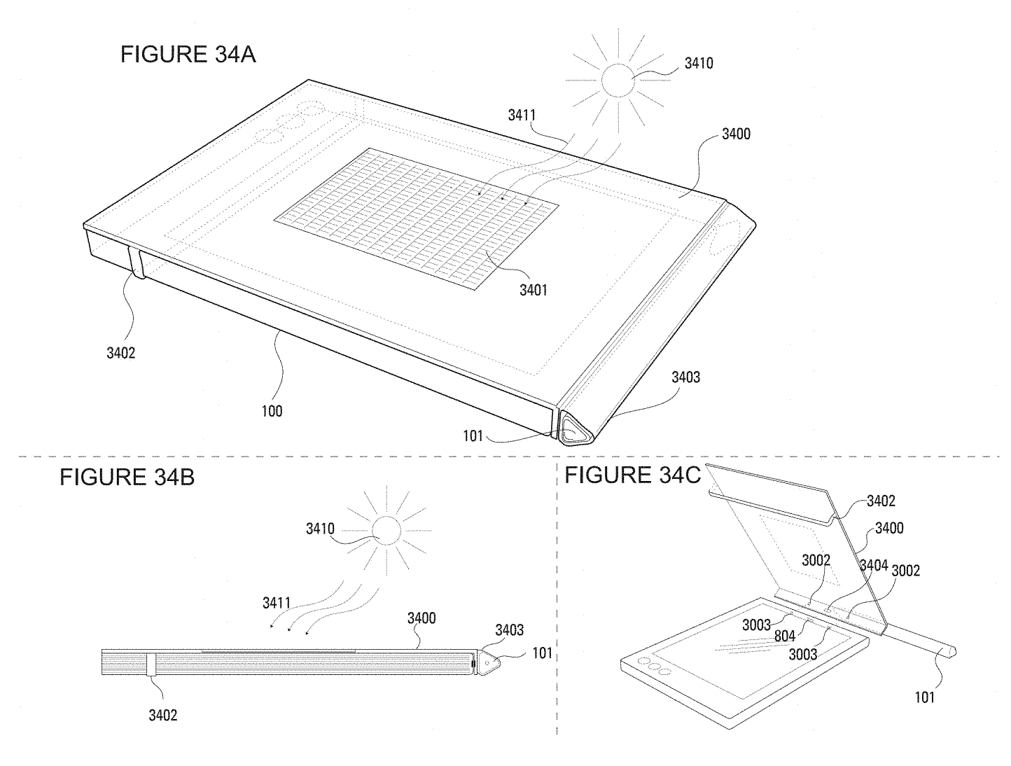

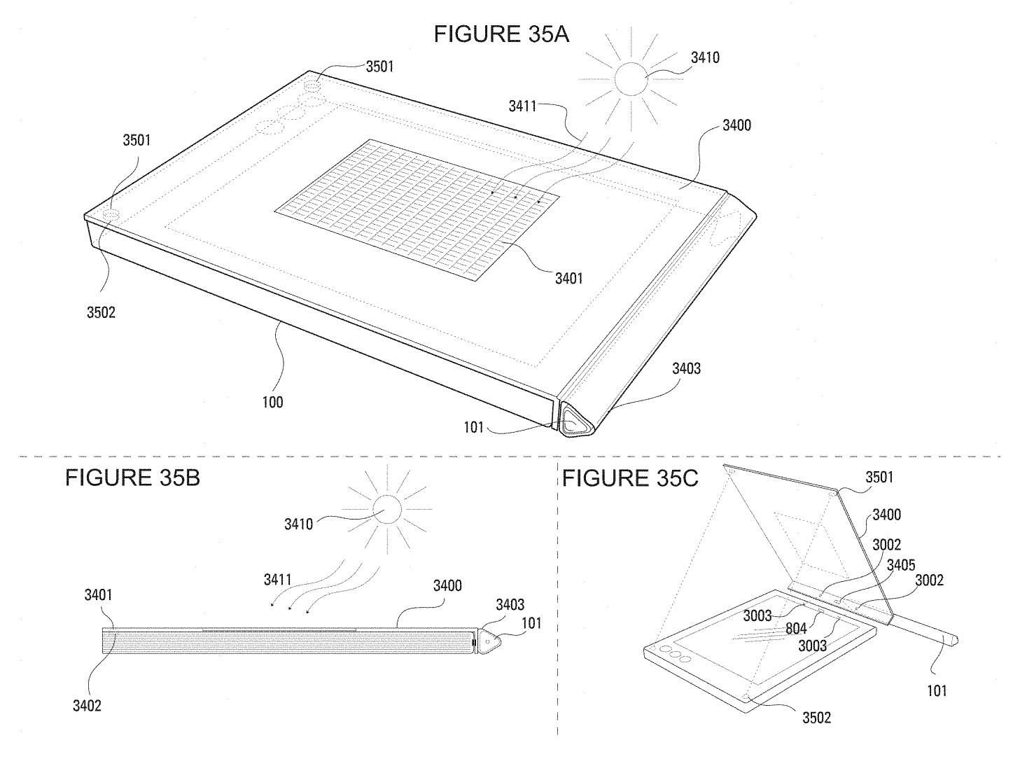

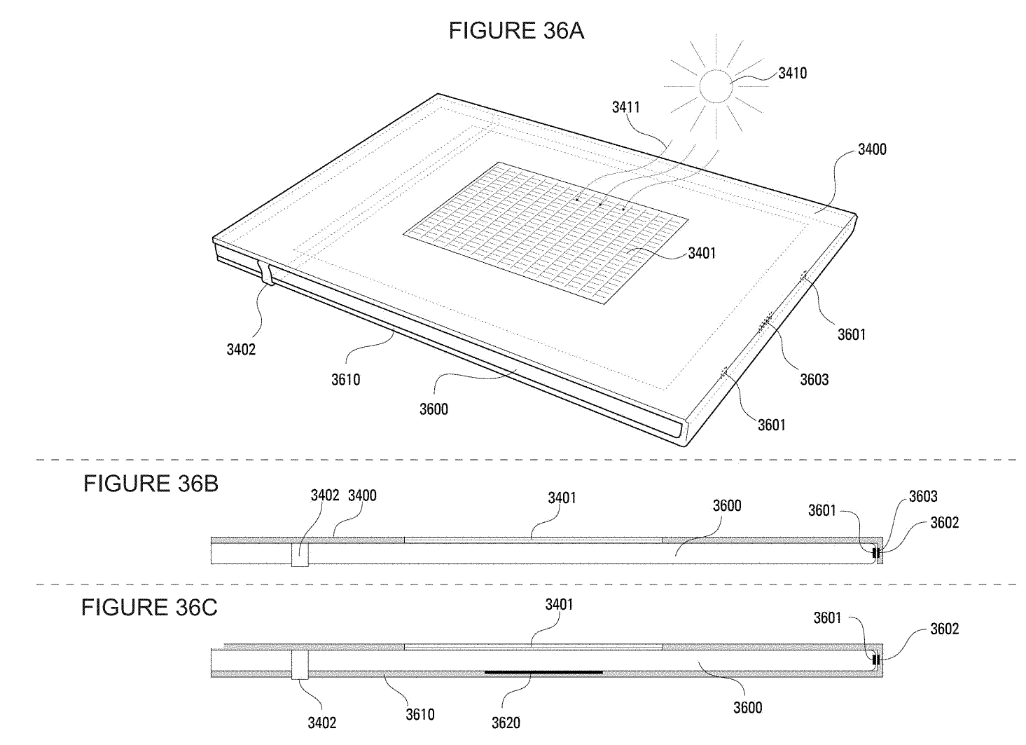

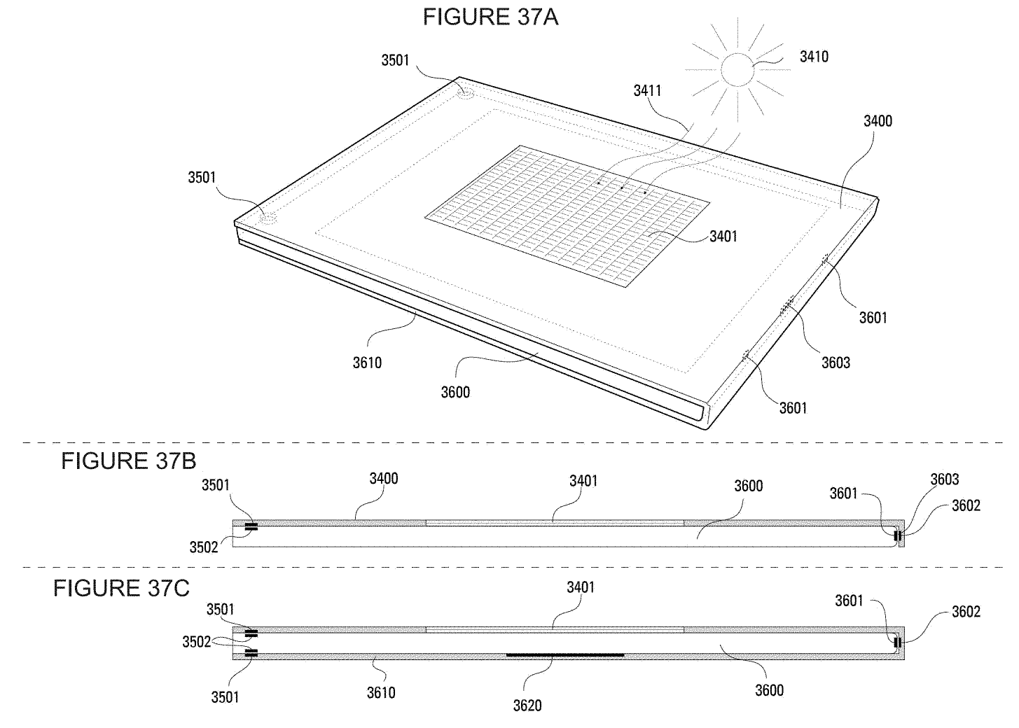

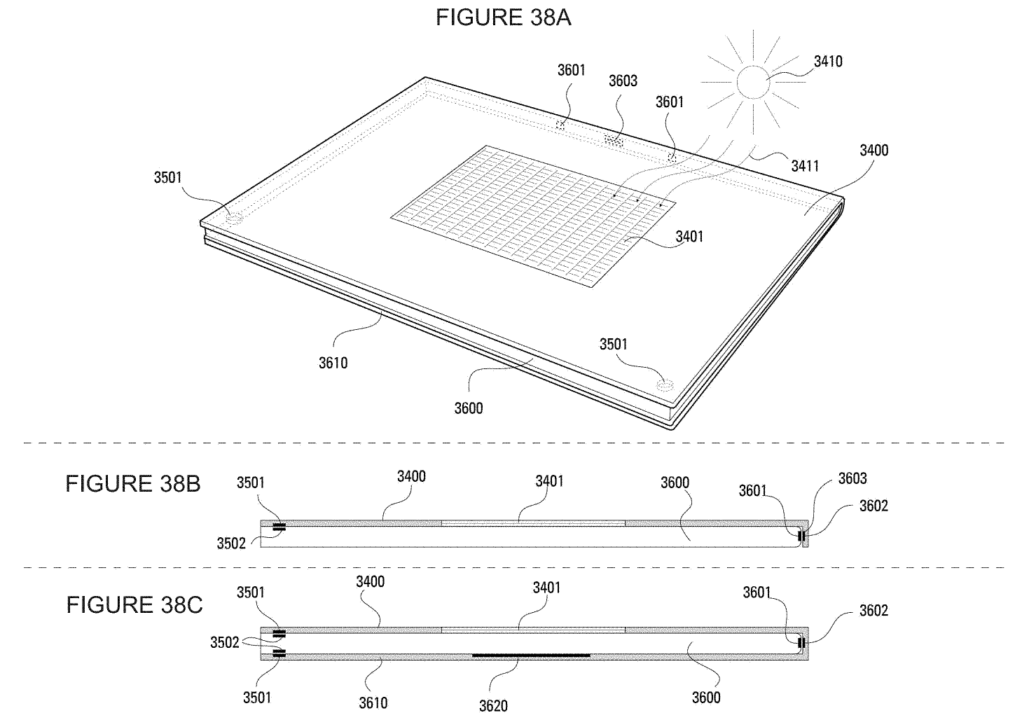

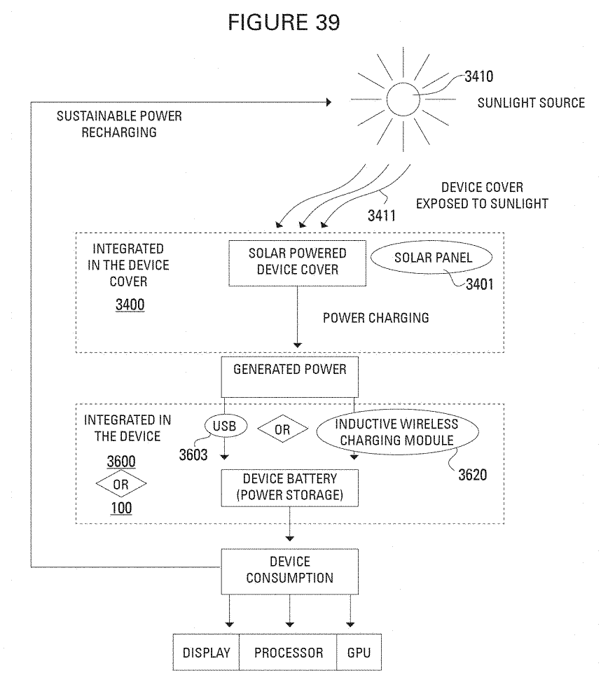

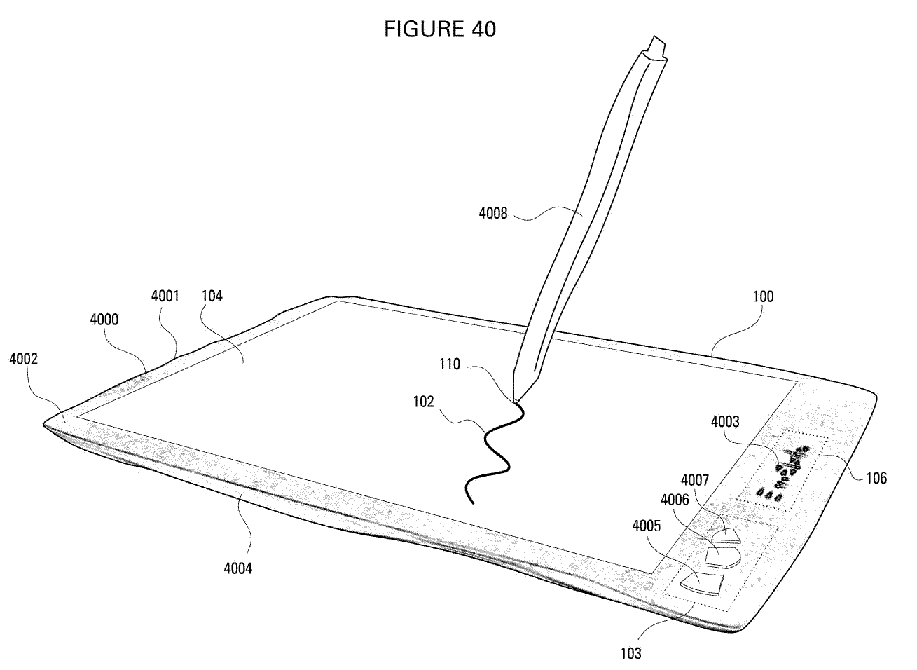

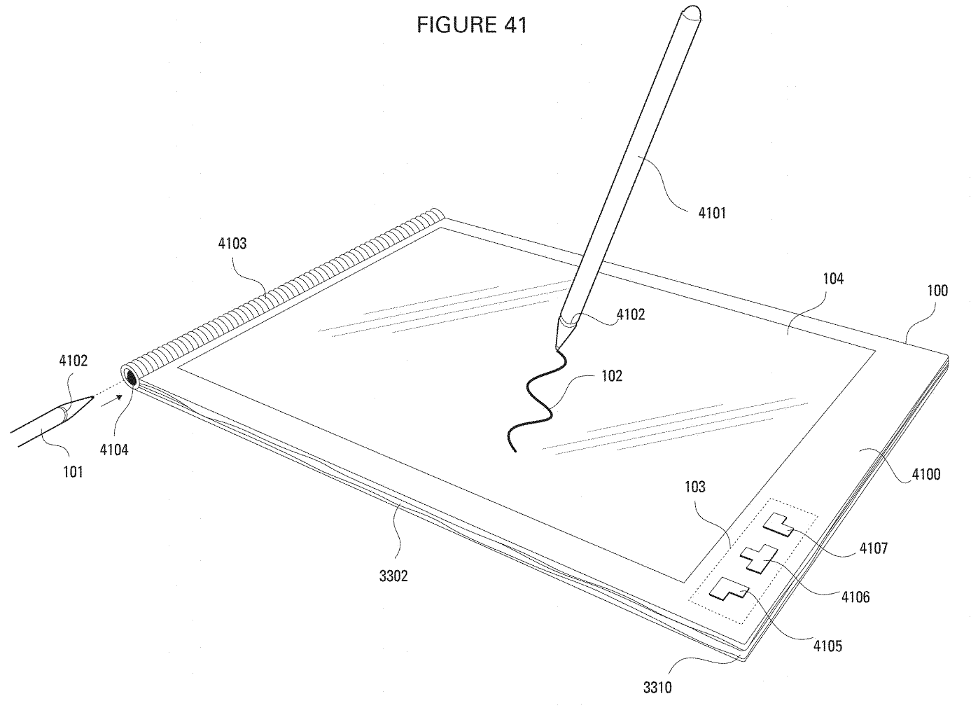

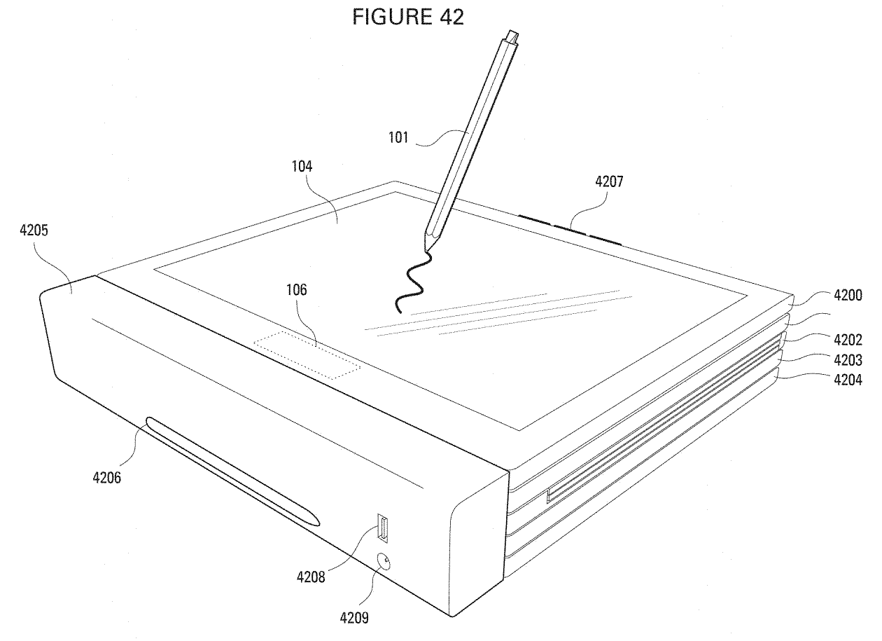

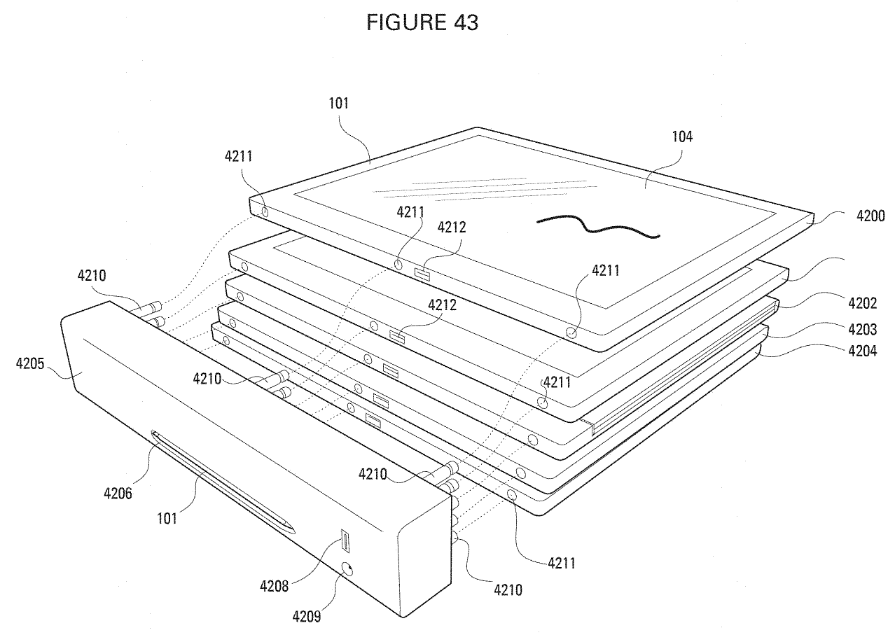

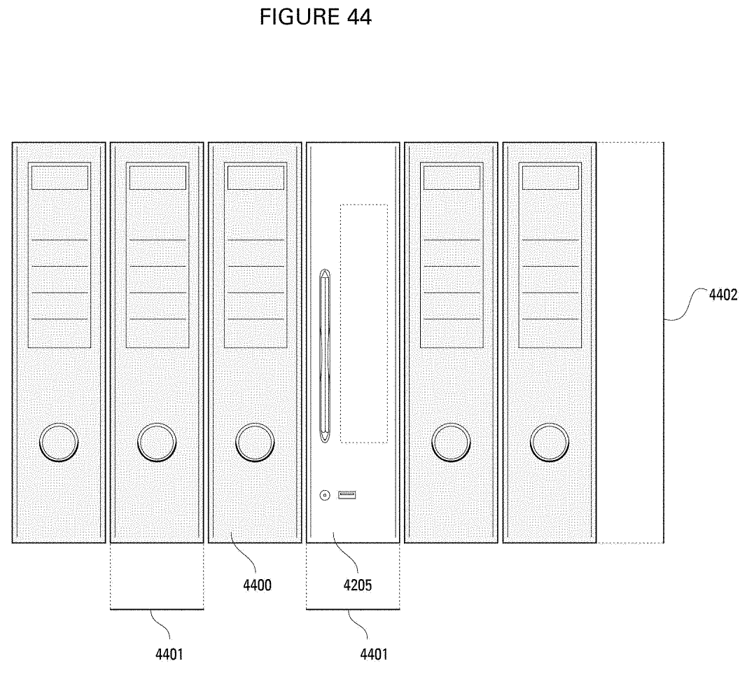

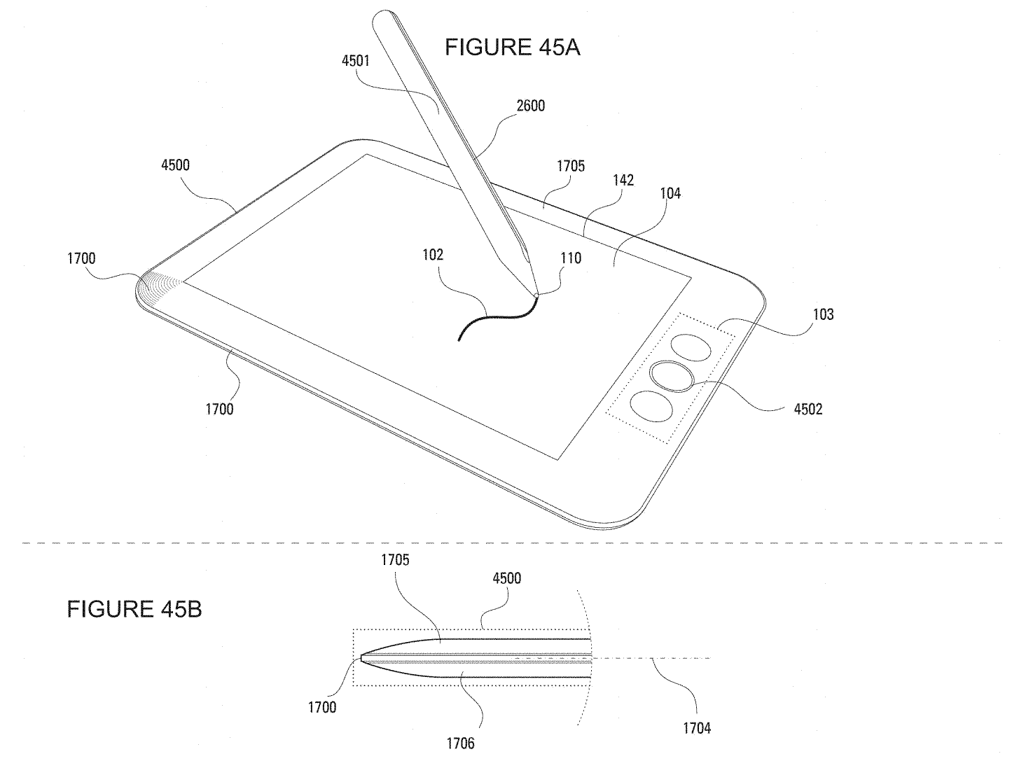

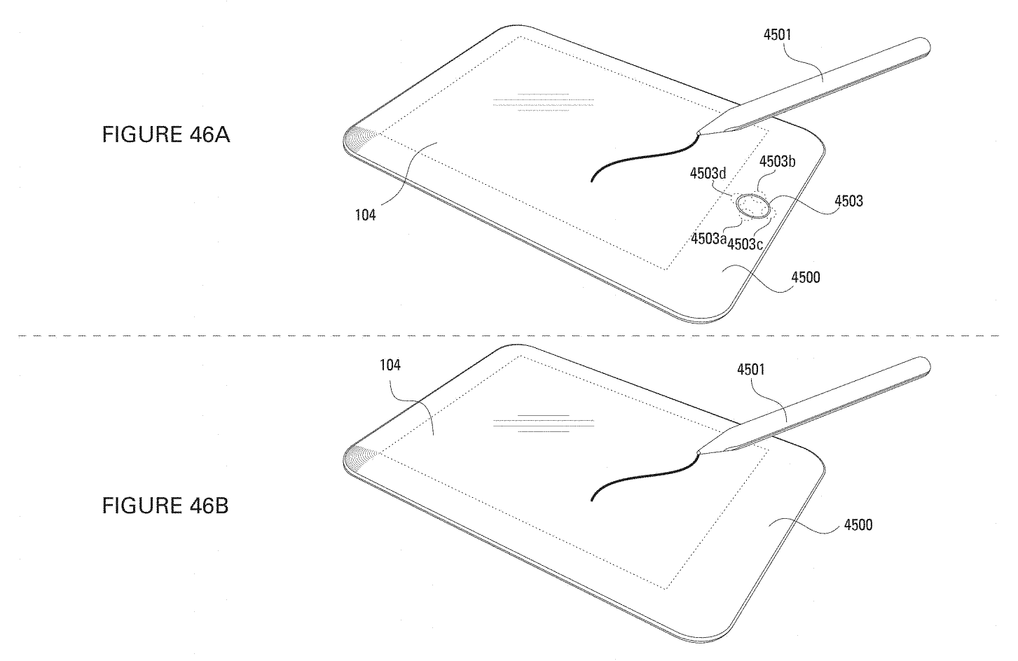

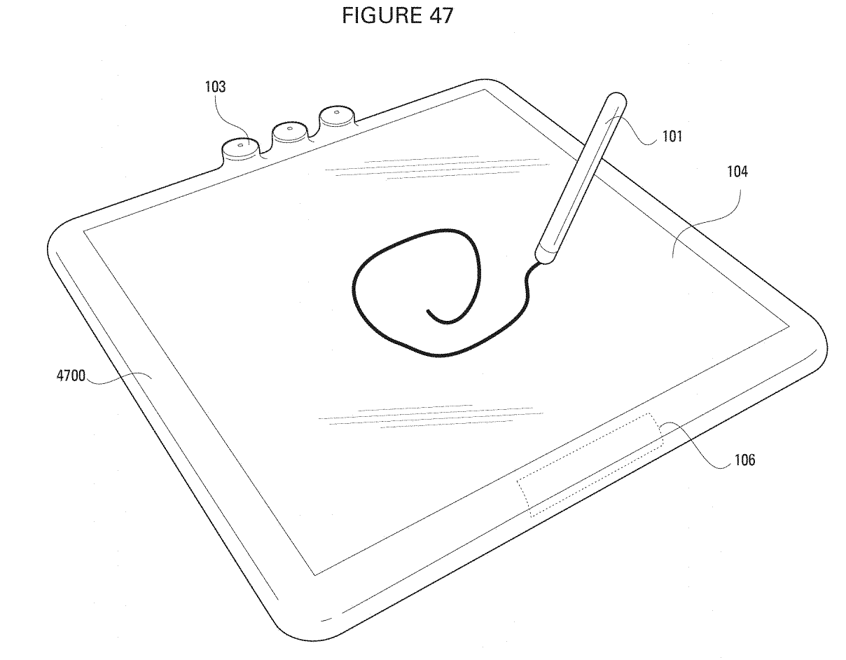

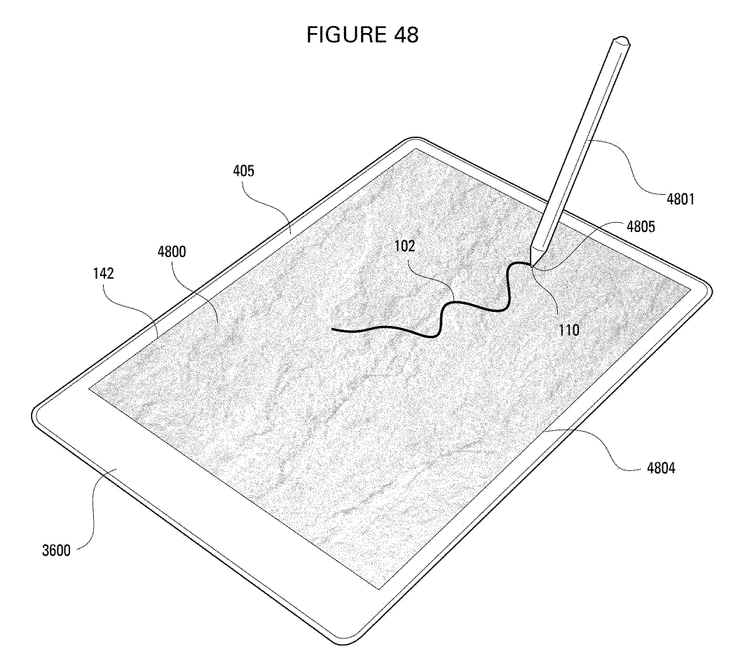

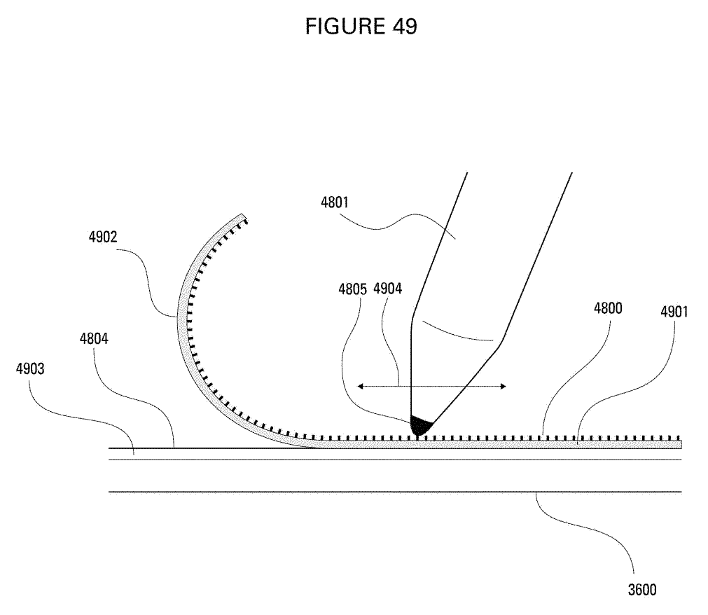

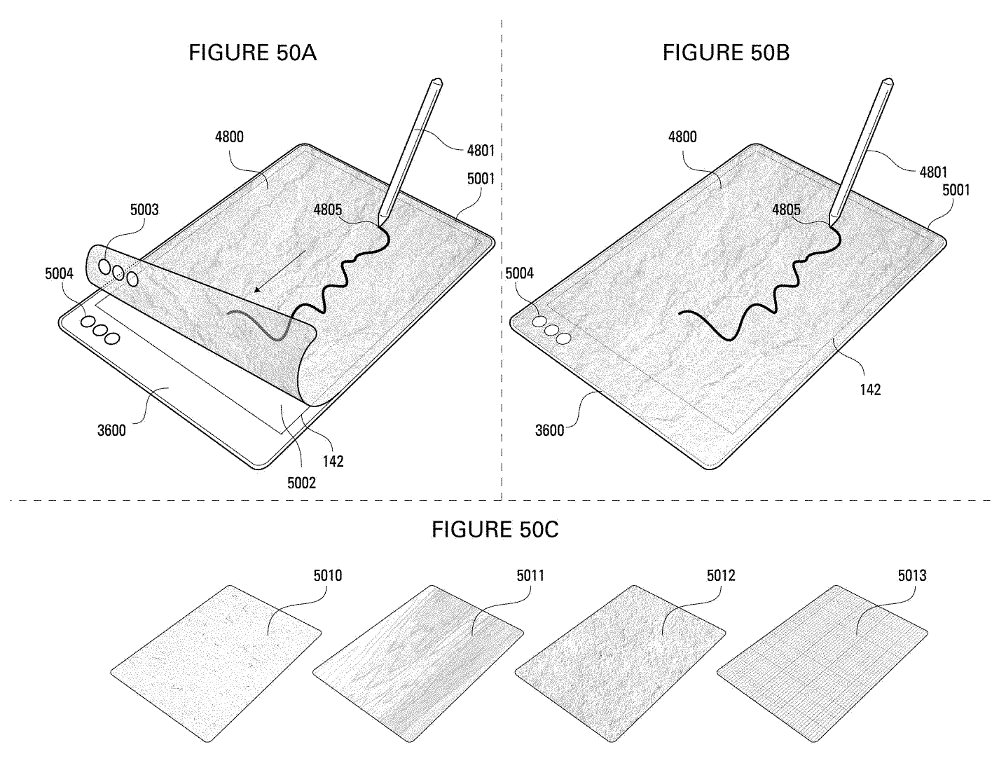

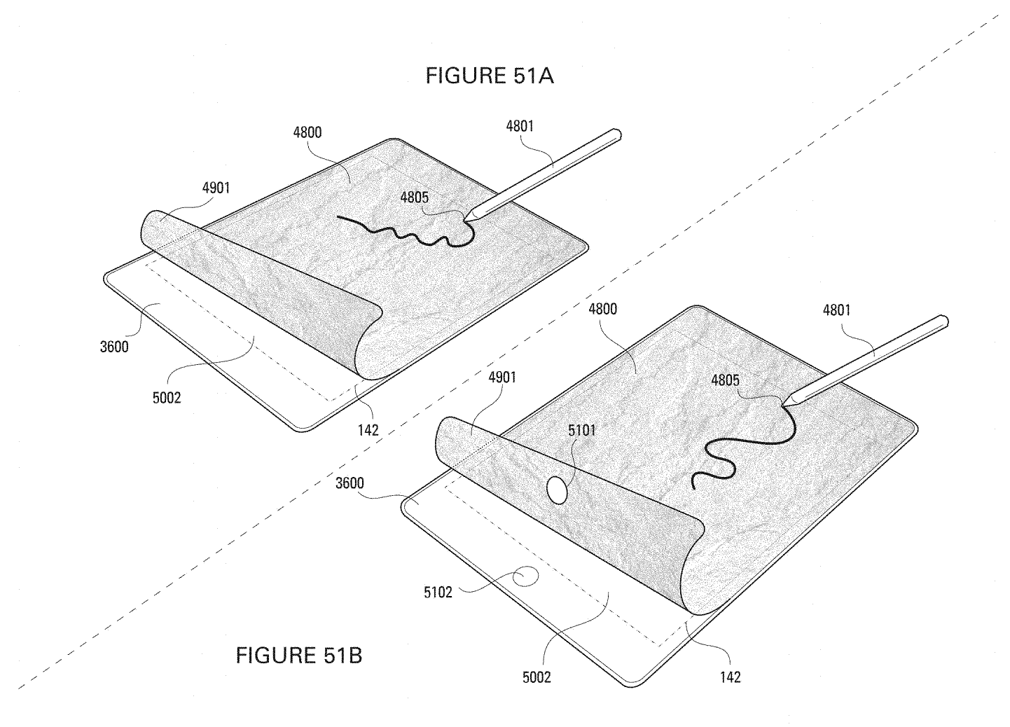

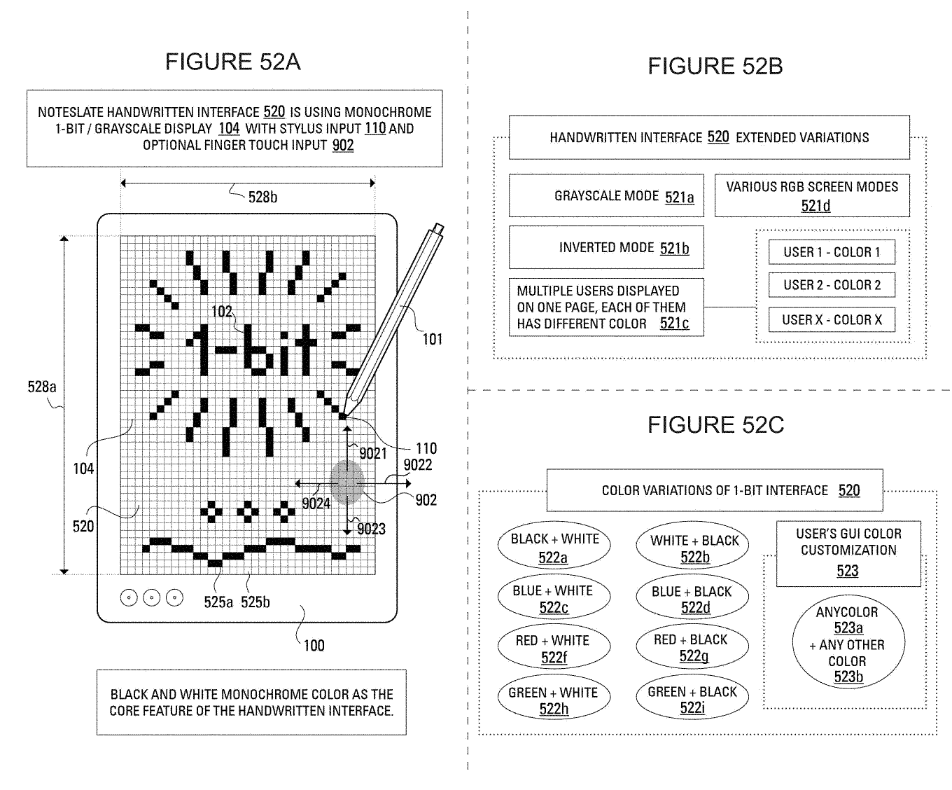

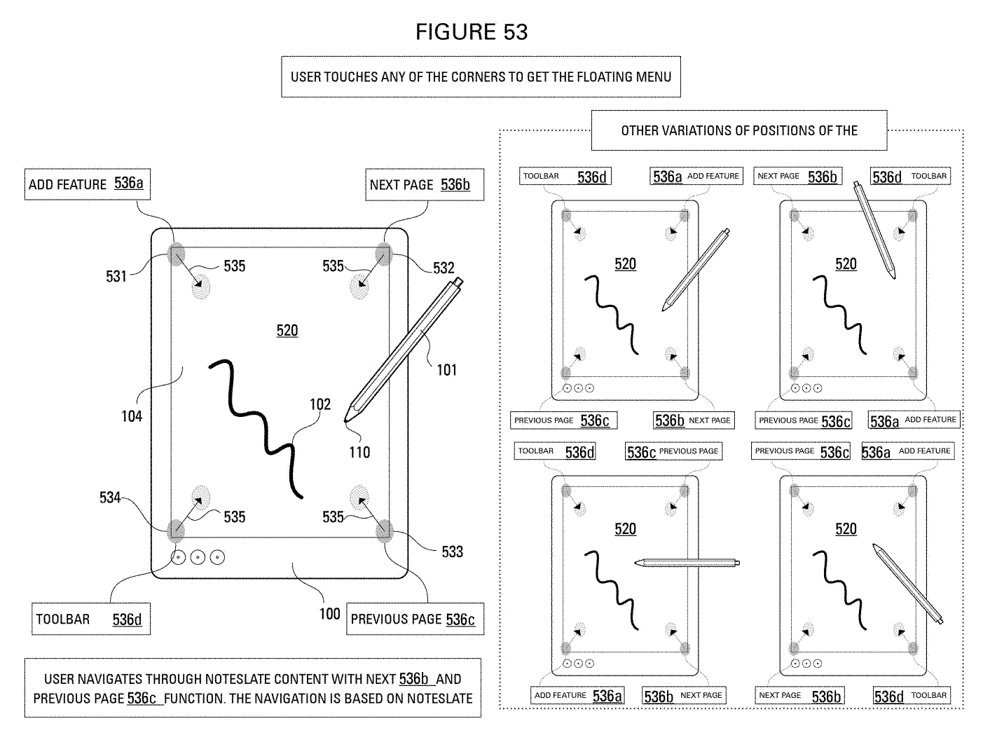

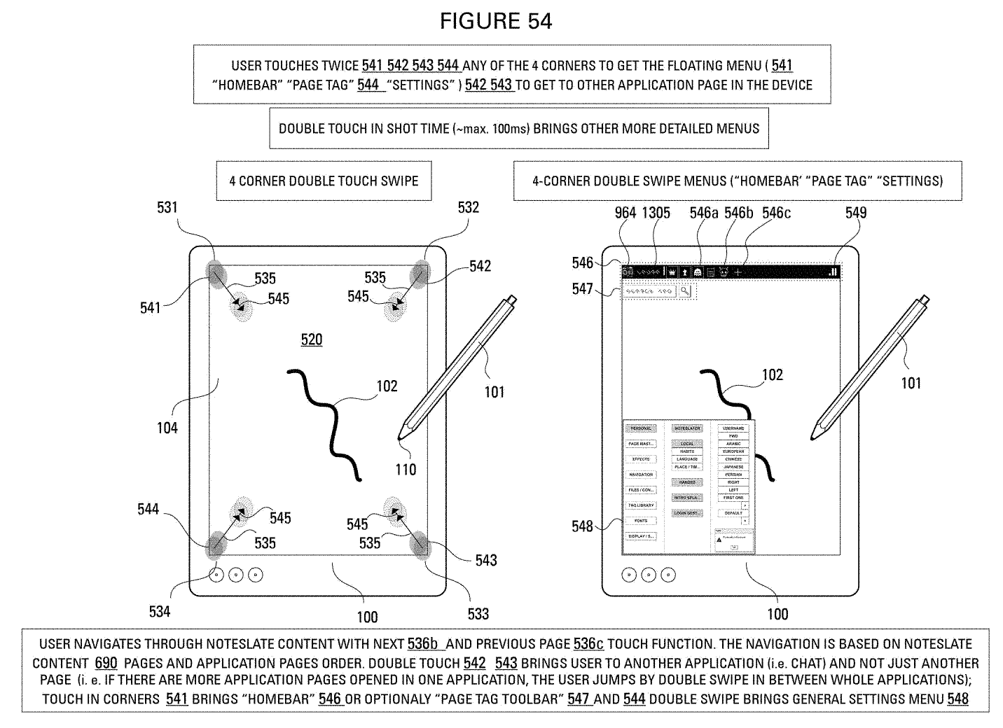

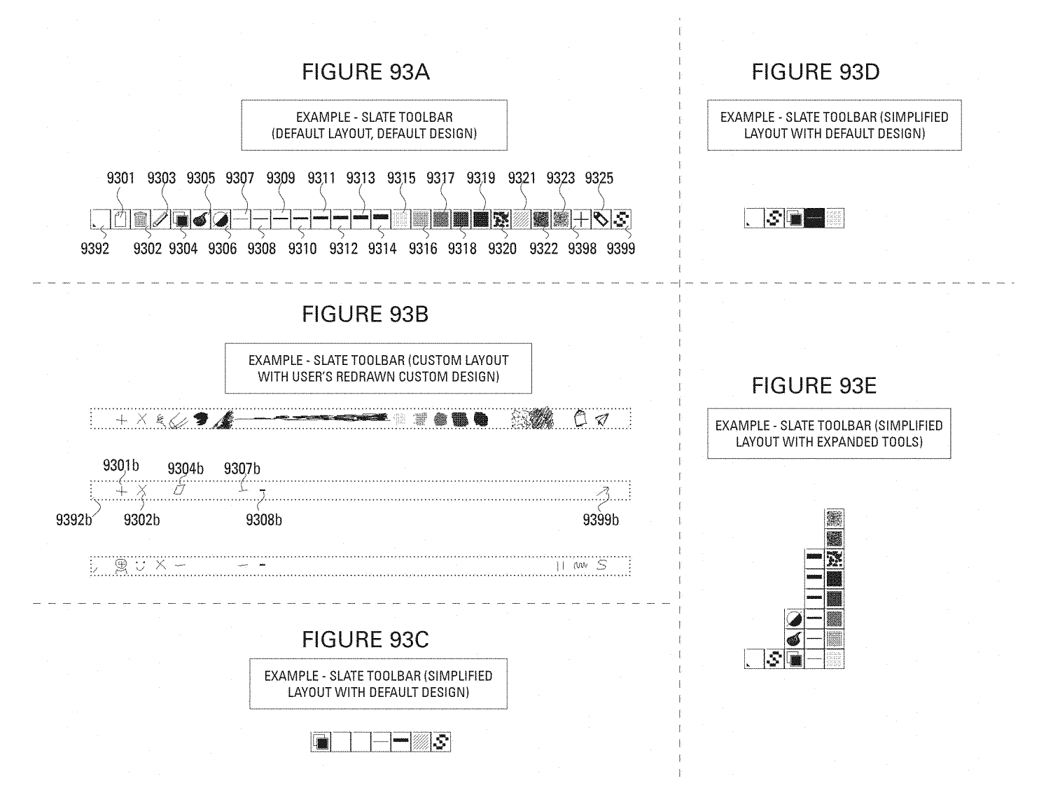

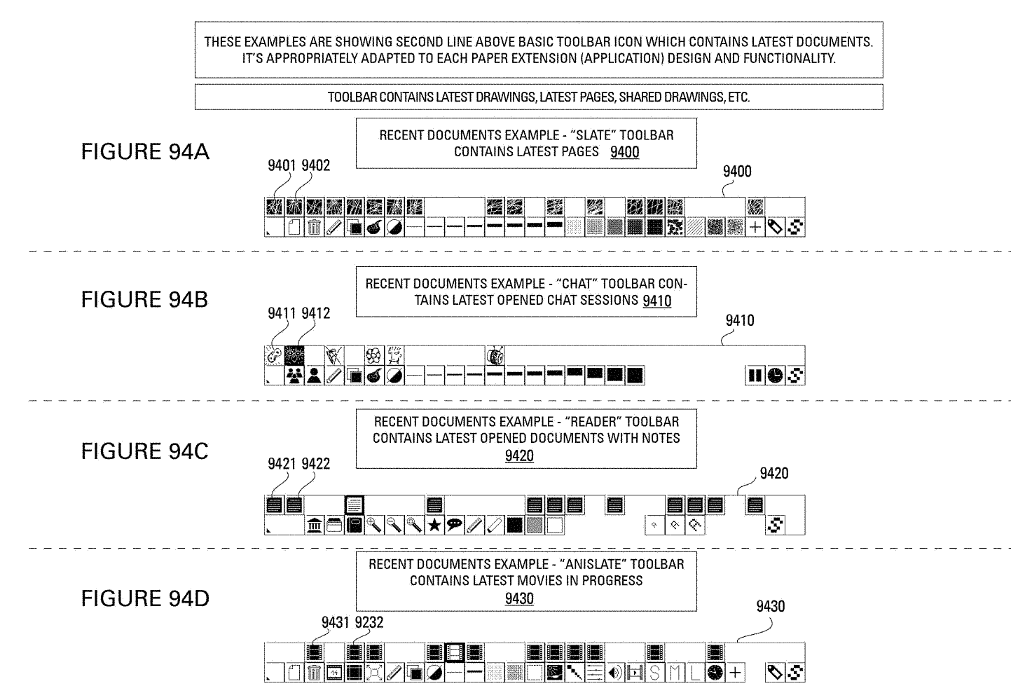

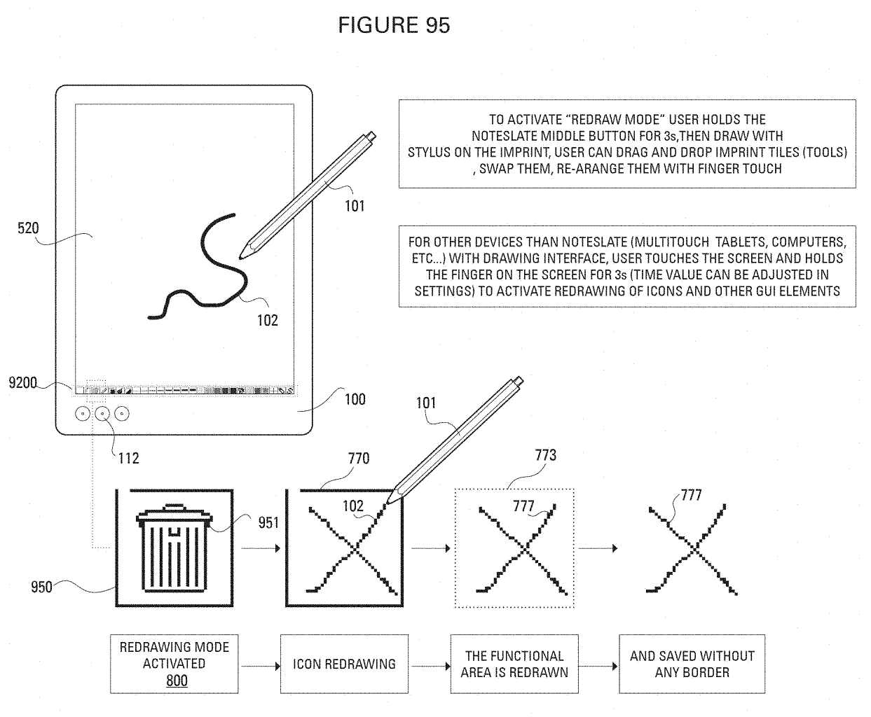

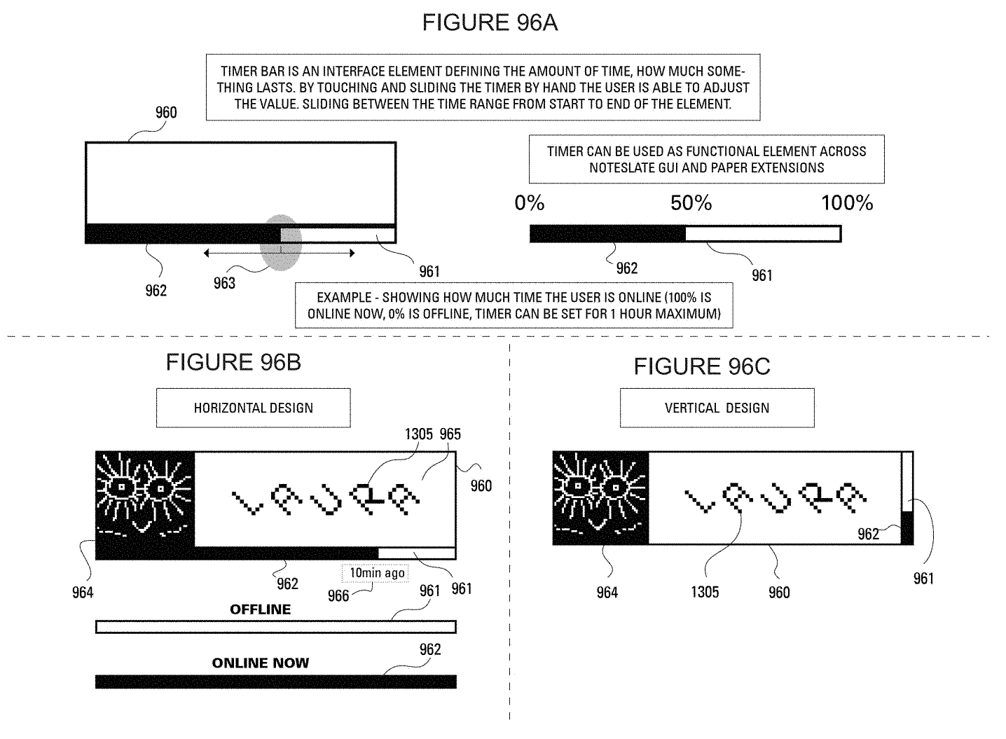

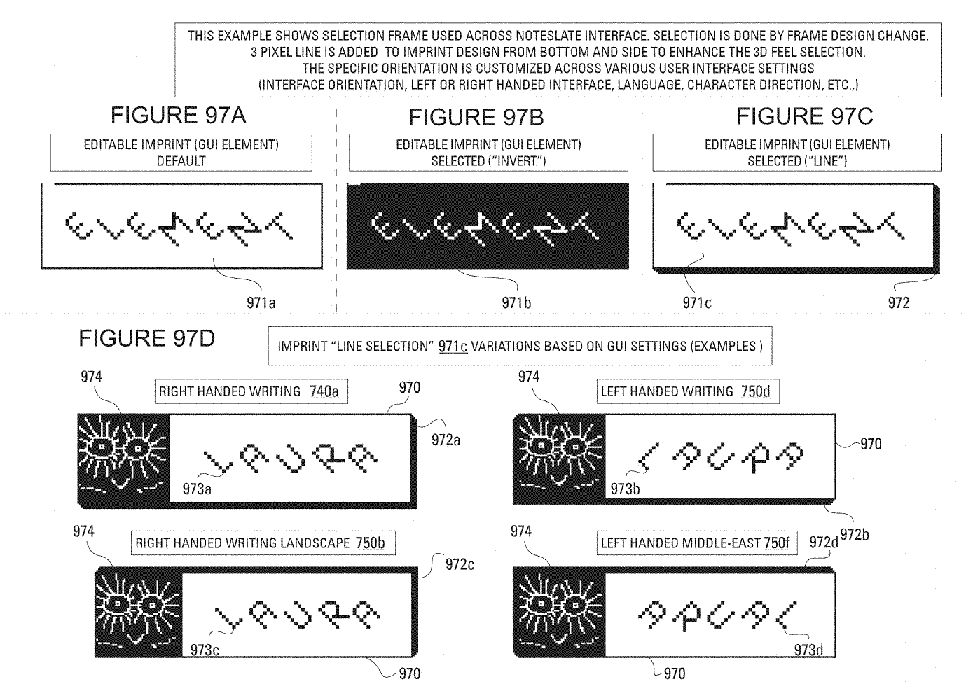

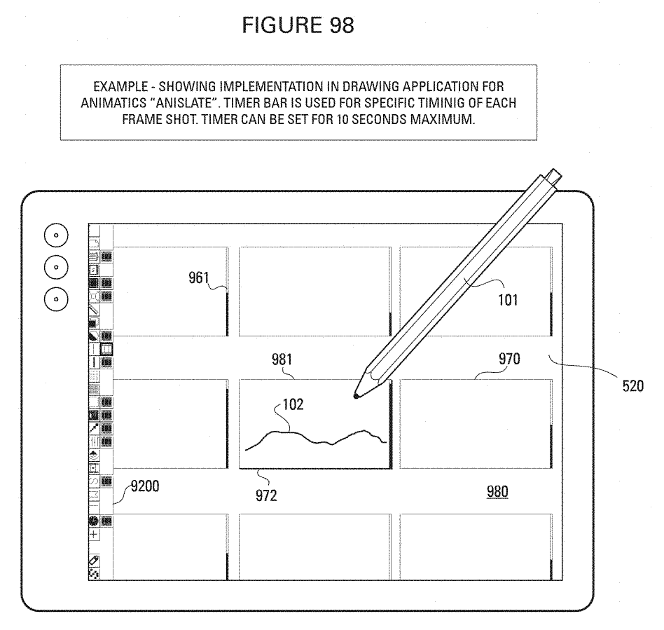

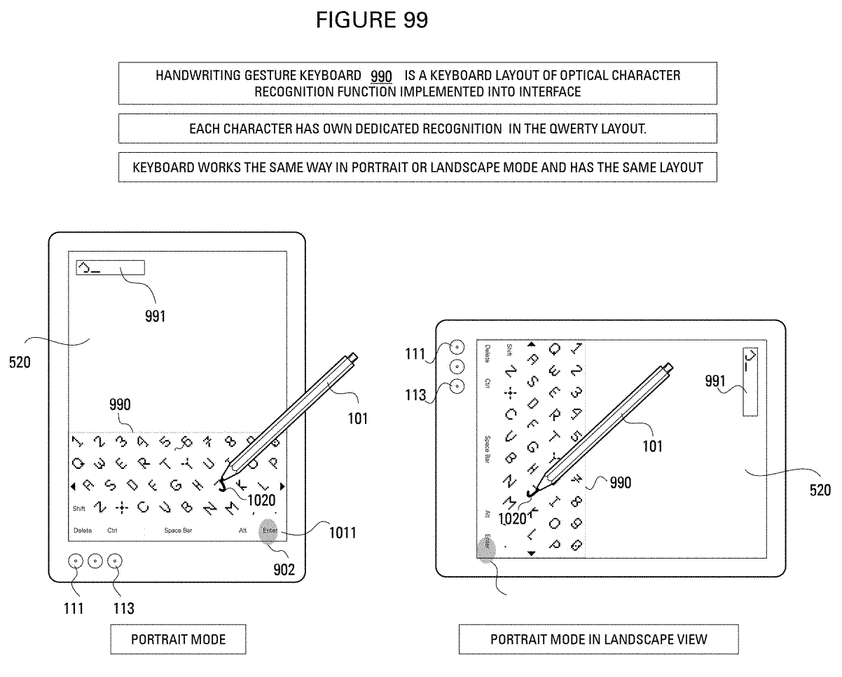

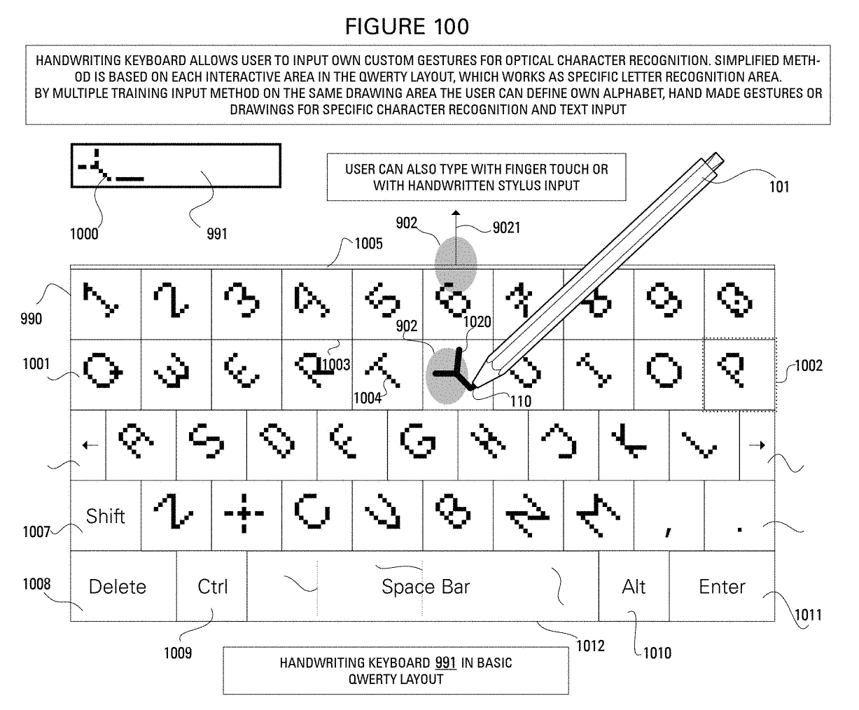

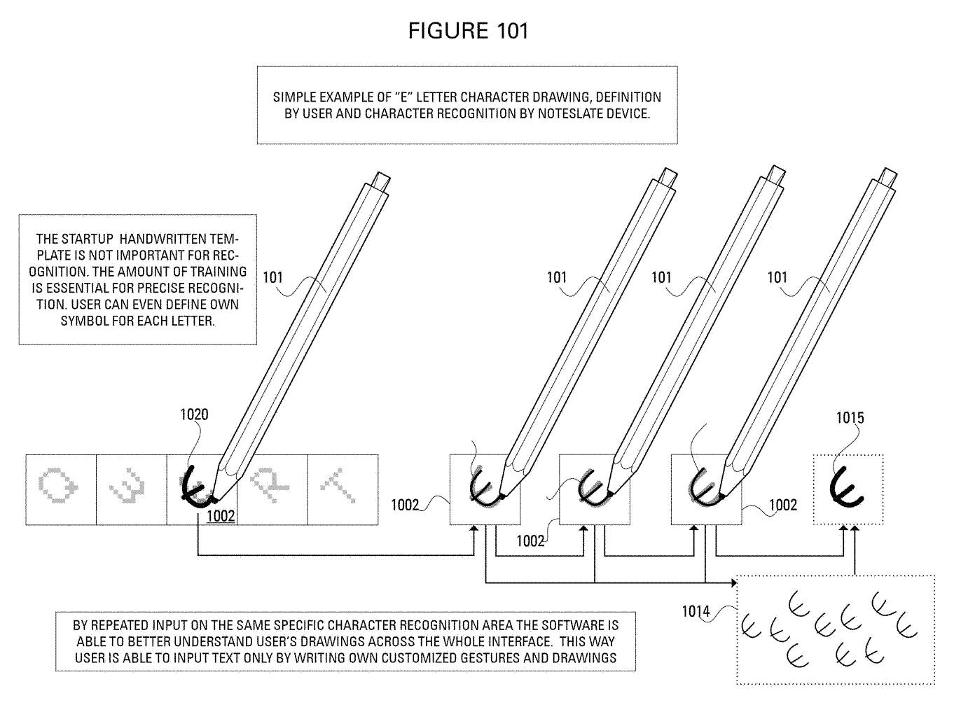

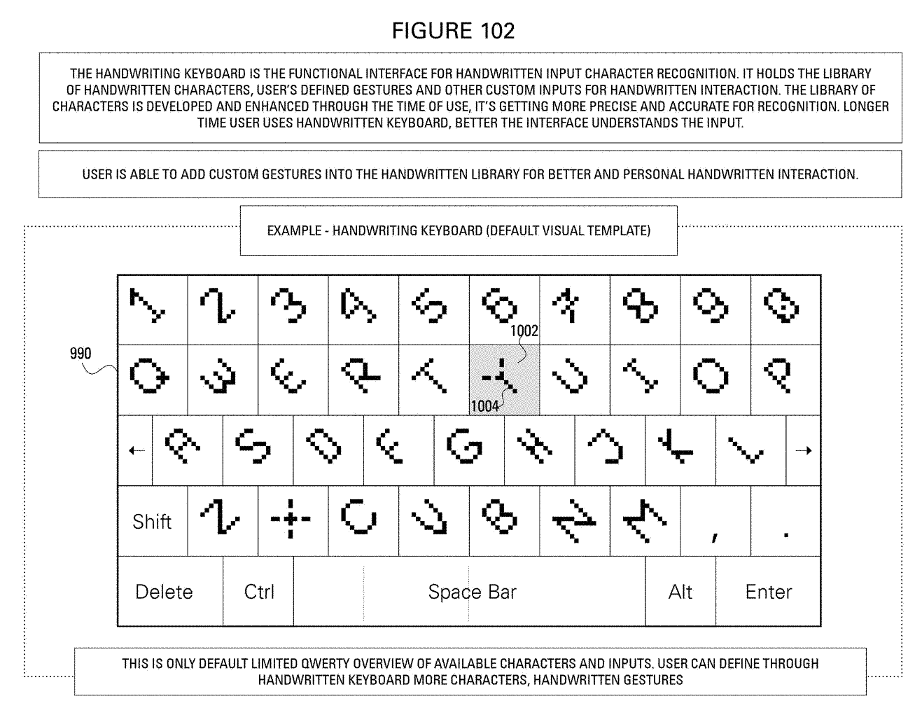

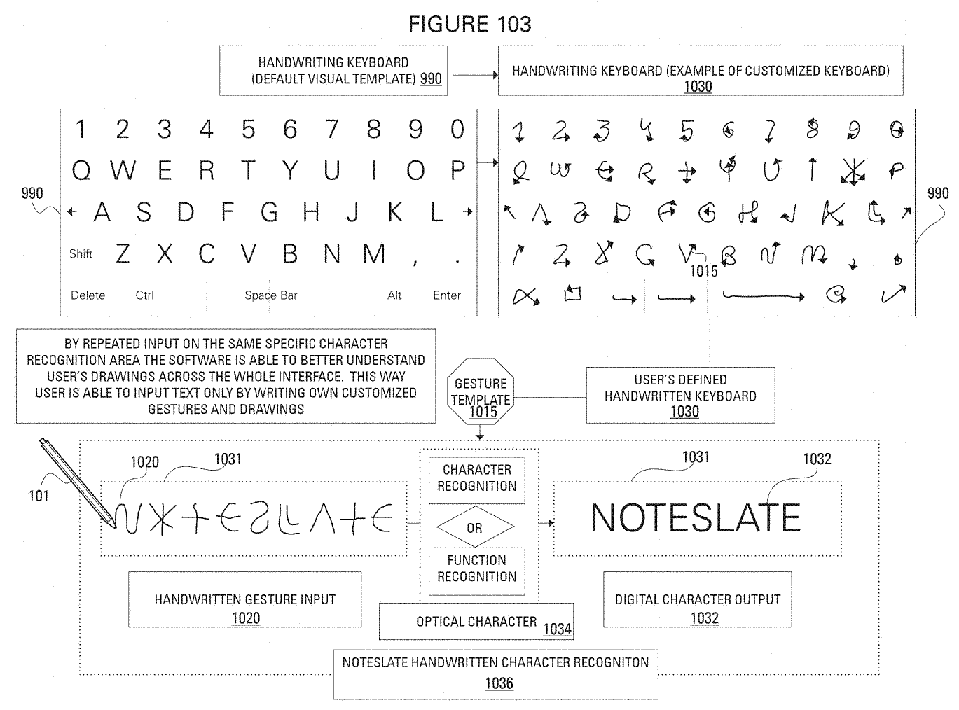

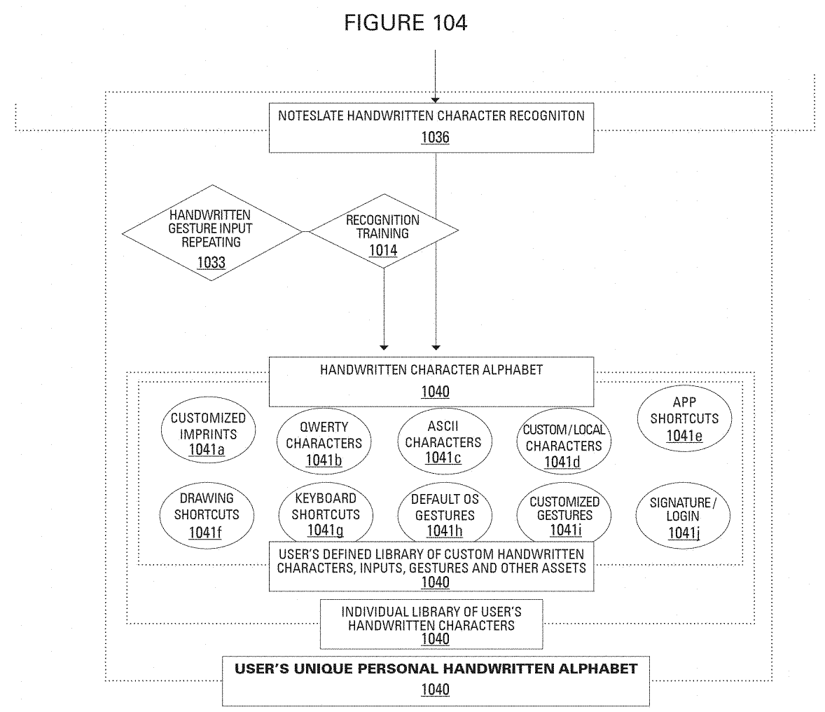

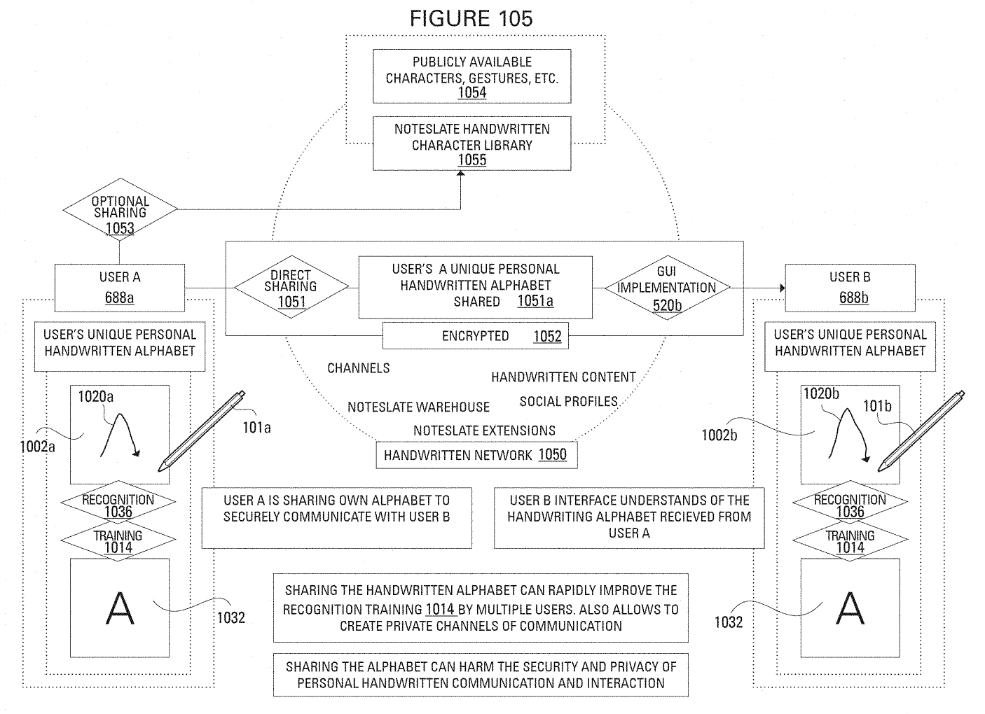

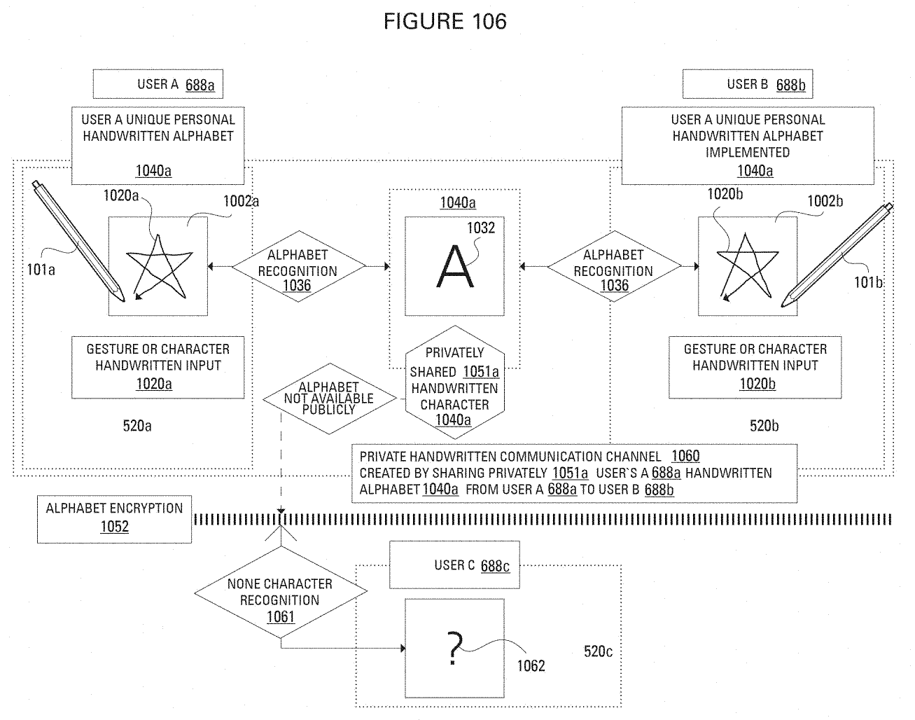

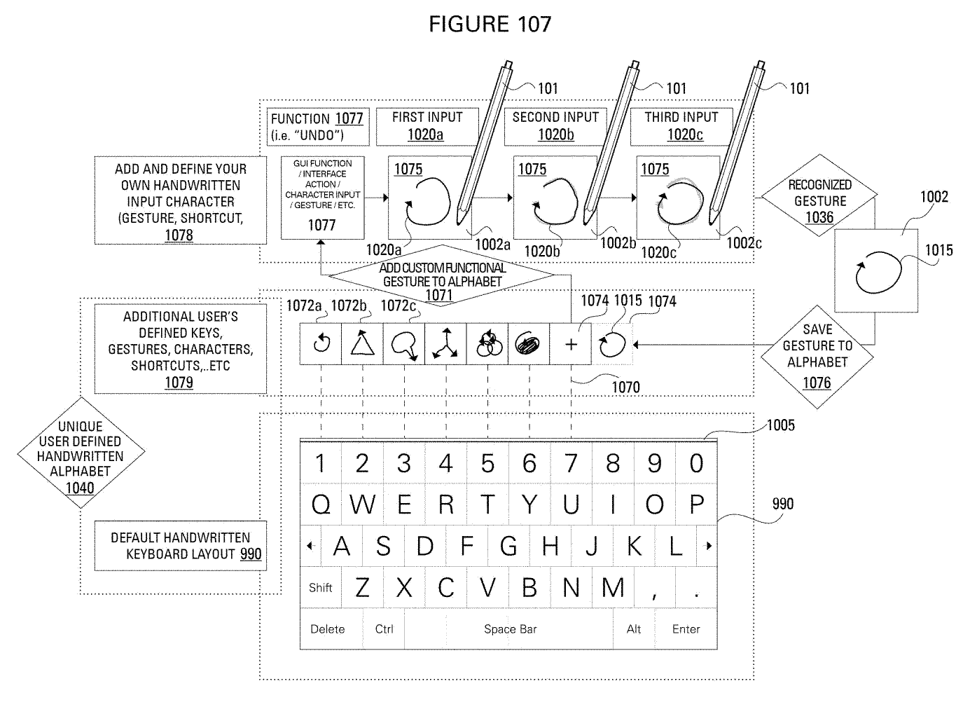

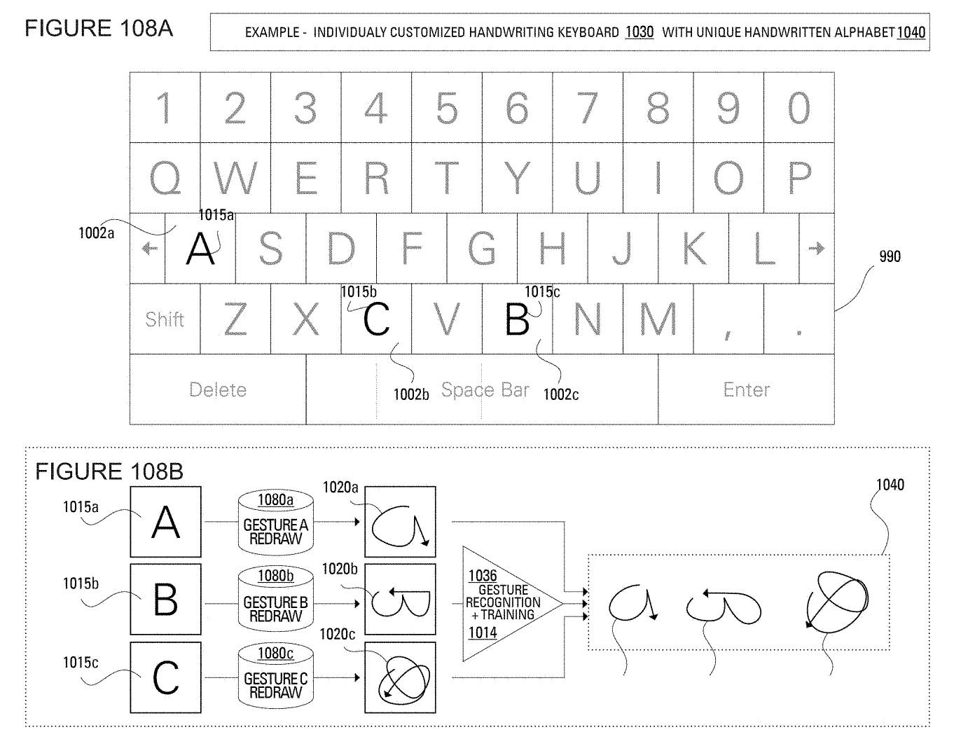

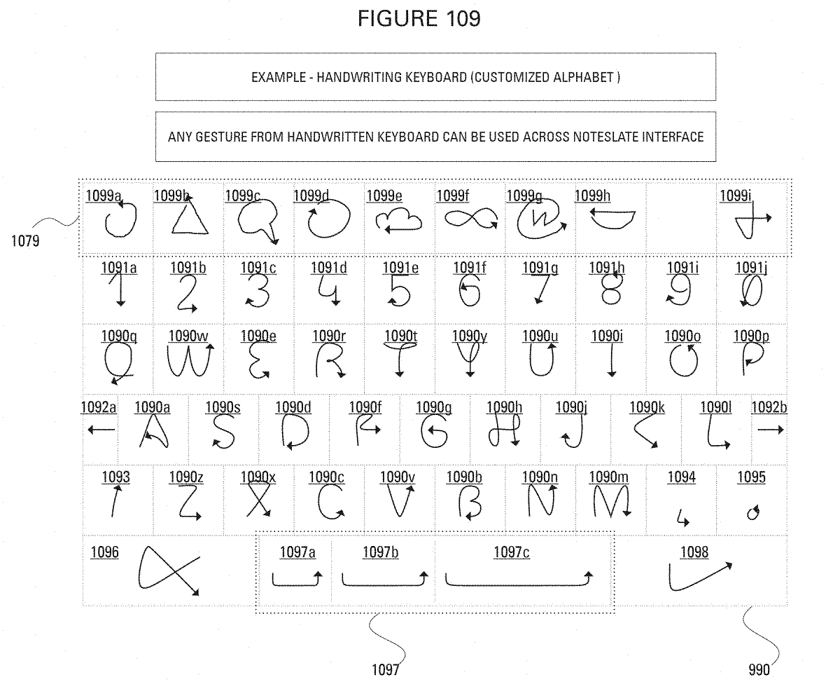

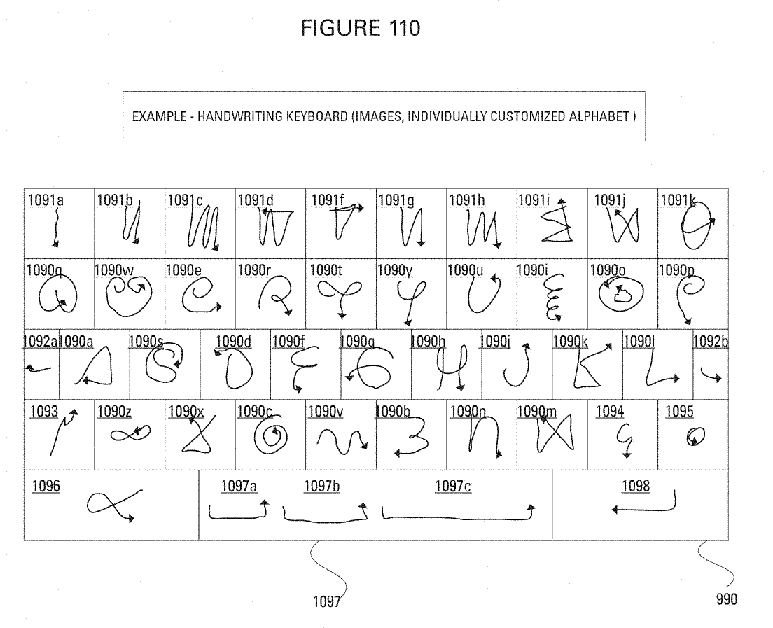

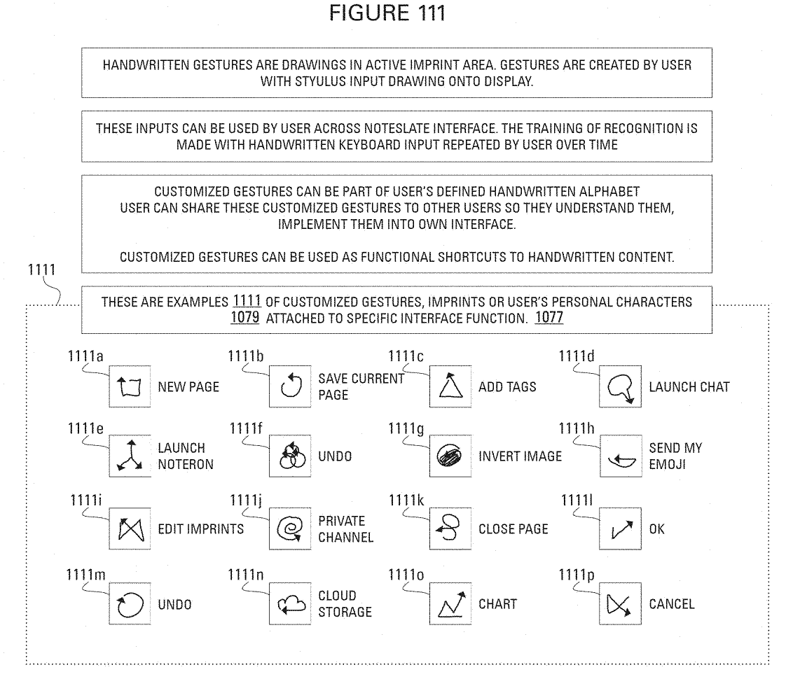

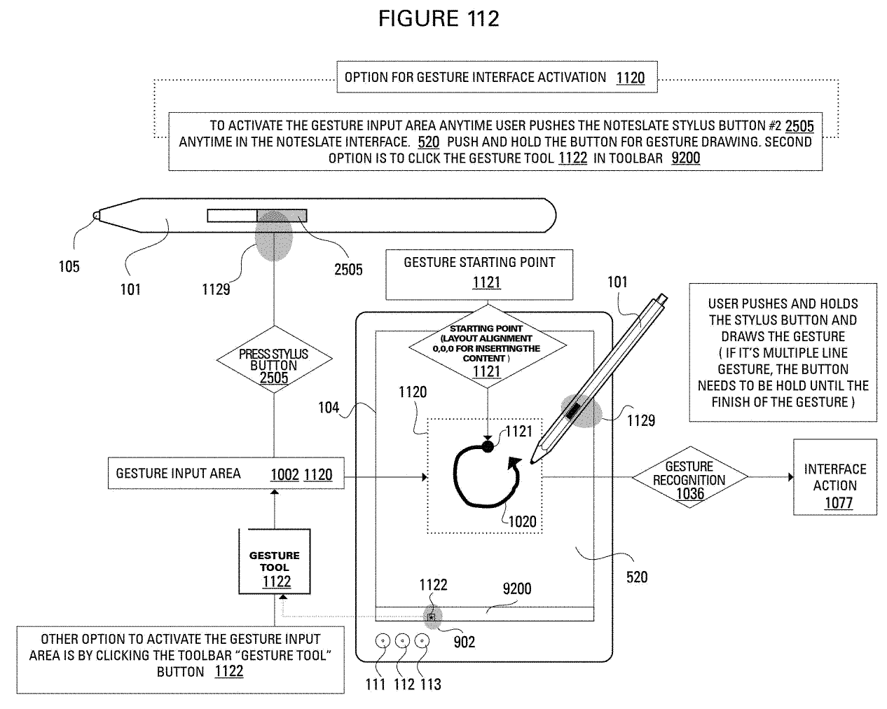

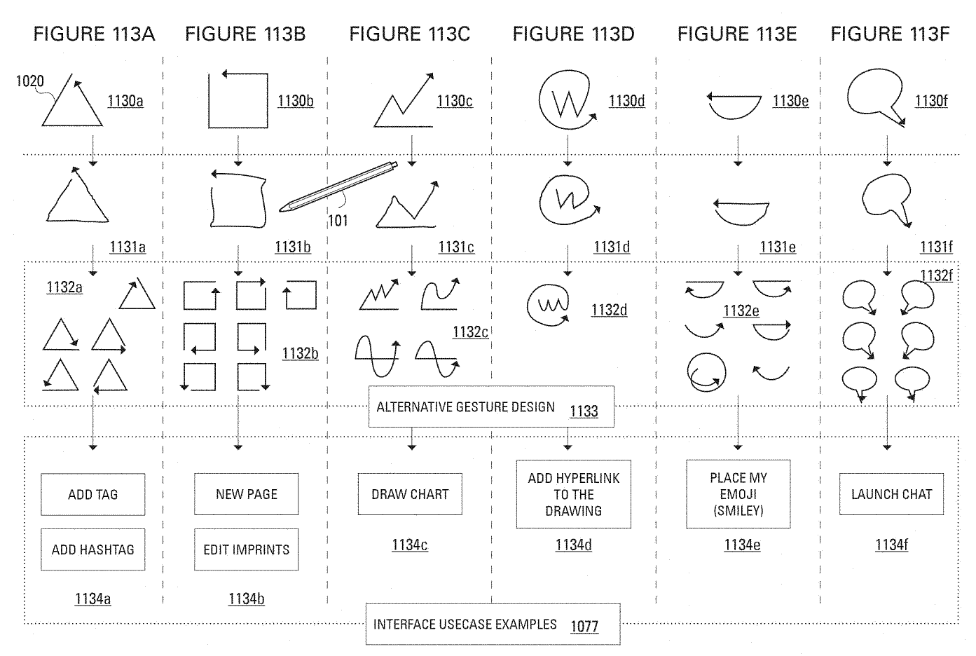

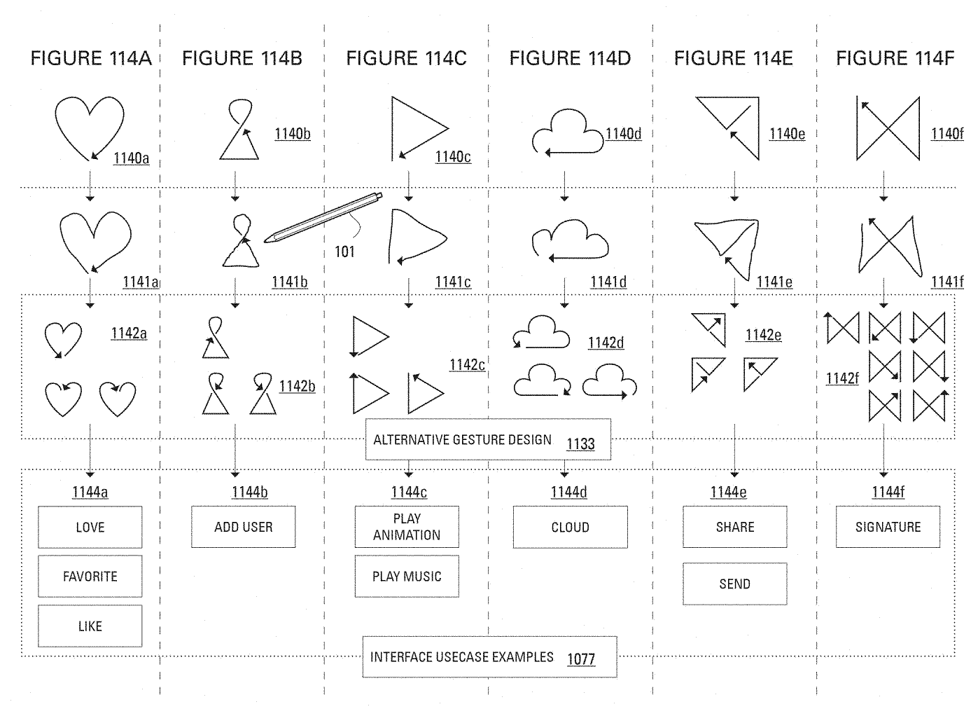

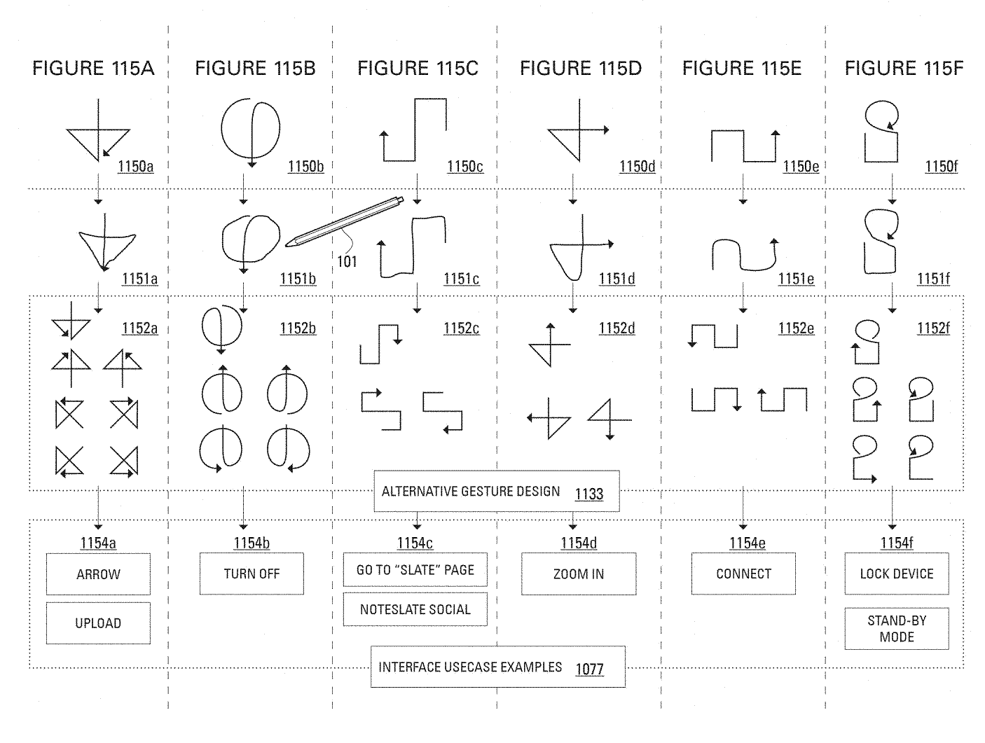

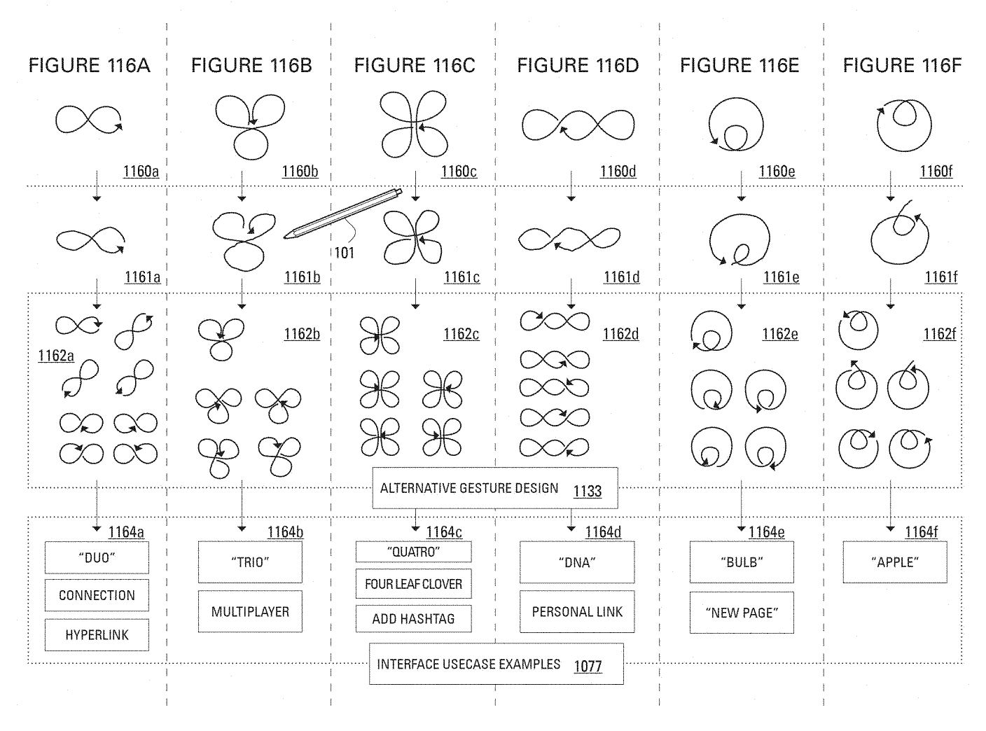

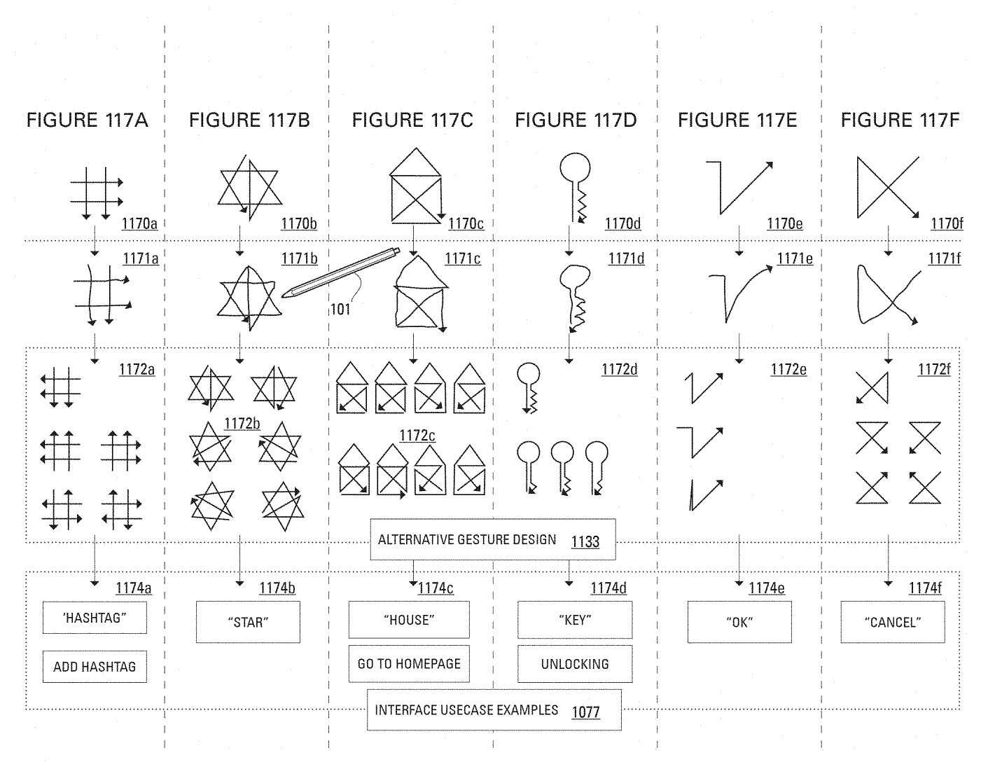

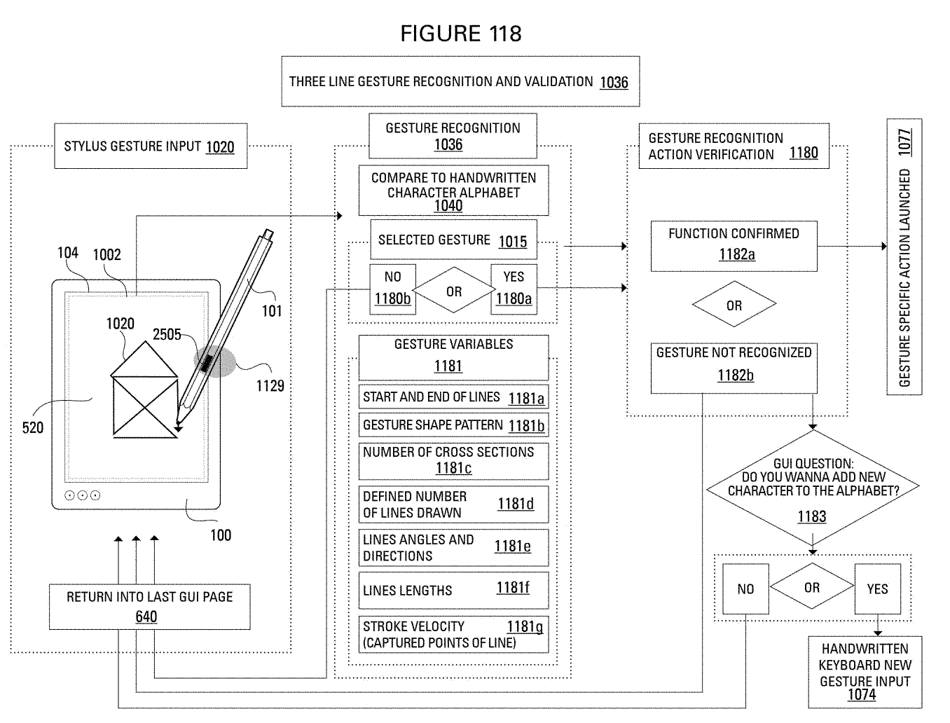

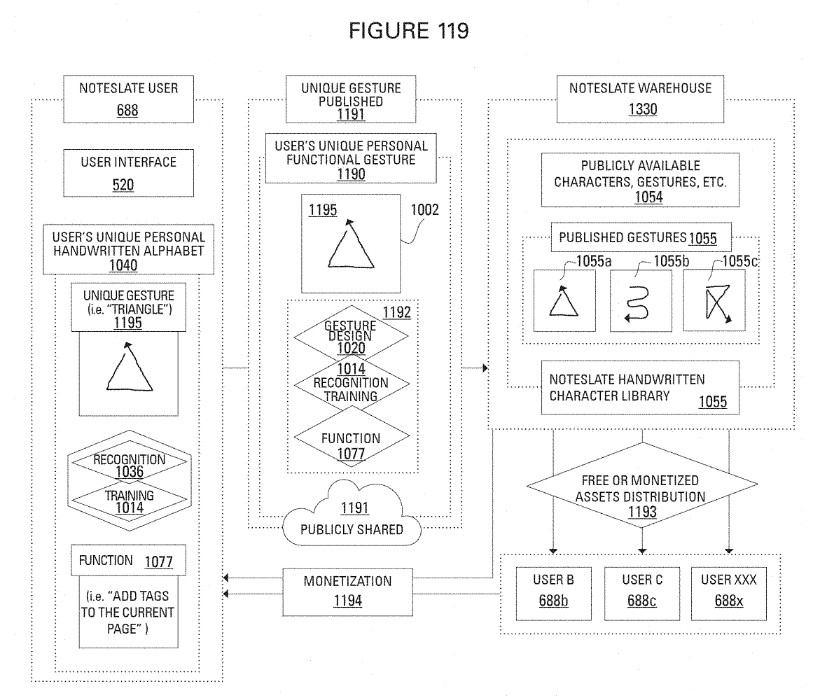

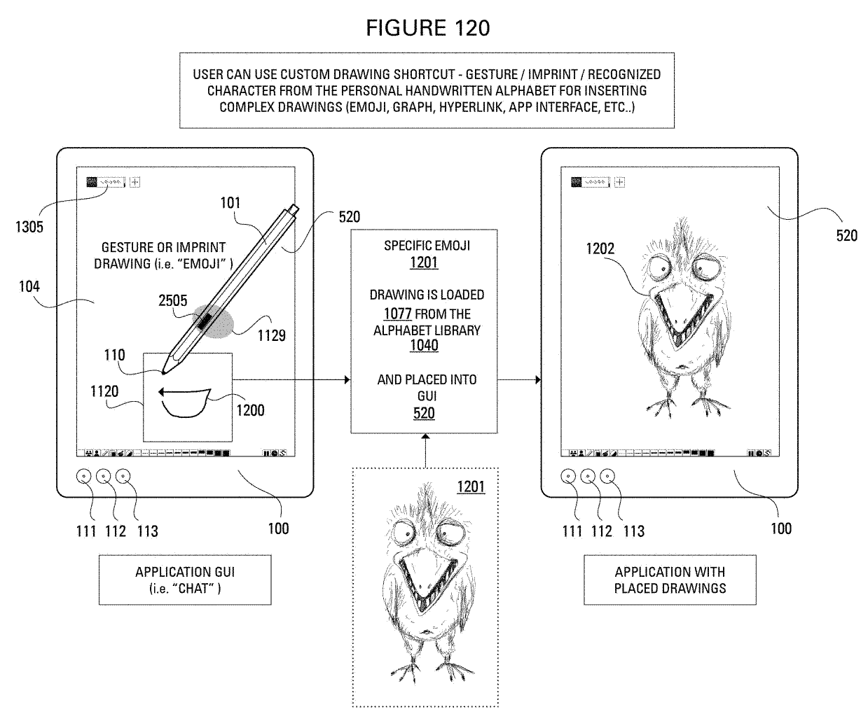

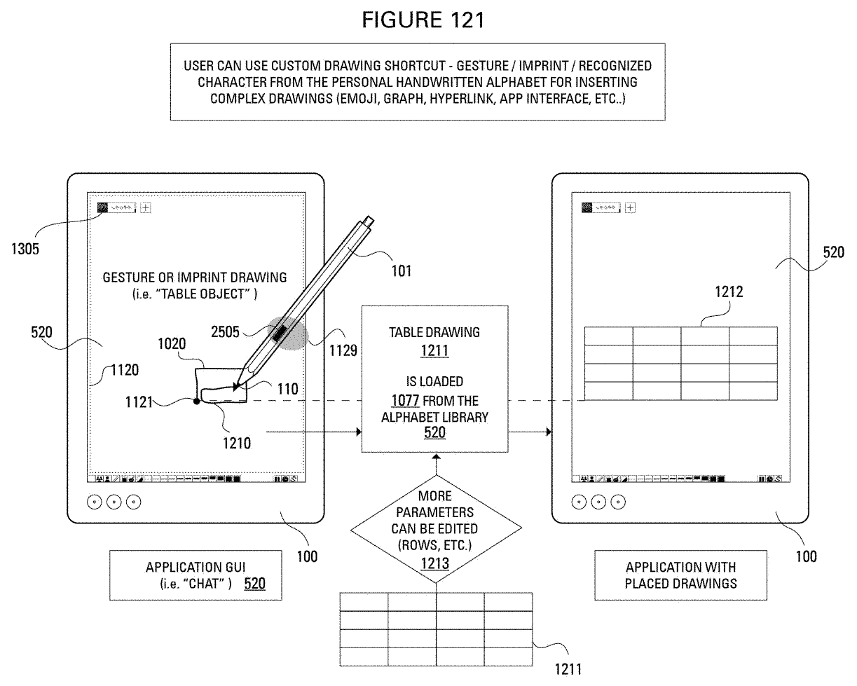

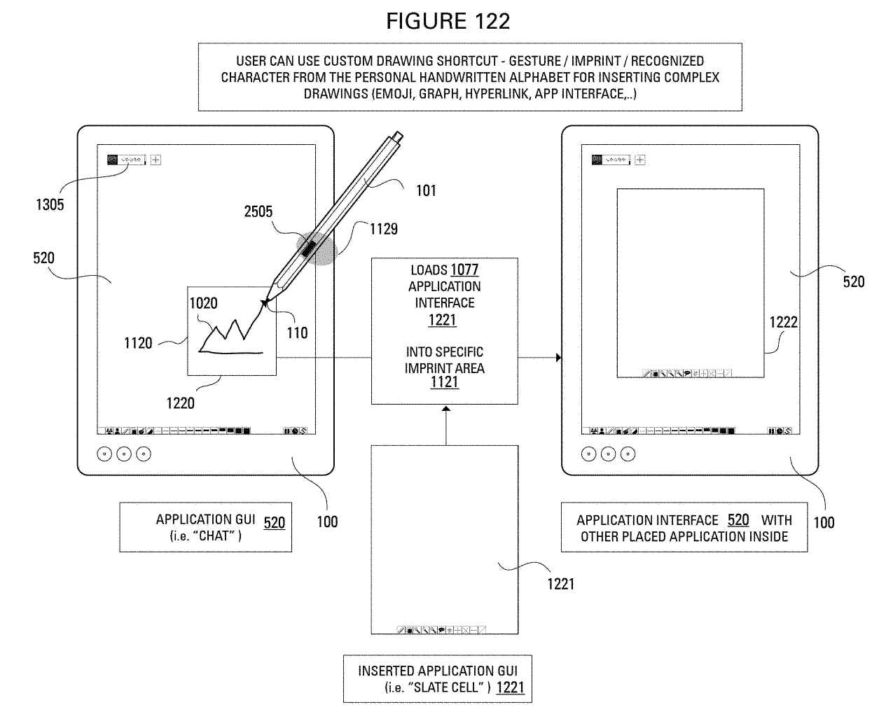

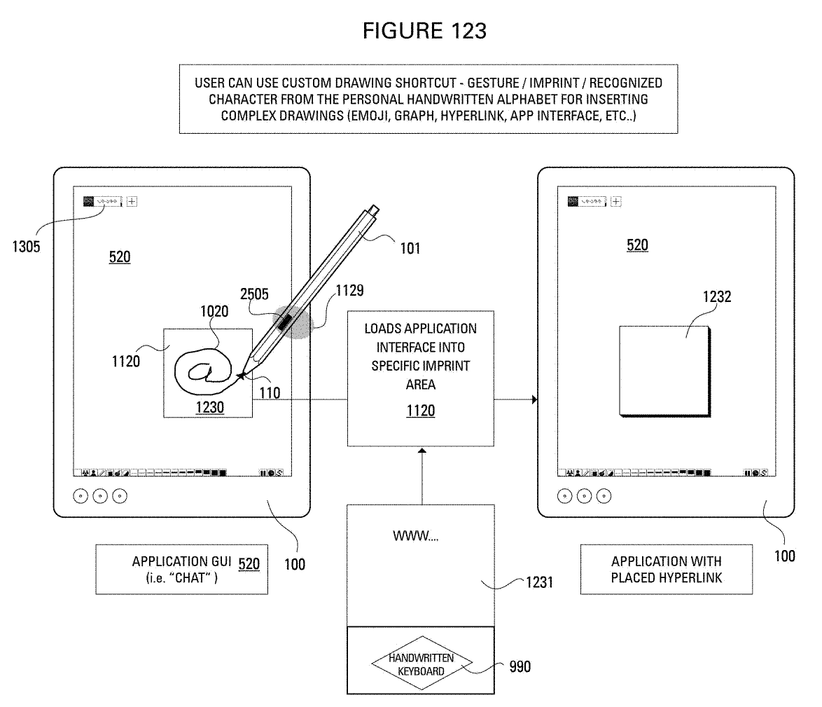

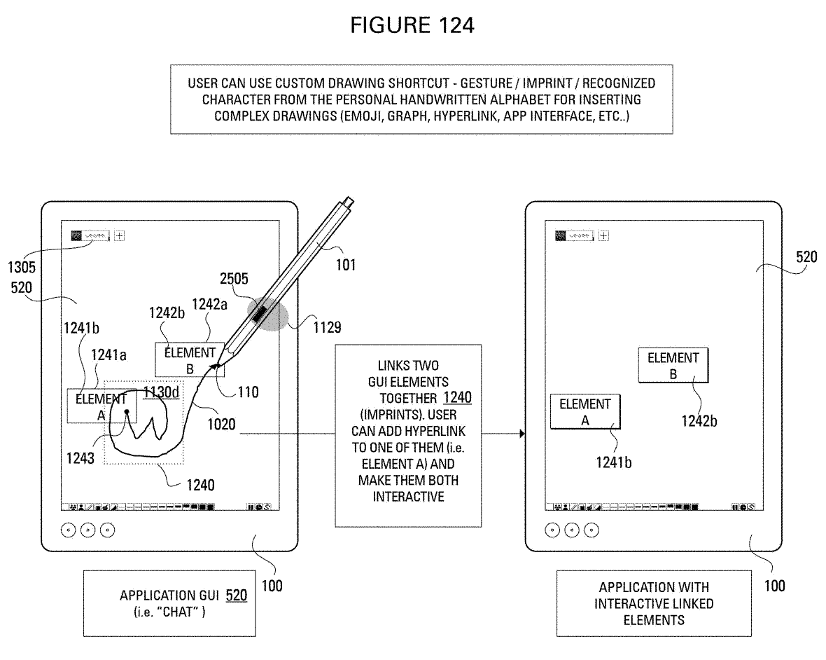

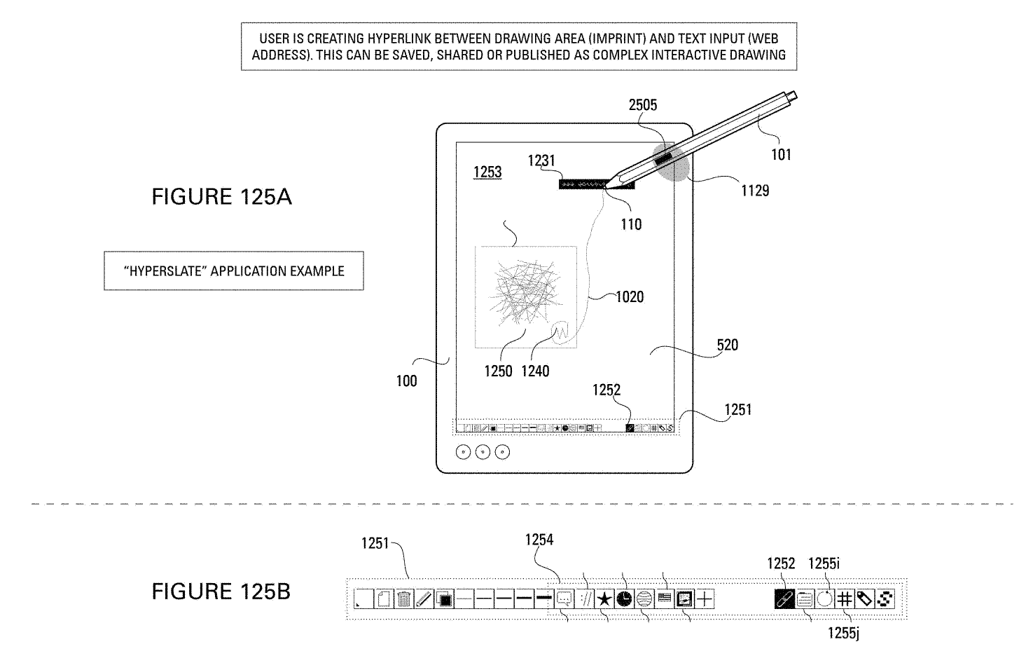

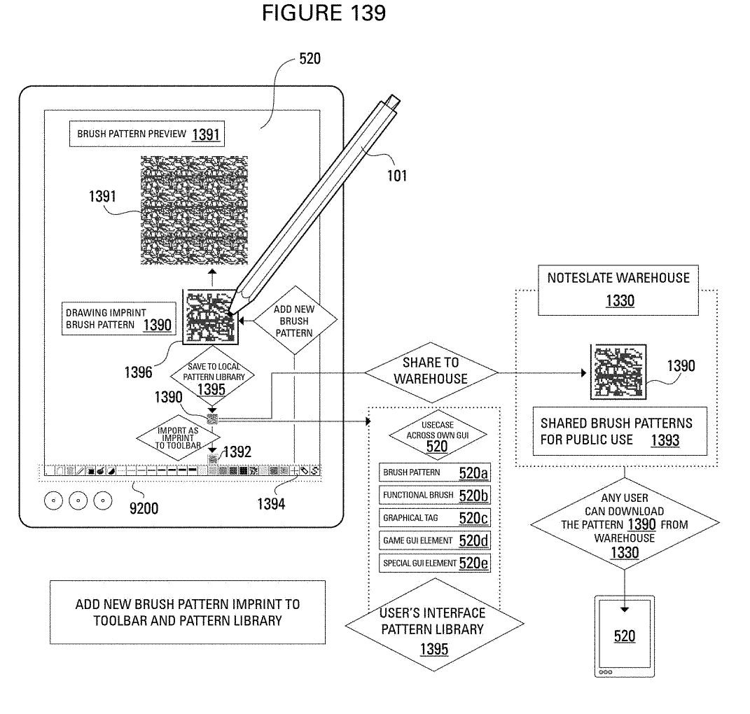

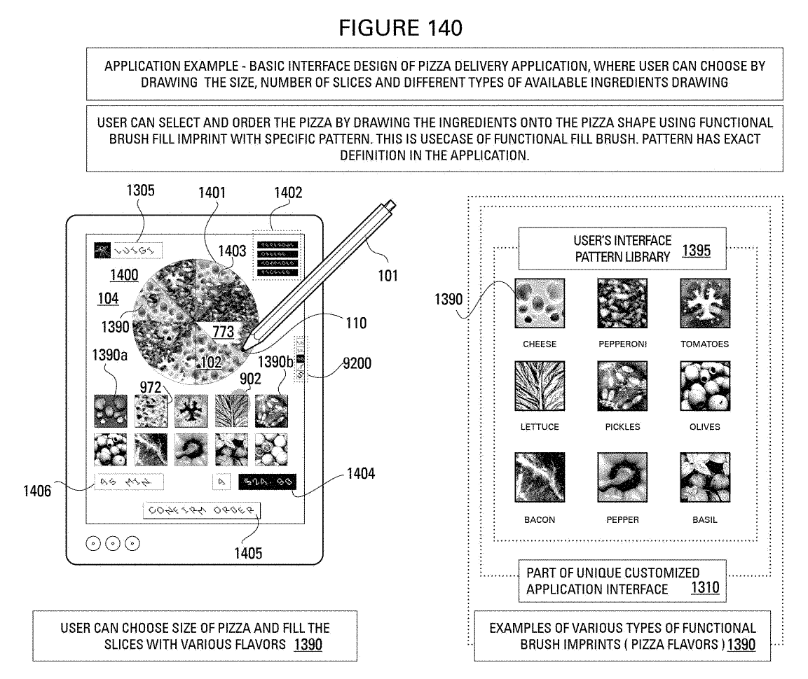

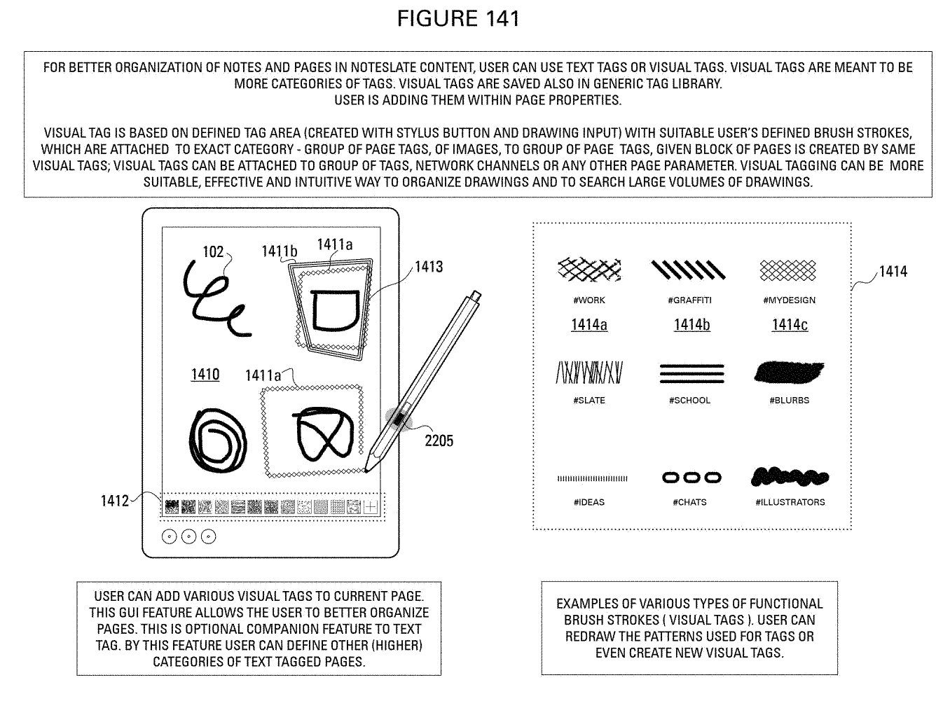

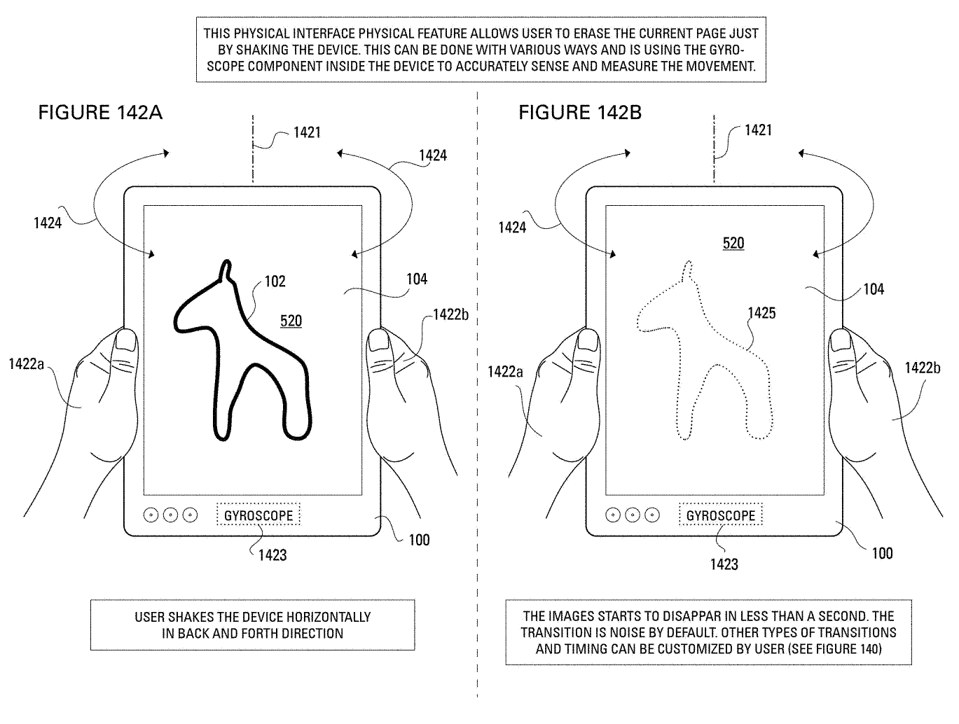

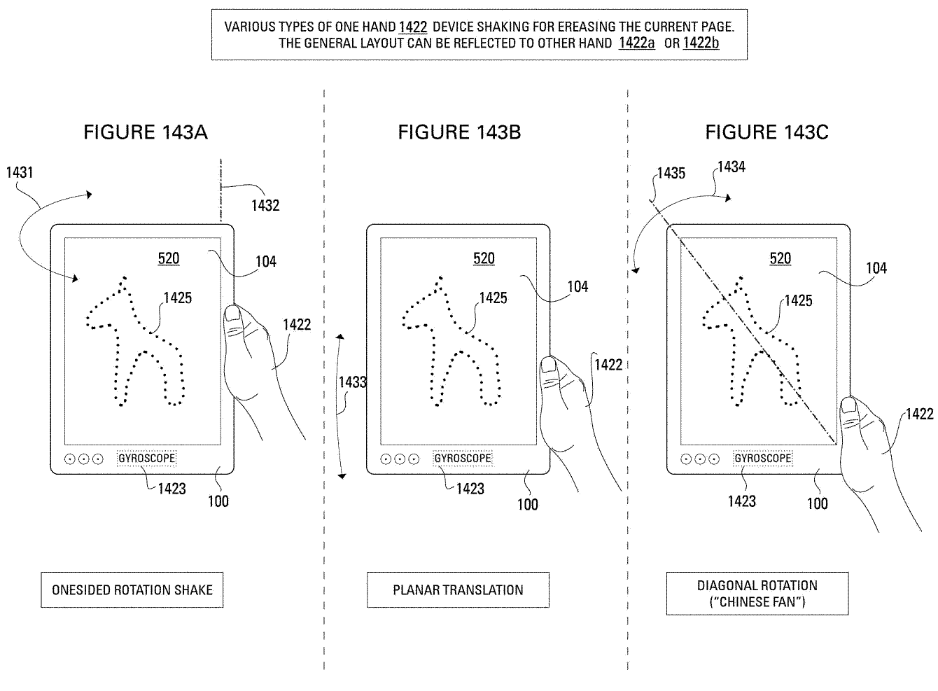

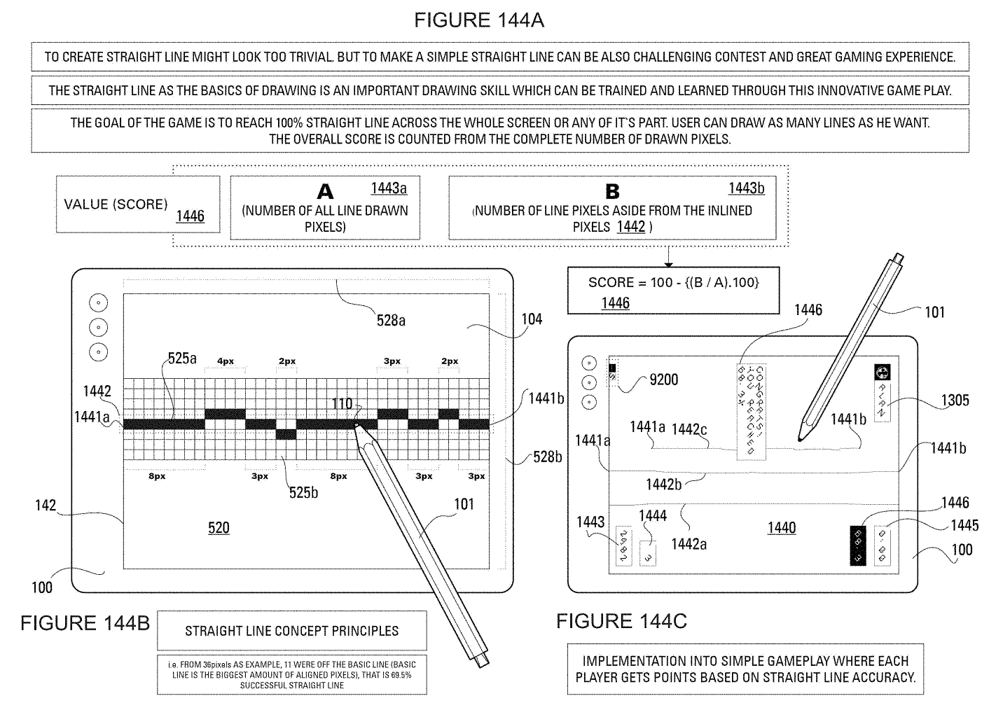

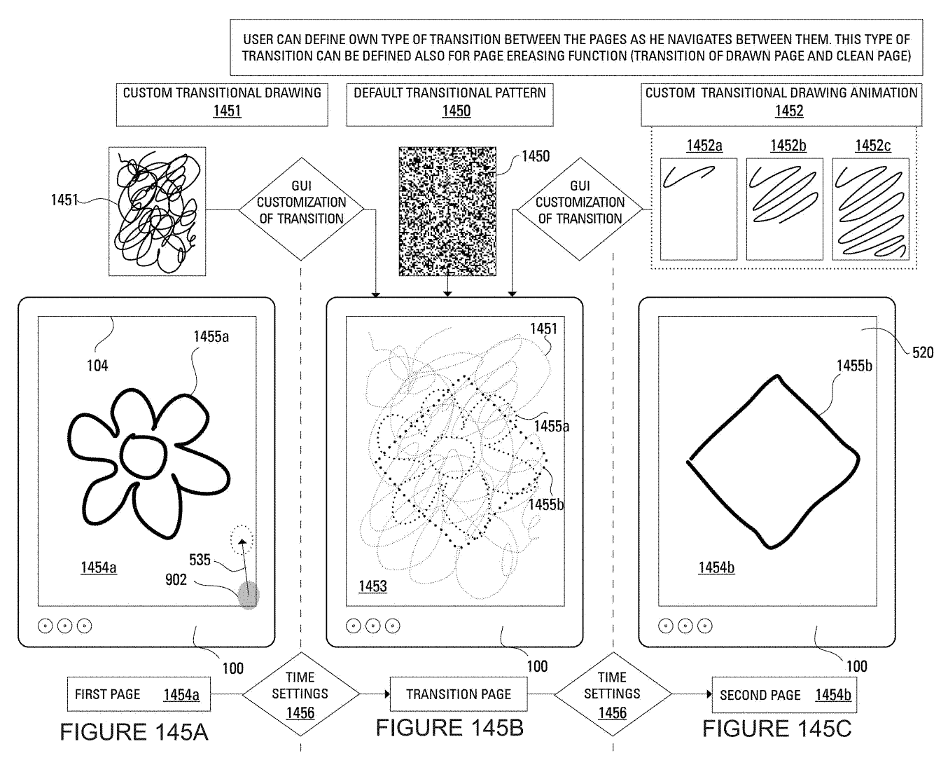

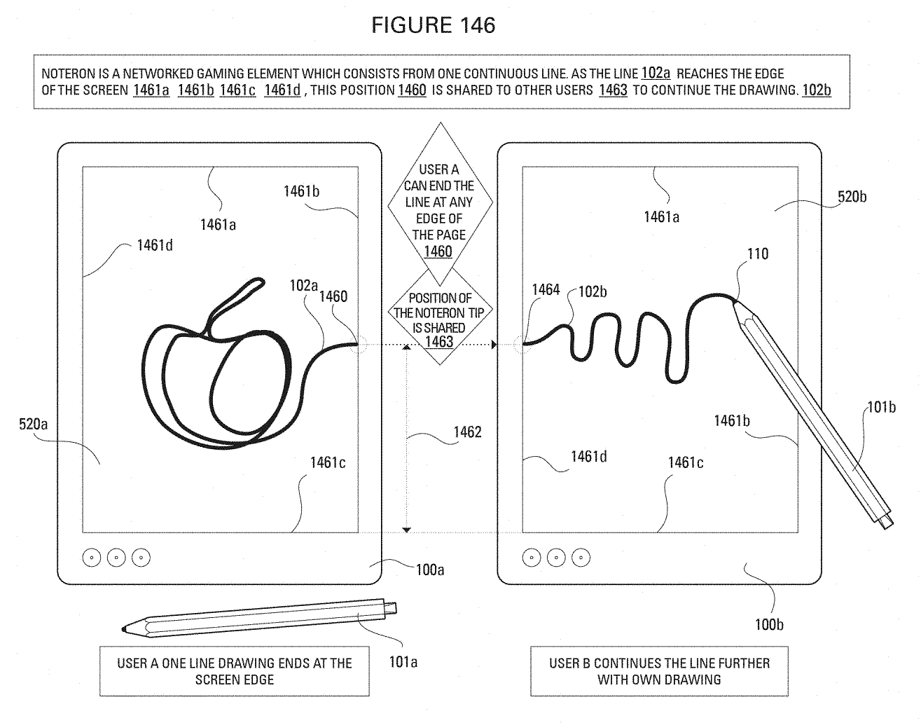

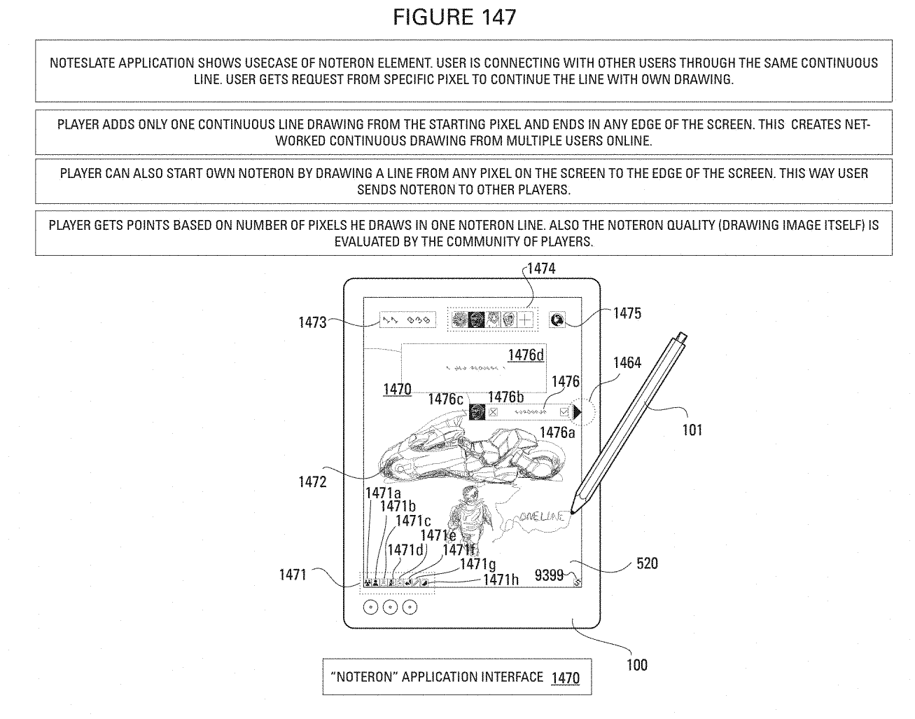

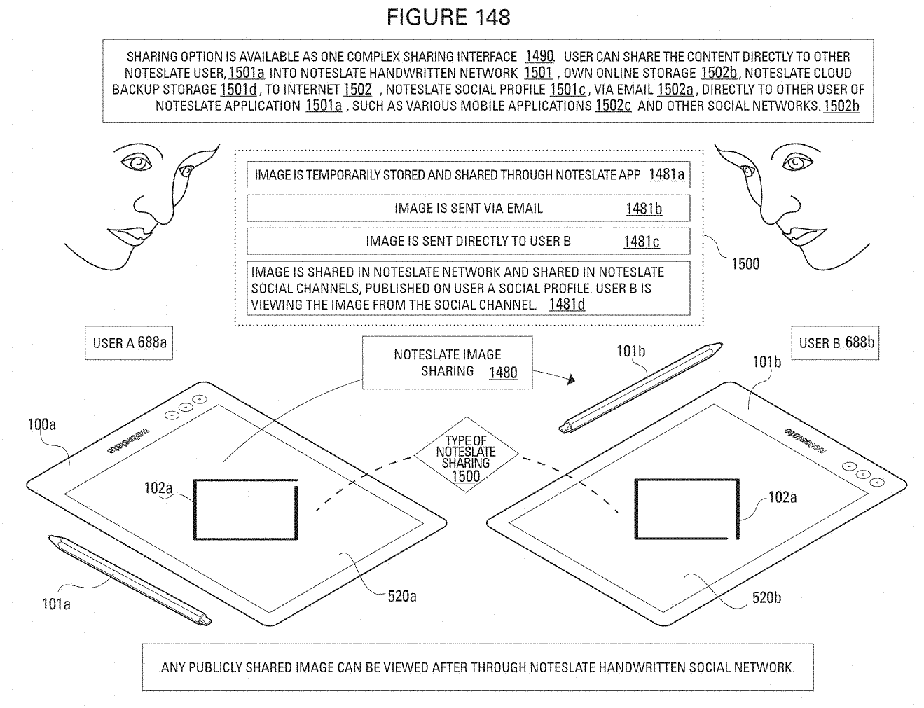

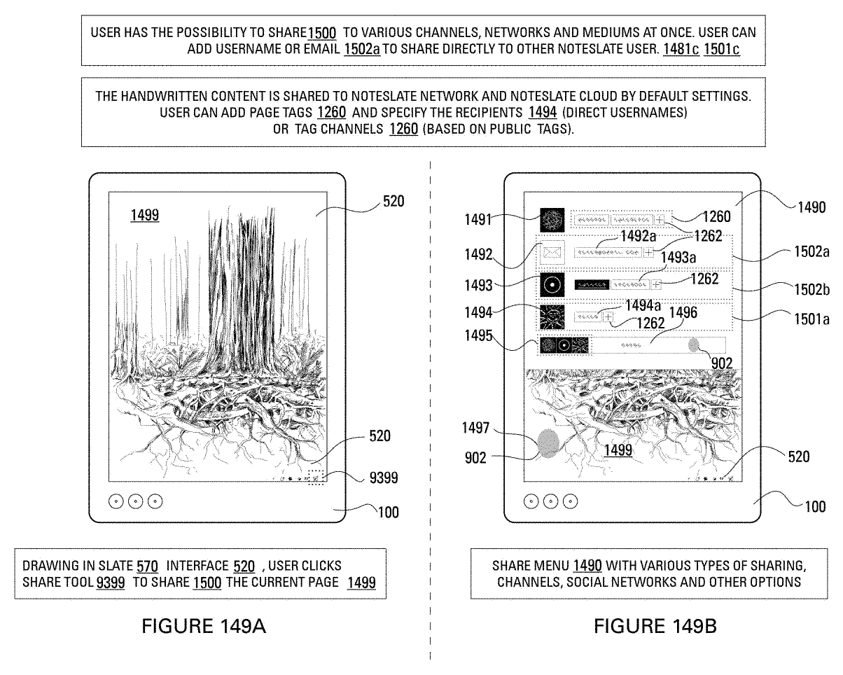

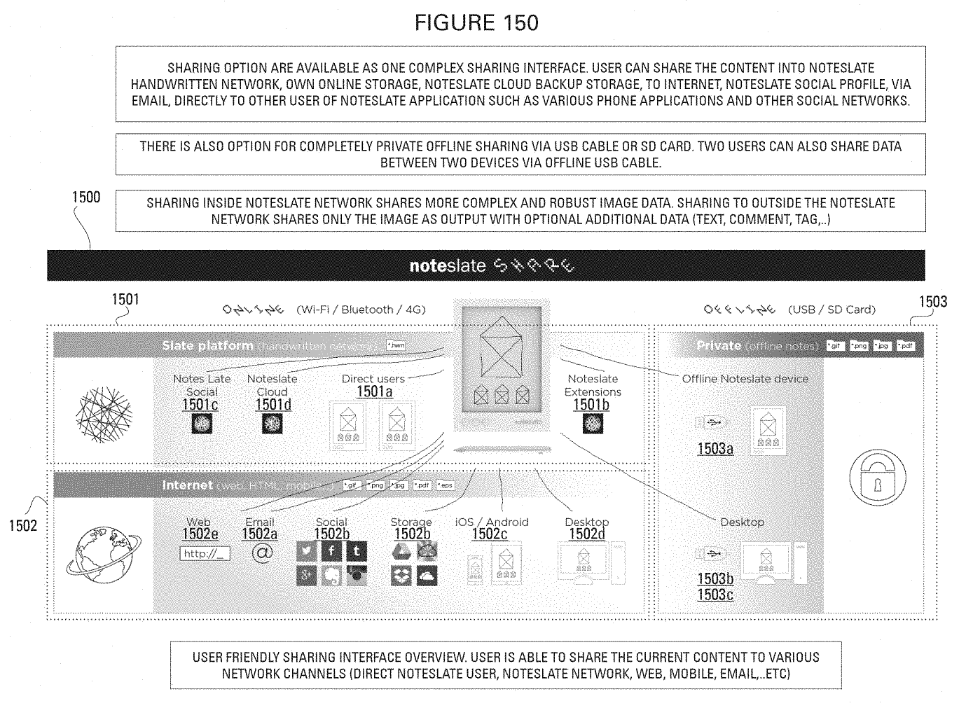

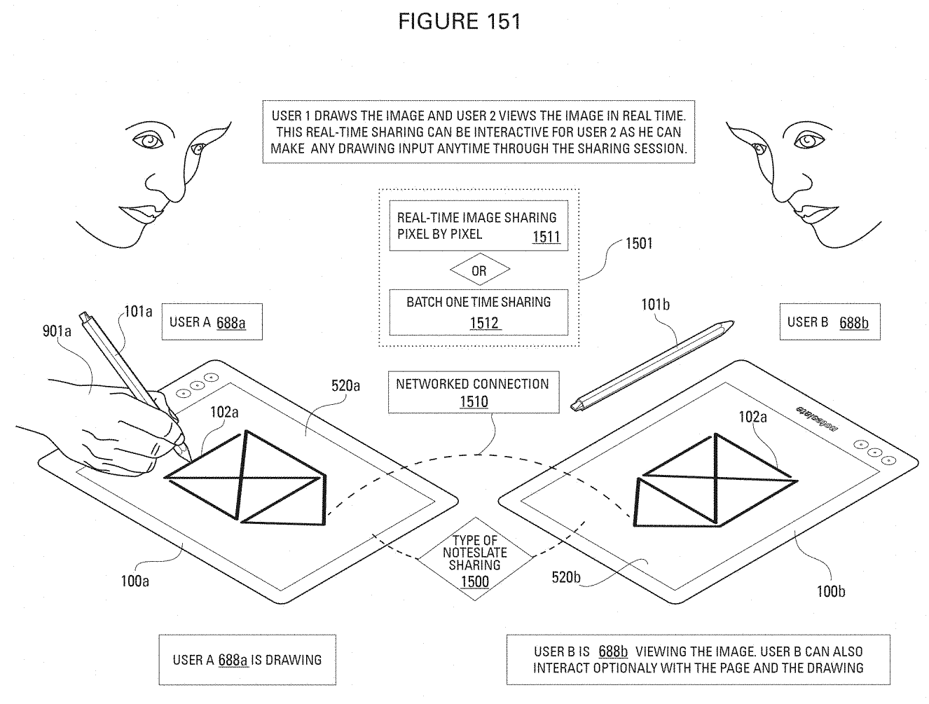

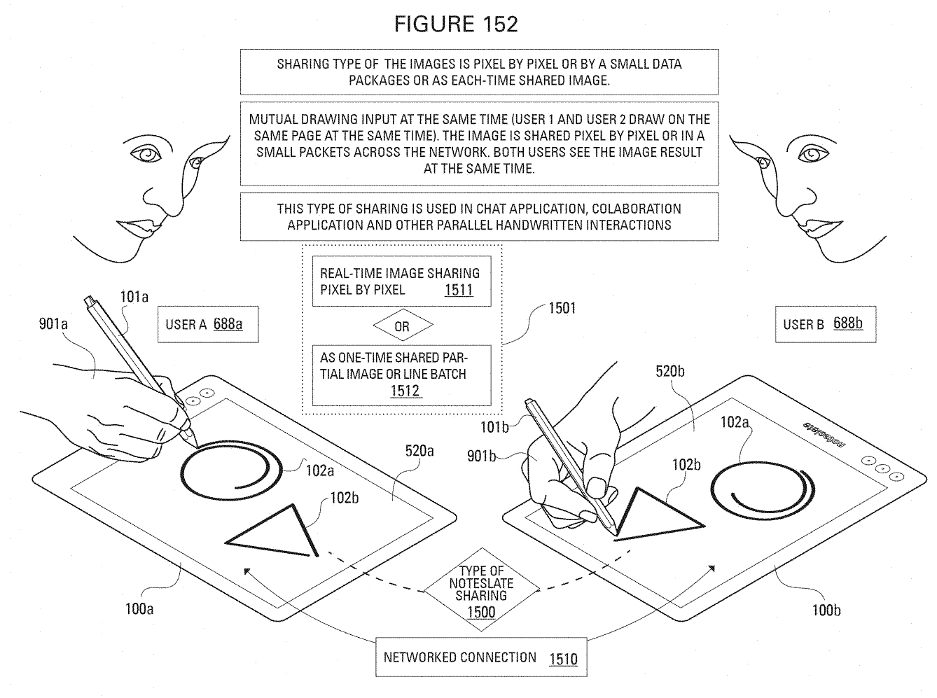

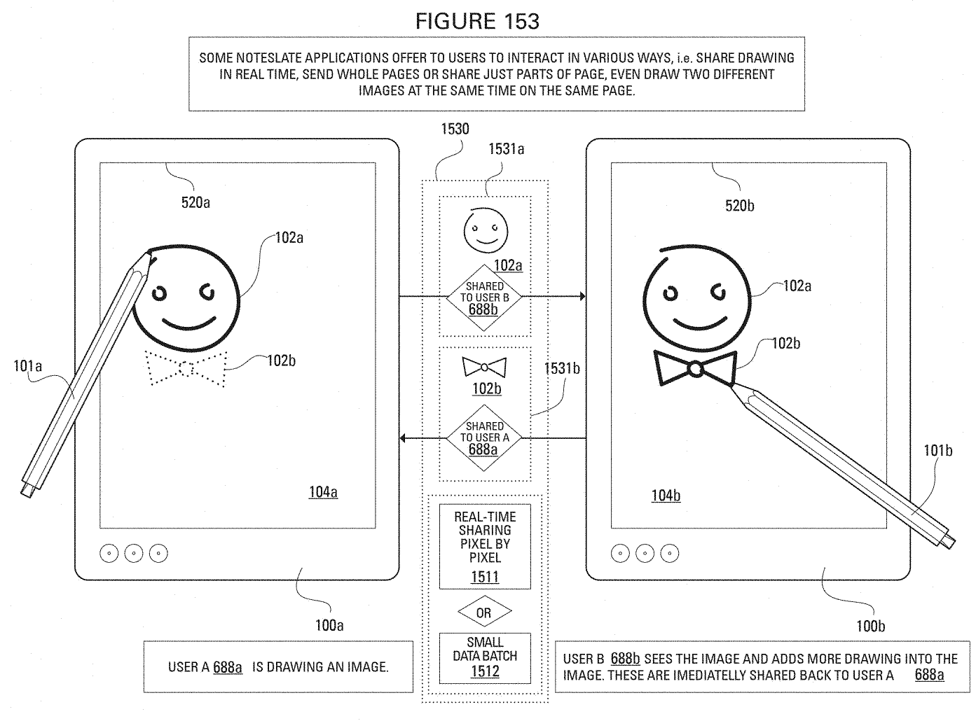

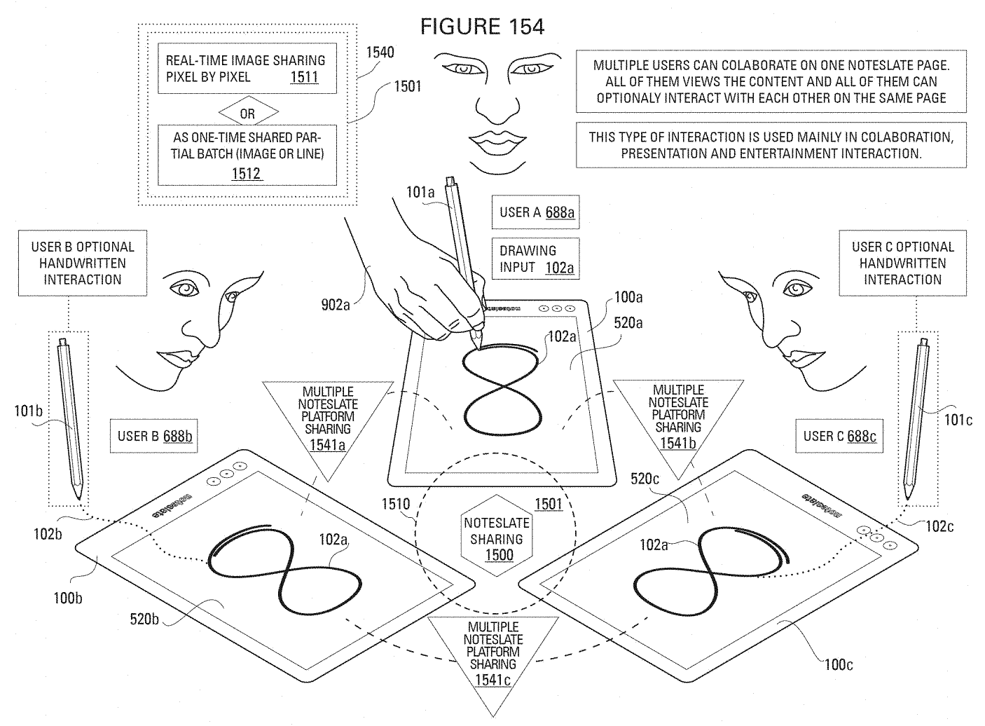

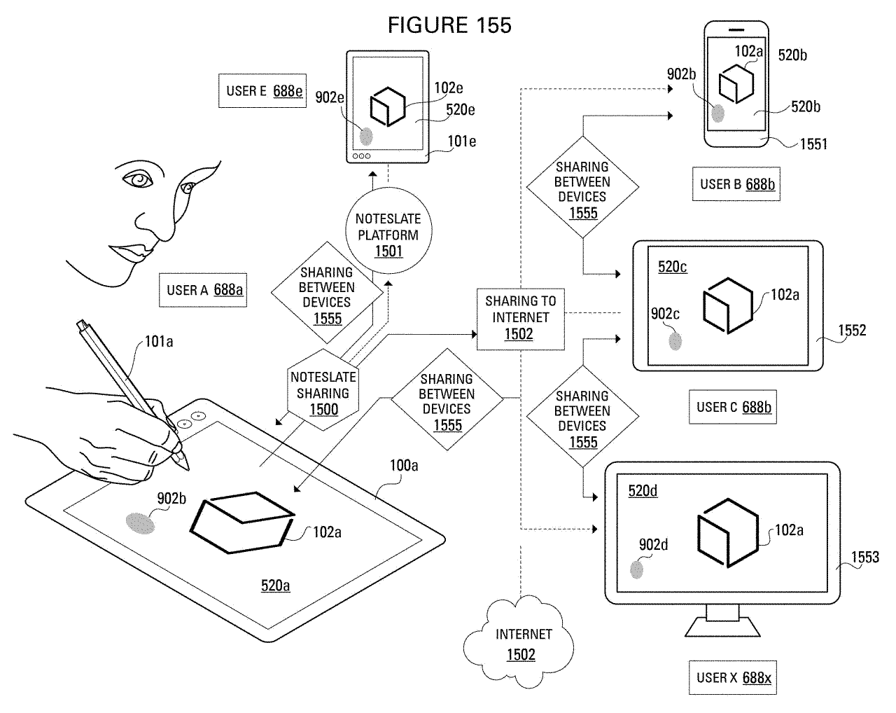

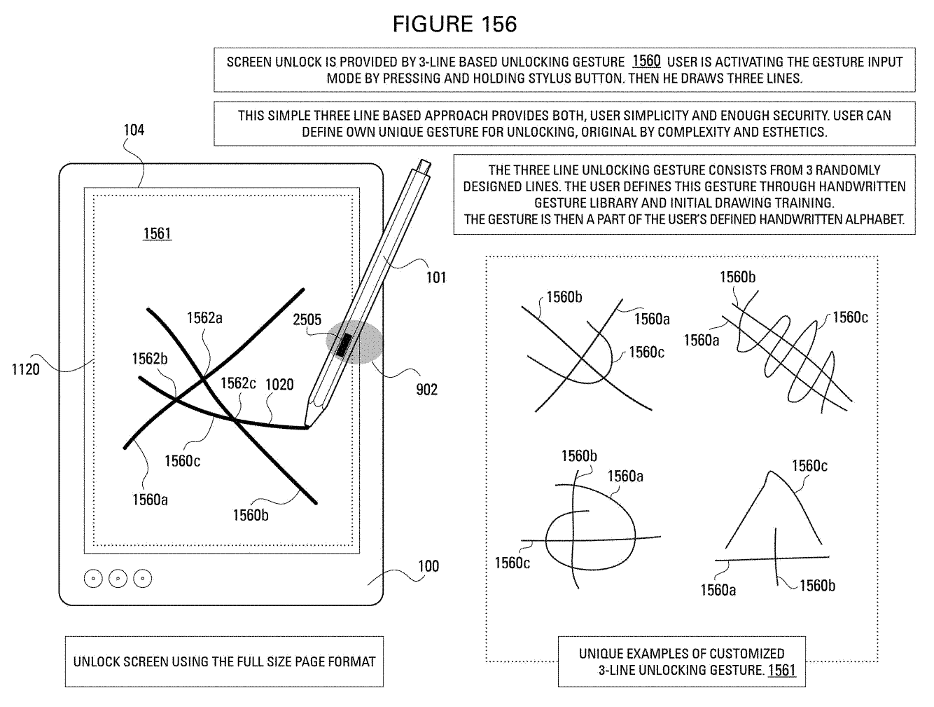

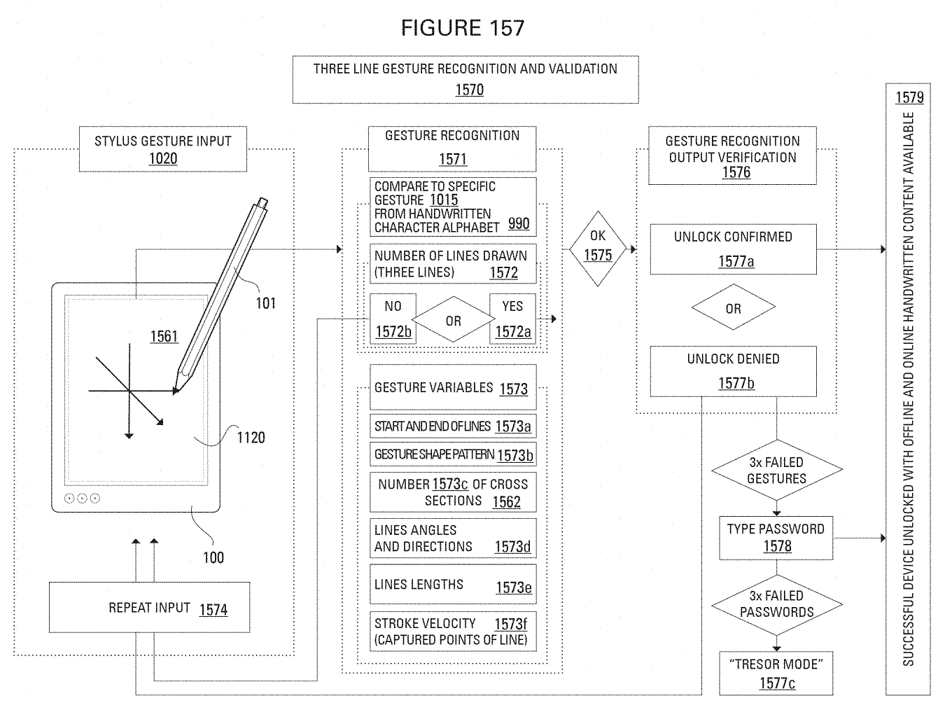

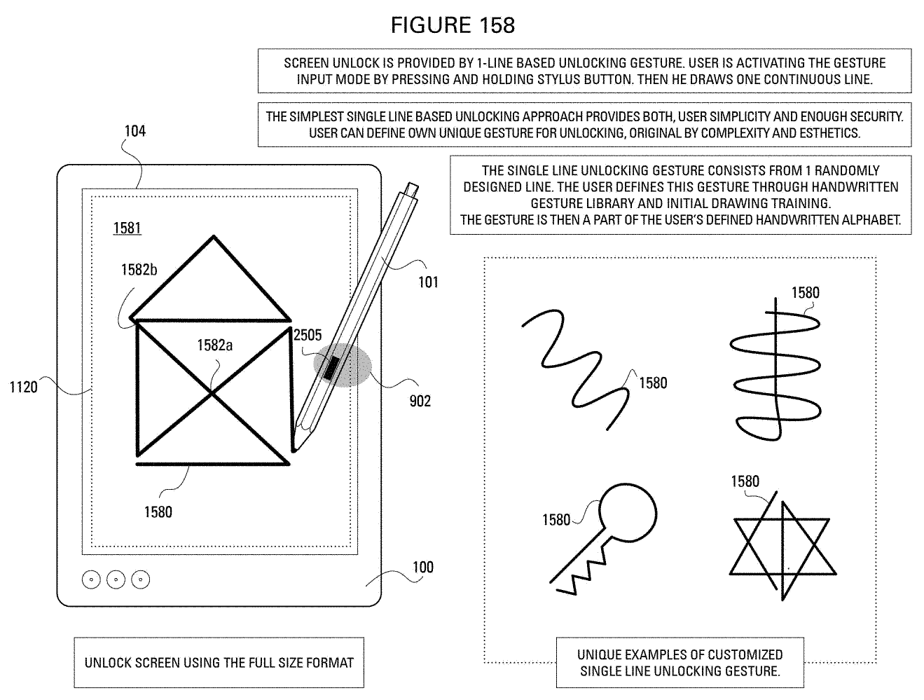

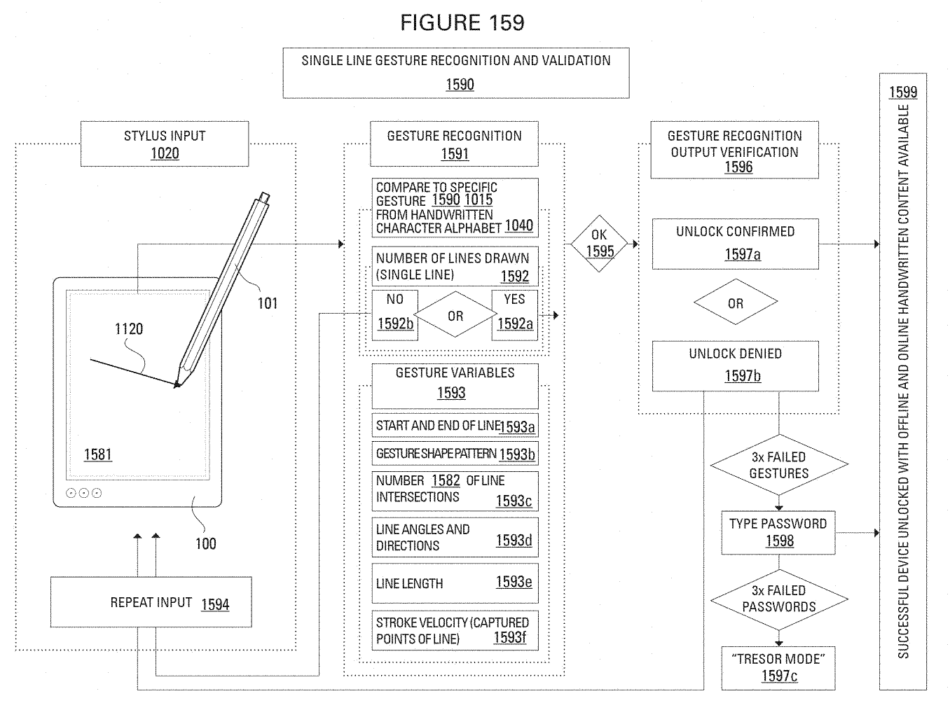

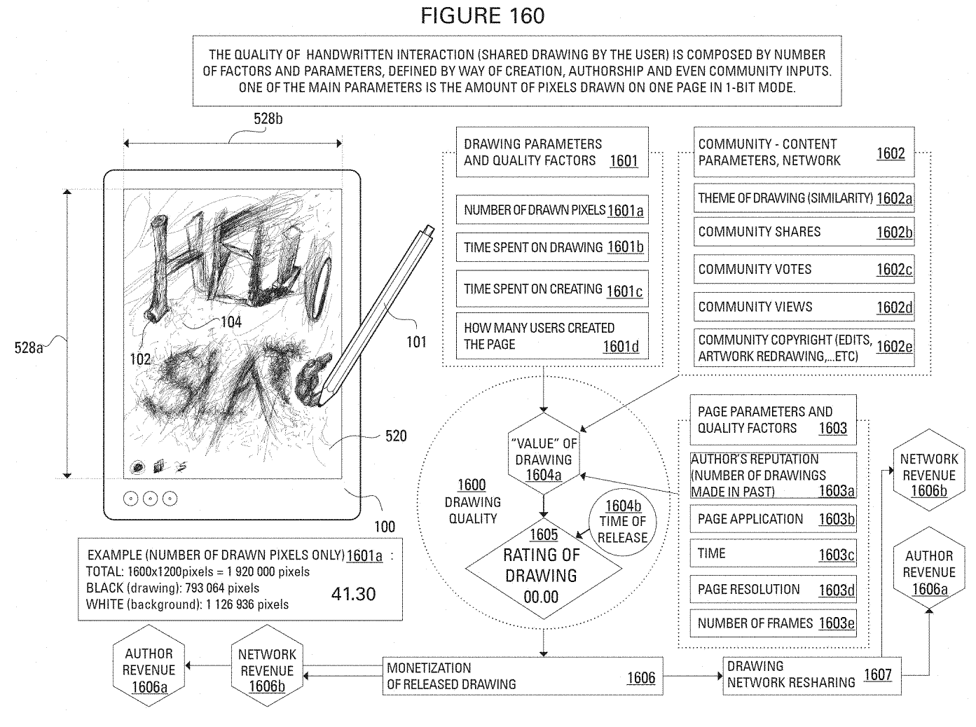

Further, the user redraws “IMPRINT” functional areas 770 across the interface 520 to achieve completely personal and unique Noteslate interface look. The hand redrawn interface elements “IMPRINTS” 777 (e.g. buttons, thumbnails, navigation, tools, etc.) are saved for future application interaction and navigation across interface.
801 Share switch button, more info at FIG. 20 and FIG. 21.
802 Power button.
803 Audio output jack 3.5 mm.
804 USB connector, USB Micro output and input.
805 Micro SD card reader (TF card).
806 Microphone slit.
810 Inner thumbnail “IMPRINT” with app page “MINIATURE”.
811 Finger touch selection of inner 8101 thumbnail “IMPRINT” area.
812 Finger touch selection of outer 8102 thumbnail “IMPRINT” area.
830 Multitouch tablet device default home screen, the tablet home screen interface customization and redrawing mode 800 can be activated by finger 902 pressing screen 5002 for 3s, user draws image across the whole screen to achieve new interface design, each functional
831 home screen element (icons) 832 are still functional even with changed design.
831 Multitouch tablet device home screen functional icon link.
832 Multitouch tablet device home screen icons.
840 Noteslate “CONTENT” page functional imprint thumbnail “J”.
841 Noteslate “CONTENT” page functional imprint thumbnail “K”.
842 Application page thumbnail “IMPRINT “J” functional area.
843 Application page thumbnail “IMPRINT “K” functional area.
844 By shifting them by finger touch, functional imprints automatically swaps their position.
870 Application page functional imprint area (e.g. “Shortnote”).
871 Application page functional imprint area (e.g. “Mindslate”).
872 Application page functional imprint area (e.g. “Warehouse”).
873 Application page functional imprint area (e.g. “Private block”).
874 Application page functional imprint thumbnail (e.g. “Inbox”).
875 Application page functional imprint thumbnail (e.g. “Shared”).
881a Page thumbnail imprint A customized design 01 (“Island”).
881b Page thumbnail imprint A customized design 02 (“Vase”).
882 Page thumbnail imprint A functional area (“Default”).
890 Default page thumbnail imprint functional grid area.
891 Functional “IMPRINT” (e.g. link to Noteslate network).
892 Functional “IMPRINT” custom design (“Compass”).
900 Specific “IMPRINT” function (link, interface action, shortcut, folder).
901 User's hand or finger for interaction.
902 User's hand finger touch point on the display 104.
950 “TOOLBAR” 9200 “TOOL” icon.
951 “TOOL” icon default design.
960 “TIMER BAR” interface element outline (frame and dimensions).
961 “TIMER BAR” value.
962 Time left from 100% time available on “TIMER BAR”.
963 Optional “TIMER BAR” settings, touch by finger and slide to adjust the “TIMER BAR” value.
964 Graphical icon attached to timer bar element.
965 “TIMER BAR” label (e.g. username, function name, time left).
966 Optional hover on detailed descriptor.
970 Default element outline for selection.
971 Graphical types of element selection.
971a “Default”element selection visual of interface element.
971b “Inverted” element selection visual of interface element.
971c “Outline” element selection visual of interface element.
972 “Selection outline” design added to element “Outline” element selection visual.
972a “Selection outline” design in right handed interface.
972b “Selection outline” design in left handed interface.
972c “Selection outline” design in right handed landscape interface.
972d “Selection outline” design in left handed landscape interface.
973 Interface element “LABEL” (e.g. username, page name).
973a “LABEL” element in right handed interface.
973b “LABEL” element in left handed interface.
973c “LABEL” element in right handed landscape interface.
973d “LABEL” element in left handed landscape interface.
974 Username “AVATAR” icon (used across Noteslate interface).
980 Interface example (“Anislate”) using timer bar elements and element selection, user adjust the playback speed of each frame to create accurate storyboard animatic.
990 Handwriting gesture input keyboard is the basic tool for handwritten gesture input and gesture library overview; user can edit and input additional gestures or change the regular QWERTY characters.
991 Text input area example using “Noteslate Regular font”.
1000 Digital text Unicode character output (from handwritten keyboard input).
1001 Each key from QWERTY keyboard has own space in the keyboard 990 layout.
1002 Each key from QWERTY keyboard has separate gesture input area 1002.
1002a Separate gesture input area for letter “A”.
1002b Separate gesture input area for letter “B”.
1002c Separate gesture input area for letter “C”.
1003 “Handwritten gesture character learning keyboard” layout divided into specific gesture areas.
1004 Handwritten template design for each character. User can define own handwritten template design.
1005 The upper edge of handwriting gesture keyboard can be augmented by additional characters or gestures.
1006a Left arrow key.
1006b Right arrow key.
1007 Shift key.
1008 Delete key.
1009 Ctrl key.
1010 Alt key.
1011 Enter key.
1012 Space bar key.
1012a Space bar key small.
1012b Space bar key middle.
1012c Space bar key large.
1013a Basic special characters key.
1013b Additional special characters key.
1014 Recognized gesture characters used for handwritten gesture training, similarity of these gestures defines the robustness of the gesture design.
1015 Handwritten gesture template based on previous training is used for precise gesture recognition and is improved further by user repeated drawing, use and gesture recognition training.
1015a Handwritten gesture template for letter “A”.
1015b Handwritten gesture template for letter “B”.
1015c Handwritten gesture template for letter “C”.
1020 The current handwritten gesture line input and current handwritten gesture character design used for gesture recognition.
1020a The current handwritten gesture line input for letter “A”.
1020b The current handwritten gesture line input for letter “B”.
1020c The current handwritten gesture line input for letter “C”.
1030 Customized example of handwriting gesture keyboard with various unique gesture design templates defined by user.
1031 The Noteslate interface area for handwritten gesture input.
1032 Recognized handwritten character gesture is translated to Unicode character and send further, recognized Unicode character is displayed as digital letter character output.
1033 User repeats specific handwritten gesture character (gesture training) to achieve better customized gesture recognition, this multiple training can rapidly improve the gesture recognition reliability.
1034 “Noteslate handwritten character gesture recognition engine” is provided by specific gesture recognition algorithms implemented into Noteslate interface, this software feature allows the user to use gestures across Noteslate interface.
1035a Gesture character design is specific gesture pattern design unique for specific gesture recognition, the pattern can be enhanced by multiple handwritten gesture training 1014.
1035b Gesture function is a Noteslate interface feature attached to specific gesture design, this function can be attached to any gesture or even various gestures.
1036 Handwritten gesture successful recognition verified output.
1040 Handwritten character alphabet contains all available gestures available in current unique Noteslate interface, some of the characters and gestures can be completely customized by user, some gestures that include previous training experience can be shared further by current user to other users, as standalone gestures or as complex handwritten character alphabet.
1040a Unique handwritten character alphabet of user A.
1040b Unique handwritten character alphabet of user B.
1041a Handwritten gesture characters used for imprint edits “e.g. “fill cheese”, “draw wooden brush”, etc).
1041b Handwritten gesture characters for QWERTY letters inputs.
1041c Handwritten gesture characters for additional ASCII input.
1041d Handwritten gesture characters for special or local input (e.g. local alphabet inputs, such as Japanese, Arabic, etc.).
1041e Handwritten gesture characters for application or interface shortcut interaction.
1041f Handwritten gesture characters for advanced drawing capabilities (e.g. insert “emoji”, “draw circle”, etc.).
1041g Handwritten gesture characters incl. special keyboard interaction (e.g. “upper letters”, “ctrl+V”, “copy image”, etc.).
1041h Unique user defined handwritten gesture characters for unique handwritten interaction (e.g., “application launch”, “sharing”, etc.).
1041i Customized handwritten gesture characters for special personal functionality (e.g. “unlocking gesture”, signature, etc.).
1041j Handwritten network 1501 1502 is a connected handwritten interaction in between various devices with Noteslate interface, users share handwritten content across Noteslate handwritten network, sharing content to other network or mobile platforms, communicate and use various Noteslate applications in Noteslate handwritten interface to create unique Noteslate networked content, attached to Noteslate handwritten network is Noteslate warehouse 1330 where users can share or even sell various handwritten assets (pages, drawings, handwritten content, icons, applications, gestures, imprints, alphabets, interface templates, .etc.).
1050 User shares directly to other user across Noteslate network 1501a (e.g. User A shares directly his own unique handwritten gesture character to User B).
1051. User A 688a shares directly data to other User B 688b.
1051a The shared handwritten content in between users is utilizing 128-bit security encryption.
1052.
1053 Besides sharing between users, user A can also share own handwritten assets (gestures, icons, interface templates,).
1054 Handwritten assets available for download through Noteslate warehouse 1330 to all Noteslate users.
1055 Noteslate handwritten character library contains various alphabets from various users, who uploaded and share own handwritten alphabets 1040 to Noteslate warehouse.
1055a
1055b.
1055c.
1070 The default handwritten keyboard layout can be extended for additional customized user's defined handwritten characters.
1071 User can add new own handwritten gesture characters to be used across Noteslate interface, these new handwritten gestures appear in handwritten keyboard layout.
1072a Handwritten gesture 1 designed by user added to keyboard.
1072b Handwritten gesture 2 designed by user added to keyboard.
1072c Handwritten gesture 3 designed by user added to keyboard.
1074 Handwritten gesture input area for unique gesture design 1020.
1075 Training area for multiple handwritten gesture input training.
1076 When user adds the new gesture (with appropriate training) to keyboard, the gesture function and design is saved into user's custom handwritten alphabet 1040.
1077 Interface action for each handwritten gesture design 1035a with specific function 1035b across Noteslate interface 520 (e.g. “UNDO”, “SHARE”, etc.).
1078 User has a freedom to define own handwritten gesture design and attach custom functionality across Noteslate interface, then progress through gesture training for better recognition.
1079 Additional gestures displayed in handwritten keyboard.
1080a Handwritten gesture “A” custom design 1015 by user.
1080b Handwritten gesture “B” custom design 1015 by user.
1080c Handwritten gesture “C” custom design 1015 by user.
1085a Unique custom design of handwritten gesture “A” with recognition training.
1085b Unique custom design of handwritten gesture “B” with recognition training.
1085c Unique custom design of handwritten gesture “C” with recognition training.
1099a Example of custom handwritten gesture character “SAVE”.
1099b Example of custom handwritten gesture character “TAG”.
1099c Example of custom handwritten gesture character “CHAT”.
1099d Example of custom handwritten gesture character “UNDO”.
1099e Example of custom handwritten gesture character “CLOUD”.
1099f Example of custom handwritten gesture character “CONNECT”.
1099g Example of custom handwritten gesture character “LINK”.
1099h Example of custom handwritten gesture character “EMOJI”.
1099i Example of custom handwritten gesture character “ADD”.
1091a Example of custom handwritten gesture character “1”.
1091b Example of custom handwritten gesture character “2”.
1091c Example of custom handwritten gesture character “3”.
1091d Example of custom handwritten gesture character “4”.
1091e Example of custom handwritten gesture character “5”.
1091f Example of custom handwritten gesture character “6”.
1091g Example of custom handwritten gesture character “7”.
1091h Example of custom handwritten gesture character “8”.
1091i Example of custom handwritten gesture character “9”.
1091j Example of custom handwritten gesture character “0”.
1090a Keyboard example of handwritten gesture character “A”.
1090b Keyboard example of handwritten gesture character “B”.
1090c Keyboard example of handwritten gesture character “C”.
1090d Keyboard example of handwritten gesture character “D”.
1090e Keyboard example of handwritten gesture character “E”.
1090f Keyboard example of handwritten gesture character “F”.
1090g Keyboard example of handwritten gesture character “G”.
1090h Keyboard example of handwritten gesture character “H”.
1090i Keyboard example of handwritten gesture character “I”.
1090j Keyboard example of handwritten gesture character “J”.
1090k Keyboard example of handwritten gesture character “K”.
1090l Keyboard example of handwritten gesture character “L”.
1090m Keyboard example of handwritten gesture character “M”.
1090n Keyboard example of handwritten gesture character “N”.
1090o Keyboard example of handwritten gesture character “0”.
1090p Keyboard example of handwritten gesture character “P”.
1090q Keyboard example of handwritten gesture character “Q”.
1090r Keyboard example of handwritten gesture character “R”.
1090s Keyboard example of handwritten gesture character “S”.
1090t Keyboard example of handwritten gesture character “T”.
1090u Keyboard example of handwritten gesture character “U”.
1090v Keyboard example of handwritten gesture character “V”.
1090w Keyboard example of handwritten gesture character “W”.
1090x Keyboard example of handwritten gesture character “X”.
1090y Keyboard example of handwritten gesture character “Y”.
1090z Keyboard example of handwritten gesture character “Z”.
1092a Example of handwritten gesture character “LEFT ARROW”.
1092b Example of handwritten gesture character “RIGHT ARROW”.
1093 Example of handwritten gesture character “UPPER CASE”.
1094 Example of handwritten gesture character “SPECIAL 2”.
1095 Example of handwritten gesture character “SPECIAL 1”.
1096 Example of handwritten gesture character “DELETE”/“CANCEL”.
1097 Area for handwritten gesture character “SPACEBAR”.
1097a Example of handwritten gesture character “SPACE BAR 1”.
1097b Example of handwritten gesture character “SPACE BAR 2”.
1097c Example of handwritten gesture character “SPACE BAR 3”.
1098 Example of handwritten gesture character “OK”/“ENTER”.
1111 Examples of various custom handwritten gestures.
1111a Example of handwritten gesture character “NEW PAGE”.
1111b Example of handwritten gesture character “SAVE PAGE”.
1111c Example of handwritten gesture character “ADD TAGS”.
1111d Example of handwritten gesture character “CHAT”.
1111e Example of handwritten gesture character “NOTERON”.
1111f Example of handwritten gesture character “UNDO”.
1111g Example of handwritten gesture character “INVERT”.
1111h Example of handwritten gesture character “SEND EMOJI”.
1111i Example of handwritten gesture character “EDIT IMPRINTS”.
1111j Example of handwritten gesture character “PRIVATE”.
1111k Example of handwritten gesture character “CLOSE”/“CONTENT”.
1111l Example of handwritten gesture character “OK”/“ENTER”/“CONFIRM”.
1111m Example of handwritten gesture character “UNDO”.
1111n Example of handwritten gesture character “CLOUD STORAGE”.
1111o Example of handwritten gesture character “INSERT CHART”.
1111p Example of handwritten gesture character “DELETE”/“CANCEL”.
1120 Illustration of handwritten gesture character input interface activation, the frame shows the interactive input area for gesture input, one option to activate the gesture input area 1120 is by clicking and holding 1129 902 the programmable stylus button 2505 and draw the gesture input line 1020, second option for input 1120 is to use gesture tool available in drawing toolbar 9200.
1121 This is the start of gesture input line 1020, this point can also define features available for each gesture (e.g. placement of inserted handwritten content).
1122 Other option to activate the gesture input interface 1120 is to touch gesture tool 1122 in drawing toolbar 9200.
1129 User touches and holds the programmable stylus button 2505 to activate the handwritten gesture input interface 1120.
1130a Handwritten gesture character “TRIANGLE” design 1015.
1130b Handwritten gesture character “SQUARE” design 1015.
1130c Handwritten gesture character “CHART” design 1015.
1130d Handwritten gesture character “LINK” design 1015.
1130e Handwritten gesture character “EMOJI” design 1015.
1130f Handwritten gesture character “CHAT” design 1015.
1131a Handwritten gesture character “TRIANGLE” example 1020.
1131b Handwritten gesture character “SQUARE” example 1020.
1131c Handwritten gesture character “CHART” example 1020.
1131d Handwritten gesture character “LINK” example 1020.
1131e Handwritten gesture character “EMOJI” example 1020.
1131f Handwritten gesture character “CHAT” example 1020.
1132a Various designs of “TRIANGLE” handwritten gesture input 1015.
1132b Various designs of “SQUARE” handwritten gesture input 1015.
1132c Various designs of “CHART” handwritten gesture input 1015.
1132d Various designs of “LINK” handwritten gesture input 1015.
1132e Various designs of “EMOJI” handwritten gesture input 1015.
1132f Various designs of “CHAT” handwritten gesture input 1015.
1133 This illustration is showing various alternative designs of handwritten gesture inputs 1020.
1134a Handwritten gesture input “TRIANGLE” use case example “ADD TAG”/“ADD HASHTAG”/“ADD PROPERTIES”/“ADD FEATURE”/“BOOKMARK”.
1134b Handwritten gesture input “SQUARE” use case example “NEW PAGE”/“NEW IMPRINT”/“EDIT IMPRINTS”.
1134c Handwritten gesture input “CHART” use case example “DRAW CHART ELEMENT”/“INSERT CHART”.
1134d Handwritten gesture input “LINK” use case example “ADD HYPERLINK”/“ATTACH LINKED CONTENT”.
1134e Handwritten gesture input “EMOJI” use case example “INSERT MY EMOJI DRAWING”/“CHOOSE EMOJI”.
1134f Handwritten gesture input “CHAT” use case example “LAUNCH CHAT APP”/“OPEN CHAT SESSION”.
1140a Handwritten gesture character “HEART” design 1015.
1140b Handwritten gesture character “FIGURINE” design 1015.
1140c Handwritten gesture character “PLAY” design 1015.
1140d Handwritten gesture character “CLOUD” design 1015.
1140e Handwritten gesture character “PLANE” design 1015.
1140f Handwritten gesture character “BOW” design 1015.
1141a Handwritten gesture character “HEART” example 1020.
1141b Handwritten gesture character “FIGURINE” example 1020.
1141c Handwritten gesture character “PLAY” example 1020.
1141d Handwritten gesture character “CLOUD” example 1020.
1141e Handwritten gesture character “PLANE” example 1020.
1141f Handwritten gesture character “BOW” example 1020.
1142a Various designs of “HEART” handwritten gesture input 1015.
1142b Various designs of “FIGURINE” handwritten gesture input 1015.
1142c Various designs of PLAY” handwritten gesture input 1015.
1142d Various designs of “CLOUD” handwritten gesture input 1015.
1142e Various designs of “PLANE” handwritten gesture input 1015.
1142f Various designs of “BOW” handwritten gesture input 1015.
1144a Handwritten gesture input “HEART” use case example “LOVE PAGE”/“LIKE CONTENT”/“FAVORITE”.
1144b Handwritten gesture input “FIGURINE” use case example “ADD USER”/“ADD PLAYER”/“SEE USERS”.
1144c Handwritten gesture input “PLAY” use case example “PLAY ANIMATION”/“PLAY MUSIC”/“START PREVIEW”.
1144d Handwritten gesture input “CLOUD” use case example “GO TO CLOUD STORAGE”/“Noteslate PROFILE”.
1144e Handwritten gesture input “PLANE” use case example “SHARE PAGE”/“SEND DRAWING”.
1144f Handwritten gesture input “BOW” use case example “INSERT SIGNATURE”.
1150a Handwritten gesture character “ARROW” design 1015.
1150b Handwritten gesture character “BUTTON” design 1015.
1150c Handwritten gesture character “SHARE” design 1015.
1150d Handwritten gesture character “PLUS” design 1015.
1150e Handwritten gesture character “CONNECT” design 1015.
1150f Handwritten gesture character “LOCK” design 1015.
1151a Handwritten gesture character “ARROW” example 1020.
1151b Handwritten gesture character “BUTTON” example 1020.
1151c Handwritten gesture character “SHARE” example 1020.
1151d Handwritten gesture character “PLUS” example 1020.
1151e Handwritten gesture character “CONNECT” example 1020.
1151f Handwritten gesture character “LOCK” example 1020.
1152a Various designs of “ARROW” handwritten gesture input 1015.
1152b Various designs of “BUTTON” handwritten gesture input 1015.
1152c Various designs of “SHARE” handwritten gesture input 1015.
1152d Various designs of “PLUS” handwritten gesture input 1015.
1152e Various designs of “CONNECT” handwritten gesture input 1015.
1152f Various designs of “LOCK” handwritten gesture input 1015.
1154a Handwritten gesture input “ARROW” use case example “GO TO”/“UPLOAD”.
1154b Handwritten gesture input “BUTTON” use case example “TURN OFF”/“CLOSE”.
1154c Handwritten gesture input “SHARE” use case example “GO TO SLATE”/“Noteslate SOCIAL”/“SHARE”.
1154d Handwritten gesture input “PLUS” use case example “ZOOM IN”/“ADD FEATURE”/“ADD TOOL”/“ADD BRUSH”.
1154e Handwritten gesture input “CONNECT” use case example “CONNECT TO”/“ADD USER”/“SHARE WITH”.
1154f Handwritten gesture input “LOCK” use case example “LOCK DEVICE”/“STAND BY MODE”.
1160a Handwritten gesture character “DUO” design 1015.
1160b Handwritten gesture character “TRIO” design 1015.
1160c Handwritten gesture character “QUATRO” design 1015.
1160d Handwritten gesture character “DNA” design 1015.
1160e Handwritten gesture character “BULB” design 1015.
1160f Handwritten gesture character “APPLE” design 1015.
1161a Handwritten gesture character “DUO” example input 1020.
1161b Handwritten gesture character “TRIO” example 1020.
1161c Handwritten gesture character “QUATRO” example 1020.
1161d Handwritten gesture character “DNA” example 1020.
1161e Handwritten gesture character “BULB” example 1020.
1161f Handwritten gesture character “APPLE” example 1020.
1162a Various designs of “DUO” handwritten gesture input 1015.
1162b Various designs of “TRIO” handwritten gesture input 1015.
1162c Various designs of “QUATRO” handwritten gesture input 1015.
1162d Various designs of “DNA” handwritten gesture input 1015.
1162e Various designs of “BULB” handwritten gesture input 1015.
1162f Various designs of “APPLE” handwritten gesture input 1015.
1164a Handwritten gesture input “DUO” use case example “CONNECT”/“ADD HYPERLINK”/“HYPERLINK”.
1164b Handwritten gesture input “TRIO” use case example “MULTIPLAYER MODE”/“ADD USER TO SESSION”.
1164c Handwritten gesture input “QUATRO” use case example “ADD HASHTAG”/“MARK SPECIAL”/“SEND LUCK”.
1164d Handwritten gesture input “DNA” use case example “PERSONAL LINK”/“LAUNCH PRIVATE CHANNEL”.
1164e Handwritten gesture input “BULB” use case example “NEW PAGE”/“NEW PAGES FOLDER”.
1164f Handwritten gesture input “APPLE” use case example “MONETIZE”/“SHARE OUTSIDE Noteslate”.
1170a Handwritten gesture character “HASHTAG” design 1015.
1170b Handwritten gesture character “STAR” design 1015.
1170c Handwritten gesture character “HOUSE” design 1015.
1170d Handwritten gesture character “KEY” design 1015.
1170e Handwritten gesture character “CHECK” design 1015.
1170f Handwritten gesture character “CANCEL” design 1015.
1171a Handwritten gesture character “HASHTAG” example 1020.
1171b Handwritten gesture character “STAR” example 1020.
1171c Handwritten gesture character “HOUSE” example 1020.
1171d Handwritten gesture character “KEY” example 1020.
1171e Handwritten gesture character “CHECK” example 1020.
1171f Handwritten gesture character “CANCEL” example 1020.
1172a Various designs of “HASHTAG” handwritten gesture input 1015.
1172b Various designs of “STAR” handwritten gesture input 1015.
1172c Various designs of “HOUSE” handwritten gesture input 1015.
1172d Various designs of “KEY” handwritten gesture input 1015.
1172e Various designs of “CHECK” handwritten gesture input 1015.
1172f Various designs of “CANCEL” handwritten gesture input 1015.
1174a Handwritten gesture input “HASHTAG” use case example “ADD HASHTAG”/“ADD FEATURES”/“ADD TOOLS”.
1174b Handwritten gesture input “STAR” use case example “ADD SIGNATURE”/“MY PAGES”/“MARK PAGE”.
1174c Handwritten gesture input “HOUSE” use case example “GO TO HOMEPAGE”/“GO TO CONTENT”/“HOME”.
1174d Handwritten gesture input “KEY” use case example “UNLOCK”/“LOCK”/“LAUNCH PRIVATE CHAT”.
1174e Handwritten gesture input “CHECK” use case example “CONFIRM”/“ENTER”/“OK”.
1174f Handwritten gesture input “CANCEL” use case example “DELETE DRAWING”/“CLEAR PAGE”/“CANCEL”.
1180 Gesture recognition engine 1034 recognition algorithm of custom designed handwritten gesture character 1020 based on multiple gesture input 1015 and training 1014.
1181 Aspects and parameters 1081a 1081b 1081c 1081d 1081e 1081f 1081g of unique custom designed handwritten gesture character based on multiple gesture input 1015 and training 1014 with interface function 1077.
1081a Handwritten gesture recognition engine 1034 recognize starting and ending position of gesture input lines 1020.
1081b Handwritten gesture recognition engine 1034 recognize shape image pattern of gesture input lines 1020.
1081c Handwritten gesture recognition engine 1034 recognize number of cross sections of gesture input lines 1020.
1081d Handwritten gesture recognition engine 1034 recognize number of drawn lines of gesture input design 1020.
1081e Handwritten gesture recognition engine 1034 recognize angles and directions of gesture input lines 1020.
1081f Handwritten gesture recognition engine 1034 recognize length of gesture input lines 1020.
1081g Handwritten gesture recognition engine 1034 recognize velocity of user's gesture input lines 1020 by capturing drawn line points 1285a 1285b 1285c.
1182a Gesture function 1077 is available in current interface, gesture design 1015 recognition is confirmed and gesture function is launched.
1182b Gesture design 1015 and gesture input 1020 is not recognized.
1190 Unique handwritten gesture character design 1015 designed by user A 688a, including specific gesture design 1015 and attached gesture function 1077, and previous recognition algorithm training 1014, this complex gesture asset 1192 can be shared and monetized by the creator through Noteslate handwritten network 1501—Noteslate warehouse 1330 and offered to use by other users.
1191 The customized handwritten gesture 1015 is publicly shared 1191 in Noteslate warehouse 1330 and is available for implementation by other users.
1192 Each handwritten gesture asset 1192 consists from specific gesture input design 1020, gesture recognition training 1014 and attached interface function 1077.
1193 This is describing distribution of various handwritten assets (gestures 1055, icons 1015, and templates 1015, etc.) from Noteslate warehouse 1330 to other users 688b, 688a, 1015, each user can download for free or buy any asset from Noteslate warehouse 1330, each asset is then installed and implemented into their Noteslate interface 520.
1194 Revenue principles for asset sales and distribution, monetization is describing revenue streams, which are shared proportionally in between the creator 688—user who created the asset (gesture 1015, content template, etc.) and Noteslate warehouse 1015 as the distribution provider.
1195 This is example of unique gesture character 1195 including all the aspects of robust gesture asset 1192.
1200 Handwritten gesture character 1015 “EMOJI” 1130e is used here for inserting specific emoji drawing, which can be used by default as personal emoji across Noteslate interface and various apps, the inserted drawing itself 1201 is created, defined, selected and tagged by user as default emoji drawing.
1201 The inserted personal “emoji” drawing defined and tagged by user.
1202 The personal “emoji” drawing 1201 is inserted into interface 520.
1210 Handwritten gesture character 1015 “TABLE” 1210 is used here for inserting specific interactive drawing of table 1211, user can edit table properties 1213 such as number of rows, columns, etc.).
1211 The interactive table drawing object, simple drawing template can be enhanced with additional interactive elements (e.g. addition, subtraction, etc.).
1212 The inserted table 1211 into interface 520.
1213 Table properties such as number of rows, columns, etc.
1220 Handwritten gesture character 1015 “CHART” 1130c is used here for inserting specific interactive application drawing 1221 (e.g. functional chart).
1221 Interactive application layout with startup values, own properties and own drawing toolbar 9200.
1222 The inserted application layout 1221 for inserting into interface 520.
1230 Handwritten gesture character 1015 “AT” 1230 is used here to insert hyperlink address element 1231 into current drawing page interface 520.
1231 Hyperlink element with additional handwritten keyboard 990 to edit the text input 1032.
1232 The inserted hyperlink element 1232 into interface 520.
1240 Handwritten gesture character 1015 “LINK” 1130d is used here to link two drawing elements 1241a 1241b together.
1241a “Element A” is a specific visual element inside drawing interface 520 (e.g. it can be drawing, drawing area, icon, imprint area, page thumbnail, inserted image, page folder, animation, etc.).
1241b This is functional feature of visual “Element A” 1241a is a specific visual inside drawing interface 520 (e.g. it can hyperlink element, handwritten gesture element 1015, functional brush element 1350, brush pattern 1390, interface action 1077, link to network, page tag 520, page thumbnail 700, etc.
1242a “Element B” is a specific visual element inside drawing interface 520 (e.g. it can be drawing, drawing area, icon, imprint area, page thumbnail, inserted image, page folder, animation, etc.).
1242b This is functional feature of visual “Element B” 1242a is a specific visual inside drawing interface 520 (e.g. it can hyperlink element, handwritten gesture element 1015, functional brush element 1350, brush pattern 1390, interface action 1077, link to network, page tag 520, page thumbnail 700, etc.
1243 The beginning of “LINK” gesture 1130d defines the link to element A 1241a.
1250 Example of element A 1241a in the drawing interface.
1251 Adapted toolbar 9200 for “HYPERSLATE” application with additional tools 1253.
1252 Link gesture tool.
1253 “HYPERSLATE” interactive drawing interface with web and JavaScript implementation.
1254 Other additional tools for “HYPERSLATE” application, incl. tools.
1255a add comment.
1255b add web address element.
1255c favorite.
1255d real-time switch.
1255e change web visibility.
1255f change language.
1255g insert image from web address.
1255h choose element.
1255i refresh screen.
1255j hashtag.
1260 “PAGE TAG” menu for current page with current page tags displayed; activated by corner finger touch 531.
1261a Current “PAGE TAG” A.
1261b Current “PAGE TAG” B.
1262a Add more tags button.
1262b Add more tags button clicked and selected.
1270 Basic sharing icon and “SHARE TOOL” 9399 design.
1271 Alternative sharing icon and Share tool 9399 design.
1272a Optional “SHARE TOOL” 9399 design.
1272b Optional “SHARE TOOL” 9399 design.
1272c Optional “SHARE TOOL” 9399 design.
1272d Optional “SHARE TOOL” 9399 design.
1272e Optional “SHARE TOOL” 9399 design.
1272f Optional “SHARE TOOL” 9399 design.
1272g Optional “SHARE TOOL” 9399 design.
1272h Optional “SHARE TOOL” 9399 design.
1280 “MISSILE” line extended based by previous drawn line 102 with few last points 1285a 1285b 1285c, the “MISSILE” curvature is extension of the curvature of these 3 points.
1281 Last point of drawn line 102 intersection with limit line 1284.
1282 Imaginary extension of drawn line 102 behind the limit line 1284.
1283 Interface element showing the level of limit drawing line 1284, it is defining the area, behind which the user can't draw the “MISSILE” line, behind (from the start of the line 102) the line is extended based on last registered line 102 points 1285a 1285b 1285c, the “MISSILE” curvature is extension of the curvature of these 3 points.
1284 Virtually splitting line based on position of limit drawing line 1283, value and distance of this limit line 1284 from the starting point of drawing line 1287 defines the level of difficulty in game (e.g. user starts to draw the line and the limiting line is near, this means the user needs to be very precise in drawing to define the precise line extension—“MISSILE” 1280 curvature across the screen and behind the limiting line 1284).
1285a The last three points 1285a 1285b 1285c of drawing line 102 which define curvature of missile line extended behind limiting line 1284, last registered vector point of drawing line 102.
1285b second last registered vector point of drawing line 102.
1285c third last registered vector point of drawing line 102.
1286 Basic approximation of missile curvature 1280 based on position of last 3 registered points 1285a 1285b 1285c of drawing line 102.
1287 Missile drawing line 102 starting point.
1290 “SLATE INVADERS” default game interface.
1290b “SLATE INVADERS” game interface (e.g. customized and redrawn).
1291a “SLATE INVADERS” game element 1 (e.g. customized and redrawn).
1291b “SLATE INVADERS” game element 2 (e.g. customized and redrawn).
1291c “SLATE INVADERS” game element 3 (e.g. customized and redrawn).
1291d “SLATE INVADERS” game element 4 (e.g. customized and redrawn).
1291e “SLATE INVADERS” game element 5 (e.g. customized and redrawn).
1291f “SLATE INVADERS” game element 6 (e.g. customized and redrawn).
1291g “SLATE INVADERS” game element 7 (e.g. customized and redrawn).
1291h “SLATE INVADERS” game element 8 (e.g. customized and redrawn).
1292 Actual drawing line of customized and redrawn interface.
1300 “TicTacToe” default game interface.
1300b “TicTacToe” game interface (e.g. customized and redrawn).
1301 “TicTacToe” default game symbols visuals.
1301a “TicTacToe” default game symbol visual of “Player A” 688a.
1301b “TicTacToe” default game symbol visual of “Player B” 688b.
1302 “TicTacToe” customized game symbols visuals examples.
1302a “TicTacToe” customized game symbol visual of “Player A” 688a examples.
1302b “TicTacToe” customized game symbol visual of “Player B” 688b examples.
1303 “TicTacToe” current redrawn game symbols visuals.
1303a “TicTacToe” current redrawn game symbol visual of “Player A” 688a.
1303b “TicTacToe” current redrawn game symbol visual of “Player B” 688b.
1304 “TicTacToe” current redrawn game symbols applied in game plan.
1305 Name of players.
1305a Name of “Player A” 688a.
1305b Name of “Player B” 688b.
1306 Countdown timer, remaining game play time.
1307a Score of “Player A” 688a.
1307b Score of “Player B” 688b.
1310a Customized user interface 1310a is an application interface 520 which is redrawn by user A via redrawing mode 800, the user modifies all current available interface imprints 773 and draws new own design 777, this redrawn interface design is saved, used and displayed across the whole customized interface, user can create unique, personal and brand new interface experience, this can include various customized game play and application interfaces (e.g. 1290a).
1311 Game play design contains various functional interface elements, some of them available for redrawing and customization 800.
1311a Unique game play interface design redrawn by “User A” 688a.
1311x Unique game play interface design redrawn by “User X” 688x.
1312 Unique set of application elements (e.g. game play elements).
1312a This set contains unique redrawn elements by user A, as part of the user A customized interface 1310, these sets can be shared by user to be used by other users via Noteslate warehouse 1330.
1313 User can share complex, unique and personal game play interfaces 1310 to other users, so they can use their applications with redrawn design (e.g. 1290a).
1320 “NOTESCHOOL” application interface is an alternative organizational structure and layout; using specific top timeline and school subject's overview.
1321 Upper timeline is for choosing the right pages, organized by date.
1322a First level of “TIMELINE” 624 search (e.g. showing days in “TIMELINE” as pages have been created).
1322b Second level of “TIMELINE” 624 search (e.g. showing months, e.g. showing specific title drawing imprint for page made that day).
1322c Third level of “TIMELINE” 624 search (e.g. showing specific drawing title drawing for page made that day).
1323 Toolbar for school subject icons; subject icons—imprints can be customized and redrawn by user; these navigates to standalone notebooks of pages based on current subject; examples are showing various school subjects 1323a 1323b 1323c.
1324 “ADD SUBJECT” button, user can add new subject to “NOTESCHOOL” application (e.g. used as standalone notebook).
1325 “NOTESCHOOL” drawing toolbar 9200 with customized tools.
1330 Noteslate warehouse is core of network interaction, the central place for download and implementation of handwritten assets 1331, such as Noteslate handwritten applications 1332, interface features and also user's generated interface assets (e.g. imprints, interface templates, customized gestures, etc.); it's the core resource for various handwritten assets and customized assets published by Noteslate users.
1331 warehouse 1330 handwritten assets published in Noteslate warehouse—incl. Noteslate applications, interface features, user's generated assets (e.g. handwritten gestures, interface templates, content templates, drawing tools,); each Noteslate user is able to buy or download for free these assets and implement them into own Noteslate interface.
1332 Noteslate applications for download from warehouse 1330 and implementation into Noteslate interface 520; including various types of interaction; each application is implemented as standalone page into Noteslate content so user can navigate through applications; applications are organized for download by type of handwritten interaction 1332a 1332b 1332c 1332d 1332e 1332f.
1333 Noteslate interface features are functional add-ons available for download from warehouse 1330 and implementation into Noteslate interface 520; this includes additional drawing tools 1333a, “SHARING TOOL” options 1333b, handwritten gesture characters 1333c, monetization options 1333d, Noteslate corporate cloud network and sharing setups 1333e, etc.,
1334 Some assets published in Noteslate warehouse 1330 are created and published by other users; these include new types of tools and their “IMPRINT” designs 1334a, customized interface templates 1334f, home screen “CONTENT” page functional templates 1330, gestures 1334c 1020 or whole customized gesture alphabets 1334g 1040, unique “BRUSH FILL” imprints 1334d 1390, functional “BRUSH strokes 1334e 1414, unique game play templates 1334h (e.g. 1311a) and GUI 520 customized elements 1334i.
1335 All the assets are available for download and implementation from Noteslate warehouse 1330.
1336 After Noteslate account login any Noteslate user is able to download and implement assets into own Noteslate interface.
1340a Basic interface and functional layout for Noteslate network showing current user's social profile, includes latest updates from the network related to current user, with options for further interaction; layout contains installed applications overview, related users and favorite content personalized by current user.
1340b Basic interface and functional layout for Noteslate network showing current user's handwritten content exploration page, user can view and discover latest content created on Noteslate handwritten network; overview is based on personalized preferences and tag selection; overview contains additional information and navigation such as installed applications and other related users; user can use additional “4-CORNER NAVIGATION” to search tags 531 or edit 534 the default content discovery page.
1341a Displayed “USERNAME” (Noteslate account name) with customized “AVATAR” icon (redrawn by redrawing mode).
1341b User's 1341a Noteslate account “AVATAR” displayed across network.
1341c Currently installed applications on user's 1341a account.
1341d Overview of current user's 1341a favorite handwritten content channels (based on selected tags).
1341e Current user's 1341a friends “AVATAR” icons (user can click through to discover more content from them).
1341f Preview of handwritten content favorite by current user 1341a.
1341g Sample page of shared content by current user 1341a.
1341h Page area for latest “SHORTNOTE” handwritten content shared by current user 1341a.
1341i Current user's 1341a handwritten wall, where other users can leave short message or drawing.
1342 Current user's 1341a social profile menu for further interaction.
1342a Add current user 1341a as friend.
1342b Follow current user's 1341a publicly shared handwritten content; optional specification of preferred tag selection.
1342c Send direct message to the user 1341a (e.g. sends one new full-screen page drawing).
1342d View user's 1341a selected drawings in the gallery.
1342e See current user's 1341a favorite channels (e.g. multiple “PAGE TAG” selection selected by current user 1341a).
1342f Go to default Noteslate handwritten network generic homepage.
1343 Stream of miscellaneous latest handwritten content shared by current user
1341a.
1344a Random hi-res handwritten content by the current user 1341a.
1344b Current user's 1341a latest shared pages (publicly, directly and privately).
1344c Showing current user's 1341a selection of favorite content channels (friends, followed, selected tags,).
1344d Randomly selected (recommended and personalized) handwritten content from Noteslate handwritten network; easy way to explore new content and new tag channels.
1344e Current user's 1341a friends; timer bar shows recent activity and online status (e.g. other users can see who was active recently to choose more updated content stream).
1344f Overview of current user's 1341a installed applications and its description.
1350 “DEFLECTOR” is functional burs line with specific properties, these properties can be used across interface for enhanced drawing experience and handwritten interaction, each “DEFLECTOR” element can include various values of function, velocity, angular deviation, snap delay, disappear delay.
1350a Visual example of deflector brush line with specific properties.
1350b Visual example of deflector brush line with specific properties.
1351 Interactive game play element “BALL” which consists from circular imprint element, this element can be used in interactive drawing applications (e.g. “Slatefall).
1351a Previous position of “BALL” element 1351.
1351b Point of collision of “BALL” element 1351 with “DEFLECTOR” line 1350.
1351c The position of “BALL” element 1351 after collision with deflector line 1350.
1352 The direction of “BALL” element 1351 before collision with deflector line 1350.
1353 The vertical axis of “BALL” element collision.
1354 The horizontal plane of “BALL” element collision.
1355 The direction and speed of “BALL” element 1351 after collision with deflector line 1350.
1360 The “SLATE PONG” application interface example using deflector elements for the core gaming experience 1361a 1361b, the goal of this multiplayer game is to reflect the ball to other side of the field, similar to ping pong game, based on user's drawing, the ball is reflected from bat (1361a or 1361b) into specific direction 1373 and speed 1374 and with specific speed, the goal is to get the ball to the opposite edge of the screen.
1361a “DEFLECTOR” (e.g. “SLATE PONG” bat) of “User A” 688a.
1361b “DEFLECTOR” (e.g. “SLATE PONG” bat) of “User B” 688b.
1362a Score of “User A” 688a.
1362b Score of “User B” 688b.
1371a Velocity (and direction 1352) of current game play “BALL” element 1351a before collision with deflector (functional brush) line 1350a.
1371b Regular velocity of game play “BALL” element after ideal collision with “DEFLECTOR” (functional brush) line 1350a.
1372 Regular direction of game play “BALL” element after ideal collision with “DEFLECTOR” (functional brush) line 1350a.
1373 Actual direction of current game play “BALL” element after current collision with “DEFLECTOR” (functional brush) line 1350a, affected by deflector 1350a parameters 1375.
1374 Actual velocity of current game play “BALL” element after current collision with “DEFLECTOR” (functional brush) line 1350a, affected by deflector 1350a parameters 1375.
1375 “DEFLECTOR” properties (functional brush parameters) include.
1375a Specific brush function across Noteslate interface (e.g. user can define type of brush for saving parts of page, user can share scraps of drawings with specific brush line, etc.).
1375b Physical properties—Velocity 1374 and friction parameters, affects collision with other elements (e.g. “BALL”).
1375c Physical properties—Angular deviation is a deviation from regular collision symmetrical direction 1372, the aspect of chaos can be implemented to change the reflection direction 1373.
1375d Physical properties—Snap time for collision with “BALL” 1351 or other interface elements.
1375e Time after the collision with first element (e.g. when there are more “BALL” elements 1351 in scene, the brush can disappear from page after specific time when collide with the first “BALL” element).
1377 Functional brush library contains functional brushes available across Noteslate interface.
1376a Visual examples of functional brushes with various properties, user can download them from Noteslate warehouse.
1376b Visual examples of functional brushes with various properties, user can create and design own functional brushes and share them to Noteslate warehouse.
1380 “SLATEFALL” application example using functional brushes as the core of gaming experience, the goal of this game is to reflect the falling ball 1351 by drawing various functional brushes 1350 and affect the direction 1373 and speed 1374 of the ball movement, each ball collision earn points and changes the movement direction and speed, user 688 can use various functional brushes, play various game designs, even share own custom game plans into Noteslate warehouse 1330.
1381 Display screen is the limitation 1381 of interaction, when ball 1351 reaches the edges 142 of screen 104 the user loose and the game ends.
1382 Actual speed of the ball.
1383 Countdown timer, remaining game play time.
1384 Current score of Player 688.
1390 Brush fill pattern imprint is a drawn visual pattern for brush tool, user can redraw or create own new pattern by drawing, there could be interface function 1077 attached to specific brush pattern visual 1390 to be used across Noteslate interface or specific Noteslate applications.
1391 Brush fill pattern imprint preview in wider area.
1392 Brush pattern is added to drawing toolbar 9200 for use.
1393 User can share own brush pattern to Noteslate warehouse 1330, these brush assets 1393 can be implemented to other user's interfaces.
1394 “Add new brush fill pattern” tool is swappable with “Add tool” 9398 and opens up drawing imprint menu where user can draw own brush texture.
1395 Brush pattern is saved in local brush pattern library and added into drawing toolbar 9200 for use.
1396 Brush pattern 2x scaled preview to check the details, user can edit the pixel precise details of brush texture.
1400 “PIZZA” application example using brush fill patterns as functional interface elements, user can order pizza by selecting specific brushes (e.g. cheese, pepperoni, tomatoes, bacon, etc.) and draw these brushes into specific pizza slices, then order it online.
1401 “PIZZA” application main drawing pizza imprint area.
1402 User's handwritten brush pattern input is displayed as information and pizza ingredient for simple order overview.
1403 Brush patterns with various patterns applied onto pizza slices.
1404 The pizza final order costs including selected ingredients.
1405 Confirmation button for the order.
1406 Estimated time of delivery (optional feature).
1410 Drawing interface with visual tag tool available (e.g. “SLATE”).
1411a Visual tag brush stroke 01 (e.g. #MYDESIGN).
1411b Visual tag brush stroke 02 (e.g. #SCHOOL).
1412 Visual tag tool with various pattern imprints, part of drawing toolbar 9200.
1413 Tagging area defined by the stylus input (e.g. user pushes stylus button 01 9200 to activate the visual tagging input).
1414 examples of visual tag brush strokes.
1414a specific brush stroke pattern attached to specific visual tag.
1414b specific brush stroke pattern attached to specific visual tag.
1414c specific brush stroke pattern attached to specific visual tag.
1421 Symmetrical centered axis for the device shaking.
1422a Left hand holding the Noteslate device.
1422b Right hand holding the Noteslate device.
1423 9-axis gyroscope unit able to detect and measure the value, direction, dynamics and velocity of shaking movement.
1424 The symmetrical direction of rotation, Noteslate device rotates around axis 1421 in both directions by shaking with hands 1422 for page erasing.
1425 The previous drawing 102 on the screen slowly dissolves.
1431 The asymmetric direction of rotation, Noteslate device rotates around one side axis 1432 in both directions by shaking with one hand 1422.
1432 One side asymmetric axis for the device shaking.
1433 Plane translation in both directions for page erasing.
1434 Both sided direction of rotation, Noteslate device rotates around diagonal axis 1435 in both directions by shaking with one hand 1422 for page erasing.
1435 Diagonal axis for the device shaking.
1440 “STRAIGHT LINE” game play interface example shows “STRAIGHT LINE” as the core handwritten gaming and learning experience.
1441a Starting point of the handwritten line 102, this point can be placed at the edge of the screen 142 or anywhere on the screen.
1441b Ending point of the handwritten line 102, this point can be placed at the edge of the screen 142 or anywhere on the screen.
1442 The approximate linear template. The selected pixel line is based on number of the most aligned pixels in one line 102.
1443a The total number of all drawn pixels in one line 102.
1443b The number of drawn pixels aside from straight in-lined pixels 1442.
1444 Number of line objects user is drawing (e.g. user can start with one line challenge, with every additional line the score is averaged by number of total pixels/number of misaligned pixels.
1445 Countdown timer, remaining game play time.
1446 Final game score, Score is based on total number of drawn pixels 1443a and number of misaligned pixels 1443b: SCORE=100−{(B 1443b/A 1443a)·100}, the goal is to reach 100%, which means completely straight line.
1450 Transitional pattern is used for switching in between two full screen pages 1454a and 1454b, this is by default solved by hardware display switching, in specific apps user can define the switching mode with own animated image transition.
1451 Transitional pattern 1450 can be customized as one drawing.
1452 Transitional pattern 1450 can be animated as sequence of multiple drawings 1452a 1452b 1452c.
1453 The transition interface screen using transitional pattern 1450 between two pages 1454a and 1454b.
1454a The previous full screen drawing page.
1454b The next “FULLSCREEN” drawing page.
1455a The previous image drawing.
1455b The next image drawing.
1460 The “NOTERON” tip is at the intersection of “User A” drawing 102a and any edge of the screen 1461a 1461b 1461c 1461d, the position of this point is shared 1463 from the “User A” across networked game plan to other “User B” to get connected.
1461a The upper edge of the screen 141.
1461b The right edge of the screen 141.
1461c The bottom edge of the screen 141.
1461d The left edge of the screen 141.
1462 The position of “User's A” 688a “NOTERON” tip 1460 is defined by specific point on selected screen edge (e.g. depends on current display pixel resolution of user's A interface 520a).
1463 Position of the “NOTERON” tip is shared from “User A” 688a across “NOTERON” networked game plan to other “User B” 688b.
1464 “User B” 688b receives the “NOTERON” tip position 1464 at correct side of the screen and “User B” continues in the line drawing 102b, “User B” can finish the drawing or send the “NOTERON” to any other edge of the screen 1461a 1461b 1461c 1461d, this way users create networked drawing from one continuous line, “User A” 688a or “User B” 688b or “User X” 688x can also start anytime new “NOTERON” line 102a 102b 102x and send it further.
1470 “Noteron” game application example is using “NOTERON” as the core gaming element, the goal of this game is to draw maximum pixels and achieve continuity of the line and ideally send it further to other users, user has to start the drawing from the point requested from other users, users can play in “Regular” or “Random” mode, users can “Return” “NOTERON” line to requested user, the goal is to create connected drawing from various drawings and networked lines.
1471 Special “NOTERON” “TOOLBAR” brings some enhanced playing options and additional “TOOLS”.
1471a View game play users, view current game play session users, edit friends, etc.
1471b My personal game play profile.
1471c Add user to game play.
1471d Turn on “Random” mode where user gets requests from random “NOTERON” users (not just friends).
1471e Start a new “Noteron” session.
1471f Return the current “NOTERON” (special drawing mode where user returns “NOTERON” drawing back to previous user who requested to continue the noteron).
1471g Draw line/Start a new “NOTERON”.
1471h Inverted preview of the screen (e.g. pleasure for drawing).
1472 “NOTERON” line drawing in current game play session.
1473 Current score (e.g. shows number of pixels drawn through current session).
1474 Active users in current “NOTERON” game play session.
1475 Change the view, user 688 can see all the other “NOTERON” drawings around, all the networked drawings which are connected through line drawings 102 to current drawing 1472.
1476 User B (“Kurosawa”) is requesting “NOTERON” connection from current user 688, current user can approve 1476a, deny 1476b or touch the “User B” icon 1476c for further personal info, also “User A” sees connection request alert box on the screen 1476d.
1480 Sharing the current drawing 102a from user A 688a across Noteslate network 1501 via specific sharing interface 1500 to other user 688b.
1481a Current page drawing is temporarily saved and shared through current drawing application 1501b, at the same time it can be saved to Noteslate cloud backup 1501b or user's 688a Noteslate social profile 1501c.
1481b Current page or part of it is shared through email 1502a.
1481c Current page or part of it is send directly 1501a to other Noteslate user 688b through handwritten network 1501, content can be saved also to Noteslate cloud 1501b and Noteslate social profile 1501c.
1481d Current page or part of it is shared to Noteslate cloud 1501b and Noteslate social profile 1501c to be viewed by other users.
1490 One complex sharing menu interface contains various options for sharing 1500 of the handwritten content 102 1499.
1491 Icon “IMPRINT” button of Noteslate handwritten platform 1501 (SELECTED BUTTON STAGE).
1492 Icon “IMPRINT” button of sharing via email 1502a (UNSELECTED BUTTON STAGE).
1492a Specific email address for sharing the drawing 1499 to.
1493 Icon “IMPRINT” button of sharing to existing internet platforms 1502b (SELECTED BUTTON STAGE).
1493a Twitter social network “IMPRINT” (SELECTED).
1493b Facebook social network “IMPRINT” (UNSELECTED).
1494 Specific direct Noteslate user sharing section, showing specific user “IMPRINT” icon (SELECTED).
1494a Specific user to whom the drawing 1499 will be shared to.
1495 Summary of current sharing direction and types, including all types of current (SELECTED) sharing.
1496 Confirmation of current sharing 1495.
1497 User can return to previous interface 520 by touching the screen outside of sharing interface 1490.
1499 The current shared page drawing 1499 made by the user, created and shared inside Noteslate interface 520, the example is using slate interface 570.
1500 “SHARING” in Noteslate interface in networked mode 1510, user needs to enable Wi-Fi or mobile connectivity on Noteslate device, “SHARING” options through Noteslate interface offers various ways to share handwritten content across network 1510, these sharing options 1501 1502 are available only with share switch button 2002 turned on.
1501 Slate platform depicts network interaction 1510 between Noteslate devices, users interact across handwritten network through Noteslate interface, create handwritten content and share that in various ways through Noteslate applications.
1501a Direct sharing depicts sharing principle directly between Noteslate users.
1501b Handwritten content is shared through various Noteslate applications (e.g. 1500) available in Noteslate warehouse 1500.
1501c Noteslate social profile 1340a is personal cloud channel 1340b of shared handwritten content, this social interaction is including various types of shared handwritten content.
1501d Noteslate cloud backup is personal cloud storage to save shared images, pages and other handwritten content.
1502 Handwritten content shared outside of handwritten network through internet, incl. mobile networks, social networks, web, private networks or any Wi-Fi enabled network interaction with other devices.
1502a Sharing through email, user adds email address to share the handwritten content.
1502b Social networks and personal cloud storage services where user can share Noteslate drawings to.
1502c Other mobile platforms for online sharing interaction with handwritten content created on Noteslate devices, users can connect through Noteslate applications available for these mobile platforms.
1502d User can share content from Noteslate device to desktop interface.
1502e Offline sharing from Noteslate device with disabled network connection 1510 is secured and private way to share handwritten content, user can share content via USB cable between devices 1503a to desktop 1503b or through SD card 805.
1503 Offline sharing via USB cable between Noteslate devices.
1503a Offline sharing via USB cable from Noteslate device to desktop.
1503b Offline sharing with SD card taken from Noteslate device reader 805.
1503c Networked mode for Noteslate device, user needs to enable this mode by turning ON the sharing button 801 and enable networked Wi-Fi or mobile connection on the device, Noteslate device 100 is able to get connected to slate handwritten network 1501, internet 1502, various mobile apps 1502c or social networks 1502b and share 1500 the handwritten content.
1511 Real-time page sharing allows to share current page 520a to other user 688b through handwritten network 1501, this real-time sharing 1510 is sending each pixel of handwritten content 102a from user A 688a to other user 688b or to network social profile 1501c, this principle is used in various Noteslate applications sharing (e.g. “CHAT” application 580).
1512 Batch sharing is sending small amount of pixels of current handwritten interaction immediately to other user 1501a or to network 1501c, the batch is a small amount of pixels or a whole drawing, sharing speed optimization is based on available network 1510 parameters and available speed.
1530 Handwritten content 1531a 1531b generated on multiple devices 100a 100b on the same Noteslate interface 520a 520b and shared in real-time 1511 or in small batches 1512 across handwritten network 1501.
1531a Handwritten drawing 102a created by user A 688a on Noteslate device 100a and shared directly to user B 688b, users are sharing the same drawing interface 520a 520b.
1531b Handwritten drawing 102b created by user B 688b on Noteslate device 100b and shared directly to user A 688a, users are sharing the same drawing interface 520a 520b.
1540 Direct sharing of the same drawing page interface 520a 520b 520c among multiple users 688a 688b 688c.
1541a User A 688a shares the current page drawing application interface 520a with other users in real-time 1511 1512 across handwritten network 1501, users 688a 688b 688c can interact anytime with the shared handwritten content 102a 102b 102c.
1541b User B 688b shares the current page drawing application interface 520b with other users in real-time 1511 1512 across handwritten network 1501, users 688a 688b 688c can interact anytime with the shared handwritten content 102a 102b 102c.
1541c User C 688c shares the current page drawing application interface 520c with other users in real-time 1511 1512 across handwritten network 1501, users 688a 688b 688c can interact anytime with the shared handwritten content 102a 102b 102c.
1555 Sharing 1500 of handwritten content 102a between various devices with networked mode 1510 enabled (from and to Noteslate device 100a and from and to other devices—desktop 1553, tablet device 1552, smart phone 1551, Noteslate device 101e—using Noteslate interface application 520a 520b 520c 520d, sharing is provided through network connection 1510 and Noteslate handwritten platform 1501 1502 enabled.
1551 Smart phone device with Noteslate interface application interface.
1552 Tablet device with Noteslate interface application interface
1553 Desktop computer with Noteslate interface application interface
1560 “Unlocking three line gesture” 1560 consists from three separate gesture input lines 1560a 1560b 1560c.
1560a The first input line of unlocking handwritten gesture 1560.
1560b The second input line of unlocking handwritten gesture 1560.
1560c The third input line of unlocking handwritten gesture 1560.
1561 The drawing unlocking screen interface fills the entire screen size.
1562 Number of intersections of handwritten input lines 1560a 1560b 1560c defined in gesture design template 1015 1560.
1562a The intersection of handwritten input lines 1560a 1560b.
1562b The intersection of handwritten input lines 1560a 1560c.
1562c The intersection of handwritten input lines 1560b 1560c.
1570 The unlocking gesture 1560 recognition process.
1571 The unlocking gesture 1560 recognition consists from various parameters 1040 1572 1573.
1572 Recognition of lines only drawn in current gesture input 1020.
1572a Number of three gesture lines successfully recognized.
1572b Number of three gesture lines not recognized.
1573 Additional unlocking gesture parameters 1573a 1573b 1573c 1573d 1573e 1573f.
1573a Starting coordinates of gesture input lines 1560a 1560b 1560c.
1573b Gesture 1560 pattern template 1015 recognition comparison.
1573c Recognition of intersections 1562 of lines 1560.
1573d Recognition of lines 1560 angles and direction (part of gesture pattern recognition 1573b.
1573e Length of lines 1560a 1560b 1560c.
1573f Additional stroke velocity recognition, comparing number of vector points captured when drawing 1020 a line 1560.
1574 If the gesture 1560 is not recognized 1571 user has to repeat the gesture input 1020 to unlock the Noteslate device.
1575 Unlocking gesture 1560 input is recognized.
1576 Gesture 1560 is verified and compared to gesture template 1015 in currently used handwritten character alphabet 990.
1577a Successfully confirmed gesture input 1560 recognition, device is unlocked 1579
1577b Unsuccessfully confirmed gesture input 1560 recognition, repeat gesture input 1574.
1577c After three failed attempts to input right unlocking gesture 1560 user can use the letter password 1578 to unlock the device, after three failed keyboard inputs device goes to “TRESOR MODE” which needs to be restored and all the data will be locked inside.
1578 After three failed gesture inputs user can unlock the device by typing the unlocking password.
1579 Noteslate device is successfully unlocked and fully functional, all features, interfaces, connectivity and settings are available.
1580 “Unlocking one line gesture” consists from one gesture input line 1580.
1581 The drawing unlocking screen interface fills the entire screen size.
1582 Number of intersections of handwritten gesture input line 1580 defined in gesture design template 1015 1580.
1582a The first intersection of handwritten gesture input line 1580.
1582b The second intersection of handwritten gesture input line 1580.
1590 The unlocking gesture 1580 recognition process.
1591 The unlocking gesture 1580 recognition consists from various parameters 1040 1592 1593.
1592 Recognition of only one line drawn in current gesture input 1020
1592a Only one gesture line successfully recognized.
1592b Number of gesture lines not recognized.
1593 Additional unlocking gesture parameters 1593a 1593b 1593c 1593d 1593e 1593f.
1593a Starting coordinates of gesture input line 1580.
1593b Gesture 1580 pattern template 1015 recognition comparison.
1593c Recognition of intersections 1582 of line 1580.
1593d Recognition of line 1580 angles and direction (part of gesture pattern recognition 1593b.
1593e Length of line 1580.
1593f Additional stroke velocity recognition, comparing number of vector points captured when drawing 1020 a line 1580.
1594 If the gesture 1580 is not recognized 1591 user has to repeat the gesture input 1020 to unlock the Noteslate device.
1595 Unlocking gesture 1560 input is recognized.
1596 Gesture 1580 is verified and compared to gesture template 1015 in currently used handwritten character alphabet 990.
1597a Successfully confirmed gesture input 1580 recognition, device is unlocked 1599.
1597b Unsuccessfully confirmed gesture input 1580 recognition, repeat gesture input 1594.
1597c After three failed attempts to input right unlocking gesture 1580 user can use the letter password 1598 to unlock the device, after three failed keyboard inputs device goes to “TRESOR MODE” which needs to be restored and all the data will be locked inside.
1598 After three failed gesture inputs user can unlock the device by typing the unlocking password.
1599 Noteslate device is successfully unlocked and fully functional, all features, interfaces, connectivity and settings are available.
1600 Drawing quality is a principle for evaluation of any handwritten content 102 made across Noteslate interface by the user, this value can be used for organization of drawings, sharing and viewing preferences, ranking of shared content, individual content monetization, etc. Content includes full page drawings, parts of page and other handwritten elements. These drawing related data can be saved (optionally shared) as part of the image file as metadata inside Noteslate handwritten platform 1501.
1601 Drawing parameters are describing features of the drawing itself, such as number of drawn pixels 1601a, time user spent on the drawing 1601b, how many users have been creating the artwork 1601c, etc.
1601a Amount of pixels drawn 525a as handwritten input 102 by the user 688.
1601b Time which was spent on drawing, counts only time when interface was active and user has been touching by stylus 110 the screen 104, net to drawing time.
1601c Time which was spent on creating the page, counts whole time when interface was active and user have been drawing 110 or touching 902 the screen 104, cumulative time of page creation.
1601d Depicts how many users have been collaborating on the drawing, more users means higher value.
1602 Content parameters are related to networked aspects of shared drawings, including community feedback values and opinions, appreciation, originality and uniqueness.
1602a Theme of drawing 102 based on tags 1260 user added to the shared drawing (e.g. originality, less often use is higher value), tags also define how interesting is the drawing for content search across handwritten network 1501.
1602b How many times community of Noteslate users had re-shared the drawing 102 through handwritten network 1501 and other networks 1502.
1602c Community positive votes for shared drawing 102.
1602d How many Noteslate users viewed the page drawing.
1602e Community copyright—the value describing use of page drawing by other users, this includes redrawing, editing, inserting, animating, etc. (e.g. how many users used the drawing for further work, implemented the drawing into own handwritten content), kind of “community copyright value”.
1603 Additional individual custom parameters.
1603a Author's experience in drawing previous content.
1603b Type of application used for the drawing, tools available, used brushes, etc. (e.g. one line “NOTERON” drawing).
1603c Time when user made the drawing.
1603d Page resolution and digital computer generated quality aspects of the image (e.g. randomness of brush patterns).
1603e Number of pages included in one drawing (e.g. related to animated pages with multiple themes and same visual basics).
1604a Approximate basic value of current drawing based on 1601 1602 1603 parameters.
1604b Aspect of moment, time when user wants to release the drawing for monetization (demand, topic, tags, community demand, popularity, etc.).
1605 Overall rating index of drawing is based on basic value 1604a and time aspects of release 1604b for monetization 1606.
1606 Monetization and shared revenue 1606a 1606b of the drawing 102, based on overall rating index 1605, revenue stream is shared among the author 1606a and Noteslate network 1606b.
1606a Revenue from drawing 102 monetization 1606 and resharing 1607 is divided between the author 1606a and handwritten network 1501 1606b Income is influenced by quality of used drawing 1600 and its rating index 1605.
1607 Drawing resharing, targeted drawing displaying, publishing, advertisement attachment and monetization, drawing artwork implementations are examples of revenue income for drawing 102 monetization 1606 made by the author 688 and shared across Noteslate handwritten network 1501.
1700 Noteslate device side thin edge profile outline.
1701 Noteslate device back body part “tub” profile.
1702 Noteslate device back body part “bowl” profile.
1703 Noteslate device back body part “leaf” profile.
1704 Noteslate device symmetrical middle thin edge profile.
1705 Noteslate device symmetrical front body panel profile.
1706 Noteslate device symmetrical back body panel profile.
1707 Noteslate device back body part “block” profile.
1708 Noteslate device body part embossed texture.
1801 Linearly extended edge profile 1700 to connectors.
1802 Smoothly extended edge profile 1700 to connectors.
2001 “Share switch button” center stylus dip.
2002 “Share switch button” slider switch.
2003 “Share switch button” graphical icon “Turned OFF” (OFFLINE) embossed.
2004 “Share switch button” graphical icon “Turned ON” (ONLINE) embossed.
2101 Share button finger slider switch nail dip.
2102 Share button finger slider switch.
2201 Hexagonal stylus body.
2202 Hexagonal stylus drawing tip.
2203 Hexagonal stylus erasing rubber tip.
2205 Hexagonal stylus functional button 01 (e.g. used for eraser, second drawing function, area selection, etc.).
2206 Placement of functional button 01 2205 on the stylus body 2201.
2207 Hexagonal stylus functional button 02 (e.g. can be used for gesture input).
2208 Placement of functional button 02 2207 on the stylus body 2201.
2210 The thin side thickness of the stylus eraser 2203.
2211 The wide side thickness of the stylus eraser 2203.
2220 The thin eraser line thickness.
2221 The wide eraser line thickness.
2222 Noteslate stylus branding placed on stylus body.
2301 Triangular stylus body.
2302 Triangular stylus drawing tip.
2303 Triangular stylus erasing rubber tip.
2304 Triangular stylus functional button 01.
2305 Triangular stylus functional button 02.
2306 Placement of functional button 01 2304 and button 02 2305 on the stylus body 2301.
2307 Noteslate stylus branding placed on stylus body.
2401 Chalk stylus body.
2402 Chalk stylus drawing tip.
2403 Chalk stylus erasing rubber tip.
2404 Chalk stylus functional button 01.
2405 Chalk stylus functional button 02.
2406 Placement of functional button 01 2404 and button 02 2405 on the stylus body
2401.
2408 The thin drawing line.
2409 The thick drawing line or eraser thickness.
2420 9-axis gyroscope unit measures position, direction and angle of stylus.
2501 Smooth stylus body.
2502 Smooth stylus drawing tip.
2503 Smooth stylus erasing rubber tip.
2504 Smooth stylus functional button 01.
2505 Smooth stylus functional button 02 (e.g. user can use this button for handwritten gesture input interface, clicking 902 this button activates the gesture input area 1120 for handwritten gesture input).
2506 Placement of functional button 01 2504 on the stylus body 2401.
2507 Placement of functional button 02 2505 on the stylus body 2401.
2600 Magnetic stylus magnetic holder channel.
2601 Magnetic stylus body.
2602 Magnetic stylus drawing tip.
2603 Magnetic stylus erasing rubber tip.
2604 Magnetic stylus holder channel magnetic elements.
2700 Stylus basic drawing touch position (starting touch point).
2701 Noteslate stylus in default drawing position and angle.
2702 The adjusted drawing line by tilted stylus 2721.
2705 The angle and direction measured by stylus gyroscope unit 2420.
2711 Noteslate stylus in raised angle drawing position.
2721 Noteslate stylus in tilted angle drawing position.
2722 The adjusted drawing line by raised stylus 2711.
2800 Noteslate A5 body (9.7-inch model).
2804 Noteslate 9.7-inch electronic paper display module.
2900 Noteslate A6+ body (6.8-inch model).
2904 Noteslate 6.8-inch electronic paper display module.
3001 Magnetic attachment module inside triangular magnetic stylus.
3002 Magnetic elements inside triangular magnetic stylus.
3003 Opposite magnetic elements inside Noteslate body frame.
3011 Opposite magnetic attachment module inside Noteslate body.
3301 Embossed paper texture “LINEAR” visual.
3302 Embossed paper texture “RANDOM” visual.
3310 Embossed paper texture applied on side of Noteslate body.
3333 Triangular magnetic stylus.
3400 Noteslate solar cover.
3401 Noteslate solar cover photovoltaic panel.
3402 Noteslate solar cover elastic strap wrapped around Noteslate body.
3403 Stylus elastic holder as part of the solar cover.
3404 USB connection between solar cover and Noteslate device.
3410 Sunlight (source of photo energy).
3411 Sunlight rays reaching the solar cover photovoltaic panel.
3501 Magnetic elements in solar cover holding the cover attached to the Noteslate device.
3502 Opposite magnetic or metal elements in Noteslate body frame.
3600 Portable generic tablet computer device with display, optional stylus, touch or multi-touch interface.
3601 Magnetic snap mechanism as part of solar cover.
3602 Opposite magnetic snap elements inside solar cover to keep solar cover attached on the device.
3603 USB connection for continuous charging of the device.
3610 Solar cover back side.
3620 Optional wireless charging module inside the solar cover.
4000 “SLATE DESIGN” Noteslate body.
4001 “SLATE DESIGN” body with curved profile.
4002 “SLATE DESIGN” body embossed texture.
4003 Embossed branding.
4004 Curved slate design Noteslate body with curved edges.
4005 Functional button 1 111 with custom “SLATE DESIGN” shape.
4006 Functional button 2 112 with custom “SLATE DESIGN” shape.
4007 Functional button 3 113 with custom “SLATE DESIGN” shape.
4008 “SLATE DESIGN” curved stylus with curved edges.
4100 “BLOCK DESIGN” Noteslate body.
4101 “BLOCK DESIGN” stylus.
4102 “BLOCK DESIGN” stylus tubular attachment ring.
4103 “BLOCK DESIGN” stylus tubular holder.
4104 Tubular stylus holder hole for nesting the stylus 4101.
4105 Functional button 1 111 with custom “BLOCK DESIGN” shape.
4106 Functional button 2 112 with custom “BLOCK DESIGN” shape.
4107 Functional button 3 113 with custom “BLOCK DESIGN” shape.
4200 Noteslate device module as part of the “MULTI OFFICE” design.
4201 2D image scanner module as part of the “MULTI OFFICE” design.
4202 Solar photovoltaic module as part of the “MULTI OFFICE” design.
4203 Additional battery module as part of the “MULTI OFFICE” design.
4204 Paper printer module as part of the “MULTI OFFICE” design.
4205 “MULTI OFFICE” design flexible docking module for attaching and holding all the modules 4200 4201 4202 4203 4204.
4206 Nesting dock for Noteslate stylus 101.
4207 Three functional Noteslate buttons 103 adapted to “MULTI OFFICE” design.
4208 USB connector input in docking module.
4209 Optional power input for all the modules 4200 4201 4202 4203 4204.
4210 Docking snap male feature to attach and connect all the “MULTI OFFICE” modules 4200 4201 4202 4203 4204.
4211 Docking snap female feature to hold and connect all the “MULTI OFFICE” modules 4200 4201 4202 4203 4204.
4212 USB connector for docking, data transfer and charging.
4400 Regular office file box dimensions.
4401 Office file box width is the same as dock 4205 width.
4402 Office file box height is the same as dock 4205 height.
4500 Smooth symmetrical design Noteslate body.
4501 Smooth symmetrical design Noteslate stylus with magnetic attachment 2600.
4502 Smooth symmetrical design second Noteslate button 112.
4503 Second Noteslate button 112 with extended functionality and joystick usability (when only second button 112 is available).
4503a Left function on Noteslate button 4503.
4503b Right function on Noteslate button 4503.
4503c Down function on Noteslate button 4503.
4503d Up function on Noteslate button 4503.
4700 Noteslate body with children design concept.
4800 Haptic screen cover surface with displaced texture, embossed texture is giving haptic feedback for stylus 4801 drawing.
4801 Passive or active tablet stylus—e.g. “Noteslate stylus” 101.
4804 Tablet display screen with haptic screen cover 4800.
4805 Stylus touching the display screen 4804.
4901 Haptic screen cover flexible plastic materials.
4902 Adhesive surface of back side of haptic screen cover.
4903 Other display screen substrate, backplane, support, etc.
4904 Tablet stylus 4801 drawing across display surface.
5001 Tablet device body frame around display.
5002 Tablet device display screen module.
5003 Haptic screen cover cutouts.
5004 Tablet device buttons, e.g. Noteslate buttons 103.
5010 Haptic screen cover granite, stone or slate texture.
5011 Haptic screen cover wood texture.
5012 Haptic screen cover bark texture.
5013 Haptic screen cover blueprint texture.
5101 Optional haptic screen cover cutout.
5102 Tablet device 3600 buttons (e.g. finger reader recognition).
6461 Variable height of the sliced page.
6462 Fixed height of the “SHORTNOTE” page.
6481a The cut line example A to format the page 641 for sharing.
6481b The cut line example B to format the page 641 for sharing.
6482 The side cut line to format “SHORTNOTE” page 642 643 644 645.
6482a The side cut example line to format the “SHORTNOTE” page 642.
6482b The side cut line to format the “SHORTNOTE” page 643.
6482c The side cut line to format the “SHORTNOTE” page 644.
6482d The side cut line to format the “SHORTNOTE” page 645.
6511 The neighbor upper page for extended drawing area.
6512 The neighbor right page for extended drawing area.
6513 The neighbor bottom page for extended drawing area.
6514 The neighbor left page for extended drawing area.
7421 Left hand is holding Noteslate device in right handed drawing interface settings.
7422 Right hand is holding Noteslate device in left handed drawing interface settings.
7451 The direction of natural device rotation from portrait to landscape view for right handed drawing interface settings.
7452 The direction of natural device rotation from portrait to landscape view for left handed drawing interface settings.
8101 Inner “PAGE THUMBNAIL” “IMPRINT” area.
8102 Outer “PAGE THUMBNAIL” “IMPRINT” area.
8101b Selected inner page thumbnail imprint area after finger touch 812 selection.
8102b Inner page thumbnail imprint area after finger touch 811 selection.
9021 Finger touch 902 pan movement “UP” direction across Noteslate interface 520.
9022 Finger touch 902 pan movement “RIGHT” direction across Noteslate interface 520.
9023 Finger touch 902 pan movement “DOWN” direction across Noteslate interface 520.
9024 Finger touch 902 pan movement “LEFT” direction across Noteslate interface 520.
9101 Basic Noteslate system font “Noteslate REGULAR RIGHT” characters, used across default Noteslate interface with right handed interface settings.
9102 Basic Noteslate system font “Noteslate REGULAR LEFT” characters, used across default Noteslate interface with left handed interface settings.
9110 Detail of “A” character of basic Noteslate system font “Noteslate REGULAR RIGHT”.
9120 Detail of “A” character of basic Noteslate system font “Noteslate REGULAR LEFT”.
9200 Noteslate drawing “TOOLBAR”, is a core of the drawing interface, “TOOLBAR” is adopted across Noteslate interface and modified based on current application interface (e.g. specific “TOOLS” are added for specific application), it's the basic place of slate “TOOLS” 9201-9399 (e.g. custom designed brushes, imprints, patterns, functional brushes, etc.) and sharing and special application “TOOLS”. The complexity and “TOOLBAR” setup can be customized based on user's drawing experience and “TOOLS” usability (see FIG. 93). Each of the tool icons (imprints) can be edited and redrawn (see FIG. 95).
9201 “TOOL” 1 example as part of the toolbar 9200.
9202 “TOOL” 2 example as part of the toolbar 9200.
9203 “TOOL” 3 example as part of the toolbar 9200.
9204 “TOOL” 4 example as part of the toolbar 9200.
9205 “TOOL” 5 example as part of the toolbar 9200.
9222 “TOOLS” can be swapped or rearranged in “TOOLBAR” layout.
9210 The latest recent document.
9211 The next recent document (based on used application, for further details about recent documents icons see FIG. 94).
9301 Icon (“IMPRINT”) of “Creating new page” “TOOL”.
9301b Edited redrawn “IMPRINT” of “Creating new page” “TOOL”.
9302 Icon (“IMPRINT”) of “Delete current page” “TOOL”.
9302b Edited redrawn “IMPRINT” of “Delete current page” “TOOL”.
9303 Icon (“IMPRINT”) of “Pencil” tool.
9303b Edited redrawn “IMPRINT” of “Pencil” “TOOL”.
9304 Icon (“IMPRINT”) of “Eraser” “TOOL”.
9304b Edited redrawn imprint of “Eraser” “TOOL”.
9305 Icon (“IMPRINT”) of “Ink” “TOOL”.
9306 Icon (“IMPRINT”) of “Invert page” “TOOL”.
9307 Icon (“IMPRINT”) of “1px width” “TOOL”.
9307b Edited redrawn “IMPRINT” of “1px width” “TOOL”.
9308 Icon (“IMPRINT”) of “2px width” “TOOL”.
9308b Edited redrawn “IMPRINT” of “2px width” “TOOL”.
9309 Icon (“IMPRINT”) of “3px width” “TOOL”.
9310 Icon (“IMPRINT”) of “4px width” “TOOL”.
9311 Icon (“IMPRINT”) of “5px width” “TOOL”.
9312 Icon (“IMPRINT”) of “7px width” “TOOL”.
9313 Icon (“IMPRINT”) of “8px width” “TOOL”.
9314 Icon (“IMPRINT”) of “10px width” “TOOL”.
9315 Icon (“IMPRINT”) of “Custom fill brush” 1 “TOOL”.
9316 Icon (“IMPRINT”) of “Custom fill brush” 2 “TOOL”.
9317 Icon (“IMPRINT”) of “Custom fill brush” 3 “TOOL”
9318 Icon (“IMPRINT”) of “Custom fill brush” 4 “TOOL”.
9319 Icon (“IMPRINT”) of “Custom fill brush” 5 “TOOL”.
9320 Icon (“IMPRINT”) of “Custom fill brush” 6 “TOOL”.
9321 Icon (“IMPRINT”) of “Custom fill brush” 7 “TOOL”.
9322 Icon (“IMPRINT”) of “Custom fill brush” 8 “TOOL”.
9323 Icon (“IMPRINT”) of “Custom fill brush” 9 “TOOL”.
9325 Icon (“IMPRINT”) of “ADD PAGE TAG” “TOOL” (see more FIG. 126).
9392 Icon (“IMPRINT”) of “Show toolbar” “TOOL” (hides or shows “TOOLBAR” 9200 in current application interface 520).
9392b Edited redrawn “IMPRINT” of “Show toolbar” “TOOL”.
9398 Edited redrawn imprint of “Add new tool” “TOOL” (i.e. adding brush fill imprint on FIG. 139), User 688 can add new “TOOL” from Noteslate warehouse 1330 or by creating own new unique “TOOL” through Noteslate interface.
9399 Icon (“IMPRINT”) of “SHARING” “TOOL” (See more FIG. 149, FIG. 150,).
9399b Edited redrawn imprint of “SHARING” “TOOL”.
9400 Second upper layer of drawing “TOOLBAR” 9200 with recent “Slate” interface documents 9401 9402, concrete functionality of recent documents icon depends on current application used.
9401 The recent document “Slate” interface 570 icon 1 example.
9402 The recent document “Slate” interface 570 icon 2 example.
9410 Second upper layer of drawing “TOOLBAR” 9210 with recent “Chat” interface documents 9411 9412, concrete functionality of recent documents icon depends on current application used.
9411 The recent document “Chat” interface 580 icon 1 example.
9412 The recent document “Chat” interface 580 icon 2 example.
9420 Second upper layer of drawing “TOOLBAR” 9220 with recent “Reader” interface documents 9421 9422, concrete functionality of recent documents icon depends on current application used.
9421 The recent document “Reader” interface 590 icon 1 example.
9422 The recent document “Reader” interface 590 icon 2 example.
9430 Second upper layer of drawing “TOOLBAR” 9230 with recent “Anislate” interface documents 9431 9432, concrete functionality of recent documents icon depends on current application used.
9431 The recent document “Anislate” interface 980 icon 1 example.
9432 The recent document “Anislate” interface 980 icon 2 example.

As described herein, computer software products can be written in any of various suitable programming languages, such as C, C++, C#, Pascal, Fortran, Perl, Matlab (from MathWorks), SAS, SPSS, JavaScript, AJAX, and Java. The computer software product can be an independent application with data input and data display modules. Alternatively, the computer software products can be classes that can be instantiated as distributed objects. The computer software products can also be component software, for example Java Beans or Enterprise Java Beans. Much functionality described herein can be implemented in computer software, computer hardware, or a combination.

Furthermore, a computer that is running the previously mentioned computer software can be connected to a network and can interface to other computers using the network. The network can be an intranet, internet, or the Internet, among others. The network can be a wired network (for example, using copper), telephone network, packet network, an optical network (for example, using optical fiber), or a wireless network, or a combination of such networks. For example, data and other information can be passed between the computer and components (or steps) of a system using a wireless network based on a protocol, for example Wi-Fi (IEEE standard 802.11 including its substandards a, b, e, g, h, i, n, et al.). In one example, signals from the computer can be transferred, at least in part, wirelessly to components or other computers.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

1. A drawing slate device to provide a unique handwriting interface to facilitate handwritten interaction, the drawing slate device comprises:
a core hardware module including a stylus digitizer and electronic paper display; a stylus as handwritten input for the stylus digitizer, wherein the stylus is one of a hexagonal design, triangular design, chalk design, smooth circular design along with two optional functional buttons;
a handwriting interface to enable drawing, writing and handwritten interactions thereby providing a user with a completely new handwriting experience and digital interaction, the handwriting interface is one of a monochrome interface and color interface;
a slate configured with one of the monochrome interface and color interface and includes a toolbar with a plurality of tools and brushes;
a plurality of interface elements to enable handwritten interaction by redrawing to achieve a unique look of the graphical user interface;
an input area configured in one of the monochrome interface and color interface to allow a user to edit and redraw a design of an interface element or current graphical design of the interface;
an imprint area with a brush tool to enable the user to define a pattern by drawing, edit and redraw a current image; and
a plurality of functional brushes to enable specific functions in the drawing.

2. The drawing slate device of claim 1 wherein the stylus includes a drawing tip and an eraser for handwritten input, the eraser holds various thickness of eraser line.

3. The drawing slate device of claim 1 wherein the stylus is controlled by three programmable buttons each possesses specific functions.

4. The drawing slate device of claim 1 and further comprising:
a finger touch layer above the electronic paper display to receive finger touch input by hand.

5. The drawing slate device of claim 4 and further comprising:
a finger touch slider bar placed on an edge of the drawing slate device; and
a plurality of touch sensitive capacitive buttons through which the user achieves various functions by touch combinations of the buttons.

6. The drawing slate device of claim 1 and further comprises of a magnetic holder functionality wherein the stylus is freely laid down to the display area against gravity.

7. The drawing slate device of claim 1 and further comprising:
a share switch button to facilitate online sharing and network connection, wherein the share switch button is operated by using one of the stylus with the stylus tip and finger tip;
an audio jack output;
a power ON/OFF button;
an USB micro connector; and
a micro SD card reader.

8. The drawing slate device of claim 1 wherein the handwritten interaction and handwriting input is based on the angle position of the stylus and data from internal stylus 9-axis gyroscope unit thereby allowing the user to change own handwriting style and handwriting input.

9. The drawing slate device of claim 1 and further comprising:
a magnetic stylus attachment that is configured with a magnetic module with at least two magnetic elements to easily attach the magnetic stylus to the drawing slate device, wherein the side of the drawing late device includes a magnetic module with in-built magnets.

10. The drawing slate device of claim 9 wherein the in-built magnets are placed on the side of connectors.

11. The drawing slate device of claim 1 wherein an embossed paper block texture is wrapped around the body and around the edges, the embossed paper block texture is one of a regular texture design and a randomized texture design.

12. The drawing slate device of claim 1 and further comprising:
solar powered cover accessories that includes a pocket for nesting the stylus, an elastic strap for attaching to the drawing slate device and a photovoltaic panel exposed to sun light source to gain electric power and connected through a USB to the drawing slate device.

13. The drawing slate device of claim 1 and further comprising:
transparent screen cover for enhanced handwriting experience, wherein the screen cover is made from semi-flexible plastic material.

14. The drawing slate device of claim 1 and further comprising:
basic four-corner navigation principles combined with one of a one time swipe, double swipe, pagination and reversed pagination.

15. The drawing slate device of claim 1 and further comprising:
an interface that redraws its visual by hand drawing, a user of the drawing slate device activates redrawing mode at anytime thereby allowing the user to redraw the whole screen area by one continuous drawing and save it as a new design template while preserving the same functionality and interaction.

16. The drawing slate device of claim 15 wherein the redrawing mode is activated by one of a button and by touching the screen for a predefined time period.

17. The drawing slate device of claim 1 wherein the imprint area is configured with a plurality of functional brushes to enable specific functions in the drawing.

18. The drawing slate device of claim 15 wherein a toolbar redrawing includes an imprint for each tool that is changed and customized through the redrawing mode thereby creating individual and non obtrusive set of tools.

19. The drawing slate device of claim 1 and further comprising:
a content interface that shows the whole content, pages, pages thumbnails, application, application pages and other data on the drawing slate device thereby allowing content to be redrawn by the user.

20. The drawing slate device of claim 1 and further comprising:
a timer bar element indicating time aspect for various interface elements thereby allowing the user to specify time length of each frame to set the whole timeline.
